(19) United States
(12) Patent Application Publication
(10) Pub. No.: US 2017/0000132 A1
(43) Pub. Date: Jan. 5, 2017

(54) BENZOXABOROLE FUNGICIDES

(71) Applicant: SYNGENTA PARTICIPATIONS AG, Basel (CH)

(72) Inventors: Ramya RAJAN, Goa (IN); Daniel STIERLI, Stein (CH); Atul MAHAJAN, Goa (IN); Renaud BEAUDEGNIES, Stein (CH); Peter RENOLD, Stein (CH)

(73) Assignee: Syngenta Participations AG, Basel (CH)

(21) Appl. No.: 15/107,018

(22) PCT Filed: Dec. 23, 2014
(86) PCT No.: PCT/EP2014/079215

§ 371 Date: Jun. 21, 2016

(30) Foreign Application Priority Data
Dec. 23, 2013 (IN) 3738/DEL/2013

(51) Int. Cl. A01N 55/08; A01N 25/04; C07F 5/02

(52) U.S. Cl. CPC A01N 55/08; C07F 5/027; A01N 25/04

(57) ABSTRACT

Compounds of formula (I) are as defined in the claims, and their use in compositions and methods for the control and/or prevention of microbial infection, particularly fungal infection, in plants and to processes for the preparation of these compounds.

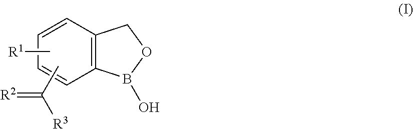

The present invention relates to novel microbiocidally active, in particular fungicidally active, oxoborazoles moiety containing compounds their use in compositions and methods for the control and/or prevention of microbial infection, particularly fungal infection, in plants or plant propagation material, harvested food crops by phytopathogenic microorganisms, preferably fungi and to processes for the preparation of these compounds. Preferably these compounds are used in agriculture or horticulture for controlling or preventing infestation of plants by phytopathogenic microorganisms, preferably fungi.

The incidence of serious microbial infections, particularly fungal infections, either systemic or topical, continues to increase for plants.

Fungicides are compounds, of natural or synthetic origin, which act to protect plants against damage caused by fungi. Current methods of agriculture rely heavily on the use of fungicides. In fact, some crops cannot be grown usefully without the use of fungicides. Using fungicides allows a grower to increase the yield of the crop and consequently, increase the value of the crop. Numerous fungicidal agents have been developed. However, the treatment of fungal infestations continues to be a major problem. Furthermore, fungicide resistance has become a serious problem, rendering these agents ineffective for some agricultural uses. As such, a need exists for the development of new fungicidal compounds with improved antifungal properties. It has been found that novel oxoborazoles with a specific substitution pattern are novel and have improved microbiocidal activity.

According to the present invention there is provided a method for controlling or preventing infestation of plants or plant propagation material and/or harvested food crops susceptible to microbial attack by treating plants or plant propagation material and/or harvested food crops with an effective amount of an oxaborole of general formula (I)

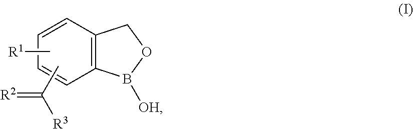

wherein
R¹ is H, fluorine, chlorine, bromine, cyano, nitro, unsubstituted or substituted C₁-C₄alkyl, unsubstituted or substituted C₁-C₄alkoxy, unsubstituted or substituted or C₁-C₄haloalkyl;
R³ is selected from H, unsubstituted or substituted C₁-C₄alkyl, unsubstituted or substituted C₁-C₄haloalkyl, unsubstituted or substituted six- to ten-membered aryl, unsubstituted or substituted five- to six-membered heteroary, unsubstituted or substituted C₃-C₇ cycloalkyl, or unsubstituted or substituted C₃-C₇ heterocycloalkyl;
R² is ═O, ═N—O—R⁵, ═N—NR⁶R⁷, ═N—N(CO)R⁶, ═N—NH(CO)NR⁸R⁹ or ═N—NH(CS)NR⁸R⁹
R⁵, R⁶, R⁷, R⁸ and R⁹ are independently of each other hydrogen, unsubstituted or substituted C₁-C₁₀alkyl, unsubstituted or substituted C₁-C₁₀ haloalkyl, unsubstituted or substituted C₁-C₁₀alkoxy(C₁-C₁₀)alkyl, unsubstituted or substituted C₂-C₁₀alkenyl, unsubstituted or substituted C₂-C₁₀haloalkenyl, unsubstituted or substituted C₂-C₁₀alkynyl, unsubstituted or substituted C₃-C₇cycloalkyl(alkylene)₍₀₋₂₎, unsubstituted or substituted six- to ten-membered-aryl(alkylene)₍₀₋₂₎, or unsubstituted or substituted five- to ten-membered heteroaryl(alkylene)₍₀₋₂₎;
wherein the substituents for the substituted aryl, heteroaryl, cycloalkyl and heterocycloalkyl moieties can be independently mono- or polysubstituted by substituents selected from the group consisting of halogen, hydroxy, nitro, cyano, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, unsubstituted or substituted six- to ten-membered-aryl(alkylene)₍₀₋₁₎ and unsubstituted or substituted six- to ten-membered-aryl(alkylene)₍₀₋₁₎oxy;
and wherein the substituents for the substituted cycloalkyl, heterocycloalkyl and alkyl can be independently mono- or polysubstituted by substituents selected from oxo, —OH, CN, NO₂, F, Cl, C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroary, unsubstituted or substituted C₃-C₇ cycloalkyl, and unsubstituted or substituted C₃-C₇ heterocycloalkyl;
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
and agronomically acceptable salts, stereoisomers, diastereoisomers, enantiomers, tautomers, atriopisomers and N-oxides of those compounds.

In a preferred aspect of the present invention there is provided a method for controlling or preventing infestation of plants or plant propagation material and/or harvested food crops susceptible to microbial attack by treating plants or plant propagation material and/or harvested food crops with an effective amount of an oxaborole of general formula (I)

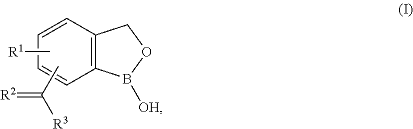

wherein
R¹ is H, fluorine, chlorine, bromine, cyano, nitro, unsubstituted or substituted C₁-C₄alkyl, unsubstituted or substituted C₁-C₄alkoxy, unsubstituted or substituted or C₁-C₄haloalkyl;
R³ is selected from H, unsubstituted or substituted C₁-C₄alkyl, unsubstituted or substituted C₁-C₄haloalkyl, unsubstituted or substituted six- to ten-membered aryl, unsubstituted or substituted five- to six-membered heteroary, unsubstituted or substituted C₃-C₇ cycloalkyl, or unsubstituted or substituted C₃-C₇ heterocycloalkyl;
R² is ═N—O—R⁵, ═N—NR⁶R⁷, ═N—N(CO)R⁶, ═N—NH(CO)NR⁸R⁹ or ═N—NH(CS)NR⁸R⁹
R⁵, R⁶, R⁷, R⁸ and R⁹ are independently of each other hydrogen, unsubstituted or substituted C₁-C₁₀alkyl, unsubstituted or substituted C₁-C₁₀ haloalkyl, unsubstituted or substituted C₁-C₁₀alkoxy(C₁-C₁₀)alkyl, unsubstituted or substituted C₂-C₁₀alkenyl, unsubstituted or substituted C₂-C₁₀haloalkenyl, unsubstituted or substituted C₂-C₁₀alkynyl, unsubstituted or substituted C₃-C₇cycloalkyl(alkylene)₍₀₋₂₎, unsubstituted or substituted six- to ten-membered-aryl(alkylene)₍₀₋₂₎, or unsubstituted or substituted five- to ten-membered heteroaryl(alkylene)₍₀₋₂₎;
wherein the substituents for the substituted aryl, heteroaryl, cycloalkyl and heterocycloalkyl moieties can be independently mono- or polysubstituted by substituents selected from the group consisting of halogen, hydroxy, nitro, cyano, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, unsubstituted or substituted six- to ten-membered-aryl(alkylene)₍₀₋₁₎ and unsubstituted or substituted six- to ten-membered-aryl(alkylene)₍₀₋₁₎oxy;
and wherein the substituents for the substituted cycloalkyl, heterocycloalkyl and alkyl can be independently mono- or polysubstituted by substituents selected from oxo, —OH, CN, NO₂, F, Cl, C₁₋₄ alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroary, unsubstituted or substituted C₃-C₇ cycloalkyl, and unsubstituted or substituted C₃-C₇ heterocycloalkyl;
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
and agronomically acceptable salts, stereoisomers, diastereoisomers, enantiomers, tautomers, atriopisomers and N-oxides of those compounds.

The present invention accordingly further relates to the use of benzoxaborole derivatives according to formula (I) and salts thereof for controlling or preventing infestation of plants or plant propagation material, the application of benzoxaborole derivatives according to formula (I) to useful plants, the application of benzoxaborole derivatives according to formula (I) to the locus of useful plants or the application of benzoxaborole derivatives according to formula (I) to plant propagation material of useful plants a compound of formula (I).

The present invention accordingly further relates to the use of benzoxaborole derivatives according to formula (I) and salts thereof for controlling or preventing infestation of plants or plant propagation material by treating plants or plant propagation material with an effective amount of an benzoxaborole of general formula (I).

The present invention accordingly further relates to the method of controlling phytopathogenic diseases on useful plants or plant propagation material thereof, which comprises applying to said plant or plant propagation material a fungicidally effective amount of a compound of formula (I). Preferably the method method of controlling phytopathogenic diseases on useful plants or plant propagation material thereof, which comprises applying to said plant or plant propagation material a fungicidally effective amount of a compound of formula (I), wherein plant propagation material of useful plants are seeds of useful plants.

The present invention accordingly further relates to the method for controlling or preventing infestation of plants or plant propagation material by treating plants or plant propagation material with an effective amount of an oxaborole of general formula (I).

The present invention accordingly further relates to the method of controlling phytopathogenic diseases on useful plants or plant propagation material thereof, which comprises applying to said plant propagation material a fungicidally effective amount of a compound of formula (I).

Accordingly the present invention also relates to a method of protecting plant propagation material and organs that grow at a later point in time against damage phytopathogenic diseases, which method comprises applying to said propagation material a fungicidally effective amount of a compound of formula I.

In a further aspect of the invention, the invention provides a plant propagation material protecting composition comprising a compound of formula I, together with a suitable carrier therefore.

In a further aspect of the invention, the invention provides a method of controlling phytopathogenic diseases on useful plants or plant propagation material thereof, which comprises applying to said plant propagation material a fungicidally effective amount of a plant propagation material protecting composition comprising a compound of formula (I) as defined in claim 1, together with a suitable carrier therefore.

A preferred embodiment of this aspect of the invention is a plant propagation material protecting composition comprising a compound of formula I, together with a suitable carrier therefor, wherein said plant propagation material protecting composition comprises additionally a colouring agent.

In yet a further aspect of the invention, the invention provides plant propagation material treated with a plant propagation material protecting composition comprising a compound of formula I, together with a suitable carrier therefor.

A preferred embodiment of this aspect of the invention is plant propagation material treated with a plant propagation material protecting composition comprising a compound of formula I, together with a suitable carrier therefor, wherein said plant propagation material protecting composition comprises additionally a colouring agent.

A method of controlling or preventing pest damage in a growing plant said method comprising applying onto the plant propagation material, before planting or sowing thereof a compound of formula (I).

A method of controlling or preventing damage by phytopathogenic diseases in a growing plant or growing plant tissue said method comprising: applying onto the plant propagation material, before planting or sowing thereof a fungicidial effective amount of a compound of formula (I).

A method of controlling or preventing fungal diseases in a growing plant or growing plant tissue said method comprising: applying onto the plant propagation material before planting or sowing thereof a fungicidial effective amount of a compound of formula (I).

In a preferred embodiment the plant propagation material is a seed or a tuber. In a further preferred embodiment the plant propagation material is a seed. In a further preferred embodiment the plant propagation material is a tuber. Preferably the seeds and tubers (stem tubers and root tubers) according to this application are alive. Preferably the seeds and tubers according to this application are able to germinate.

In a further aspect of the invention, the invention provides a method of controlling or preventing damage by phytopathogenic diseases in a growing plant said method comprising applying onto the seed, before planting or sowing thereof a compound of formula (I).

In a further aspect of the invention, the invention provides a method of controlling or preventing damage by phytopathogenic diseases in a growing plant or growing plant tissue said method comprising: applying onto the seed, before planting or sowing thereof a fungicidial effective amount of a compound of formula (I).

In a further aspect of the invention, the invention provides a method of controlling or preventing fungal diseases in a growing plant or growing plant tissue said method comprising: applying onto the seed before planting or sowing thereof a fungicidial effective amount of a compound of formula (I).

In a further aspect of the invention, the invention provides a method of protecting plant propagation material and organs that grow at a later point in time against damage by phytopathogenic diseases, which method comprises applying to said propagation material a fungicidally effective amount of a compound of formula (I).

In a further aspect of the invention, the invention provides a plant propagation material comprising compound a compound of formula (I). Preferably the plant propargation material comprising a fungicidial effective amount of a compound of formula (I).

In a further aspect of the invention, the invention provides a plant propagation material comprising compound a compound of formula (I) and comprises additionally a colouring agent.

In a further aspect of the invention, the invention provides a coated plant propagation material coated with a compound of formula (I).

In a further aspect of the invention, the invention provides a combination of a plant propagation material and a compound of formula (I).

In a further aspect of the invention, the invention provides a coated plant propagation material coated with coating comprising a compound of formula (I) as defined in claim 1.

In a further aspect of the invention, the invention provides a plant propagation material comprising an outer coating characterized that the outer coating comprises a compound according to formula (I), preferably a seed comprising an outer coating characterized that the outer coating comprises a compound according to formula (I).

In a further aspect of the invention, the invention provides a composition comprising a plant propagation material and a compound of formula (I).

In a further aspect of the invention, the invention provides a composition comprising a plant propagation material and a compound of formula and further comprising a a seed grow medium.

In a further aspect of the invention, the invention provides a plant which results from the germination of a a coated seed wherein the coating comprises a compound of formula (I).

In a further aspect of the invention, the invention provides a coated plant propagation material wherein the coating comprises a compound of formula (I).

In a further aspect of the invention, the invention provides a coated plant propagation material according to the preceding paragraph, wherein the said material is a seed.

In a further aspect of the invention, the invention provides the combination of a plant propagation material and a composition comprising a compound of formula (I).

In a further aspect of the invention, the invention provides the combination according to the preceding paragraph wherein the said material is a seed.

In a further aspect of the invention, the invention provides the combination according to one of the two preceding paragraphs, further comprising a plant growth and/or seed germination medium.

In a further aspect of the invention, the invention provides a plant which results from the germination and/or growth of the coated plant propagation material wherein the coating comprises a compound of formula (I).

In a further aspect of the invention, the invention provides a plant which results from the germination and/or growth of the coated plant propagation material wherein the coating comprises a compound of formula (I) and wherein the coated plant propagation material is a seed. Preferably the coated plant propagation material is a seed.

In a further aspect of the invention, the invention relates to the use of a compound of formula (I) according to claim 1, in the preparation of a composition for coating a plant propagation material for the prevention or control of plant pathogenic fungi.

In a further aspect of the invention, the invention relates to a method of controlling or preventing infestation of plants or plant propagation material and/or harvested food crops susceptible to microbial attack by treating plants or plant propagation material and/or harvested food crops with an effective amount of an oxaborole of general formula (I)

In a further aspect of the invention, the invention relates to a method of controlling or preventing infestation of plants or plant propagation material and/or harvested food crops susceptible to microbial attack by providing in a first step a agrochemical compositions according to the present invention comprising from 0.1 to 99% by weight of the compound of formula (I) and 99.9 to 1% by weight, of a solid or liquid adjuvant and/or an surfactant and in a second step applying said composition to the plants or the locus thereof.

The compounds of formula I are applied by treating plant propagation material with a fungicidally effective amount of a compound of formula I. Preferably, compounds of formula I are applied by adhering compounds of formula I to plant propagation material in a fungicidally effective amount.

A preferred application method is seed treatment.

The method according to the invention is especially suitable to increase the yield and/or quality of useful plants, such as crop yield of crop plants.

The invention covers all agronomically acceptable salts, isomers, stereoisomers, diastereoisomers, enantiomers, tautomers, atropisomers and N-oxides of those compounds. The compounds of formula (I) may exist in different geometric or optical isomeric forms or in different tautomeric forms. One or more centres of chirality may be present, in which case compounds of the formula (I) may be present as pure enantiomers, mixtures of enantiomers, pure diastereomers or mixtures of diastereomers. There may be double bonds present in the molecule, such as C═C or C═N bonds, in which case compounds of formula (I) may exist as single isomers or mixtures of isomers. Centres of tautomerisation may be present. This invention covers all such isomers and tautomers and mixtures thereof in all proportions as well as isotopic forms such as deuterated compounds. Also atropisomerism may occur as a result of a restricted rotation about a single bond.

Suitable salts of the compounds of formula (I) include acid addition salts such as those with an inorganic acid such as hydrochloric, hydrobromic, sulphuric, nitric or phosphoric acid, or an organic carboxylic acid such as oxalic, tartaric, lactic, butyric, toluic, hexanoic or phthalic acid, or a sulphonic acid such as methane, benzene or toluene sulphonic acid. Other examples of organic carboxylic acids include haloacids such as trifluoroacetic acid.

N-oxides are oxidised forms of tertiary amines or oxidised forms of nitrogen containing heteroaromatic compounds. They are described in many books for example in “Heterocyclic N-oxides” by Angelo Albini and Silvio Pietra, CRC Press, Boca Raton, Fla., 1991.

In the context of this invention “mono- to polysubstituted” in the definition of the substituents, means typically, depending on the chemical structure of the substituents, monosubstituted to seven-times substituted, preferably monosubstituted to five-times substituted, more preferably mono-, di- or tri-substituted.

In the context of the present specification the term “aryl” refers to a ring system which may be mono-, bi- or tricyclic. Examples of such rings include phenyl, naphthalenyl, anthracenyl, indenyl or phenanthrenyl. A preferred aryl group is phenyl.

The term “heteroaryl” refers to an aromatic ring system containing at least one heteroatom and consisting either of a single ring or of two or more fused rings. Preferably, single rings will contain up to three and bicyclic systems up to four heteroatoms which will preferably be chosen from nitrogen, oxygen and sulfur. Examples of such groups include pyridyl, pyridazinyl, pyrimidinyl, pyrazinyl, furanyl, thiophenyl, oxazolyl, isoxazolyl, oxadiazolyl, thiazolyl, isothiazolyl, thiadiazolyl, pyrrolyl, pyrazolyl, imidazolyl, triazolyl and tetrazolyl. A preferred heteroaryl group is pyridine. Examples of bicyclic groups are benzothiophenyl, benzimidazolyl, benzothiadiazolyl, quinolinyl, cinnolinyl and quinoxalinyl.

The term “heterocyclyl” is defined to include heteroaryl and in addition their unsaturated or partially unsaturated analogues such as 4,5,6,7-tetrahydro-benzothiophenyl, 9H-fluorenyl, 3,4-dihydro-2H-benzo-1,4-dioxepinyl, 2,3-dihydro-benzofuranyl, piperidinyl, 1,3-dioxolanyl, 1,3-dioxanyl, 4,5-dihydro-isoxazolyl, tetrahydrofuranyl and morpholinyl.

The alkyl groups, the alkenyl groups, the alkynyl groups and the alkoxy groups in the compound of formula (I) are either linear or branched or they are perhalogenated and forming haloalkyl groups, haloalkenyl groups, haloalkynyl groups or haloalkoxy groups. Halogen signifies preferably F, Cl, Br, I, and more preferred halogen signifies F or Cl. A oxo substituent is ═O, thus a oxygen atom doubly bonded to carbon or another element. The term “oxo substituent” thus embraces aldehydes, carboxylic acids, ketones, sulfonic acids, amides and esters.

The preferred substituents of the substituted alkyl groups, the substituted alkenyl groups, the substituted alkynyl groups, the substituted alkoxy groups, substituted aryl groups and/or the aromatic heterocycle groups in the compound of formula (I) are selected from the following substituents F, Cl, Br, I, —OH, —CN, nitro, an oxo substituent, —C₁₋₄alkoxy, —C₁₋₄ alkylthio, C₁₋₄alkyl, C₂₋₄alkenyl, C₂₋₄alkenyl, C₂₋₄alkynyl, —C(O)H, —C(O)(C₁₋₄ alkyl), —C(O)(C₁₋₄ alkoxy), —C(O)NH₂, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄ alkyl)₃, —Si(C₁₋₄ alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₂₋₆alkynyl, —C₂₋₆alkenyl, heteroarylC₂₋₆alkynyl, —C₂₋₆alkenyl, C₃₋₈cycloalkyl, —NR⁸R⁹ where R⁸ and R⁹ are independently H, —C₁₋₄alkyl —C₂₋₄alkenyl, —C₂₋₄alkynyl or combine with the interjacent nitrogen to form a five- or six-membered ring which may comprise one or two or three heteroatoms (one or two N, O or S atoms in addition to the interjacent nitrogen atom), in which case the heterocyclic ring is unsubstituted or the heterocyclic ring is substituted by one or two oxo substituent, C₁₋₄ alkyl groups, —C₂₋₄alkenyl or substituted —C₂₋₄alkenyl, —C₂₋₄alkynyl or substituted —C₂-4alkynyl, —C(O)H, —C(O)(C₁₋₄ alkyl), —C(O)(C₁₋₄ alkoxy), —C(O)NH₂, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), —OC(O)(C₁₋₄ alkoxy), —Si(C₁₋₄ alkyl)₃, —Si(C₁₋₄ alkoxy)₃, C₆₋₁₀aryl, C₆₋₁₀aryloxy, C₆₋₁₀arylthio, C₆₋₁₀heteroaryl, —(C₁₋₈-perhaloalkyl), arylC₁₋₄alkynyl, —C₁₋₆alkynyl, wherein all the alkyl, alkenyl, alkynyl, alkoxy, aryl, aryloxy, arylthio or heteroaryl groups are either substituted or unsubstituted, preferably these substituents of the substituted groups bear only one further substituent, more preferably these substituents of the substituted groups are not further substituted.

The more preferred substituents of the substituted alkyl groups, alkenyl groups, the alkynyl groups and the alkoxy are selected from the following substituents —OH, CN, F, Cl, C₁₋₄alkoxy, —C₁₋₄alkoxy, —C₁₋₄ alkylthio, C₁₋₄alkyl, C₂-4alkenyl, C₂-4alkenyl, C₂-4alkinyl, C₆₋₁₀aryl, —C₁₋₄alkylamino, —OC(O) (C₁₋₄ alkyl) —C(O)(C₁₋₄ alkoxy). The alkyl groups are branched or linear. The most preferred alkyl groups are methyl, ethyl, propyl, iso-propyl, n-butyl, t-butyl (1,1-diemthylethyl), sec-butyl (1-methylpropyl), iso-butyl (2-methylpropyl), pentyl, iso-pentyl (3-methylbutyl, isoamyl), 1-methylpentyl, 1-ethylpentyl, hexyl, heptyl, or octyl. Preferred alkenyl groups are ethenyl, propenyl (1-propenyl, 2-propenyl), butenyl (1-butenyl, 2-butenyl, 3-butenyl, 2-methylpropen-1-yl, 2-methylpropen-2-yl), pentenyl (pent-1-enyl, pent-2-enyl, pent-3-enyl, 2-methylbut-1-enyl, 3-methylbut-1-enyl, 2-methylbut-2-enyl, 3-methylbut-2-enyl, 2-methylbut-3-enyl, 3-methylbut-3-enyl, 1,2-dimethylprop-2-enyl, 1,1-dimethylprop-2-enyl). Preferred alkynyl groups are ethinyl, propinyl (prop-1-inyl or prop-2-inyl (propargyl)), butyl (but-1-ynyl, but-2-ynyl, but-3-ynyl), pentinyl (pent-1-inyl, pent-2-inyl, pent-3-inyl, pent-4-yl, 3-methylbut-1-inyl, 2-methylbut-3-inyl, 1-methylbut-3-inyl). The most preferred alkyl groups and the most preferred alkoxy groups are methyl, ethyl, propyl, t-buyl, methoxy and ethoxy groups. Methyl, ethyl and methoxy groups are very particularly preferred.

Preferably the alkyl groups in the compound of formula (I) and/or the alkoxy groups in the compound of formula (I) bear not more than two further substituents, more preferably the alkyl groups in the compound of formula (I) and/or the alkoxy groups in the compound of formula (I) bear not more than one further substituent, most preferred the alkyl groups in the compound of formula (I) and/or the alkoxy groups in the compound of formula (I) are not further substituted.

The aryl and hetero aryl groups are either substituted or unsubstituted 5-membered or 6-membered aromatic monocyclic which may contain at least one heteroatom selected from N, S, O or unsubstituted or substituted 9-membered or 10-membered aromatic bicyclic ring system which may contain one or two heteroatoms selected from N, S, O.

Preferrably the unsubstituted or substituted heteroaryl which is mono cyclic or bicyclic ring system which is five to ten membered containing at least one heteroatom selected from O, N or S and has not more than 3 heteroatoms

For examples of such groups include furyl, thienyl, pyrrolyl, pyrazolyl, imidazolyl, 1,2,3-triazolyl, 1,2,4-triazolyl, 1,3,4-triazolyl, oxazolyl, isoxazolyl, thiazolyl, isothiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl, preferably thiazolyl, imidazolyl, pyrrazolyl, pyridyl and pyrimidinyl

The aryl groups and heteroaryl groups are preferably unsubstituted or substituted 5-membered or 6-membered aromatic monocyclic ring system which may contain one or two heteroatoms selected from N or S or O wherein the substituents are selected from the group consisting of halogen, hydroxy, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino and C₁-C₄alkylendioxy groups, phenyl, pyridyl, thiophene, imidazole or pyrrazol groups The aryl groups and heteroaryl groups are preferably unsubstituted or substituted 9-membered or 10-membered aromatic bicyclic ring system which may contain one or two heteroatoms selected from N or S or O wherein the substituents are selected from the group consisting of halogen, hydroxy, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino and C₁-C₄alkylendioxy groups, more preferably naphtyl, benzofuranyl, purinyl, indolyl, benzo[b]thiophenyl or quinolinyl groups

The preferred substituents of the substituted aryl groups and heteroaryl groups in the compound of formula (I) are selected from the group consisting of halogen, hydroxy, cyano, nitro, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁-C₄alkyl, C₁-C₄haloalkyl, C₁-C₄alkoxy, C₁-C₄alkylthio, C₁-C₄alkoxy-C₁-C₄alkyl, C₁-C₄haloalkoxy, C₁-C₄alkoximino, C₁-C₄alkylendioxy, —C(O)NH(C₁₋₄ alkyl), —C(O)N(C₁₋₄ alkyl)(C₁₋₄ alkyl), —OC(O)NH(C₁₋₄ alkyl), —OC(O)N(C₁₋₄ alkyl)(C₁₋₄ alkyl), —NHC(O)(C₁₋₄ alkyl), —NHC(O)(C₁₋₄ alkoxy), —N(C₁₋₄ alkyl)C(O)(C₁₋₄ alkyl), —N(C₁₋₄ alkyl)C(O)(C₁₋₄ alkoxy), —OC(O) (C₁₋₄ alkyl), more preferred substituents of the substituted aryl groups or heteroaryl groups in the compound of formula (I) are selected from the following substituents F, Cl, CF₃, CN, —OH, nitro, —C₁₋₄ alkyl, —C₁₋₄ alkoxy, —C(O)(C₁₋₄ alkoxy), —C(O)H, —C(O)(C₁₋₄ Alkyl),—wherein the alkyl groups are either substituted or unsubstituted.

The most preferred substituents of the substituted aryl groups and heteroaryl groups in the compound of formula (I) are selected from the following substituents, F, Cl, —C₁₋₄Alkyl, C₁₋₄alkoxy, —CN, —C(O)(C₁₋₄ alkoxy), —C(O)(C₁₋₄ alkyl), —C(O)—N—(C₁₋₄ alkyl) and preferably F, Cl are the even more preferred substituents of the substituted aryl groups in the compound of formula (I).

In a further aspect the present invention relates to compounds of formula (I)

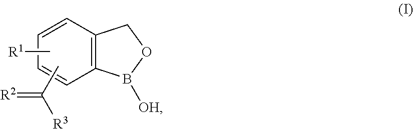

wherein
R¹ is H, fluorine, chlorine, bromine, cyano, nitro, unsubstituted or substituted C₁-C₄alkyl, unsubstituted or substituted C₁-C₄alkoxy, unsubstituted or substituted or C₁-C₄haloalkyl;
R³ is selected from H, unsubstituted or substituted C₁-C₄alkyl, unsubstituted or substituted C₁-C₄haloalkyl, unsubstituted or substituted six- to ten-membered aryl, unsubstituted or substituted five- to six-membered heteroary, unsubstituted or substituted C₃-C₇ cycloalkyl, or unsubstituted or substituted C₃-C₇ heterocycloalkyl;
R² is ═O, ═N—O—R⁵, ═N—NR⁶R⁷, ═N—N(CO)R⁶, ═N—NH(CO)NR⁸R⁹ or ═N—NH(CS)NR⁸R⁹
R⁵, R⁶, R⁷, R⁸ and R⁹ are independently of each other hydrogen, unsubstituted or substituted C₁-C₁₀alkyl, unsubstituted or substituted C₁-C₁₀ haloalkyl, unsubstituted or substituted C₁-C₁₀alkoxy(C₁-C₁₀)alkyl, unsubstituted or substituted C₂-C₁₀alkenyl, unsubstituted or substituted C₂-C₁₀haloalkenyl, unsubstituted or substituted C₂-C₁₀alkynyl, unsubstituted or substituted C₃-C₇cycloalkyl(alkylene)₍₀₋₂₎, unsubstituted or substituted six- to ten-membered-aryl(alkylene)₍₀₋₂₎, or unsubstituted or substituted five- to ten-membered heteroaryl(alkylene)₍₀₋₂₎;
wherein the substituents for the substituted aryl, heteroaryl, cycloalkyl and heterocycloalkyl moieties can be independently mono- or polysubstituted by substituents selected from the group consisting of halogen, hydroxy, nitro, cyano, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, unsubstituted or substituted six- to ten-membered-aryl(alkylene)₍₀₋₁₎ and unsubstituted or substituted six- to ten-membered-aryl(alkylene)₍₀₋₁₎oxy;
and wherein the substituents for the substituted cycloalkyl, heterocycloalkyl and alkyl can be independently mono- or polysubstituted by substituents selected from oxo, —OH, CN, NO₂, F, Cl, C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroary, unsubstituted or substituted C₃-C₇ cycloalkyl, and unsubstituted or substituted C₃-C₇ heterocycloalkyl;
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
and agronomically acceptable salts, stereoisomers, diastereoisomers, enantiomers, tautomers, atriopisomers and N-oxides of those compounds.
provided that
if R¹ is H then R⁵ is not methyl
if R¹ is H then R⁵ is not benzyl
R¹ and R³ are defined under formula I, provided that
If R¹ is H then —C(O)—R³ is not 6-CHO
If R¹ is H then —C(O)—R³ is not 4-CHO
If R¹ is 4-F then —C(O)—R³ is not 7-CHO
If R¹ is 4-OCH₃ then —C(O)—R³ is not 7-CHO
If R¹ is H then —C(O)—R³ is not 5-CHO
If R¹ is H then —C(O)—R³ is not 7-CHO
and if R¹ is H then R³ is not butyl or phenyl.
and agronomically acceptable salts, stereoisomers, diastereoisomers, enantiomers, tautomers, atropisomers and N-oxides of those compounds.

In a yet further aspect the present invention relates to compounds of formula (I)

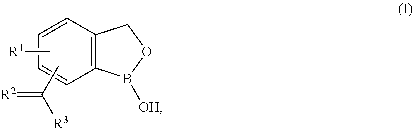

wherein
R¹ is H, fluorine, chlorine, bromine, cyano, nitro, unsubstituted or substituted C₁-C₄alkyl, unsubstituted or substituted C₁-C₄alkoxy, unsubstituted or substituted or C₁-C₄haloalkyl;
R³ is selected from H, unsubstituted or substituted C₁-C₄alkyl, unsubstituted or substituted C₁-C₄haloalkyl, unsubstituted or substituted six- to ten-membered aryl, unsubstituted or substituted five- to six-membered heteroary, unsubstituted or substituted C₃-C₇ cycloalkyl, or unsubstituted or substituted C₃-C₇ heterocycloalkyl;
R² is ═N—O—R⁵, ═N—NR⁶R⁷, ═N—N(CO)R⁶, ═N—NH(CO)NR⁸R⁹ or ═N—NH(CS)NR⁸R⁹
R⁵, R⁶, R⁷, R⁸ and R⁹ are independently of each other hydrogen, unsubstituted or substituted C₁-C₁₀alkyl, unsubstituted or substituted C₁-C₁₀ haloalkyl, unsubstituted or substituted C₁-C₁₀alkoxy(C₁-C₁₀)alkyl, unsubstituted or substituted C₂-C₁₀alkenyl, unsubstituted or substituted C₂-C₁₀haloalkenyl, unsubstituted or substituted C₂-C₁₀alkynyl, unsubstituted or substituted C₃-C₇cycloalkyl(alkylene)₍₀₋₂₎, unsubstituted or substituted six- to ten-membered-aryl(alkylene)₍₀₋₂₎, or unsubstituted or substituted five- to ten-membered heteroaryl(alkylene)₍₀₋₂₎;
wherein the substituents for the substituted aryl, heteroaryl, cycloalkyl and heterocycloalkyl moieties can be independently mono- or polysubstituted by substituents selected from the group consisting of halogen, hydroxy, nitro, cyano, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, unsubstituted or substituted six- to ten-membered-aryl(alkylene)₍₀₋₁₎ and unsubstituted or substituted six- to ten-membered-aryl(alkylene)₍₀₋₁₎oxy;
and wherein the substituents for the substituted cycloalkyl, heterocycloalkyl and alkyl can be independently mono- or polysubstituted by substituents selected from oxo, —OH, CN, NO₂, F, Cl, C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroary, unsubstituted or substituted C₃-C₇ cycloalkyl, and unsubstituted or substituted C₃-C₇ heterocycloalkyl;
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
and agronomically acceptable salts, stereoisomers, diastereoisomers, enantiomers, tautomers, atriopisomers and N-oxides of those compounds.
provided that
if R¹ is H then R⁵ is not benzyl
and agronomically acceptable salts, stereoisomers, diastereoisomers, enantiomers, tautomers, atriopisomers and N-oxides of those compounds.

In a yet further aspect the present invention relates to compounds of formula (I)

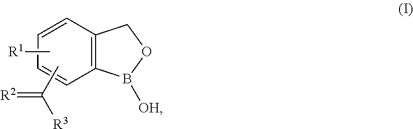

wherein
R¹ is H, fluorine, chlorine, bromine, cyano, nitro, unsubstituted or substituted C₁-C₄alkyl, unsubstituted or substituted C₁-C₄alkoxy, unsubstituted or substituted or C₁-C₄haloalkyl;
R³ is selected from H, unsubstituted or substituted C₁-C₄alkyl, unsubstituted or substituted C₁-C₄haloalkyl, unsubstituted or substituted six- to ten-membered aryl, unsubstituted or substituted five- to six-membered heteroary, unsubstituted or substituted C₃-C₇ cycloalkyl, or unsubstituted or substituted C₃-C₇ heterocycloalkyl;

### R² is ═O;

R⁵, R⁶, R⁷, R⁸ and R⁹ are independently of each other hydrogen, unsubstituted or substituted C₁-C₁₀alkyl, unsubstituted or substituted C₁-C₁₀ haloalkyl, unsubstituted or substituted C₁-C₁₀alkoxy(C₁-C₁₀)alkyl, unsubstituted or substituted C₂-C₁₀alkenyl, unsubstituted or substituted C₂-C₁₀haloalkenyl, unsubstituted or substituted C₂-C₁₀alkynyl, unsubstituted or substituted C₃-C₇cycloalkyl(alkylene)₍₀₋₂₎, unsubstituted or substituted six- to ten-membered-aryl(alkylene)₍₀₋₂₎, or unsubstituted or substituted five- to ten-membered heteroaryl(alkylene)₍₀₋₂₎;
wherein the substituents for the substituted aryl, heteroaryl, cycloalkyl and heterocycloalkyl moieties can be independently mono- or polysubstituted by substituents selected from the group consisting of halogen, hydroxy, nitro, cyano, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, unsubstituted or substituted six- to ten-membered-aryl(alkylene)₍₀₋₁₎ and unsubstituted or substituted six- to ten-membered-aryl(alkylene)₍₀₋₁₎oxy;
and wherein the substituents for the substituted cycloalkyl, heterocycloalkyl and alkyl can be independently mono- or polysubstituted by substituents selected from oxo, —OH, CN, NO₂, F, Cl, C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroary, unsubstituted or substituted C₃-C₇ cycloalkyl, and unsubstituted or substituted C₃-C₇ heterocycloalkyl;
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
and agronomically acceptable salts, stereoisomers, diastereoisomers, enantiomers, tautomers, atriopisomers and N-oxides of those compounds.
provided that
R¹ and R³ are defined under formula I, provided that
If R¹ is H then —C(O)—R³ is not 6-CHO
If R¹ is H then —C(O)—R³ is not 4-CHO
If R¹ is 4-F then —C(O)—R³ is not 7-CHO
If R¹ is 4-OCH₃ then —C(O)—R³ is not 7-CHO
If R¹ is H then —C(O)—R³ is not 5-CHO
If R¹ is H then —C(O)—R³ is not 7-CHO
and if R¹ is H then R³ is not butyl or phenyl.

In particularly preferred embodiments for the methods and compounds of the present invention the preferred groups R¹, R², R³, R⁴, R⁵, R⁶, R⁷, R⁸ and R⁹, in any combination thereof, are as set out below.

In a preferred embodiment invention the compounds of formula (I) have the formula A1

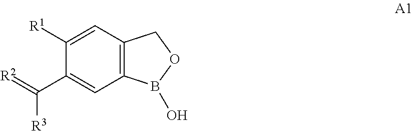

In a preferred embodiment invention the compounds of formula (I) have the formula A2

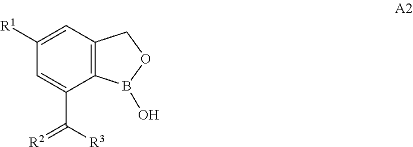

In a preferred embodiment invention the compounds of formula (I) have the formula A3

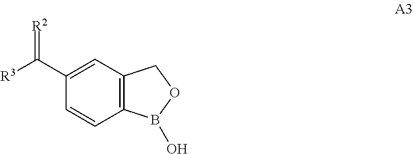

In a preferred embodiment invention the compounds of formula (I) have the formula A4

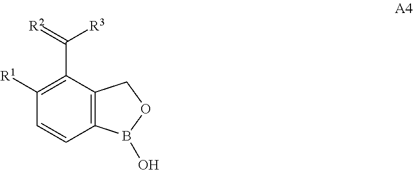

In a preferred embodiment R¹ is H, fluorine, chlorine, bromine, cyano,

More preferably R¹ is H, fluorine, chlorine, bromine;

In a preferred embodiment R² is ═N—O—R⁵;

In a preferred embodiment R² is ═N—NR⁶R⁷;

In a preferred embodiment R² is ═N—N(CO)R⁶;

In a preferred embodiment R² is ═N—NH(CO)NR⁸R⁹;

In a preferred embodiment R² is ═N—NH(CS)NR⁸R⁹;

In a preferred embodiment R² is ═O;

In a preferred embodiment R² is ═O, ═N—OH, ═N—O—CH3-CH═CH—Cl, ═N—O—CH₃, ═N—OCH₂-Ph, ═N—OCH₂CH₃, ═N—OCH₂—CH═CH, ═N—OCH₂CH═C(CH₃)₂, ═N—O—CH₂—CH(CH₃)₂, ═N—OCH₂-4-NO₂-Ph, ═N—OCH₂-4-Me-Ph, ═N—OCH₂-4-Cl-Ph, ═N—OCH₂-2-F-Ph, ═N—OCH₂-2-Cl-4-F-Ph, ═N—OCH₂-2,6-Cl-Ph, ═N—OCH₂-2,4-Cl-Ph, ═N—O—CH₂-2,4,5-Cl-Ph, ═N—OCH₂-2,3,4,5,6-F-Ph, ═N—OCH(CH₃)₂, ═N—OC(CH₃)₃, ═N—O-4-NO₂-Ph, ═N—O-4-CN-Ph, ═N—O(CH₂)₅CH₃, ═N—O(CH₂)₃CH₃, ═N—O—(CH₂)₃—C(O)—O—CH₂—CH₃, ═N—O(CH₂)₂CH₃, ═N—O(CH₂)₂—CH₂—C(O)OH, ═N—O—(CH₂)₁₁—CH₃, ═N—NHCH₂-Ph, ═N—NH—CH₂—O—C(O)CH₂CH₃, ═N—NH—CH₂—C(O)OEt, ═N—NH—CH(CH₃)₂, ═N—NH—C(S)—NH-Ph, ═N—NH—C(S)—NH-Me, ═N—NH—C(S)—NH—CH₂-Ph, ═N—NH—C(S)—NH—CH₂-Ph, ═N—NH—C(S)—NH—CH₂—CH₃, ═N—NH—C(S)—NH—CH₂—CH═CH₂, ═N—NH—C(S)—NH₂, ═N—NH—C(O)OMe, ═N—NH—C(O)OEt, ═N—NHC(O)—NH-Ph, ═N—NHC(O)—NH-4-OMe-Ph, ═N—NHC(O)—NH-2,4-Ph, ═N—NHC(O)-4-NO₂-Ph, ═N—NHC(O)-4-Cl-Ph, ═N—NH—C(O)-3-pyridyl, ═N—NHC(O)-2-NO₂-Ph, ═N—NHC(O)-2,5-Cl-Ph, ═N—NH-4-OCH₃-Ph, ═N—NH-4-Me-Ph, ═N—NH-4-Cl-Ph, ═N—NH-4-CF₃-Ph, ═N—NH-3-NO₂-Ph, ═N—NH-3,5-Cl-Ph, ═N—NH-2-NO₂-Ph, ═N—NH-2,6-Cl-Ph, ═N—NH-2,6-Cl-4-CF₃-Ph, ═N—NH-2,5-F-Ph, ═N—NH-2,4-F-Ph, ═N—NH-2,4-Cl-Ph, ═N—NH₂, ═N—N(CH₃)Ph, ═N—N(CH₃)CH₂-Ph, ═N—N(CH₃)CH₂CH₃, ═N—N(CH₃)CH₂CH(CH₃)₂, ═N—N(CH₃)CH₂C(CH₃)₃, ═N—N(CH₃)CH₂-4-F-Ph, ═N—N(CH₃)CH₂-4-Cl-Ph, ═N—N(CH₃)CH₂-3,5-F-Ph, ═N—N(CH₃)CH₂-3,5-Cl-Ph, ═N—N(CH₃)CH₂-2,6-F-Ph, ═N—N(CH₃)CH₂-2,6-Cl-Ph, ═N—N(CH₃)CH₂-2,5-F-Ph, ═N—N(CH₃)CH₂-2,5-Cl-Ph, ═N—N(CH₃)CH₂-2,4-F-Ph, ═N—N(CH₃)CH₂-2,4-Cl-Ph, ═N—N(CH₃)CH₂-2,4, 6-F-Ph, ═N—N(CH₃)CH₂-2,4,6-Cl-Ph, ═N—N(CH₃)CH(CH₃)₂, ═N—N(CH₃)C(CH₃)₃, ═N—N(CH₃)-4-F-Ph, ═N—N(CH₃)-4-Cl-Ph, ═N—N(CH₃)-2,4-F-Ph, ═N—N(CH₃)-2,4-Cl-Ph, ═N—N(CH₃)₂, ═N—N(CH₃)(CH₂)₅CH₃, ═N—N(CH₃)(CH₂)₄CH₃, ═N—N(CH₃)(CH₂)₃CH₃, ═N—N(CH₃)(CH₂)₂CH₃,

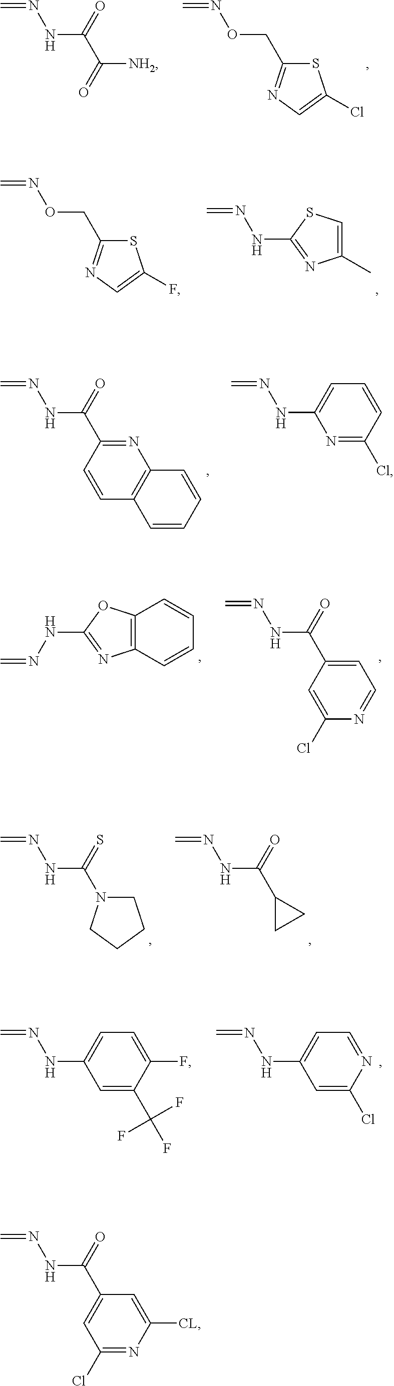

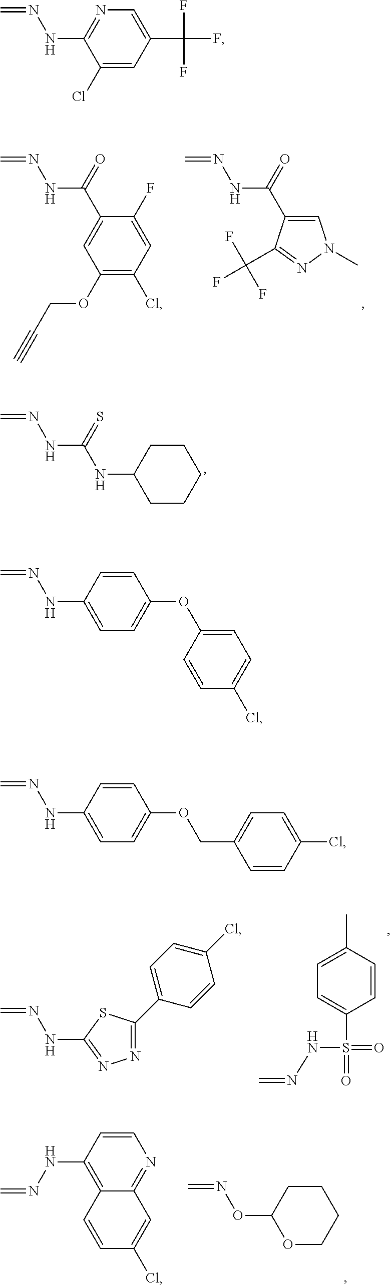

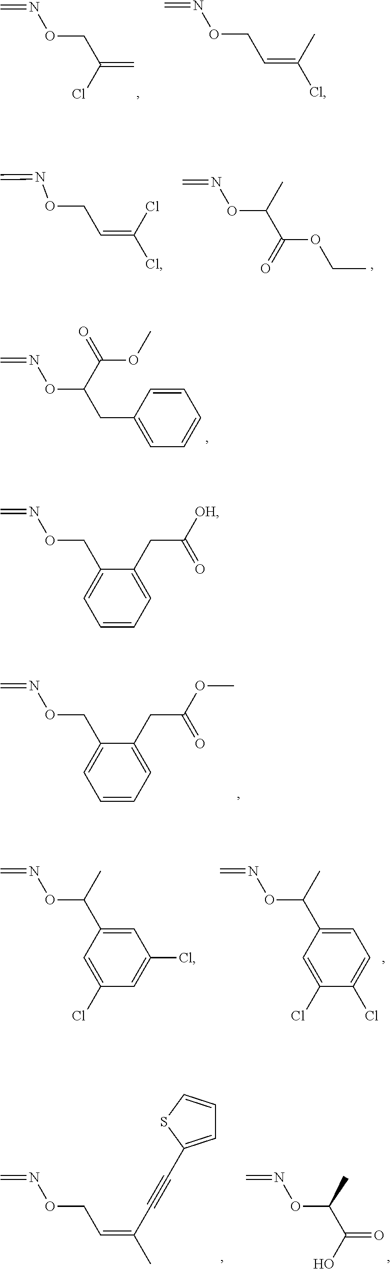

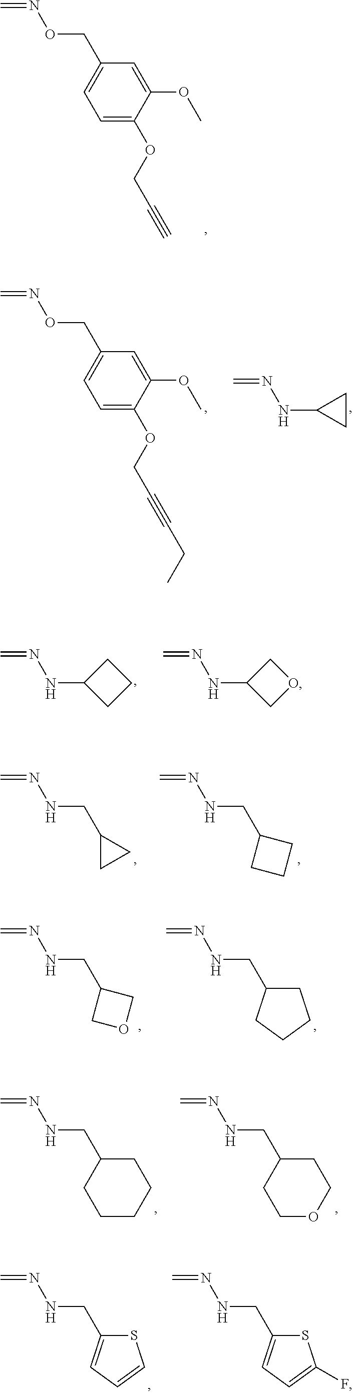

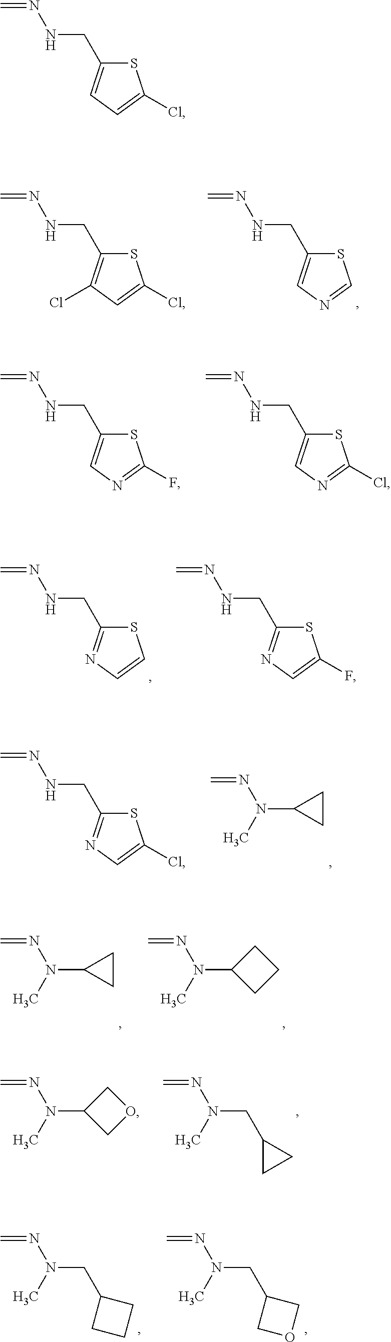

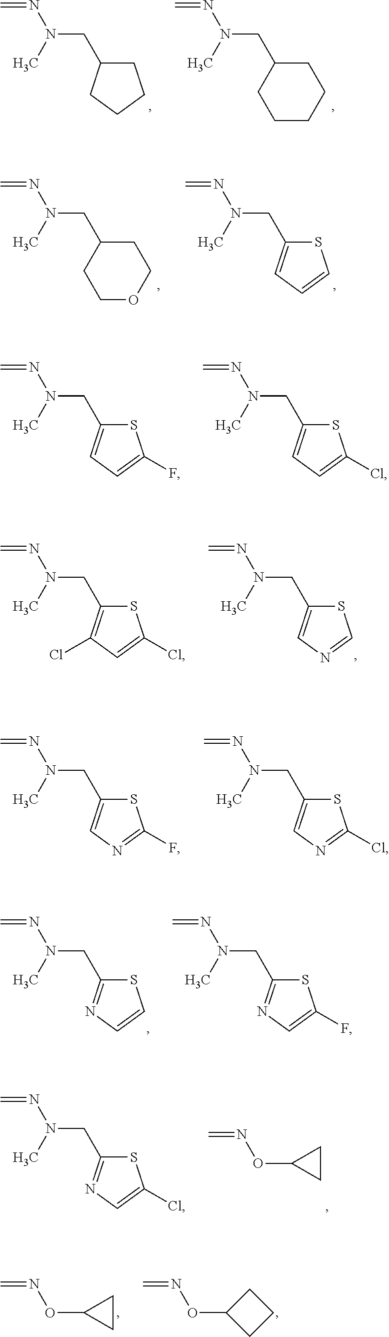

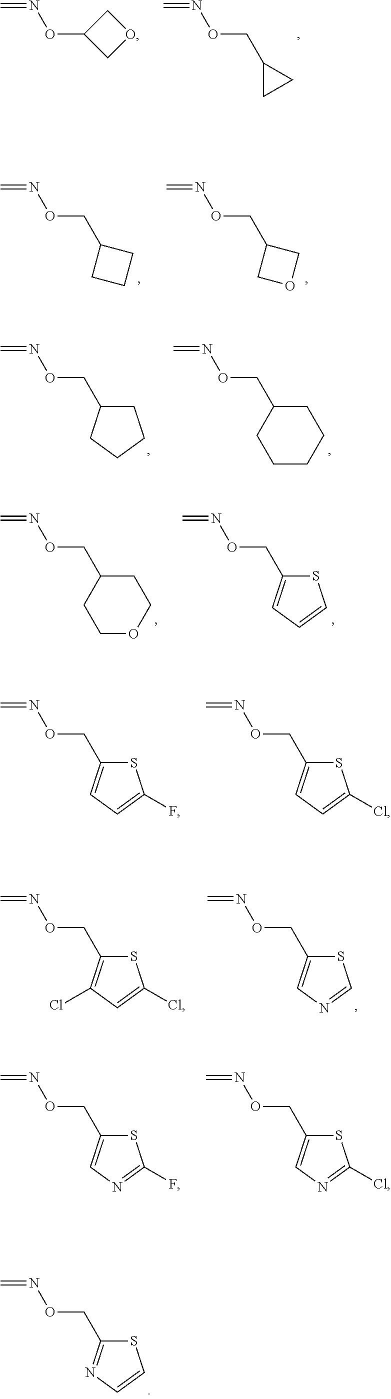

In a more preferred embodiment R² is selected from

═N—OH, ═N—O—CH3-CH═CH—Cl, ═N—O—CH₃, ═N—OCH₂-Ph, ═N—OCH₂CH₃, ═N—OCH₂—CH═CH, ═N—OCH₂CH═C(CH₃)₂, ═N—O—CH₂—CH(CH₃)₂, ═N—OCH₂-4-NO₂-Ph, ═N—OCH₂-4-Me-Ph, ═N—OCH₂-4-Cl-Ph, ═N—OCH₂-2-F-Ph, ═N—OCH₂-2-Cl-4-F-Ph, ═N—OCH₂-2,6-Cl-Ph, ═N—OCH₂-2,4-Cl-Ph, ═N—O—CH₂-2,4,5-Cl-Ph, ═N—OCH₂-2,3,4,5,6-F-Ph, ═N—OCH(CH₃)₂, ═N—OC(CH₃)₃, ═N—O-4-NO₂-Ph, ═N—O-4-CN-Ph, ═N—O(CH₂)₅CH₃, ═N—O(CH₂)₃CH₃, ═N—O—(CH₂)₃—C(O)—O—CH₂—CH₃, ═N—O(CH₂)₂CH₃, ═N—O(CH₂)₂—CH₂—C(O)OH, ═N—O—(CH₂)₁₁—CH₃, ═N—NHCH₂-Ph, ═N—NH—CH₂—O—C(O)CH₂CH₃, ═N—NH—CH₂—C(O)OEt, ═N—NH—CH(CH₃)₂, ═N—NH—C(S)—NH-Ph, ═N—NH—C(S)—NH-Me, ═N—NH—C(S)—NH—CH₂-Ph, ═N—NH—C(S)—NH—CH₂-Ph, ═N—NH—C(S)—NH—CH₂—CH₃, ═N—NH—C(S)—NH—CH₂—CH═CH₂, ═N—NH—C(S)—NH₂, ═N—NH—C(O)OMe, ═N—NH—C(O)OEt, ═N—NHC(O)—NH-Ph, ═N—NHC(O)—NH-4-OMe-Ph, ═N—NHC(O)—NH-2,4-Ph, ═N—NHC(O)-4-NO₂-Ph, ═N—NHC(O)-4-Cl-Ph, ═N—NH—C(O)-3-pyridyl, ═N—NHC(O)-2-NO₂-Ph, ═N—NHC(O)-2,5-Cl-Ph, ═N—NH-4-OCH₃-Ph, ═N—NH-4-Me-Ph, ═N—NH-4-Cl-Ph, ═N—NH-4-CF₃-Ph, ═N—NH-3-NO₂-Ph, ═N—NH-3,5-Cl-Ph, ═N—NH-2-NO₂-Ph, ═N—NH-2,6-Cl-Ph, ═N—NH-2,6-Cl-4-CF₃-Ph, ═N—NH-2,5-F-Ph, ═N—NH-2,4-F-Ph, ═N—NH-2,4-Cl-Ph, ═N—NH₂,

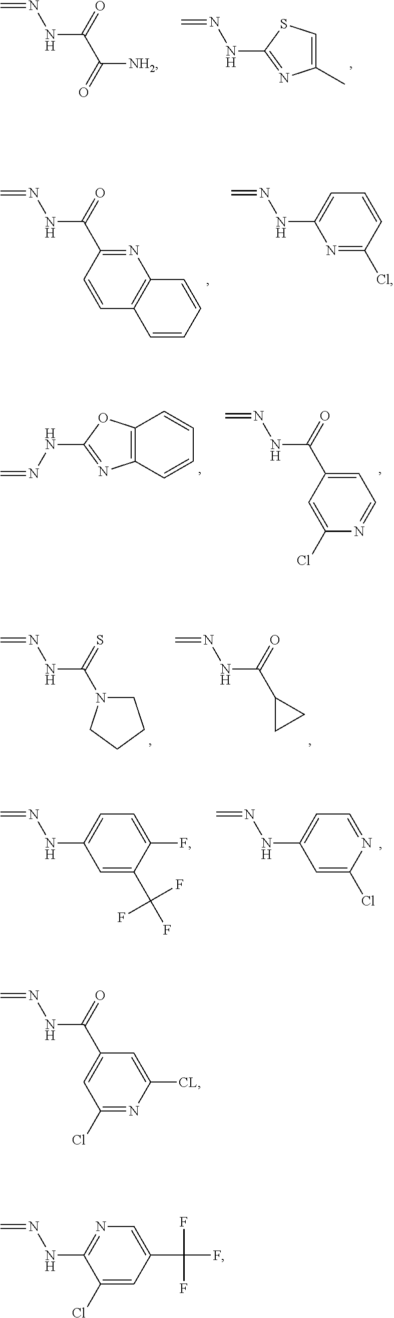

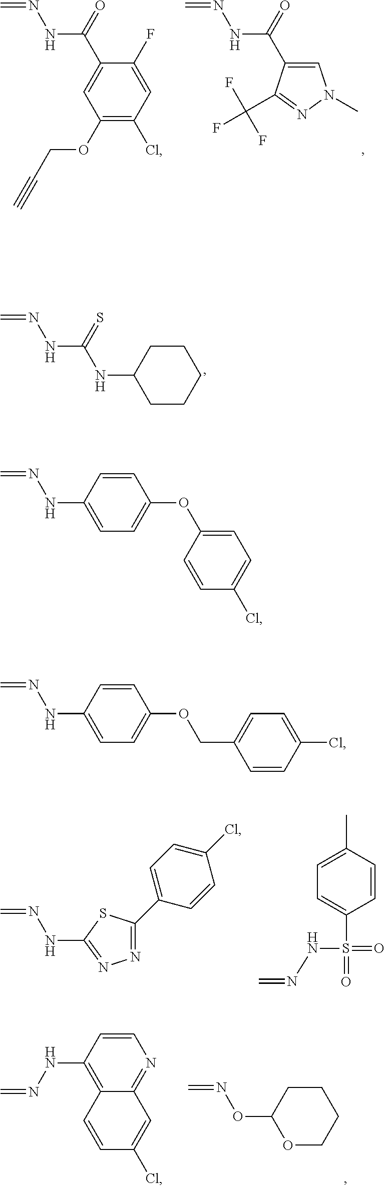

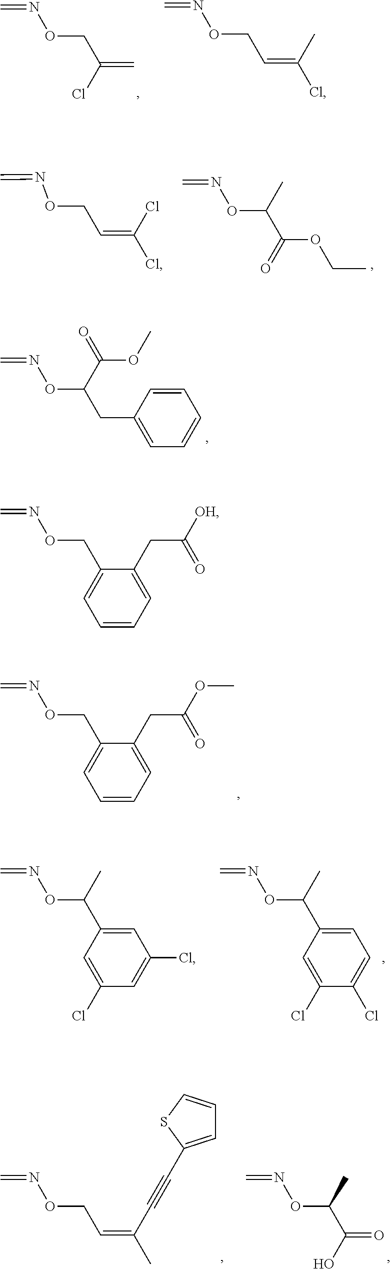

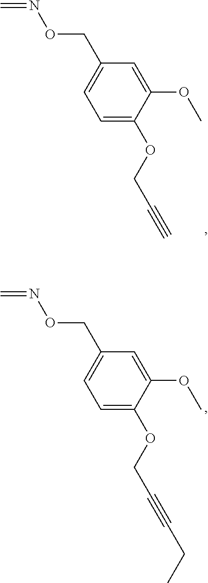

In another further preferred embodiment R² is selected from:

═O, ═N—OH, ═N—OCH₃, ═N—OCH₂CH₃, ═N—O(CH₂)₂CH₃, ═N—O(CH₂)₃CH₃, ═N—O(CH₂)₄CH₃, ═N—O(CH₂)₅CH₃, ═N—OCH(CH₃)₂, ═N—OC(CH₃)₃, ═N—OCH₂CH(CH₃)₂, ═N—OCH₂C(CH₃)₃, ═N—OPh, ═N—O-4-F-Ph, ═N—O-4-Cl-Ph, ═N—O-2,4-F-Ph, ═N—O-2,4-Cl-Ph, ═N—OCH₂-Ph, ═N—OCH₂-4-F-Ph, ═N—OCH₂-4-Cl-Ph, ═N—OCH₂-2,4-F-Ph, ═N—OCH₂-2,5-F-Ph, ═N—OCH₂-2,6-F-Ph, ═N—OCH₂-3,5-F-Ph, ═N—OCH₂-2,4, 6-F-Ph, ═N—OCH₂-2,4-Cl-Ph, ═N—OCH₂-2,5-Cl-Ph, ═N—OCH₂-2,6-Cl-Ph, ═N—OCH₂-3,5-Cl-Ph, ═N—OCH₂-2,4, 6-Cl-Ph, ═N—OCH₂-2-OMePh, ═N—OCH₂-3-OMePh, ═N—OCH₂-4-OMePh, ═N—O-2-OMe-Ph, ═N—O-3-OMePh, ═N—O-4-OMePh,

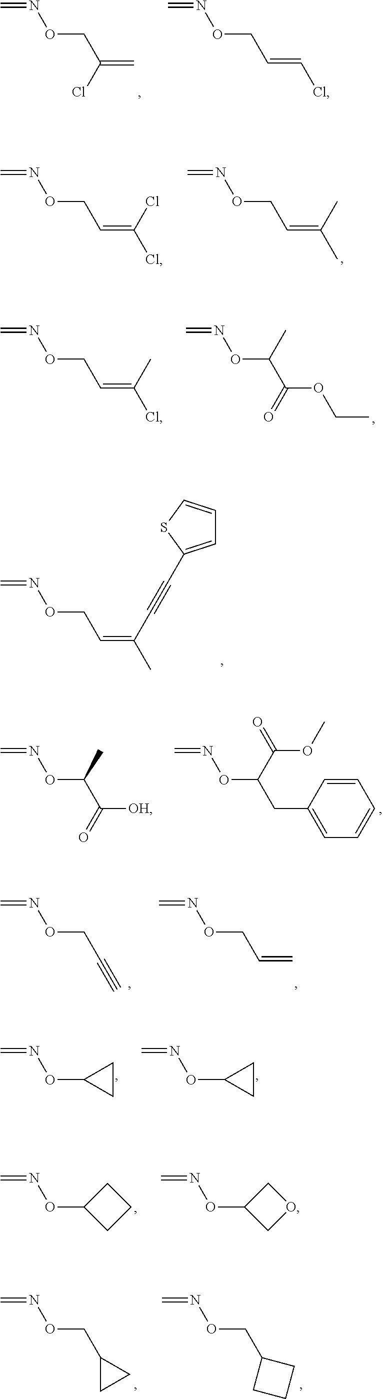

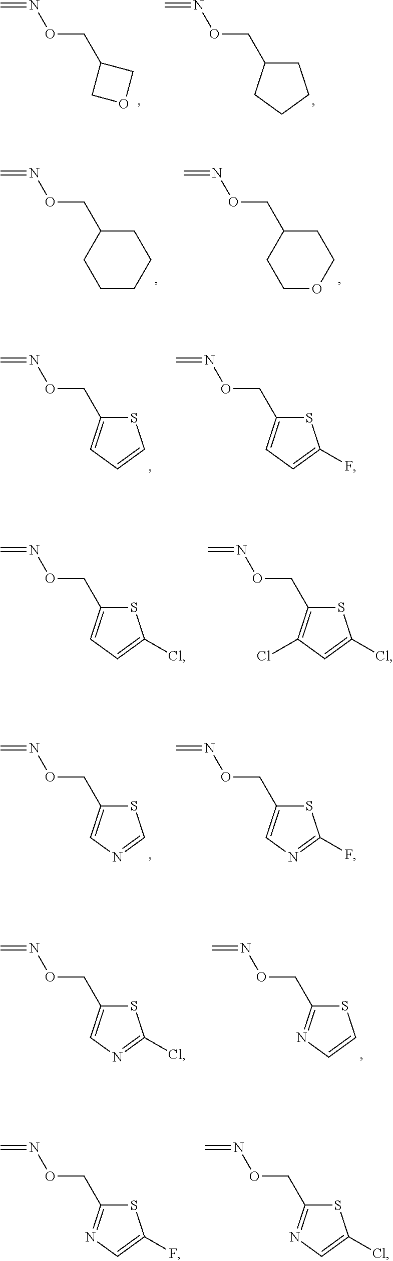

In another further preferred embodiment R² is selected from:

═N—NH₂═N—NHCH₃, ═N—NHCH₂CH₃, ═N—NH(CH₂)₂CH₃, ═N—NH(CH₂)₃CH₃, ═N—NH(CH₂)₄CH₃, ═N—NH(CH₂)₅CH₃, ═N—NHCH(CH₃)₂, ═N—NHC(CH₃)₃, ═N—NHCH₂CH(CH₃)₂, ═N—NHCH₂C(CH₃)₃, ═N—NH—C(O)OMe, ═N—NHPh, ═N—NH-4-F-Ph, ═N—NH-4-Cl-Ph, ═N—NH-2,4-F-Ph, ═N—NH-2,4-Cl-Ph, ═N—NHCH₂-Ph, ═N—NHCH₂-4-F-Ph, ═N—NHCH₂-4-Cl-Ph, ═N—NHCH₂-2,4-F-Ph, ═N—NHCH₂-2,5-F-Ph, ═N—NHCH₂-2,6-F-Ph, ═N—NHCH₂-3,5-F-Ph, ═N—NHCH₂-2,4, 6-F-Ph, ═N—NHCH₂-2,4-Cl-Ph, ═N—NHCH₂-2,5-Cl-Ph, ═N—NHCH₂-2,6-Cl-Ph, ═N—NHCH₂-3,5-Cl-Ph, ═N—NHCH₂-2,4, 6-Cl-Ph,

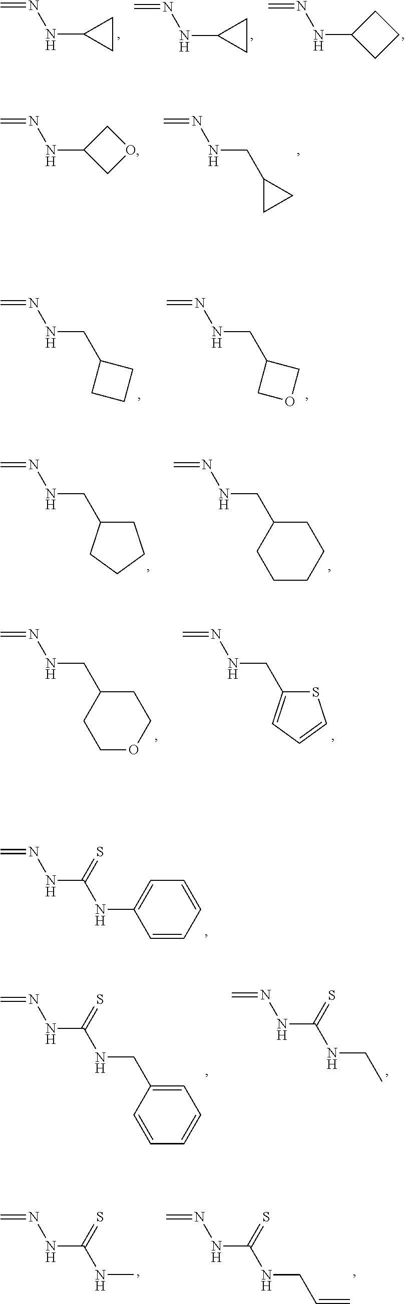

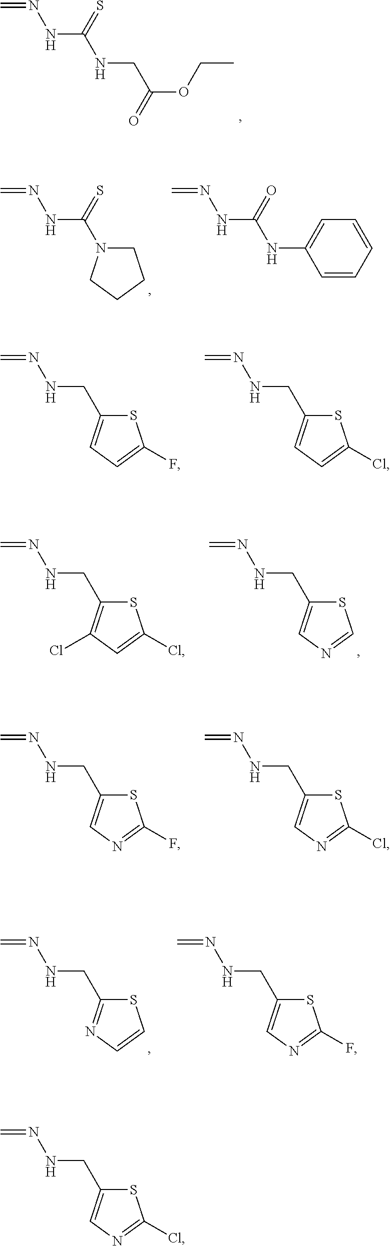

═N—N(CH₃)₂, ═N—N(CH₃)CH₂CH₃, ═N—N(CH₃)(CH₂)₂CH₃, ═N—N(CH₃)(CH₂)₃CH₃, ═N—N(CH₃)(CH₂)₄CH₃, ═N—N(CH₃)(CH₂)₅CH₃, ═N—N(CH₃)CH(CH₃)₂, ═N—N(CH₃)C(CH₃)₃, ═N—N(CH₃)CH₂CH(CH₃)₂, ═N—N(CH₃)CH₂C(CH₃)₃, ═N—N(CH₃)Ph, ═N—N(CH₃)-4-F-Ph, ═N—N(CH₃)-4-Cl-Ph, ═N—N(CH₃)-2,4-F-Ph, ═N—N(CH₃)-2,4-Cl-Ph, ═N—N(CH₃)CH₂-Ph, ═N—N(CH₃)CH₂-4-F-Ph, ═N—N(CH₃)CH₂-4-Cl-Ph, ═N—N(CH₃)CH₂-2,4-F-Ph, ═N—N(CH₃)CH₂-2,5-F-Ph, ═N—N(CH₃)CH₂-2,6-F-Ph, ═N—N(CH₃)CH₂-3,5-F-Ph, ═N—N(CH₃)CH₂-2,4, 6-F-Ph, ═N—N(CH₃)CH₂-2,4-Cl-Ph, ═N—N(CH₃)CH₂-2,5-Cl-Ph, ═N—N(CH₃)CH₂-2,6-Cl-Ph, ═N—N(CH₃)CH₂-3,5-Cl-Ph, ═N—N(CH₃)CH₂-2,4, 6-Cl-Ph,

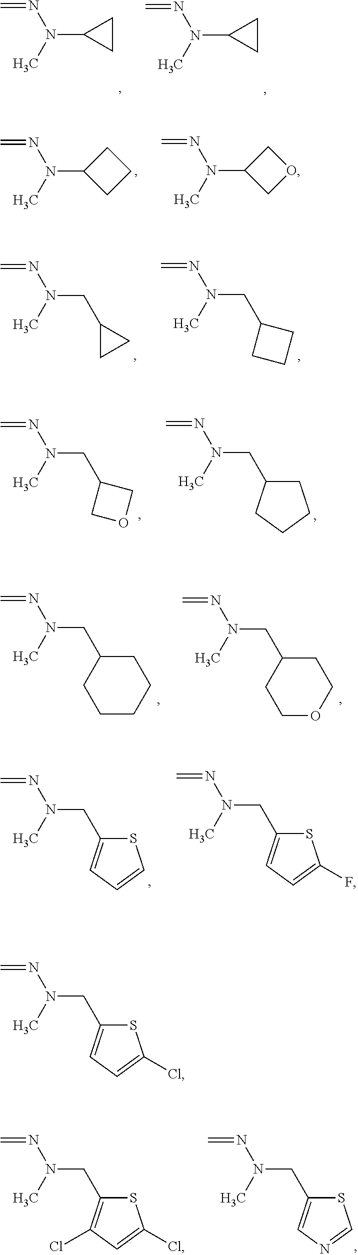

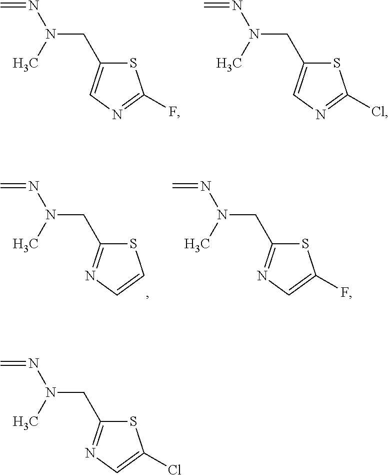

In an another further preferred embodiment R² is selected from:

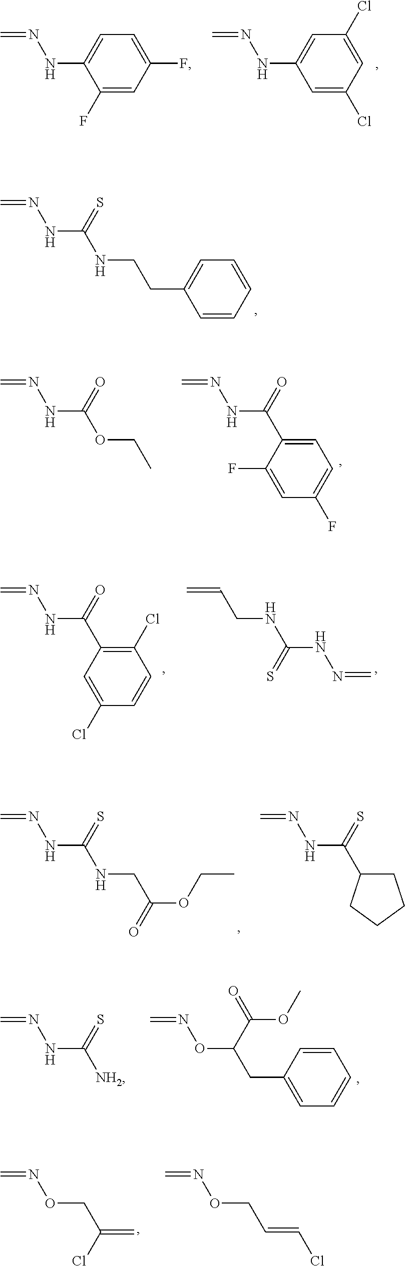

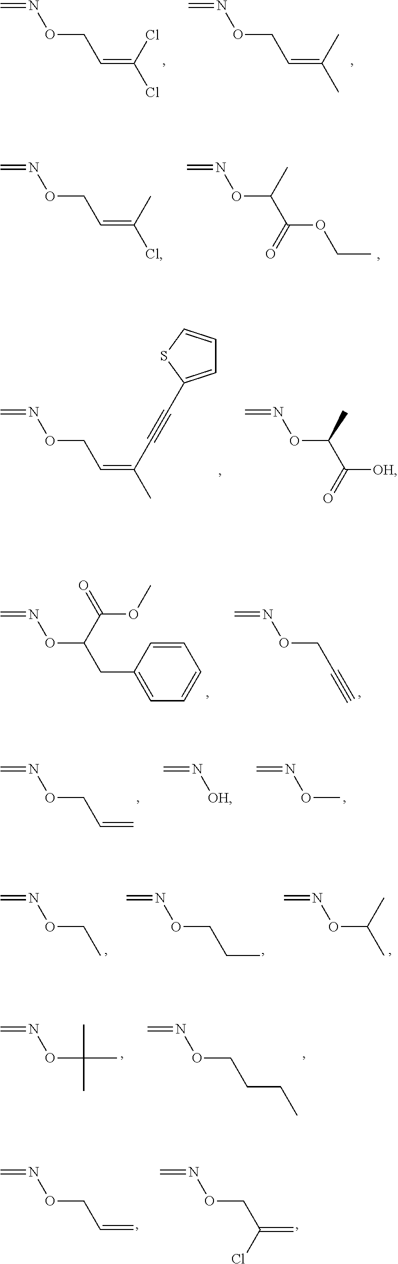

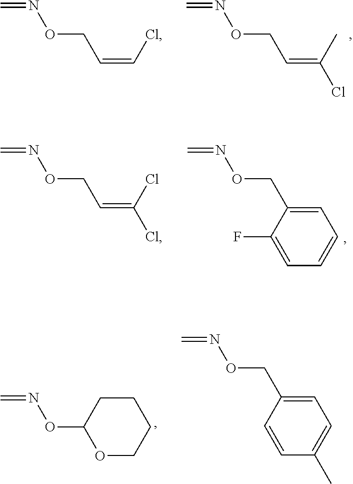

R³ is selected from H, Me, 4-Cl-Ph, 4-F-Ph, 2,4-Cl-Ph, 4-OMe-Ph, 4-Me-Ph, acetylene, cyclopropyl, vinyl, Allyl, or Ph. More preferably R³ is H

The present application further relates to compounds of formula (II)

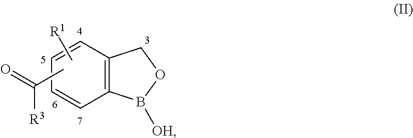

Wherein R¹ and R³ are defined under formula (I), provided that

If R¹ is H then —C(O)—R³ is not 6-CHO
If R¹ is H then —C(O)—R³ is not 4-CHO
If R¹ is 4-F then —C(O)—R³ is not 7-CHO
If R¹ is 4-OCH₃ then —C(O)—R³ is not 7-CHO
If R¹ is H then —C(O)—R³ is not 5-CHO
If R¹ is H then —C(O)—R³ is not 7-CHO
and if R¹ is H then R³ is not butyl or phenyl.

Preferably preferably R¹ is selected from H, Methyl, F and Cl, and R³ is selected from H, C₁-C₄alkyl, aryl, heteroaryl or C₁-C₄haloalkyl, C₃-C₇ cycloalkyl;

More preferably R¹ is selected from H, Methyl, F and Cl and R³ is selected from H, C₁-C₄alkyl, preferably H;

Yet even more preferably R¹ is selected from H, Methyl, F and Cl and R³ is selected from H, C₁-C₄alkyl, preferably H;

In all compounds shown in the schemes below X, R¹, R², R³, R⁴, R⁵, R⁶ and R⁷ are as defined above.

Compounds of formula (I)

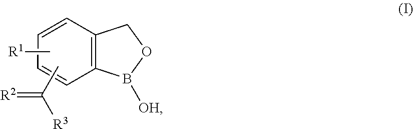

may be prepared from compounds of formula (II)

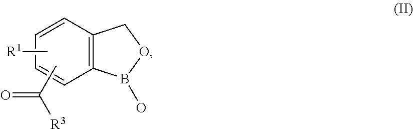

by condensation with compounds of formula (III-a) or (III-b)

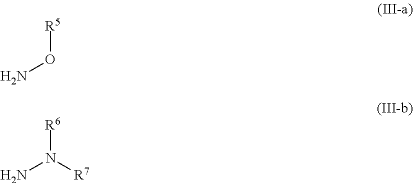

Wherein R¹ and R³ and R⁵, R⁶ and R⁷ are as defined under formula (I;

Compounds of formula (II) are known or may be prepared in analogy to the methods described in following literature by those skilled in art according to the Schemes 1 to 3: Journal of Labelled Compounds and Radiopharmaceuticals (2012), 55(6), 201-205; Journal of Medicinal Chemistry (2012), 55(7), 3553-3557; Bioorganic & Medicinal Chemistry Letters (2012), 22(3), 1299-1307; Tetrahedron Letters (2011), 52(30), 3909-3911; Bioorganic & Medicinal Chemistry Letters (2011), 21(2), 644-651; Tetrahedron (2009), 65(42), 8738-8744; WO2012109164 A1; WO2011022337A1.

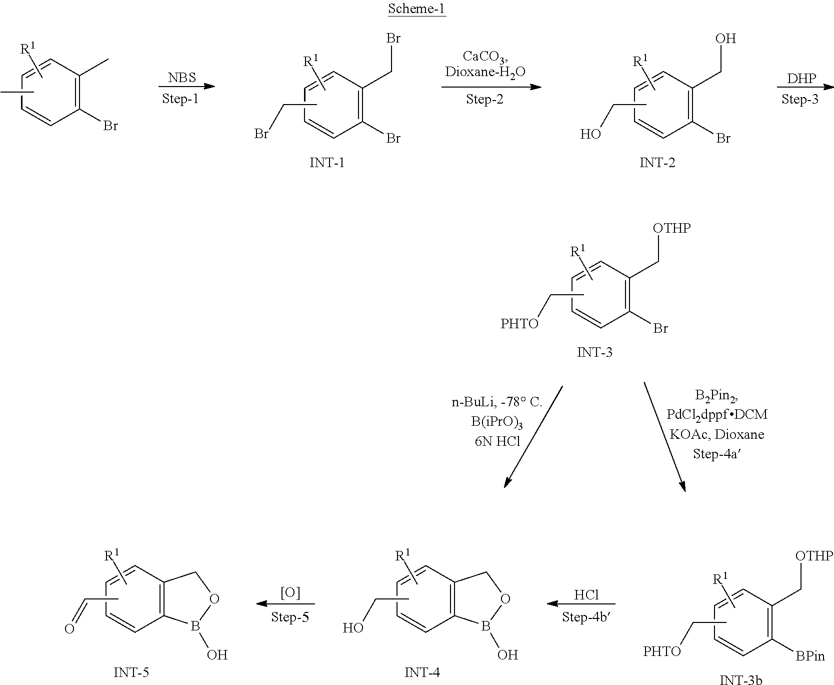

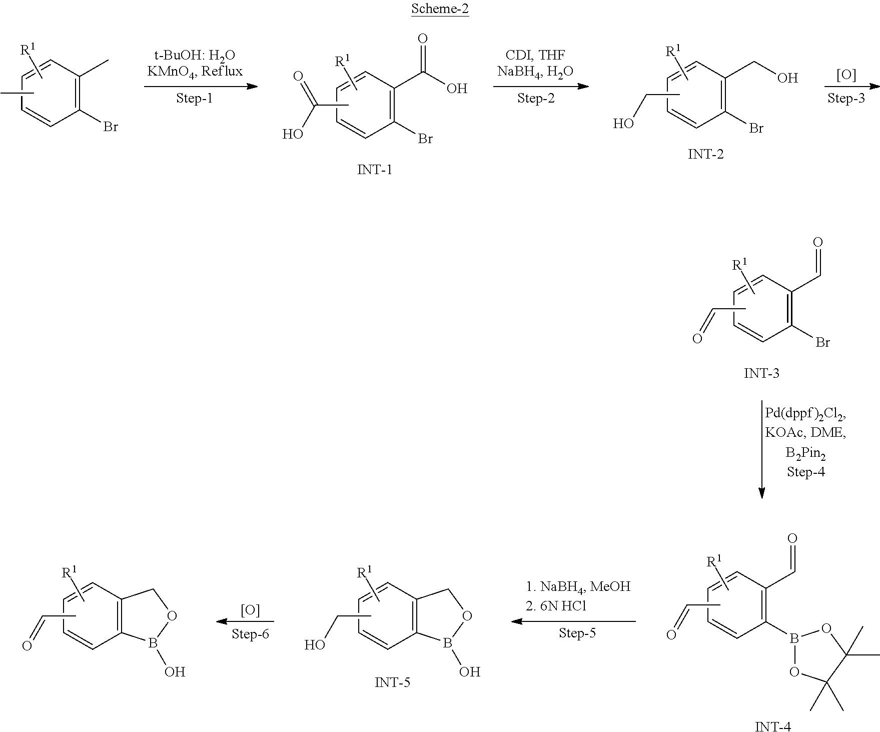

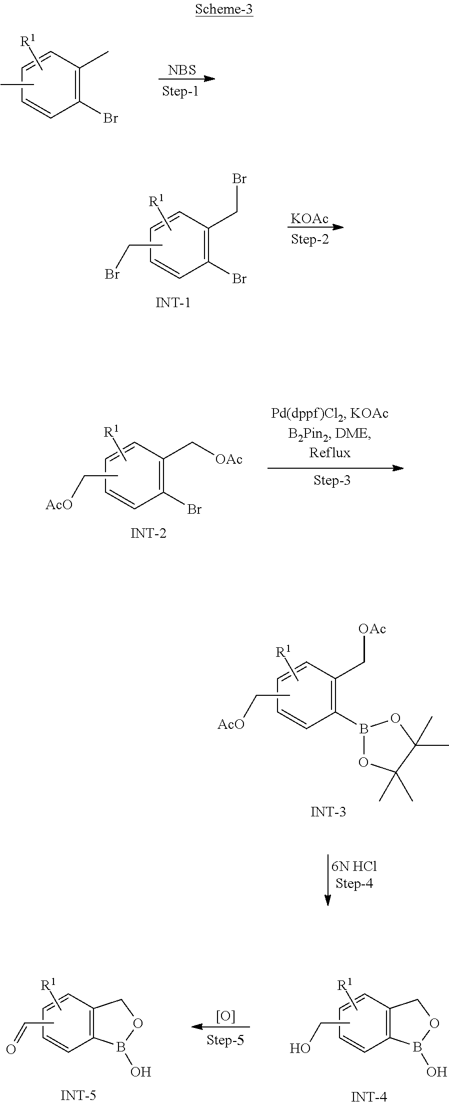

Compounds of formula II with specific substitution for R³ may be prepared by reacting intermediate-5 with organometallic reagents like organo magnesium reagents, organo-lithium reagents or organo zinc reagents to get intermediate 6 which may be further be oxidised to intermediate-7, compounds of formula II as disclosed in Scheme-4.

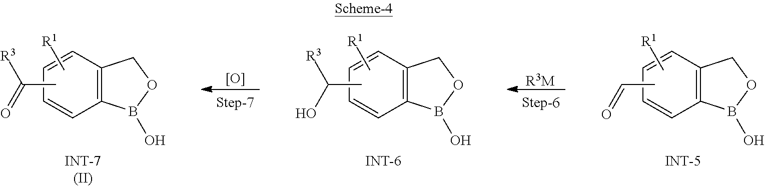

Compounds of formula III-a and III-b are known and several of them are commercially available but can also be prepared by known state of the art methodologies.

Compounds of formula I may be prepared from compounds of formula II by condensation with compounds of formula III-a and III-b optionally in suitable solvent such as methanol, ethanol THF or toluene optionally in presence of an acid like acetic acid or salt such as sodium acetate or both salt and acid such as sodium formate and small amount of acid like formic acid at a temperature between 20° C. and 200° C. and optionally in the presence of a water extraction system like a Dean-Stark apparatus or a chemical water scavenger like magnesium sulphate. For examples of analogous methods see Tetrahedron 65 (2009) 8738-8744

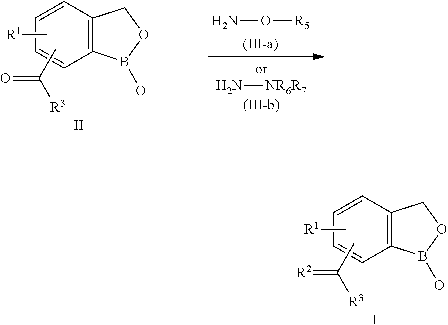

Compounds of formula (I) wherein R² is ═N—OR⁵ may be prepared by treating compounds of formula (I) wherein R² is ═N—OH with compounds of formula (C) in the presence of a base like sodium hydride, potassium carbonate or potassium acetate optionally in a suitable solvent like tetrahydrofuran or dimethylformamide and at a temperature between 20° C. and 100° C.

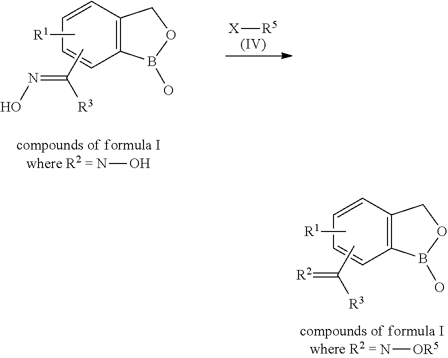

In a similar way, compounds of formula (I) wherein R² is ═N—NR⁶R⁷ may be prepared by treating compounds of formula (I) wherein R² is ═N—NH2 or compounds of formula (I) wherein R² is ═N—NR⁷H with compounds of formula (D) in the presence of a base like sodium hydride, lithium diisopropyl amide, butyl lithium, sodium hexamethyldisilazide optionally in a suitable solvent like tetrahydrofuran or dimethylformamide and at a temperature between 20° C. and 100° C.

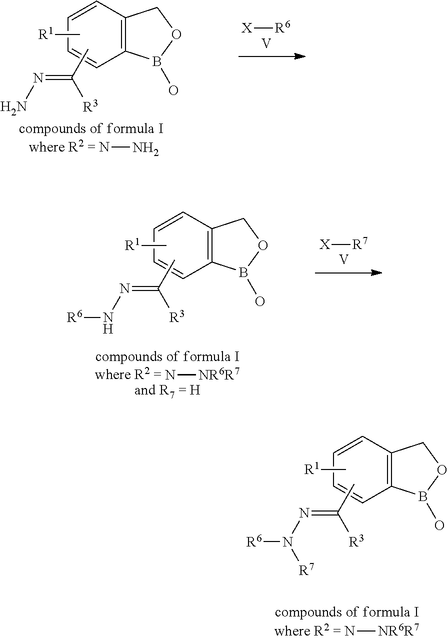

Compounds of formula V wherein X is a suitable leaving group such as a halogen or an alkyl- or aryl-sulfonate are known, or may be made from known compounds by known methods.

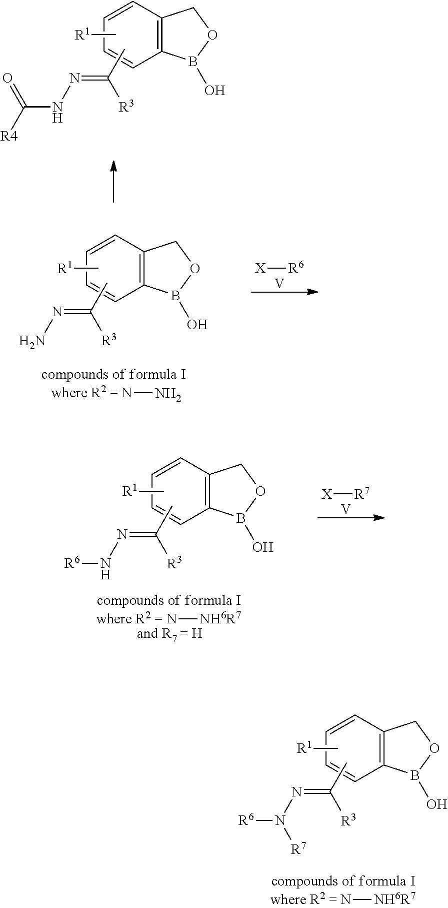

The invention therefore also relates to a method of controlling or preventing infestation of useful plants by phytopathogenic microorganisms, wherein a compound of formula (I) is applied as active ingredient to the plants, to parts thereof or the locus thereof. The compounds of formula (I) according to the invention are distinguished by excellent activity at low rates of application, by being well tolerated by plants and by being environmentally safe. They have very useful curative, preventive and systemic properties and are used for protecting numerous useful plants. The compounds of formula (I) can be used to inhibit or destroy the diseases that occur on plants or parts of plants (fruit, blossoms, leaves, stems, tubers, roots) of different crops of useful plants, while at the same time protecting also those parts of the plants that grow later e.g. from phytopathogenic microorganisms.

It is also possible to use compounds of formula (I) as dressing agents for the treatment of plant propagation material, in particular of seeds (fruit, tubers, grains) and plant cuttings (e.g. rice), for the protection against fungal infections as well as against phytopathogenic fungi occurring in the soil.

Furthermore, the compounds of formula (I) according to the invention may be used for controlling fungi in related areas, for example in the protection of technical materials, including wood and wood related technical products, in food storage or in hygiene management.

The methods according to the instant invention are particularly effective to protect useful plants or plant propagation material thereof against phytopathogenic fungi belonging to the following classes: Ascomycetes (e.g. the genus Cochliobolus, Colletotrichum, Fusarium, Gaeumannomyces, Giberella, Monographella, Microdochium, Penicillium, Phoma, Pyricularia, Magnaporthe, Septoria, Pseudocercosporella, Tapesia and Thielaviopsis); Basidiomycetes (e.g. the genus Phakopsora, Puccinia, Rhizoctonia, Thanatephorus, Sphacelotheca, Tilletia, Typhula and Ustilago); Fungi imperfecti (also known as Deuteromycetes; e.g. the genus Ascochyta, Diplodia, Erysiphe, Fusarium, Helminthosporium, Phomopsis, Pyrenophora and Verticillium); Oomycetes (e.g. Aphanomyces, Peronospora, Peronosclerospora, Phytophthora, Plasmopara, Pseudoperonospora, Pythium); and Zygomycets (e.g. the genus Rhizopus).

Within the scope of the invention, useful plants to be protected typically comprise the following species of plants: cereal (wheat, barley, rye, oat, rice, maize, sorghum and related species); beet (sugar beet and fodder beet); pomes, drupes and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (pumpkins, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocado, cinnamomum, camphor) or plants such as tobacco, nuts, coffee, eggplants, sugar cane, tea, pepper, vines, hops, bananas and natural rubber plants, as well as ornamentals.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors or PPO (protoporphyrinogen-oxidase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® Agrisure® GT Advantage (GA21 glyphosate-tolerant trait), Agrisure® CB Advantage (Bt11 corn borer (CB) trait), Agrisure® RW (corn rootworm trait) and Protecta®.

The term “crops” is to be understood as including also crop plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins from Bacillus cereus or Bacillus popilliae; or insecticidal proteins from Bacillus thuringiensis, such as δ-endotoxins, e.g. Cry1Ab, Cry1Ac, Cry1F, Cry1Fa2, Cry2Ab, Cry3A, Cry3Bb1 or Cry9C, or vegetative insecticidal proteins (Vip), e.g. Vip1, Vip2, Vip3 or Vip3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsin inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by 8-endotoxins, for example Cry1Ab, Cry1Ac, Cry1F, Cry1Fa2, Cry2Ab, Cry3A, Cry3Bb1 or Cry9C, or vegetative insecticidal proteins (Vip), for example Vip1, Vip2, Vip3 or Vip3A, expressly also hybrid toxins, truncated toxins and modified toxins. Hybrid toxins are produced recombinantly by a new combination of different domains of those proteins (see, for example, WO 02/15701). Truncated toxins, for example a truncated Cry1Ab, are known. In the case of modified toxins, one or more amino acids of the naturally occurring toxin are replaced. In such amino acid replacements, preferably non-naturally present protease recognition sequences are inserted into the toxin, such as, for example, in the case of Cry3A055, a cathepsin-G-recognition sequence is inserted into a Cry3A toxin (see WO03/018810).

Examples of such toxins or transgenic plants capable of synthesising such toxins are disclosed, for example, in EP-A-0 374 753, WO93/07278, WO95/34656, EP-A-0 427 529, EP-A-451 878 and WO03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a Cry1Ab toxin); YieldGard Rootworm® (maize variety that expresses a Cry3Bb1 toxin); YieldGard Plus® (maize variety that expresses a Cry1Ab and a Cry3Bb1 toxin); Starlink® (maize variety that expresses a Cry9C toxin); Herculex I® (maize variety that expresses a Cry1Fa2 toxin and the enzyme phosphinothricine N-acetyltransferase (PAT) to achieve tolerance to the herbicide glufosinate ammonium); NuCOTN 33B® (cotton variety that expresses a Cry1Ac toxin); Bollgard I® (cotton variety that expresses a Cry1Ac toxin); Bollgard II® (cotton variety that expresses a Cry1Ac and a Cry2Ab toxin); VipCot® (cotton variety that expresses a Vip3A and a Cry1Ab toxin); NewLeaf® (potato variety that expresses a Cry3A toxin); NatureGard®, Agrisure® GT Advantage (GA21 glyphosate-tolerant trait), Agrisure® CB Advantage (Bt11 corn borer (CB) trait) and Protecta®.

Further examples of such transgenic crops are:

1. Bt11 Maize from Syngenta Seeds SAS, Chemin de I'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated Cry1Ab toxin. Bt11 maize also transgenically expresses the enzyme PAT to achieve tolerance to the herbicide glufosinate ammonium.

2. Bt176 Maize from Syngenta Seeds SAS, Chemin de I'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a Cry1Ab toxin. Bt176 maize also transgenically expresses the enzyme PAT to achieve tolerance to the herbicide glufosinate ammonium.

3. MIR604 Maize from Syngenta Seeds SAS, Chemin de I'Hobit 27, F-31 790 St. Sauveur, France, registration number C/FR/96/05/10. Maize which has been rendered insect-resistant by transgenic expression of a modified Cry3A toxin. This toxin is Cry3A055 modified by insertion of a cathepsin-G-protease recognition sequence. The preparation of such transgenic maize plants is described in WO 03/018810.

4. MON 863 Maize from Monsanto Europe S.A. 270-272 Avenue de Tervuren, B-1150 Brussels, Belgium, registration number C/DE/02/9. MON 863 expresses a Cry3Bb1 toxin and has resistance to certain Coleoptera insects.

5. IPC 531 Cotton from Monsanto Europe S.A. 270-272 Avenue de Tervuren, B-1150 Brussels, Belgium, registration number C/ES/96/02.

6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.

7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a Cry1Ab toxin obtained from Bacillus thuringiensis subsp. kurstaki which brings about tolerance to certain Lepidoptera, include the European corn borer.

Transgenic crops of insect-resistant plants are also described in BATS (Zentrum für Biosicherheit und Nachhaltigkeit, Zentrum BATS, Clarastrasse 13, 4058 Basel, Switzerland) Report 2003, (http://bats.ch).

The term “crops” is to be understood as including also crop plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818 and EP-A-0 353 191. The methods of producing such transgenic plants are generally known to the person skilled in the art and are described, for example, in the publications mentioned above.

Crops may also be modified for enhanced resistance to fungal (for example Fusarium, Anthracnose, or Phytophthora), bacterial (for example Pseudomonas) or viral (for example potato leafroll virus, tomato spotted wilt virus, cucumber mosaic virus) pathogens.

Crops also include those that have enhanced resistance to nematodes, such as the soybean cyst nematode.

Crops that are tolerance to abiotic stress include those that have enhanced tolerance to drought, high salt, high temperature, chill, frost, or light radiation, for example through expression of NF-YB or other proteins known in the art.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The compounds of formula (I) can be used in unmodified form or, preferably, together with carriers and adjuvants conventionally employed in the art of formulation.

Therefore the invention also relates to compositions for controlling and protecting against phytopathogenic microorganisms, comprising a compound of formula (I) and an inert carrier, and to a method of controlling or preventing infestation of useful plants by phytopathogenic microorganisms, wherein a composition, comprising a compound of formula (I) as active ingredient and an inert carrier, is applied to the plants, to parts thereof or the locus thereof.

To this end compounds of formula (I) and inert carriers are conveniently formulated in known manner to emulsifiable concentrates, coatable pastes, directly sprayable or dilutable solutions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants (auxiliaries) can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The invention therefore also relates to pesticidal compositions such as emulsifiable concentrates, suspension concentrates, microemulsions, oil dispersibles, directly sprayable or dilutable solutions, spreadable pastes, dilute emulsions, soluble powders, dispersible powders, wettable powders, dusts, granules or encapsulations in polymeric substances, which comprise—at least—one of the active ingredients according to the invention and which are to be selected to suit the intended aims and the prevailing circumstances.

In these compositions, the active ingredient is employed in pure form, a solid active ingredient for example in a specific particle size, or, preferably, together with—at least—one of the auxiliaries conventionally used in the art of formulation, such as extenders, for example solvents or solid carriers, or such as surface-active compounds (surfactants).

Examples of suitable solvents are: unhydrogenated or partially hydrogenated aromatic hydrocarbons, preferably the fractions C₈ to C₁₂ of alkylbenzenes, such as xylene mixtures, alkylated naphthalenes or tetrahydronaphthalene, aliphatic or cycloaliphatic hydrocarbons, such as paraffins or cyclohexane, alcohols such as ethanol, propanol or butanol, glycols and their ethers and esters such as propylene glycol, dipropylene glycol ether, ethylene glycol or ethylene glycol monomethyl ether or ethylene glycol monoethyl ether, ketones, such as cyclohexanone, isophorone or diacetone alcohol, strongly polar solvents, such as N-methylpyrrolid-2-one, dimethyl sulfoxide or N,N-dimethylformamide, water, unepoxidized or epoxidized vegetable oils, such as unexpodized or epoxidized rapeseed, castor, coconut or soya oil, and silicone oils.

Solid carriers which are used for example for dusts and dispersible powders are, as a rule, ground natural minerals such as calcite, talc, kaolin, montmorillonite or attapulgite. To improve the physical properties, it is also possible to add highly disperse silicas or highly disperse absorbtive polymers.

Suitable adsorptive carriers for granules are porous types, such as pumice, brick grit, sepiolite or bentonite, and suitable non-sorptive carrier materials are calcite or sand. In addition, a large number of granulated materials of inorganic or organic nature can be used, in particular dolomite or comminuted plant residues.

Suitable surface-active compounds are, depending on the type of the active ingredient to be formulated, non-ionic, cationic and/or anionic surfactants or surfactant mixtures which have good emulsifying, dispersing and wetting properties. The surfactants mentioned below are only to be considered as examples; a large number of further surfactants which are conventionally used in the art of formulation and suitable according to the invention are described in the relevant literature.

Suitable non-ionic surfactants are, especially, polyglycol ether derivatives of aliphatic or cycloaliphatic alcohols, of saturated or unsaturated fatty acids or of alkyl phenols which may contain approximately 3 to approximately 30 glycol ether groups and approximately 8 to approximately 20 carbon atoms in the (cyclo)aliphatic hydrocarbon radical or approximately 6 to approximately 18 carbon atoms in the alkyl moiety of the alkyl phenols. Also suitable are water-soluble polyethylene oxide adducts with polypropylene glycol, ethylenediaminopolypropylene glycol or alkyl polypropylene glycol having 1 to approximately 10 carbon atoms in the alkyl chain and approximately 20 to approximately 250 ethylene glycol ether groups and approximately 10 to approximately 100 propylene glycol ether groups.

Normally, the abovementioned compounds contain 1 to approximately 5 ethylene glycol units per propylene glycol unit. Examples which may be mentioned are nonylphenoxypolyethoxyethanol, castor oil polyglycol ether, polypropylene glycol/polyethylene oxide adducts, tributylpheno-xypolyethoxyethanol, polyethylene glycol or octylphenoxypolyethoxyethanol. Also suitable are fatty acid esters of polyoxyethylene sorbitan, such as polyoxyethylene sorbitan trioleate.

The cationic surfactants are, especially, quarternary ammonium salts which generally have at least one alkyl radical of approximately 8 to approximately 22 C atoms as substituents and as further substituents (unhalogenated or halogenated) lower alkyl or hydroxyalkyl or benzyl radicals. The salts are preferably in the form of halides, methylsulfates or ethylsulfates. Examples are stearyltrimethylammonium chloride and benzylbis(2-chloroethyl)ethylammonium bromide.

Examples of suitable anionic surfactants are water-soluble soaps or water-soluble synthetic surface-active compounds. Examples of suitable soaps are the alkali, alkaline earth or (unsubstituted or substituted) ammonium salts of fatty acids having approximately 10 to approximately 22 C atoms, such as the sodium or potassium salts of oleic or stearic acid, or of natural fatty acid mixtures which are obtainable for example from coconut or tall oil; mention must also be made of the fatty acid methyl taurates. However, synthetic surfactants are used more frequently, in particular fatty sulfonates, fatty sulfates, sulfonated benzimidazole derivatives or alkylaryl sulfonates. As a rule, the fatty sulfonates and fatty sulfates are present as alkali, alkaline earth or (substituted or unsubstituted) ammonium salts and they generally have an alkyl radical of approximately 8 to approximately 22 C atoms, alkyl also to be understood as including the alkyl moiety of acyl radicals; examples which may be mentioned are the sodium or calcium salts of lignosulfonic acid, of the dodecylsulfuric ester or of a fatty alcohol sulfate mixture prepared from natural fatty acids. This group also includes the salts of the sulfuric esters and sulfonic acids of fatty alcohol/ethylene oxide adducts. The sulfonated benzimidazole derivatives preferably contain 2 sulfonyl groups and a fatty acid radical of approximately 8 to approximately 22 C atoms. Examples of alkylarylsulfonates are the sodium, calcium or triethanolammonium salts of decylbenzenesulfonic acid, of dibutylnaphthalenesulfonic acid or of a naphthalenesulfonic acid/formaldehyde condensate. Also possible are, furthermore, suitable phosphates, such as salts of the phosphoric ester of a p-nonylphenol/(4-14)ethylene oxide adduct, or phospholipids.

As a rule, the compositions comprise 0.1 to 99%, especially 0.1 to 95%, of active ingredient and 1 to 99.9%, especially 5 to 99.9%, of at least one solid or liquid adjuvant, it being possible as a rule for 0 to 25%, especially 0.1 to 20%, of the composition to be surfactants (% in each case meaning percent by weight). Whereas concentrated compositions tend to be preferred for commercial goods, the end consumer as a rule uses dilute compositions which have substantially lower concentrations of active ingredient.

Typically, a pre-mix formulation for foliar application comprises 0.1 to 99.9%, especially 1 to 95%, of the desired ingredients, and 99.9 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Normally, a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation.

Typically, a pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Whereas commercial products will preferably be formulated as concentrates (e.g., pre-mix composition (formulation)), the end user will normally employ dilute formulations (e.g., tank mix composition).

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating.

After coating, the seeds are typically dried and then transferred to a sizing machine for sizing. Such procedures are known in the art.

In general, the pre-mix compositions of the invention contain 0.5 to 99.9 especially 1 to 95, advantageously 1 to 50%, by mass of the desired ingredients, and 99.5 to 0.1, especially 99 to 5%, by mass of a solid or liquid adjuvant (including, for example, a solvent such as water), where the auxiliaries (or adjuvant) can be a surfactant in an amount of 0 to 50, especially 0.5 to 40%, by mass based on the mass of the pre-mix formulation.

The compounds of formula (I) or compositions, comprising a compound of formula (I) as active ingredient and an inert carrier, can be applied to the locus of the plant or plant to be treated, simultaneously or in succession with further compounds. These further compounds can be e.g. fertilizers or micronutrient donors or other preparations which influence the growth of plants. They can also be selective herbicides as well as insecticides, fungicides, bactericides, nematicides, molluscicides or mixtures of several of these preparations, if desired together with further carriers, surfactants or application promoting adjuvants customarily employed in the art of formulation. A preferred method of applying a compound of formula (I), or a composition, comprising a compound of formula (I) as active ingredient and an inert carrier, is foliar application. The frequency of application and the rate of application will depend on the risk of infestation by the corresponding pathogen.

However, the compounds of formula (I) can also penetrate the plant through the roots via the soil (systemic action) by drenching the locus of the plant with a liquid formulation, or by applying the compounds in solid form to the soil, e.g. in granular form (soil application). In crops of water rice such granulates can be applied to the flooded rice field. The compounds of formula (I) may also be applied to seeds (coating) by impregnating the seeds or tubers either with a liquid formulation of the fungicide or coating them with a solid formulation.

A formulation, i.e. a composition comprising the compound of formula (I) and, if desired, a solid or liquid adjuvant or, if desired as well, a further, other biocidally active ingredient, is prepared in a known manner, typically by intimately mixing and/or grinding the compound with extenders, for example solvents, solid carriers and, optionally, surface-active compounds (surfactants).

The activity of the compositions according to the invention can be broadened considerably, and adapted to prevailing circumstances, by adding other insecticidally, acaricidally and/or fungicidally active ingredients. The mixtures of the compounds of formula (I) with other insecticidally, acaricidally and/or fungicidally active ingredients may also have further surprising advantages which can also be described, in a wider sense, as synergistic activity. For example, better tolerance by plants, reduced phytotoxicity, insects can be controlled in their different development stages or better behaviour during their production, for example during grinding or mixing, during their storage or during their use. Suitable additions to active ingredients here are, for example, representatives of the following classes of active ingredients: organophosphorus compounds, nitrophenol derivatives, thioureas, juvenile hormones, formamidines, benzophenone derivatives, ureas, pyrrole derivatives, carbamates, pyrethroids, chlorinated hydrocarbons, acylureas, pyridylmethyleneamino derivatives, macrolides, neonicotinoids and Bacillus thuringiensis preparations.

The compositions can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compositions according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the compositions, that is the methods of controlling pests of the abovementioned type, such as spraying, atomizing, dusting, brushing on, dressing, scattering or pouring—which are to be selected to suit the intended aims of the prevailing circumstances—and the use of the compositions for controlling pests of the abovementioned type are other subjects of the invention. Typical rates of concentration are between 0.1 and 1000 ppm, preferably between 0.1 and 500 ppm, of active ingredient. The rate of application per hectare is generally 1 to 2000 g of active ingredient per hectare, in particular 10 to 1000 g/ha, preferably 10 to 600 g/ha.

A preferred method of application in the field of crop protection is application to the foliage of the plants (foliar application), it being possible to select frequency and rate of application to match the danger of infestation with the pest in question. Alternatively, the active ingredient can reach the plants via the root system (systemic action), by drenching the locus of the plants with a liquid composition or by incorporating the active ingredient in solid form into the locus of the plants, for example into the soil, for example in the form of granules (soil application). In the case of paddy rice crops, such granules can be metered into the flooded paddy-field.

The compositions according to the invention are also suitable for the protection of plant propagation material, for example seeds, such as fruit, tubers or kernels, or nursery plants, against pests of the abovementioned type. The propagation material can be treated with the compositions prior to planting, for example seed can be treated prior to sowing. Alternatively, the compositions can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention.

The activity of the compositions according to the invention can be broadened considerably, and adapted to prevailing circumstances, by adding other insecticidally, acaricidally and/or fungicidally active ingredients. The mixtures of the compounds of formula (I) with other insecticidally, acaricidally and/or fungicidally active ingredients may also have further surprising advantages which can also be described, in a wider sense, as synergistic activity. For example, better tolerance by plants, reduced phytotoxicity, insects can be controlled in their different development stages or better behaviour during their production, for example during grinding or mixing, during their storage or during their use. Suitable additions to active ingredients here are, for example, representatives of the following classes of active ingredients: organophosphorus compounds, nitrophenol derivatives, thioureas, juvenile hormones, formamidines, benzophenone derivatives, ureas, pyrrole derivatives, carbamates, pyrethroids, chlorinated hydrocarbons, acylureas, pyridylmethyleneamino derivatives, macrolides, neonicotinoids and Bacillus thuringiensis preparations.

The following mixtures of the compounds of formula I with active ingredients are preferred (the abbreviation “TX” means “one compound selected from the group consisting of the compounds described in Tables 1 to 300 and Table T1 of the present invention”):

an adjuvant selected from the group of substances consisting of petroleum oils (alternative name) (628)+TX, an acaricide selected from the group of substances consisting of 1,1-bis(4-chlorophenyl)-2-ethoxyethanol (IUPAC name) (910)+TX, 2,4-dichlorophenyl benzenesulfonate (IUPAC/Chemical Abstracts name) (1059)+TX, 2-fluoro-N-methyl-N-1-naphthylacetamide (IUPAC name) (1295)+TX, 4-chlorophenyl phenyl sulfone (IUPAC name) (981)+TX, abamectin (1)+TX, acequinocyl (3)+TX, acetoprole [CCN]+TX, acrinathrin (9)+TX, aldicarb (16)+TX, aldoxycarb (863)+TX, alpha-cypermethrin (202)+TX, amidithion (870)+TX, amidoflumet [CCN]+TX, amidothioate (872)+TX, amiton (875)+TX, amiton hydrogen oxalate (875)+TX, amitraz (24)+TX, aramite (881)+TX, arsenous oxide (882)+TX, AVI 382 (compound code)+TX, AZ 60541 (compound code)+TX, azinphos-ethyl (44)+TX, azinphos-methyl (45)+TX, azobenzene (IUPAC name) (888)+TX, azocyclotin (46)+TX, azothoate (889)+TX, benomyl (62)+TX, benoxafos (alternative name) [CCN]+TX, benzoximate (71)+TX, benzyl benzoate (IUPAC name) [CCN]+TX, bifenazate (74)+TX, bifenthrin (76)+TX, binapacryl (907)+TX, brofenvalerate (alternative name)+TX, bromo-cyclen (918)+TX, bromophos (920)+TX, bromophos-ethyl (921)+TX, bromopropylate (94)+TX, buprofezin (99)+TX, butocarboxim (103)+TX, butoxycarboxim (104)+TX, butylpyridaben (alternative name)+TX, calcium polysulfide (IUPAC name) (111)+TX, camphechlor (941)+TX, carbanolate (943)+TX, carbaryl (115)+TX, carbofuran (118)+TX, carbophenothion (947)+TX, CGA 50′439 (development code) (125)+TX, chinomethionat (126)+TX, chlorbenside (959)+TX, chlordimeform (964)+TX, chlordimeform hydrochloride (964)+TX, chlorfenapyr (130)+TX, chlorfenethol (968)+TX, chlorfenson (970)+TX, chlorfensulfide (971)+TX, chlorfenvinphos (131)+TX, chlorobenzilate (975)+TX, chloromebuform (977)+TX, chloromethiuron (978)+TX, chloropropylate (983)+TX, chlorpyrifos (145)+TX, chlorpyrifos-methyl (146)+TX, chlorthiophos (994)+TX, cinerin 1 (696)+TX, cinerin II (696)+TX, cinerins (696)+TX, clofentezine (158)+TX, closantel (alternative name) [CCN]+TX, coumaphos (174)+TX, crotamiton (alternative name) [CCN]+TX, crotoxyphos (1010)+TX, cufraneb (1013)+TX, cyanthoate (1020)+TX, cyflumetofen (CAS Reg. No.: 400882-07-7)+TX, cyhalothrin (196)+TX, cyhexatin (199)+TX, cypermethrin (201)+TX, DCPM (1032)+TX, DDT (219)+TX, demephion (1037)+TX, demephion-O (1037)+TX, demephion-S(1037)+TX, demeton (1038)+TX, demeton-methyl (224)+TX, demeton-O (1038)+TX, demeton-O-methyl (224)+TX, demeton-S(1038)+TX, demeton-S-methyl (224)+TX, demeton-S-methylsulfon (1039)+TX, diafenthiuron (226)+TX, dialifos (1042)+TX, diazinon (227)+TX, dichlofluanid (230)+TX, dichlorvos (236)+TX, dicliphos (alternative name)+TX, dicofol (242)+TX, dicrotophos (243)+TX, dienochlor (1071)+TX, dimefox (1081)+TX, dimethoate (262)+TX, dinactin (alternative name) (653)+TX, dinex (1089)+TX, dinex-diclexine (1089)+TX, dinobuton (269)+TX, dinocap (270)+TX, dinocap-4 [CCN]+TX, dinocap-6 [CCN]+TX, dinocton (1090)+TX, dinopenton (1092)+TX, dinosulfon (1097)+TX, dinoterbon (1098)+TX, dioxathion (1102)+TX, diphenyl sulfone (IUPAC name) (1103)+TX, disulfiram (alternative name) [CCN]+TX, disulfoton (278)+TX, DNOC (282)+TX, dofenapyn (1113)+TX, doramectin (alternative name) [CCN]+TX, endosulfan (294)+TX, endothion (1121)+TX, EPN (297)+TX, eprinomectin (alternative name) [CCN]+TX, ethion (309)+TX, ethoate-methyl (1134)+TX, etoxazole (320)+TX, etrimfos (1142)+TX, fenazaflor (1147)+TX, fenazaquin (328)+TX, fenbutatin oxide (330)+TX, fenothiocarb (337)+TX, fenpropathrin (342)+TX, fenpyrad (alternative name)+TX, fen-pyroximate (345)+TX, fenson (1157)+TX, fentrifanil (1161)+TX, fenvalerate (349)+TX, fipronil (354)+TX, fluacrypyrim (360)+TX, fluazuron (1166)+TX, flubenzimine (1167)+TX, flucycloxuron (366)+TX, flucythrinate (367)+TX, fluenetil (1169)+TX, flufenoxuron (370)+TX, flumethrin (372)+TX, fluorbenside (1174)+TX, fluvalinate (1184)+TX, FMC 1137 (development code) (1185)+TX, formetanate (405)+TX, formetanate hydrochloride (405)+TX, formothion (1192)+TX, formparanate (1193)+TX, gamma-HCH (430)+TX, glyodin (1205)+TX, halfenprox (424)+TX, heptenophos (432)+TX, hexadecyl cyclopropanecarboxylate (IUPAC/Chemical Abstracts name) (1216)+TX, hexythiazox (441)+TX, iodomethane (IUPAC name) (542)+TX, isocarbophos (alternative name) (473)+TX, isopropyl O-(methoxyaminothiophosphoryl)salicylate (IUPAC name) (473)+TX, ivermectin (alternative name) [CCN]+TX, jasmolin 1 (696)+TX, jasmolin 11 (696)+TX, jodfenphos (1248)+TX, lindane (430)+TX, lufenuron (490)+TX, malathion (492)+TX, malonoben (1254)+TX, mecarbam (502)+TX, mephosfolan (1261)+TX, mesulfen (alternative name) [CCN]+TX, methacrifos (1266)+TX, methamidophos (527)+TX, methidathion (529)+TX, methiocarb (530)+TX, methomyl (531)+TX, methyl bromide (537)+TX, metolcarb (550)+TX, mevinphos (556)+TX, mexacarbate (1290)+TX, milbemectin (557)+TX, milbemycin oxime (alternative name) [CCN]+TX, mipafox (1293)+TX, monocrotophos (561)+TX, morphothion (1300)+TX, moxidectin (alternative name) [CCN]+TX, naled (567)+TX, NC-184 (compound code)+TX, NC-512 (compound code)+TX, nifluridide (1309)+TX, nikkomycins (alternative name) [CCN]+TX, nitrilacarb (1313)+TX, nitrilacarb 1:1 zinc chloride complex (1313)+TX, NNI-0101 (compound code)+TX, NNI-0250 (compound code)+TX, omethoate (594)+TX, oxamyl (602)+TX, oxydeprofos (1324)+TX, oxydisulfoton (1325)+TX, pp′-DDT (219)+TX, parathion (615)+TX, permethrin (626)+TX, petroleum oils (alternative name) (628)+TX, phenkapton (1330)+TX, phenthoate (631)+TX, phorate (636)+TX, phosalone (637)+TX, phosfolan (1338)+TX, phosmet (638)+TX, phosphamidon (639)+TX, phoxim (642)+TX, pirimiphos-methyl (652)+TX, polychloroterpenes (traditional name) (1347)+TX, polynactins (alternative name) (653)+TX, proclonol (1350)+TX, profenofos (662)+TX, promacyl (1354)+TX, propargite (671)+TX, propetamphos (673)+TX, propoxur (678)+TX, prothidathion (1360)+TX, prothoate (1362)+TX, pyrethrin 1 (696)+TX, pyrethrin 11 (696)+TX, pyrethrins (696)+TX, pyridaben (699)+TX, pyridaphenthion (701)+TX, pyrimidifen (706)+TX, pyrimitate (1370)+TX, quinalphos (711)+TX, quintiofos (1381)+TX, R-1492 (development code) (1382)+TX, RA-17 (development code) (1383)+TX, rotenone (722)+TX, schradan (1389)+TX, sebufos (alternative name)+TX, selamectin (alternative name) [CCN]+TX, SI-0009 (compound code)+TX, sophamide (1402)+TX, spirodiclofen (738)+TX, spiromesifen (739)+TX, SSI-121 (development code) (1404)+TX, sulfiram (alternative name) [CCN]+TX, sulfluramid (750)+TX, sulfotep (753)+TX, sulfur (754)+TX, SZI-121 (development code) (757)+TX, tau-fluvalinate (398)+TX, tebufenpyrad (763)+TX, TEPP (1417)+TX, terbam (alternative name)+TX, tetrachlorvinphos (777)+TX, tetradifon (786)+TX, tetranactin (alternative name) (653)+TX, tetrasul (1425)+TX, thiafenox (alternative name)+TX, thiocarboxime (1431)+TX, thiofanox (800)+TX, thiometon (801)+TX, thioquinox (1436)+TX, thuringiensin (alternative name) [CCN]+TX, triamiphos (1441)+TX, triarathene (1443)+TX, triazophos (820)+TX, triazuron (alternative name)+TX, trichlorfon (824)+TX, trifenofos (1455)+TX, trinactin (alternative name) (653)+TX, vamidothion (847)+TX, vaniliprole [CCN] and YI-5302 (compound code)+TX,
an algicide selected from the group of substances consisting of bethoxazin [CCN]+TX, copper dioctanoate (IUPAC name) (170)+TX, copper sulfate (172)+TX, cybutryne [CCN]+TX, dichlone (1052)+TX, dichlorophen (232)+TX, endothal (295)+TX, fentin (347)+TX, hydrated lime [CCN]+TX, nabam (566)+TX, quinoclamine (714)+TX, quinonamid (1379)+TX, simazine (730)+TX, triphenyltin acetate (IUPAC name) (347) and triphenyltin hydroxide (IUPAC name) (347)+TX, an anthelmintic selected from the group of substances consisting of abamectin (1)+TX, crufomate (1011)+TX, doramectin (alternative name) [CCN]+TX, emamectin (291)+TX, emamectin benzoate (291)+TX, eprinomectin (alternative name) [CCN]+TX, ivermectin (alternative name) [CCN]+TX, milbemycin oxime (alternative name) [CCN]+TX, moxidectin (alternative name) [CCN]+TX, piperazine [CCN]+TX, selamectin (alternative name) [CCN]+TX, spinosad (737) and thiophanate (1435)+TX,
an avicide selected from the group of substances consisting of chloralose (127)+TX, endrin (1122)+TX, fenthion (346)+TX, pyridin-4-amine (IUPAC name) (23) and strychnine (745)+TX, a bactericide selected from the group of substances consisting of 1-hydroxy-1H-pyridine-2-thione (IUPAC name) (1222)+TX, 4-(quinoxalin-2-ylamino)benzenesulfonamide (IUPAC name) (748)+TX, 8-hydroxyquinoline sulfate (446)+TX, bronopol (97)+TX, copper dioctanoate (IUPAC name) (170)+TX, copper hydroxide (IUPAC name) (169)+TX, cresol [CCN]+TX, dichlorophen (232)+TX, dipyrithione (1105)+TX, dodicin (1112)+TX, fenaminosulf (1144)+TX, formaldehyde (404)+TX, hydrargaphen (alternative name) [CCN]+TX, kasugamycin (483)+TX, kasugamycin hydrochloride hydrate (483)+TX, nickel bis(dimethyldithiocarbamate) (IUPAC name) (1308)+TX, nitrapyrin (580)+TX, octhilinone (590)+TX, oxolinic acid (606)+TX, oxytetracycline (611)+TX, potassium hydroxyquinoline sulfate (446)+TX, probenazole (658)+TX, streptomycin (744)+TX, streptomycin sesquisulfate (744)+TX, tecloftalam (766)+TX, and thiomersal (alternative name) [CCN]+TX, a biological agent selected from the group of substances consisting of Adoxophyes orana GV (alternative name) (12)+TX, Agrobacterium radiobacter (alternative name) (13)+TX, Amblyseius spp. (alternative name) (19)+TX, Anagrapha falcifera NPV (alternative name) (28)+TX, Anagrus atomus (alternative name) (29)+TX, Aphelinus abdominalis (alternative name) (33)+TX, Aphidius colemani (alternative name) (34)+TX, Aphidoletes aphidimyza (alternative name) (35)+TX, Autographa californica NPV (alternative name) (38)+TX, Bacillus firmus (alternative name) (48)+TX, Bacillus sphaericus Neide (scientific name) (49)+TX, Bacillus thuringiensis Berliner (scientific name) (51)+TX, Bacillus thuringiensis subsp. aizawai (scientific name) (51)+TX, Bacillus thuringiensis subsp. israelensis (scientific name) (51)+TX, Bacillus thuringiensis subsp. japonensis (scientific name) (51)+TX, Bacillus thuringiensis subsp. kurstaki (scientific name) (51)+TX, Bacillus thuringiensis subsp. tenebrionis (scientific name) (51)+TX, Beauveria bassiana (alternative name) (53)+TX, Beauveria brongniartii (alternative name) (54)+TX, Chrysoperla carnea (alternative name) (151)+TX, Cryptolaemus montrouzieri (alternative name) (178)+TX, Cydia pomonella GV (alternative name) (191)+TX, Dacnusa sibirica (alternative name) (212)+TX, Diglyphus isaea (alternative name) (254)+TX, Encarsia formosa (scientific name) (293)+TX, Eretmocerus eremicus (alternative name) (300)+TX, Helicoverpa zea NPV (alternative name) (431)+TX, Heterorhabditis bacteriophora and H. megidis (alternative name) (433)+TX, Hippodamia convergens (alternative name) (442)+TX, Leptomastix dactylopii (alternative name) (488)+TX, Macrolophus caliginosus (alternative name) (491)+TX, Mamestra brassicae NPV (alternative name) (494)+TX, Metaphycus helvolus (alternative name) (522)+TX, Metarhizium anisopliae var. acridum (scientific name) (523)+TX, Metarhizium anisopliae var. anisopliae (scientific name) (523)+TX, Neodiprion sertifer NPV and N. lecontei NPV (alternative name) (575)+TX, Orius spp. (alternative name) (596)+TX, Paecilomyces fumosoroseus (alternative name) (613)+TX, Phytoseiulus persimilis (alternative name) (644)+TX, Spodoptera exigua multicapsid nuclear polyhedrosis virus (scientific name) (741)+TX, Steinernema bibionis (alternative name) (742)+TX, Steinernema carpocapsae (alternative name) (742)+TX, Steinernema feltiae (alternative name) (742)+TX, Steinernema glaseri (alternative name) (742)+TX, Steinernema riobrave (alternative name) (742)+TX, Steinernema riobravis (alternative name) (742)+TX, Steinernema scapterisci (alternative name) (742)+TX, Steinernema spp. (alternative name) (742)+TX, Trichogramma spp. (alternative name) (826)+TX, Typhlodromus occidentalis (alternative name) (844) and Verticillium lecanii (alternative name) (848)+TX,
a soil sterilant selected from the group of substances consisting of iodomethane (IUPAC name) (542) and methyl bromide (537)+TX,
a chemosterilant selected from the group of substances consisting of apholate [CCN]+TX, bisazir (alternative name) [CCN]+TX, busulfan (alternative name) [CCN]+TX, diflubenzuron (250)+TX, dimatif (alternative name) [CCN]+TX, hemel [CCN]+TX, hempa [CCN]+TX, metepa [CCN]+TX, methiotepa [CCN]+TX, methyl apholate [CCN]+TX, morzid [CCN]+TX, penfluron (alternative name) [CCN]+TX, tepa [CCN]+TX, thiohempa (alternative name) [CCN]+TX, thiotepa (alternative name) [CCN]+TX, tretamine (alternative name) [CCN] and uredepa (alternative name) [CCN]+TX, an insect pheromone selected from the group of substances consisting of (E)-dec-5-en-1-yl acetate with (E)-dec-5-en-1-ol (IUPAC name) (222)+TX, (E)-tridec-4-en-1-yl acetate (IUPAC name) (829)+TX, (E)-6-methylhept-2-en-4-ol (IUPAC name) (541)+TX, (E,Z)-tetradeca-4,10-dien-1-yl acetate (IUPAC name) (779)+TX, (Z)-dodec-7-en-1-yl acetate (IUPAC name) (285)+TX, (Z)-hexadec-11-enal (IUPAC name) (436)+TX, (Z)-hexadec-11-en-1-yl acetate (IUPAC name) (437)+TX, (Z)-hexadec-13-en-11-yn-1-yl acetate (IUPAC name) (438)+TX, (Z)-icos-13-en-10-one (IUPAC name) (448)+TX, (Z)-tetradec-7-en-1-al (IUPAC name) (782)+TX, (Z)-tetradec-9-en-1-ol (IUPAC name) (783)+TX, (Z)-tetradec-9-en-1-yl acetate (IUPAC name) (784)+TX, (7E,9Z)-dodeca-7,9-dien-1-yl acetate (IUPAC name) (283)+TX, (9Z,11E)-tetradeca-9,11-dien-1-yl acetate (IUPAC name) (780)+TX, (9Z,12E)-tetradeca-9,12-dien-1-yl acetate (IUPAC name) (781)+TX, 14-methyloctadec-1-ene (IUPAC name) (545)+TX, 4-methylnonan-5-ol with 4-methylnonan-5-one (IUPAC name) (544)+TX, alpha-multistriatin (alternative name) [CCN]+TX, brevicomin (alternative name) [CCN]+TX, codlelure (alternative name) [CCN]+TX, codlemone (alternative name) (167)+TX, cuelure (alternative name) (179)+TX, disparlure (277)+TX, dodec-8-en-1-yl acetate (IUPAC name) (286)+TX, dodec-9-en-1-yl acetate (IUPAC name) (287)+TX, dodeca-8+TX, 10-dien-1-yl acetate (IUPAC name) (284)+TX, dominicalure (alternative name) [CCN]+TX, ethyl 4-methyloctanoate (IUPAC name) (317)+TX, eugenol (alternative name) [CCN]+TX, frontalin (alternative name) [CCN]+TX, gossyplure (alternative name) (420)+TX, grandlure (421)+TX, grandlure I (alternative name) (421)+TX, grandlure II (alternative name) (421)+TX, grandlure III (alternative name) (421)+TX, grandlure IV (alternative name) (421)+TX, hexalure [CCN]+TX, ipsdienol (alternative name) [CCN]+TX, ipsenol (alternative name) [CCN]+TX, japonilure (alternative name) (481)+TX, lineatin (alternative name) [CCN]+TX, litlure (alternative name) [CCN]+TX, looplure (alternative name) [CCN]+TX, medlure [CCN]+TX, megatomoic acid (alternative name) [CCN]+TX, methyl eugenol (alternative name) (540)+TX, muscalure (563)+TX, octadeca-2,13-dien-1-yl acetate (IUPAC name) (588)+TX, octadeca-3,13-dien-1-yl acetate (IUPAC name) (589)+TX, orfralure (alternative name) [CCN]+TX, oryctalure (alternative name) (317)+TX, ostramone (alternative name) [CCN]+TX, siglure [CCN]+TX, sordidin (alternative name) (736)+TX, sulcatol (alternative name) [CCN]+TX, tetradec-11-en-1-yl acetate (IUPAC name) (785)+TX, trimedlure (839)+TX, trimedlure A (alternative name) (839)+TX, trimedlure B₁ (alternative name) (839)+TX, trimedlure B₂ (alternative name) (839)+TX, trimedlure C (alternative name) (839) and trunc-call (alternative name) [CCN]+TX,
an insect repellent selected from the group of substances consisting of 2-(octylthio)ethanol (IUPAC name) (591)+TX, butopyronoxyl (933)+TX, butoxy(polypropylene glycol) (936)+TX, dibutyl adipate (IUPAC name) (1046)+TX, dibutyl phthalate (1047)+TX, dibutyl succinate (IUPAC name) (1048)+TX, diethyltoluamide [CCN]+TX, dimethyl carbate [CCN]+TX, dimethyl phthalate [CCN]+TX, ethyl hexanediol (1137)+TX, hexamide [CCN]+TX, methoquin-butyl (1276)+TX, methylneodecanamide [CCN]+TX, oxamate [CCN] and picaridin [CCN]+TX, an insecticide selected from the group of substances consisting of 1-dichloro-1-nitroethane (IUPAC/Chemical Abstracts name) (1058)+TX, 1,1-dichloro-2,2-bis(4-ethylphenyl)ethane (IUPAC name) (1056), +TX, 1,2-dichloropropane (IUPAC/Chemical Abstracts name) (1062)+TX, 1,2-dichloropropane with 1,3-dichloropropene (IUPAC name) (1063)+TX, 1-bromo-2-chloroethane (IUPAC/Chemical Abstracts name) (916)+TX, 2,2,2-trichloro-1-(3,4-dichlorophenyl)ethyl acetate (IUPAC name) (1451)+TX, 2,2-dichlorovinyl 2-ethylsulfinylethyl methyl phosphate (IUPAC name) (1066)+TX, 2-(1,3-dithiolan-2-yl)phenyl dimethylcarbamate (IUPAC/Chemical Abstracts name) (1109)+TX, 2-(2-butoxyethoxy)ethyl thiocyanate (IUPAC/Chemical Abstracts name) (935)+TX, 2-(4,5-dimethyl-1,3-dioxolan-2-yl)phenyl methylcarbamate (IUPAC/Chemical Abstracts name) (1084)+TX, 2-(4-chloro-3,5-xylyloxy)ethanol (IUPAC name) (986)+TX, 2-chlorovinyl diethyl phosphate (IUPAC name) (984)+TX, 2-imidazolidone (IUPAC name) (1225)+TX, 2-isovalerylindan-1,3-dione (IUPAC name) (1246)+TX, 2-methyl(prop-2-ynyl)aminophenyl methylcarbamate (IUPAC name) (1284)+TX, 2-thiocyanatoethyl laurate (IUPAC name) (1433)+TX, 3-bromo-1-chloroprop-1-ene (IUPAC name) (917)+TX, 3-methyl-1-phenylpyrazol-5-yl dimethylcarbamate (IUPAC name) (1283)+TX, 4-methyl(prop-2-ynyl)amino-3,5-xylyl methylcarbamate (IUPAC name) (1285)+TX, 5,5-dimethyl-3-oxocyclohex-1-enyl dimethylcarbamate (IUPAC name) (1085)+TX, abamectin (1)+TX, acephate (2)+TX, acetamiprid (4)+TX, acethion (alternative name) [CCN]+TX, acetoprole [CCN]+TX, acrinathrin (9)+TX, acrylonitrile (IUPAC name) (861)+TX, alanycarb (15)+TX, aldicarb (16)+TX, aldoxycarb (863)+TX, aldrin (864)+TX, allethrin (17)+TX, allosamidin (alternative name) [CCN]+TX, allyxycarb (866)+TX, alpha-cypermethrin (202)+TX, alpha-ecdysone (alternative name) [CCN]+TX, aluminium phosphide (640)+TX, amidithion (870)+TX, amidothioate (872)+TX, aminocarb (873)+TX, amiton (875)+TX, amiton hydrogen oxalate (875)+TX, amitraz (24)+TX, anabasine (877)+TX, athidathion (883)+TX, AVI 382 (compound code)+TX, AZ 60541 (compound code)+TX, azadirachtin (alternative name) (41)+TX, azamethiphos (42)+TX, azinphos-ethyl (44)+TX, azinphos-methyl (45)+TX, azothoate (889)+TX, Bacillus thuringiensis delta endotoxins (alternative name) (52)+TX, barium hexafluorosilicate (alternative name) [CCN]+TX, barium polysulfide (IUPAC/Chemical Abstracts name) (892)+TX, barthrin [CCN]+TX, Bayer 22/190 (development code) (893)+TX, Bayer 22408 (development code) (894)+TX, bendiocarb (58)+TX, benfuracarb (60)+TX, bensultap (66)+TX, beta-cyfluthrin (194)+TX, beta-cypermethrin (203)+TX, bifenthrin (76)+TX, bioallethrin (78)+TX, bioallethrin S-cyclopentenyl isomer (alternative name) (79)+TX, bioethanomethrin [CCN]+TX, biopermethrin (908)+TX, bioresmethrin (80)+TX, bis(2-chloroethyl) ether (IUPAC name) (909)+TX, bistrifluron (83)+TX, borax (86)+TX, brofenvalerate (alternative name)+TX, bromfenvinfos (914)+TX, bromocyclen (918)+TX, bromo-DDT (alternative name) [CCN]+TX, bromophos (920)+TX, bromophos-ethyl (921)+TX, bufencarb (924)+TX, buprofezin (99)+TX, butacarb (926)+TX, butathiofos (927)+TX, butocarboxim (103)+TX, butonate (932)+TX, butoxycarboxim (104)+TX, butylpyridaben (alternative name)+TX, cadusafos (109)+TX, calcium arsenate [CCN]+TX, calcium cyanide (444)+TX, calcium polysulfide (IUPAC name) (111)+TX, camphechlor (941)+TX, carbanolate (943)+TX, carbaryl (115)+TX, carbofuran (118)+TX, carbon disulfide (IUPAC/Chemical Abstracts name) (945)+TX, carbon tetrachloride (IUPAC name) (946)+TX, carbophenothion (947)+TX, carbosulfan (119)+TX, cartap (123)+TX, cartap hydrochloride (123)+TX, cevadine (alternative name) (725)+TX, chlorbicyclen (960)+TX, chlordane (128)+TX, chlordecone (963)+TX, chlordimeform (964)+TX, chlordimeform hydrochloride (964)+TX, chlorethoxyfos (129)+TX, chlorfenapyr (130)+TX, chlorfenvinphos (131)+TX, chlorfluazuron (132)+TX, chlormephos (136)+TX, chloroform [CCN]+TX, chloropicrin (141)+TX, chlorphoxim (989)+TX, chlorprazophos (990)+TX, chlorpyrifos (145)+TX, chlorpyrifos-methyl (146)+TX, chlorthiophos (994)+TX, chromafenozide (150)+TX, cinerin 1 (696)+TX, cinerin II (696)+TX, cinerins (696)+TX, cis-resmethrin (alternative name)+TX, cismethrin (80)+TX, clocythrin (alternative name)+TX, cloethocarb (999)+TX, closantel (alternative name) [CCN]+TX, clothianidin (165)+TX, copper acetoarsenite [CCN]+TX, copper arsenate [CCN]+TX, copper oleate [CCN]+TX, coumaphos (174)+TX, coumithoate (1006)+TX, crotamiton (alternative name) [CCN]+TX, crotoxyphos (1010)+TX, crufomate (1011)+TX, cryolite (alternative name) (177)+TX, CS 708 (development code) (1012)+TX, cyanofenphos (1019)+TX, cyanophos (184)+TX, cyanthoate (1020)+TX, cyclethrin [CCN]+TX, cycloprothrin (188)+TX, cyfluthrin (193)+TX, cyhalothrin (196)+TX, cypermethrin (201)+TX, cyphenothrin (206)+TX, cyromazine (209)+TX, cythioate (alternative name) [CCN]+TX, d-limonene (alternative name) [CCN]+TX, d-tetramethrin (alternative name) (788)+TX, DAEP (1031)+TX, dazomet (216)+TX, DDT (219)+TX, decarbofuran (1034)+TX, deltamethrin (223)+TX, demephion (1037)+TX, demephion-O (1037)+TX, demephion-S(1037)+TX, demeton (1038)+TX, demeton-methyl (224)+TX, demeton-O (1038)+TX, demeton-O-methyl (224)+TX, demeton-S(1038)+TX, demeton-S-methyl (224)+TX, demeton-S-methylsulphon (1039)+TX, diafenthiuron (226)+TX, dialifos (1042)+TX, diamidafos (1044)+TX, diazinon (227)+TX, dicapthon (1050)+TX, dichlofenthion (1051)+TX, dichlorvos (236)+TX, dicliphos (alternative name)+TX, dicresyl (alternative name) [CCN]+TX, dicrotophos (243)+TX, dicyclanil (244)+TX, dieldrin (1070)+TX, diethyl 5-methylpyrazol-3-yl phosphate (IUPAC name) (1076)+TX, diflubenzuron (250)+TX, dilor (alternative name) [CCN]+TX, dimefluthrin [CCN]+TX, dimefox (1081)+TX, dimetan (1085)+TX, dimethoate (262)+TX, dimethrin (1083)+TX, dimethylvinphos (265)+TX, dimetilan (1086)+TX, dinex (1089)+TX, dinex-diclexine (1089)+TX, dinoprop (1093)+TX, dinosam (1094)+TX, dinoseb (1095)+TX, dinotefuran (271)+TX, diofenolan (1099)+TX, dioxabenzofos (1100)+TX, dioxacarb (1101)+TX, dioxathion (1102)+TX, disulfoton (278)+TX, dithicrofos (1108)+TX, DNOC (282)+TX, doramectin (alternative name) [CCN]+TX, DSP (1115)+TX, ecdysterone (alternative name) [CCN]+TX, EI 1642 (development code) (1118)+TX, emamectin (291)+TX, emamectin benzoate (291)+TX, EMPC (1120)+TX, empenthrin (292)+TX, endosulfan (294)+TX, endothion (1121)+TX, endrin (1122)+TX, EPBP (1123)+TX, EPN (297)+TX, epofenonane (1124)+TX, eprinomectin (alternative name) [CCN]+TX, esfenvalerate (302)+TX, etaphos (alternative name) [CCN]+TX, ethiofencarb (308)+TX, ethion (309)+TX, ethiprole (310)+TX, ethoate-methyl (1134)+TX, ethoprophos (312)+TX, ethyl formate (IUPAC name) [CCN]+TX, ethyl-DDD (alternative name) (1056)+TX, ethylene dibromide (316)+TX, ethylene dichloride (chemical name) (1136)+TX, ethylene oxide [CCN]+TX, etofenprox (319)+TX, etrimfos (1142)+TX, EXD (1143)+TX, famphur (323)+TX, fenamiphos (326)+TX, fenazaflor (1147)+TX, fenchlorphos (1148)+TX, fenethacarb (1149)+TX, fenfluthrin (1150)+TX, fenitrothion (335)+TX, fenobucarb (336)+TX, fenoxacrim (1153)+TX, fenoxycarb (340)+TX, fenpirithrin (1155)+TX, fenpropathrin (342)+TX, fenpyrad (alternative name)+TX, fensulfothion (1158)+TX, fenthion (346)+TX, fenthion-ethyl [CCN]+TX, fenvalerate (349)+TX, fipronil (354)+TX, flonicamid (358)+TX, flubendiamide (CAS. Reg. No.: 272451-65-7)+TX, flucofuron (1168)+TX, flucycloxuron (366)+TX, flucythrinate (367)+TX, fluenetil (1169)+TX, flufenerim [CCN]+TX, flufenoxuron (370)+TX, flufenprox (1171)+TX, flumethrin (372)+TX, fluvalinate (1184)+TX, FMC 1137 (development code) (1185)+TX, fonofos (1191)+TX, formetanate (405)+TX, formetanate hydrochloride (405)+TX, formothion (1192)+TX, formparanate (1193)+TX, fosmethilan (1194)+TX, fospirate (1195)+TX, fosthiazate (408)+TX, fosthietan (1196)+TX, furathiocarb (412)+TX, furethrin (1200)+TX, gamma-cyhalothrin (197)+TX, gamma-HCH (430)+TX, guazatine (422)+TX, guazatine acetates (422)+TX, GY-81 (development code) (423)+TX, halfenprox (424)+TX, halofenozide (425)+TX, HCH (430)+TX, HEOD (1070)+TX, heptachlor (1211)+TX, heptenophos (432)+TX, heterophos [CCN]+TX, hexaflumuron (439)+TX, HHDN (864)+TX, hydramethylnon (443)+TX, hydrogen cyanide (444)+TX, hydroprene (445)+TX, hyquincarb (1223)+TX, imidacloprid (458)+TX, imiprothrin (460)+TX, indoxacarb (465)+TX, iodomethane (IUPAC name) (542)+TX, IPSP (1229)+TX, isazofos (1231)+TX, isobenzan (1232)+TX, isocarbophos (alternative name) (473)+TX, isodrin (1235)+TX, isofenphos (1236)+TX, isolane (1237)+TX, isoprocarb (472)+TX, isopropyl O-(methoxy-aminothiophosphoryl)salicylate (IUPAC name) (473)+TX, isoprothiolane (474)+TX, isothioate (1244)+TX, isoxathion (480)+TX, ivermectin (alternative name) [CCN]+TX, jasmolin 1 (696)+TX, jasmolin 11 (696)+TX, jodfenphos (1248)+TX, juvenile hormone I (alternative name) [CCN]+TX, juvenile hormone II (alternative name) [CCN]+TX, juvenile hormone III (alternative name) [CCN]+TX, kelevan (1249)+TX, kinoprene (484)+TX, lambda-cyhalothrin (198)+TX, lead arsenate [CCN]+TX, lepimectin (CCN)+TX, leptophos (1250)+TX, lindane (430)+TX, lirimfos (1251)+TX, lufenuron (490)+TX, lythidathion (1253)+TX, m-cumenyl methylcarbamate (IUPAC name) (1014)+TX, magnesium phosphide (IUPAC name) (640)+TX, malathion (492)+TX, malonoben (1254)+TX, mazidox (1255)+TX, mecarbam (502)+TX, mecarphon (1258)+TX, menazon (1260)+TX, mephosfolan (1261)+TX, mercurous chloride (513)+TX, mesulfenfos (1263)+TX, metaflumizone (CCN)+TX, metam (519)+TX, metam-potassium (alternative name) (519)+TX, metam-sodium (519)+TX, methacrifos (1266)+TX, methamidophos (527)+TX, methanesulfonyl fluoride (IUPAC/Chemical Abstracts name) (1268)+TX, methidathion (529)+TX, methiocarb (530)+TX, methocrotophos (1273)+TX, methomyl (531)+TX, methoprene (532)+TX, methoquin-butyl (1276)+TX, methothrin (alternative name) (533)+TX, methoxychlor (534)+TX, methoxyfenozide (535)+TX, methyl bromide (537)+TX, methyl isothiocyanate (543)+TX, methylchloroform (alternative name) [CCN]+TX, methylene chloride [CCN]+TX, metofluthrin [CCN]+TX, metolcarb (550)+TX, metoxadiazone (1288)+TX, mevinphos (556)+TX, mexacarbate (1290)+TX, milbemectin (557)+TX, milbemycin oxime (alternative name) [CCN]+TX, mipafox (1293)+TX, mirex (1294)+TX, monocrotophos (561)+TX, morphothion (1300)+TX, moxidectin (alternative name) [CCN]+TX, naftalofos (alternative name) [CCN]+TX, naled (567)+TX, naphthalene (IUPAC/Chemical Abstracts name) (1303)+TX, NC-170 (development code) (1306)+TX, NC-184 (compound code)+TX, nicotine (578)+TX, nicotine sulfate (578)+TX, nifluridide (1309)+TX, nitenpyram (579)+TX, nithiazine (1311)+TX, nitrilacarb (1313)+TX, nitrilacarb 1:1 zinc chloride complex (1313)+TX, NNI-0101 (compound code)+TX, NNI-0250 (compound code)+TX, nornicotine (traditional name) (1319)+TX, novaluron (585)+TX, noviflumuron (586)+TX, O-5-dichloro-4-iodophenyl O-ethyl ethylphosphonothioate (IUPAC name) (1057)+TX, O,O-diethyl O-4-methyl-2-oxo-2H-chromen-7-yl phosphorothioate (IUPAC name) (1074)+TX, O,O-diethyl O-6-methyl-2-propylpyrimidin-4-yl phosphorothioate (IUPAC name) (1075)+TX, O,O,O′,O′-tetrapropyl dithiopyrophosphate (IUPAC name) (1424)+TX, oleic acid (IUPAC name) (593)+TX, omethoate (594)+TX, oxamyl (602)+TX, oxydemeton-methyl (609)+TX, oxydeprofos (1324)+TX, oxydisulfoton (1325)+TX, pp′-DDT (219)+TX, para-dichlorobenzene [CCN]+TX, parathion (615)+TX, parathion-methyl (616)+TX, penfluron (alternative name) [CCN]+TX, pentachlorophenol (623)+TX, pentachlorophenyl laurate (IUPAC name) (623)+TX, permethrin (626)+TX, petroleum oils (alternative name) (628)+TX, PH 60-38 (development code) (1328)+TX, phenkapton (1330)+TX, phenothrin (630)+TX, phenthoate (631)+TX, phorate (636)+TX, phosalone (637)+TX, phosfolan (1338)+TX, phosmet (638)+TX, phosnichlor (1339)+TX, phosphamidon (639)+TX, phosphine (IUPAC name) (640)+TX, phoxim (642)+TX, phoxim-methyl (1340)+TX, pirimetaphos (1344)+TX, pirimicarb (651)+TX, pirimiphos-ethyl (1345)+TX, pirimiphos-methyl (652)+TX, polychlorodicyclopentadiene isomers (IUPAC name) (1346)+TX, polychloroterpenes (traditional name) (1347)+TX, potassium arsenite [CCN]+TX, potassium thiocyanate [CCN]+TX, prallethrin (655)+TX, precocene I (alternative name) [CCN]+TX, precocene II (alternative name) [CCN]+TX, precocene III (alternative name) [CCN]+TX, primidophos (1349)+TX, profenofos (662)+TX, profluthrin [CCN]+TX, promacyl (1354)+TX, promecarb (1355)+TX, propaphos (1356)+TX, propetamphos (673)+TX, propoxur (678)+TX, prothidathion (1360)+TX, prothiofos (686)+TX, prothoate (1362)+TX, protrifenbute [CCN]+TX, pymetrozine (688)+TX, pyraclofos (689)+TX, pyrazophos (693)+TX, pyresmethrin (1367)+TX, pyrethrin 1 (696)+TX, pyrethrin II (696)+TX, pyrethrins (696)+TX, pyridaben (699)+TX, pyridalyl (700)+TX, pyridaphenthion (701)+TX, pyrimidifen (706)+TX, pyrimitate (1370)+TX, pyriproxyfen (708)+TX, quassia (alternative name) [CCN]+TX, quinalphos (711)+TX, quinalphos-methyl (1376)+TX, quinothion (1380)+TX, quintiofos (1381)+TX, R-1492 (development code) (1382)+TX, rafoxanide (alternative name) [CCN]+TX, resmethrin (719)+TX, rotenone (722)+TX, RU 15525 (development code) (723)+TX, RU 25475 (development code) (1386)+TX, ryania (alternative name) (1387)+TX, ryanodine (traditional name) (1387)+TX, sabadilla (alternative name) (725)+TX, schradan (1389)+TX, sebufos (alternative name)+TX, selamectin (alternative name) [CCN]+TX, SI-0009 (compound code)+TX, SI-0205 (compound code)+TX, SI-0404 (compound code)+TX, SI-0405 (compound code)+TX, silafluofen (728)+TX, SN 72129 (development code) (1397)+TX, sodium arsenite [CCN]+TX, sodium cyanide (444)+TX, sodium fluoride (IUPAC/Chemical Abstracts name) (1399)+TX, sodium hexafluorosilicate (1400)+TX, sodium pentachlorophenoxide (623)+TX, sodium selenate (IUPAC name) (1401)+TX, sodium thiocyanate [CCN]+TX, sophamide (1402)+TX, spinosad (737)+TX, spiromesifen (739)+TX, spirotetrmat (CCN)+TX, sulcofuron (746)+TX, sulcofuron-sodium (746)+TX, sulfluramid (750)+TX, sulfotep (753)+TX, sulfuryl fluoride (756)+TX, sulprofos (1408)+TX, tar oils (alternative name) (758)+TX, tau-fluvalinate (398)+TX, tazimcarb (1412)+TX, TDE (1414)+TX, tebufenozide (762)+TX, tebufenpyrad (763)+TX, tebupirimfos (764)+TX, teflubenzuron (768)+TX, tefluthrin (769)+TX, temephos (770)+TX, TEPP (1417)+TX, terallethrin (1418)+TX, terbam (alternative name)+TX, terbufos (773)+TX, tetrachloroethane [CCN]+TX, tetrachlorvinphos (777)+TX, tetramethrin (787)+TX, theta-cypermethrin (204)+TX, thiacloprid (791)+TX, thiafenox (alternative name)+TX, thiamethoxam (792)+TX, thicrofos (1428)+TX, thiocarboxime (1431)+TX, thiocyclam (798)+TX, thiocyclam hydrogen oxalate (798)+TX, thiodicarb (799)+TX, thiofanox (800)+TX, thiometon (801)+TX, thionazin (1434)+TX, thiosultap (803)+TX, thiosultap-sodium (803)+TX, thuringiensin (alternative name) [CCN]+TX, tolfenpyrad (809)+TX, tralomethrin (812)+TX, transfluthrin (813)+TX, transpermethrin (1440)+TX, triamiphos (1441)+TX, triazamate (818)+TX, triazophos (820)+TX, triazuron (alternative name)+TX, trichlorfon (824)+TX, trichlormetaphos-3 (alternative name) [CCN]+TX, trichloronat (1452)+TX, trifenofos (1455)+TX, triflumuron (835)+TX, trimethacarb (840)+TX, triprene (1459)+TX, vamidothion (847)+TX, vaniliprole [CCN]+TX, veratridine (alternative name) (725)+TX, veratrine (alternative name) (725)+TX, XMC (853)+TX, xylylcarb (854)+TX, YI-5302 (compound code)+TX, zeta-cypermethrin (205)+TX, zetamethrin (alternative name)+TX, zinc phosphide (640)+TX, zolaprofos (1469) and ZXI 8901 (development code) (858)+TX, cyantraniliprole [736994-63-19+TX, chlorantraniliprole [500008-45-7]+TX, cyenopyrafen [560121-52-0]+TX, cyflumetofen [400882-07-7]+TX, pyrifluquinazon [337458-27-2]+TX, spinetoram [187166-40-1+187166-15-0]+TX, spirotetramat [203313-25-1]+TX, sulfoxaflor [946578-00-3]+TX, flufiprole [704886-18-0]+TX, meperfluthrin [915288-13-0]+TX, tetramethylfluthrin [84937-88-2]+TX, triflumezopyrim (disclosed in WO 2012/092115)+TX,
a molluscicide selected from the group of substances consisting of bis(tributyltin) oxide (IUPAC name) (913)+TX, bromoacetamide [CCN]+TX, calcium arsenate [CCN]+TX, cloethocarb (999)+TX, copper acetoarsenite [CCN]+TX, copper sulfate (172)+TX, fentin (347)+TX, ferric phosphate (IUPAC name) (352)+TX, metaldehyde (518)+TX, methiocarb (530)+TX, niclosamide (576)+TX, niclosamide-olamine (576)+TX, pentachlorophenol (623)+TX, sodium pentachlorophenoxide (623)+TX, tazimcarb (1412)+TX, thiodicarb (799)+TX, tributyltin oxide (913)+TX, trifenmorph (1454)+TX, trimethacarb (840)+TX, triphenyltin acetate (IUPAC name) (347) and triphenyltin hydroxide (IUPAC name) (347)+TX, pyriprole [394730-71-3]+TX,
a nematicide selected from the group of substances consisting of AKD-3088 (compound code)+TX, 1,2-dibromo-3-chloropropane (IUPAC/Chemical Abstracts name) (1045)+TX, 1,2-dichloropropane (IUPAC/Chemical Abstracts name) (1062)+TX, 1,2-dichloropropane with 1,3-dichloropropene (IUPAC name) (1063)+TX, 1,3-dichloropropene (233)+TX, 3,4-dichlorotetrahydrothiophene 1,1-dioxide (IUPAC/Chemical Abstracts name) (1065)+TX, 3-(4-chlorophenyl)-5-methylrhodanine (IUPAC name) (980)+TX, 5-methyl-6-thioxo-1,3,5-thiadiazinan-3-ylacetic acid (IUPAC name) (1286)+TX, 6-isopentenylaminopurine (alternative name) (210)+TX, abamectin (1)+TX, acetoprole [CCN]+TX, alanycarb (15)+TX, aldicarb (16)+TX, aldoxycarb (863)+TX, AZ 60541 (compound code)+TX, benclothiaz [CCN]+TX, benomyl (62)+TX, butylpyridaben (alternative name)+TX, cadusafos (109)+TX, carbofuran (118)+TX, carbon disulfide (945)+TX, carbosulfan (119)+TX, chloropicrin (141)+TX, chlorpyrifos (145)+TX, cloethocarb (999)+TX, cytokinins (alternative name) (210)+TX, dazomet (216)+TX, DBCP (1045)+TX, DCIP (218)+TX, diamidafos (1044)+TX, dichlofenthion (1051)+TX, dicliphos (alternative name)+TX, dimethoate (262)+TX, doramectin (alternative name) [CCN]+TX, emamectin (291)+TX, emamectin benzoate (291)+TX, eprinomectin (alternative name) [CCN]+TX, ethoprophos (312)+TX, ethylene dibromide (316)+TX, fenamiphos (326)+TX, fenpyrad (alternative name)+TX, fensulfothion (1158)+TX, fosthiazate (408)+TX, fosthietan (1196)+TX, furfural (alternative name) [CCN]+TX, GY-81 (development code) (423)+TX, heterophos [CCN]+TX, iodomethane (IUPAC name) (542)+TX, isamidofos (1230)+TX, isazofos (1231)+TX, ivermectin (alternative name) [CCN]+TX, kinetin (alternative name) (210)+TX, mecarphon (1258)+TX, metam (519)+TX, metam-potassium (alternative name) (519)+TX, metam-sodium (519)+TX, methyl bromide (537)+TX, methyl isothiocyanate (543)+TX, milbemycin oxime (alternative name) [CCN]+TX, moxidectin (alternative name) [CCN]+TX, Myrothecium verrucaria composition (alternative name) (565)+TX, NC-184 (compound code)+TX, oxamyl (602)+TX, phorate (636)+TX, phosphamidon (639)+TX, phosphocarb [CCN]+TX, sebufos (alternative name)+TX, selamectin (alternative name) [CCN]+TX, spinosad (737)+TX, terbam (alternative name)+TX, terbufos (773)+TX, tetrachlorothiophene (IUPAC/Chemical Abstracts name) (1422)+TX, thiafenox (alternative name)+TX, thionazin (1434)+TX, triazophos (820)+TX, triazuron (alternative name)+TX, xylenols [CCN]+TX, YI-5302 (compound code) and zeatin (alternative name) (210)+TX, fluensulfone [318290-98-1]+TX, a nitrification inhibitor selected from the group of substances consisting of potassium ethylxanthate [CCN] and nitrapyrin (580)+TX,
a plant activator selected from the group of substances consisting of acibenzolar (6)+TX, acibenzolar-S-methyl (6)+TX, probenazole (658) and Reynoutria sachalinensis extract (alternative name) (720)+TX,
a rodenticide selected from the group of substances consisting of 2-isovalerylindan-1,3-dione (IUPAC name) (1246)+TX, 4-(quinoxalin-2-ylamino)benzenesulfonamide (IUPAC name) (748)+TX, alpha-chlorohydrin [CCN]+TX, aluminium phosphide (640)+TX, antu (880)+TX, arsenous oxide (882)+TX, barium carbonate (891)+TX, bisthiosemi (912)+TX, brodifacoum (89)+TX, bromadiolone (91)+TX, bromethalin (92)+TX, calcium cyanide (444)+TX, chloralose (127)+TX, chlorophacinone (140)+TX, cholecalciferol (alternative name) (850)+TX, coumachlor (1004)+TX, coumafuryl (1005)+TX, coumatetralyl (175)+TX, crimidine (1009)+TX, difenacoum (246)+TX, difethialone (249)+TX, diphacinone (273)+TX, ergocalciferol (301)+TX, flocoumafen (357)+TX, fluoroacetamide (379)+TX, flupropadine (1183)+TX, flupropadine hydrochloride (1183)+TX, gamma-HCH (430)+TX, HCH (430)+TX, hydrogen cyanide (444)+TX, iodomethane (IUPAC name) (542)+TX, lindane (430)+TX, magnesium phosphide (IUPAC name) (640)+TX, methyl bromide (537)+TX, norbormide (1318)+TX, phosacetim (1336)+TX, phosphine (IUPAC name) (640)+TX, phosphorus [CCN]+TX, pindone (1341)+TX, potassium arsenite [CCN]+TX, pyrinuron (1371)+TX, scilliroside (1390)+TX, sodium arsenite [CCN]+TX, sodium cyanide (444)+TX, sodium fluoroacetate (735)+TX, strychnine (745)+TX, thallium sulfate [CCN]+TX, warfarin (851) and zinc phosphide (640)+TX,
a synergist selected from the group of substances consisting of 2-(2-butoxyethoxy)ethyl piperonylate (IUPAC name) (934)+TX, 5-(1,3-benzodioxol-5-yl)-3-hexylcyclohex-2-enone (IUPAC name) (903)+TX, farnesol with nerolidol (alternative name) (324)+TX, MB-599 (development code) (498)+TX, MGK 264 (development code) (296)+TX, piperonyl butoxide (649)+TX, piprotal (1343)+TX, propyl isomer (1358)+TX, S421 (development code) (724)+TX, sesamex (1393)+TX, sesasmolin (1394) and sulfoxide (1406)+TX,
an animal repellent selected from the group of substances consisting of anthraquinone (32)+TX, chloralose (127)+TX, copper naphthenate [CCN]+TX, copper oxychloride (171)+TX, diazinon (227)+TX, dicyclopentadiene (chemical name) (1069)+TX, guazatine (422)+TX, guazatine acetates (422)+TX, methiocarb (530)+TX, pyridin-4-amine (IUPAC name) (23)+TX, thiram (804)+TX, trimethacarb (840)+TX, zinc naphthenate [CCN] and ziram (856)+TX,
a virucide selected from the group of substances consisting of imanin (alternative name) [CCN] and ribavirin (alternative name) [CCN]+TX,
a wound protectant selected from the group of substances consisting of mercuric oxide (512)+TX, octhilinone (590) and thiophanate-methyl (802)+TX,
and biologically active compounds selected from the group consisting of azaconazole (60207-31-0]+TX, bitertanol [70585-36-3]+TX, bromuconazole [116255-48-2]+TX, cyproconazole [94361-06-5]+TX, difenoconazole [119446-68-3]+TX, diniconazole [83657-24-3]+TX, epoxiconazole [106325-08-0]+TX, fenbuconazole [114369-43-6]+TX, fluquinconazole [136426-54-5]+TX, flusilazole [85509-19-9]+TX, flutriafol [76674-21-0]+TX, hexaconazole [79983-71-4]+TX, imazalil [35554-44-0]+TX, imibenconazole [86598-92-7]+TX, ipconazole [125225-28-7]+TX, metconazole [125116-23-6]+TX, myclobutanil [88671-89-0]+TX, pefurazoate [101903-30-4]+TX, penconazole [66246-88-6]+TX, prothioconazole [178928-70-6]+TX, pyrifenox [88283-41-4]+TX, prochloraz [67747-09-5]+TX, propiconazole [60207-90-1]+TX, simeconazole [149508-90-7]+TX, tebucon-azole [107534-96-3]+TX, tetraconazole [112281-77-3]+TX, triadimefon [43121-43-3]+TX, triadimenol [55219-65-3]+TX, triflumizole [99387-89-0]+TX, triticonazole [131983-72-7]+TX, ancymidol [12771-68-5]+TX, fenarimol [60168-88-9]+TX, nuarimol [63284-71-9]+TX, bupirimate [41483-43-6]+TX, dimethirimol [5221-53-4]+TX, ethirimol [23947-60-6]+TX, dodemorph [1593-77-7]+TX, fenpropidine [67306-00-7]+TX, fenpropimorph [67564-91-4]+TX, spiroxamine [118134-30-8]+TX, tridemorph [81412-43-3]+TX, cyprodinil [121552-61-2]+TX, mepanipyrim [110235-47-7]+TX, pyrimethanil [53112-28-0]+TX, fenpiclonil [74738-17-3]+TX, fludioxonil [131341-86-1]+TX, benalaxyl [71626-11-4]+TX, furalaxyl [57646-30-7]+TX, metalaxyl [57837-19-1]+TX, R-metalaxyl [70630-17-0]+TX, ofurace [58810-48-3]+TX, oxadixyl [77732-09-3]+TX, benomyl [17804-35-2]+TX, carbendazim [10605-21-7]+TX, debacarb [62732-91-6]+TX, fuberidazole [3878-19-1]+TX, thiabendazole [148-79-8]+TX, chlozolinate [84332-86-5]+TX, dichlozoline [24201-58-9]+TX, iprodione [36734-19-7]+TX, myclozoline [54864-61-8]+TX, procymidone [32809-16-8]+TX, vinclozoline [50471-44-8]+TX, boscalid [188425-85-6]+TX, carboxin [5234-68-4]+TX, fenfuram [24691-80-3]+TX, flutolanil [66332-96-5]+TX, mepronil [55814-41-0]+TX, oxycarboxin [5259-88-1]+TX, penthiopyrad [183675-82-3]+TX, thifluzamide [130000-40-7]+TX, guazatine [108173-90-6]+TX, dodine [2439-10-3] [112-65-2] (free base)+TX, iminoctadine [13516-27-3]+TX, azoxystrobin [131860-33-8]+TX, dimoxystrobin [149961-52-4]+TX, enestroburin {Proc. BCPC, Int. Congr., Glasgow, 2003, 1, 93}+TX, fluoxastrobin [361377-29-9]+TX, kresoxim-methyl [143390-89-0]+TX, metominostrobin [133408-50-1]+TX, trifloxystrobin [141517-21-7]+TX, orysastrobin [248593-16-0]+TX, picoxystrobin [117428-22-5]+TX, pyraclostrobin [175013-18-0]+TX, ferbam [14484-64-1]+TX, mancozeb [8018-01-7]+TX, maneb [12427-38-2]+TX, metiram [9006-42-2]+TX, propineb [12071-83-9]+TX, thiram [137-26-8]+TX, zineb [12122-67-7]+TX, ziram [137-30-4]+TX, captafol [2425-06-1]+TX, captan [133-06-2]+TX, dichlofluanid [1085-98-9]+TX, fluoroimide [41205-21-4]+TX, folpet [133-07-3]+TX, tolylfluanid [731-27-1]+TX, bordeaux mixture [8011-63-0]+TX, copperhydroxid [20427-59-2]+TX, copperoxychlorid [1332-40-7]+TX, coppersulfat [7758-98-7]+TX, copperoxid [1317-39-1]+TX, mancopper [53988-93-5]+TX, oxine-copper [10380-28-6]+TX, dinocap [131-72-6]+TX, nitrothal-isopropyl [10552-74-6]+TX, edifenphos [17109-49-8]+TX, iprobenphos [26087-47-8]+TX, isoprothiolane [50512-35-1]+TX, phosdiphen [36519-00-3]+TX, pyrazophos [13457-18-6]+TX, tolclofos-methyl [57018-04-9]+TX, acibenzolar-S-methyl [135158-54-2]+TX, anilazine [101-05-3]+TX, benthiavalicarb [413615-35-7]+TX, blasticidin-S [2079-00-7]+TX, chinomethionat [2439-01-2]+TX, chloroneb [2675-77-6]+TX, chlorothalonil [1897-45-6]+TX, cyflufenamid [180409-60-3]+TX, cymoxanil [57966-95-7]+TX, dichlone [117-80-6]+TX, diclocymet [139920-32-4]+TX, diclomezine [62865-36-5]+TX, dicloran [99-30-9]+TX, diethofencarb [87130-20-9]+TX, dimetho-morph [110488-70-5]+TX, SYP-LI90 (Flumorph) [211867-47-9]+TX, dithianon [3347-22-6]+TX, ethaboxam [162650-77-3]+TX, etridiazole [2593-15-9]+TX, famoxadone [131807-57-3]+TX, fenamidone [161326-34-7]+TX, fenoxanil [115852-48-7]+TX, fentin [668-34-8]+TX, ferimzone [89269-64-7]+TX, fluazinam [79622-59-6]+TX, fluopicolide [239110-15-7]+TX, flusulfamide [106917-52-6]+TX, fenhexamid [126833-17-8]+TX, fosetyl-aluminium [39148-24-8]+TX, hymexazol [10004-44-1]+TX, iprovalicarb [140923-17-7]+TX, IKF-916 (Cyazofamid) [120116-88-3]+TX, kasugamycin [6980-18-3]+TX, methasulfocarb [66952-49-6]+TX, metrafenone [220899-03-6]+TX, pencycuron [66063-05-6]+TX, phthalide [27355-22-2]+TX, polyoxins [11113-80-7]+TX, probenazole [27605-76-1]+TX, propamocarb [25606-41-1]+TX, proquinazid [189278-12-4]+TX, pyroquilon [57369-32-1]+TX, quinoxyfen [124495-18-7]+TX, quintozene [82-68-8]+TX, sulfur [7704-34-9]+TX, tiadinil [223580-51-6]+TX, triazoxide [72459-58-6]+TX, tricyclazole [41814-78-2]+TX, triforine [26644-46-2]+TX, validamycin [37248-47-8]+TX, zoxamide (RH7281) [156052-68-5]+TX, mandipropamid [374726-62-2]+TX, isopyrazam [881685-58-1]+TX, sedaxane [874967-67-6]+TX, 3-difluoromethyl-1-methyl-1H-pyrazole-4-carboxylic acid (9-dichloromethylene-1,2,3,4-tetrahydro-1,4-methano-naphthalen-5-yl)-amide (dislosed in WO 2007/048556)+TX, 3-difluoromethyl-1-methyl-1H-pyrazole-4-carboxylic acid (3′,4′,5′-trifluoro-biphenyl-2-yl)-amide (disclosed in WO 2006/087343)+TX, [(3S,4R,4aR,6S,6aS,12R,12aS,12bS)-3-[(cyclopropylcarbonyl)oxy]-1,3,4,4a,5,6,6a, 12,12a, 12b-decahydro-6,12-dihydroxy-4,6a, 12b-trimethyl-11-oxo-9-(3-pyridinyl)-2H, 11H naphtho[2,1-b]pyrano[3,4-e]pyran-4-yl]methyl-cyclopropanecarboxylate [915972-17-7]+TX, 1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide [926914-55-8]+TX, flufiprole [704886-18-0]+TX, cyclaniliprole [1031756-98-5]+TX, tetraniliprole [1229654-66-3]+TX, guadipyr (described in WO2010/060231)+TX and
cycloxaprid (described in WO 2005/077934)+TX.

The references in brackets behind the active ingredients, e.g. [3878-19-1] refer to the Chemical Abstracts Registry number. The above described mixing partners are known. Where the active ingredients are included in “The Pesticide Manual” [The Pesticide Manual—A World Compendium; Thirteenth Edition; Editor: C. D. S. TomLin; The British Crop Protection Council], they are described therein under the entry number given in round brackets hereinabove for the particular compound; for example, the compound “abamectin” is described under entry number (1). Where “[CCN]” is added hereinabove to the particular compound, the compound in question is included in the “Compendium of Pesticide Common Names”, which is accessible on the internet [A. Wood; Compendium of Pesticide Common Names, Copyright © 1995-2004]; for example, the compound “acetoprole” is described under the internet address http://www.alanwood.net/pesticides/acetoprole.html.

Most of the active ingredients described above are referred to hereinabove by a so-called “common name”, the relevant “ISO common name” or another “common name” being used in individual cases.

If the designation is not a “common name”, the nature of the designation used instead is given in round brackets for the particular compound; in that case, the IUPAC name, the IUPAC/Chemical Abstracts name, a “chemical name”, a “traditional name”, a “compound name” or a “development code” is used or, if neither one of those designations nor a “common name” is used, an “alternative name” is employed. “CAS Reg. No” means the Chemical Abstracts Registry Number.

The active ingredient mixture of the compounds of formula I selected from Tables 1 to 300 and Table T1 with active ingredients described above comprises a compound selected from Tables 1 to 300 and Table T1 and an active ingredient as described above preferably in a mixing ratio of from 100:1 to 1:6000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred, above all in a ratio of 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are by weight.

The mixtures as described above can be used in a method for controlling pests, which comprises applying a composition comprising a mixture as described above to the pests or their environment, with the exception of a method for treatment of the human or animal body by surgery or therapy and diagnostic methods practised on the human or animal body.

The mixtures comprising a compound of formula I selected from Tables 1 to 300 and Table T1 and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds of formula I selected from Tables 1 to 300 and Table T1 and the active ingredients as described above is not essential for working the present invention.

The compositions according to the invention can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The compositions according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the compositions, that is the methods of controlling pests of the abovementioned type, such as spraying, atomizing, dusting, brushing on, dressing, scattering or pouring—which are to be selected to suit the intended aims of the prevailing circumstances—and the use of the compositions for controlling pests of the abovementioned type are other subjects of the invention. Typical rates of concentration are between 0.1 and 1000 ppm, preferably between 0.1 and 500 ppm, of active ingredient. The rate of application per hectare is generally 1 to 2000 g of active ingredient per hectare, in particular 10 to 1000 g/ha, preferably 10 to 600 g/ha.

A preferred method of application in the field of crop protection is application to the foliage of the plants (foliar application), it being possible to select frequency and rate of application to match the danger of infestation with the pest in question. Alternatively, the active ingredient can reach the plants via the root system (systemic action), by drenching the locus of the plants with a liquid composition or by incorporating the active ingredient in solid form into the locus of the plants, for example into the soil, for example in the form of granules (soil application). In the case of paddy rice crops, such granules can be metered into the flooded paddy-field.

The compounds of the invention and compositions thereof are also be suitable for the protection of plant propagation material, for example seeds, such as fruit, tubers or kernels, or nursery plants, against pests of the abovementioned type. The propagation material can be treated with the compound prior to planting, for example seed can be treated prior to sowing. Alternatively, the compound can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention. Typical treatment rates would depend on the plant and pest/fungi to be controlled and are generally between 1 to 200 grams per 100 kg of seeds, preferably between 5 to 150 grams per 100 kg of seeds, such as between 10 to 100 grams per 100 kg of seeds.

The term seed embraces seeds and plant propagules of all kinds including but not limited to true seeds, seed pieces, suckers, corns, bulbs, fruit, tubers, grains, rhizomes, cuttings, cut shoots and the like and means in a preferred embodiment true seeds.

The present invention also comprises seeds coated or treated with or containing a compound of formula I. The term “coated or treated with and/or containing” generally signifies that the active ingredient is for the most part on the surface of the seed at the time of application, although a greater or lesser part of the ingredient may penetrate into the seed material, depending on the method of application. When the said seed product is (re)planted, it may absorb the active ingredient. In an embodiment, the present invention makes available a plant propagation material adhered thereto with a compound of formula (I). Further, it is hereby made available, a composition comprising a plant propagation material treated with a compound of formula (I).

Seed treatment comprises all suitable seed treatment techniques known in the art, such as seed dressing, seed coating, seed dusting, seed soaking and seed pelleting. The seed treatment application of the compound formula (I) can be carried out by any known methods, such as spraying or by dusting the seeds before sowing or during the sowing/planting of the seeds.

The following Examples illustrate, but do not limit, the invention.

The compounds of the invention can be distinguished from known compounds by virtue of greater efficacy at low application rates, which can be verified by the person skilled in the art using the experimental procedures outlined in the Examples, using lower application rates if necessary, for example 50 ppm, 12.5 ppm, 6 ppm, 3 ppm, 1.5 ppm or 0.8 ppm.

### PREPARATION EXAMPLES

The following examples illustrate the above-described invention in greater detail without limiting it.

### Example 1

### Synthesis of 1-Bromo-2,5-bis-bromomethyl-4-fluoro-benzene

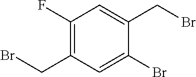 [SMILES: Fc1cc(CBr)c(Br)cc1CBr]

To a stirred solution of 1-Bromo-4-fluoro-2,5-dimethyl-benzene (35 g, 0.1723 mol) in acetonitrile (350 ml) was added N-Bromosuccinimide (64.42 g, 0.3619 mol) followed by AIBN (1.4 g, 0.0086 mol) at room temperature. Resulting mixture was heated to reflux at 90° C. for 4 h. Reaction mixture was cooled to ambient temperature and acetonitrile was evaporated completely under vacuum. Resulting residue obtained was partitioned between Ethyl acetate (500 mL) and water (500 mL). Organic layer was separated and the aqueous layer was extracted with ethyl acetate (2×200 mL). Combined organic layer was washed with water (2×250 mL) followed by brine (250 mL) and dried over Na₂SO₄, filtered and evaporated completely to give crude mass (62 g). This crude compound obtained was purified by flash chromatography using 2% ethyl acetate in hexane as eluent to afford pure 1-Bromo-2,5-bis-bromomethyl-4-fluoro-benzene (35 g, 56.23% of theoretical yield) as white solid.

¹H NMR (400 MHz, CDCl₃) δ ppm 4.42 (s, 2H), 4.50 (s, 2H) 7.2 (d, J=9.6 Hz, 1H), 7.6 (d, J=7 Hz, 1H)

LC−MS− M+H− 361

### Example 2

### Synthesis of (5-Bromo-2-fluoro-4-hydroxymethyl-phenyl)-methanol

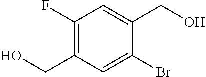 [SMILES: OCc1cc(Br)c(CO)cc1F]

To a stirred suspension of 1-Bromo-2,5-bis-bromomethyl-4-fluoro-benzene (30 g, 0.08313 mol) in 1:1 mixture of 1,4-Dioxane (200 mL) and Water (200 mL) was added CaCO₃ (24.96 g, 0.2494 mol) at ambient temperature. Resulting mixture was heated to reflux at 100° C. for 12 h. Reaction mixture was then cooled to 0° C. and pH ˜4 was adjusted with 6N HCl solution. It was then extracted with ethyl acetate (3×250 mL). Combined organic layer was washed with brine solution (250 mL). Organic layer was dried over Na₂SO₄, filtered and evaporated completely to afford (5-Bromo-2-fluoro-4-hydroxymethyl-phenyl)-methanol (19 g, 97.43% of theoretical yield) as white solid.

¹H NMR (400 MHz, DMSO-d₆) δ ppm 4.46 (d, J=5.6 Hz, 2H), 4.51 (d, J=5.8 Hz, 2H), 4.51 (t, J=5.8 Hz, 1H), 5.57 (t, J=5.6 Hz, 1H), 7.245 (d, J=10.88 Hz, 1H), 7.6 (d, J=6.8 Hz, 1H)

LC−MS− M+H− 235

### Example 3

### Synthesis of 2-[[2-bromo-5-fluoro-4-(tetrahydropyran-2-yloxymethyl)phenyl] methoxy]tetrahydropyran

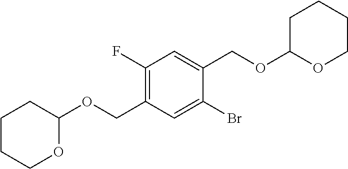 [SMILES: Fc1cc(COC2CCCCO2)c(Br)cc1COC1CCCCO1]

To a stirred solution of (5-Bromo-2-fluoro-4-hydroxymethyl-phenyl)-methanol (20.0 g, 0.08508 mol) in dry DMF (160 mL) was added p-TSA (0.89 g, 0.004 mol) at ambient temperature. Resulting reaction mixture was cooled to 0° C. To this was added 3,4-dihydro-2H-pyran (28.6 g, 0.3403 mol) drop wise over a period of 30 min. Reaction mixture was stirred for 24 h at ambient temperature. After completion, monitored by TLC, reaction mixture was quenched with ice cold water (200 mL). Added saturated solution of NaHCO₃ (50 mL) and then extracted with ethyl acetate (3×200 mL). Combined organic layer was washed with water (3×200 mL) followed by brine wash (200 mL). Organic layer was dried over Na₂SO₄, filtered and evaporated completely to give oily crude mass (35 g). This crude obtained was purified by flash chromatography using 8% ethyl acetate in hexane as eluent to afford 2-[[2-bromo-5-fluoro-4-(tetrahydropyran-2-yloxymethyl)phenyl] methoxy] tetrahydropyran (25 g, 73.27% of theoretical yield) as an oily compound.

¹H NMR (400 MHz, CHLOROFORM-d) δ ppm 1.52-1.60 (m, 3H), 1.627-1.674 (m, 3H) 1.71-1.76 (m, 3H), 1.77-1.866, (m, 3H), 3.59 (br. s., 2H) 3.85-3.93 (m, 2H) 4.50-4.57 (m, 2H) 4.72-4.80 (m, 4H) 7.26 (s, 1H) 7.60 (d, J=6.64 Hz, 1H)

### Example 4

### Synthesis of 2-[4-fluoro-2,5-bis(tetrahydropyran-2-yloxymethyl)phenyl]-4,4,5,5-tetra methyl-1,3,2-dioxaborolane

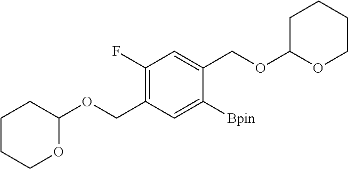

To a stirred solution of 2-[[2-bromo-5-fluoro-4-(tetrahydropyran-2-yloxymethyl)phenyl]methoxy]tetrahydropyran (14.7 g, 36.4 mmol) in 1,4 dioxane (140 mL) was added fused potassium acetate (3 equiv., 109 mmol), 4,4,5,5-tetramethyl-2-(4,4,5,5-tetramethyl-1,3,2-dioxaborolan-2-yl)-1,3,2-dioxaborolane (1.5 equiv., 54.7 mmol) and finally [1,1′-Bis(diphenylphosphino) ferrocene]-dichloropalladium(II) dichloromethane adduct (0.05 equiv., 1.82 mmol) under nitrogen. The reaction mixture was heated at 100° C. for 3 h. The reaction mixture was cooled to ambient temperature and diluted with water (100 mL) and then extracted with ethyl acetate (3×200 mL). Combined organic layer was washed with water (3×200 mL) followed by brine wash (200 mL). Organic layer was dried over Na₂SO₄, filtered and evaporated completely to give crude compound. This crude obtained was purified by flash chromatography using 10% ethyl acetate in hexane as eluent to afford desired compound 2-[4-fluoro-2,5-bis(tetrahydropyran-2-yloxymethyl)phenyl]-4,4,5,5-tetramethyl-1,3,2-dioxaborolane (15 g, 33.30 mmol, 91.4% of theoretical yield).

¹H NMR (400 MHz, CHLOROFORM-d) δ ppm 1.31 (s, 12H), 1.49-1.86 (m, 9H), 3.50-3.58 (m, 2H), 3.87-3.96 (m, 2H), 4.52 (d, J=11.54 Hz, 1H) 4.69-4.84 (m, 4H) 4.90-4.95 (m, 1H) 7.25 (d, J=11.71 Hz, 1H) 7.83 (d, J=8.28 Hz, 1H)

### Example 5

### Synthesis of (5-fluoro-1-hydroxy-3H-2,1-benzoxaborol-6-yl)methanol

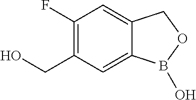 [SMILES: OCc1cc2c(cc1F)COB2O]

Method A:

To a stirred solution of 2-[4-fluoro-2,5-bis(tetrahydropyran-2-yloxymethyl)phenyl]-4,4,5,5-tetramethyl-1,3,2-dioxaborolane (16 g, 35.52 mmol) in methanol (100 mL) was added 6N HCl (100 mL) in drops at 0° C. over a period of 5 min. Reaction mixture was then allowed to stir at ambient temperature for 12 h. The reaction mixture was diluted with water (100 mL) and then extracted with dichloromethane (3×100 mL) Organic layer was dried over Na₂SO₄, filtered and evaporated completely to give crude compound as yellow oil. Crude mass was further purified by trituration with cyclohexane afforded (5-fluoro-1-hydroxy-3H-2,1-benzoxaborol-6-yl)methanol (4 g, 21.9831 mmol, 61.88% of theoretical yield) as a solid compound.

Method B:

To a stirred solution of 2-[[2-bromo-5-fluoro-4-(tetrahydropyran-2-yloxymethyl)phenyl] methoxy]tetrahydropyran (20.0 g, 0.04959 mol) in dry THF (200 mL) was added n-BuLi (2.5 M in n-Hexane) (27.7 mL, 4.44 g, 0.06942 mol) drop wise at −78° C. over a period of 30 min. Reaction mixture was stirred at −78° C. for 45 min. To this resulting reaction mixture was added Tri-isopropyl borate (13.99 g, 0.0743 mol) drop wise over a period of 15 min. Reaction mixture was allowed to come at ambient temperature and stirred for 12 h. Starting was consumed completely, confirmed by TLC. The reaction mixture was then cooled to 0° C., added 6N HCl solution (200 mL) drop wise and stirred at ambient temperature for 24 h. The resulting mixture was diluted with water (50 mL) and extracted with ethyl acetate (3×100 mL). Combined organic layer was washed with water (200 mL) followed by brine wash (100 mL). Organic layer was dried over Na₂SO₄, filtered and evaporated completely to afford (5-fluoro-1-hydroxy-3H-2,1-benzoxaborol-6-yl)methanol (5 g, 55% of theoretical yield) as a semi solid.

¹H NMR (400 MHz, DMSO-d₆) δ ppm 4.52-4.59 (m, 2H), 4.96 (s, 2H), 5.28 (t, J=5.64 Hz, 1H), 7.2 (d, J=10.44 Hz, 1H) 7.84 (d, J=7.64 Hz, 1H), 9.21 (s., 1H)

LC−MS− M+H− 182

### Example 6

### Synthesis of 5-Fluoro-1-hydroxy-1,3-dihydro-benzo[c][1,2]oxaborole-6-carbaldehyde

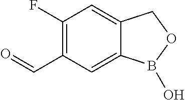 [SMILES: O=Cc1cc2c(cc1F)COB2O]

To a stirred solution of compound (5-fluoro-1-hydroxy-3H-2,1-benzoxaborol-6-yl)methanol in DCM (150 mL) was added Pyridinium Chlorochromate (17.76 g, 0.08243 mol) and celite (20 g) at 0° C. lot wise. Reaction mixture was then stirred at ambient temperature for 6 h. starting was consumed completely as confirmed by TLC. Reaction mixture was then filtered through celite bed and bed was washed with DCM (50 mL). Filtrate was evaporated and crude obtained was purified by flash chromatography using 60% ethyl acetate in hexane as eluent to afford pure 5-Fluoro-1-hydroxy-1,3-dihydro-benzo[c][1,2]oxaborole-6-carbaldehyde (1.8 g, 18.2% of theoretical yield).

¹H NMR (400 MHz, DMSO-d₆) δ ppm 5.06 (s, 2H) 7.47 (d, J=10.96 Hz, 1H) 8.23 (d, J=7.16 Hz, 1H) 9.47 (s, 1H) 10.24 (s, 1H)

LC−MS− M+H− 181.1 (RT; 1.24)

### Example 7

### Synthesis of 1-bromo-2,5-bis(bromomethyl)-4-chloro-benzene

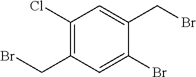 [SMILES: Clc1cc(CBr)c(Br)cc1CBr]

To a stirred solution of 1-Bromo-4-fluoro-2,5-dimethyl-benzene (20 g, 91.114 mmol) in acetonitrile (200 ml) was added N-Bromosuccinimide (34 g, 191.3318) followed by AIBN (0.748 g, 4.55 mmol) at ambient temperature. Resulting reaction mixture was heated to reflux at 90° C. for 4 h. starting was consumed completely, as confirmed by TLC. Reaction mixture was then cooled to ambient temperature and acetonitrile was evaporated completely under vacuum. Residue obtained was partitioned between Ethyl acetate (50 mL) and water (50 mL). Organic layer was separated and aqueous was extracted with ethyl acetate (2×20 mL). Combined organic layer was washed with water (2×20 mL) followed by brine (20 mL) and dried over Na₂SO₄, filtered and evaporated completely to afford crude mass (56 g). Crude mass was further purified by crystallisation using cyclohexane as the solvent to afford 1-bromo-2,5-bis(bromomethyl)-4-chloro-benzene (21 g, 61% of theoretical yield)

¹H NMR (400 MHz, CDCl₃) δ ppm 4.51 (d, J=5.02 Hz, 4H) 7.49 (s, 1H) 7.65 (s, 1H)

### Example 8

### Synthesis of [4-(acetoxymethyl)-2-bromo-5-chloro-phenyl]methyl acetate

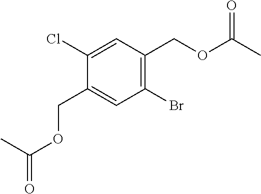 [SMILES: CC(=O)OCc1cc(Br)c(COC(C)=O)cc1Cl]

To a stirred solution of 1-bromo-2,5-bis(bromomethyl)-4-chloro-benzene (17 g, 45.057 mmol) in DMF (50 ml) was added potassium acetate (22.79 g, 225.28 mmol) slowly at ambient temperature. Resulting reaction mixture was heated at 70° C. for 3 h. starting was consumed completely, as confirmed by TLC. Reaction mixture was then cooled to ambient temperature. The reaction mixture was diluted with water (100 mL) and extracted with dichloromethane (3×100 mL). Organic layer was dried over Na₂SO₄, filtered and evaporated completely to afford [4-(acetoxymethyl)-2-bromo-5-chloro-phenyl]methyl acetate (14.5 g 93% of theoretical yield)

1H NMR (400 MHz, DMSO-d6) δ ppm 2.11 (d, J=4.4 Hz, 6H) 5.12 (d, J=13.05 Hz, 4H) 7.61 (s, 1H), 7.79 (s, 1H)

### Example 9

### Synthesis of [4-(acetoxymethyl)-2-bromo-5-chloro-phenyl]methyl acetate

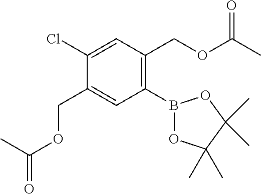 [SMILES: CC(=O)OCc1cc(B2OC(C)(C)C(C)(C)O2)c(COC(C)=O)cc1Cl]

To a stirred solution of [4-(acetoxymethyl)-2-bromo-5-chloro-phenyl]methyl acetate (14.5 g, 43.2 mmol) in 1,4 dioxane (140 mL) was added fused potassium acetate (12.9 g, 130 mmol), 4,4,5,5-tetramethyl-2-(4,4,5,5-tetramethyl-1,3,2-dioxaborolan-2-yl)-1,3,2-dioxaborolane (16.5 g, 64.8 mmol) and finally [1,1′-Bis(diphenylphosphino) ferrocene]-dichloropalladium(II) dichloromethane adduct (1.8 g, 2.16 mmol) under nitrogen. The reaction mixture was heated at 100° C. for 3 h. The reaction mixture was cooled to ambient temperature and diluted with water (100 mL) and then extracted with ethyl acetate (3×200 mL). Combined organic layer was washed with water (3×200 mL) followed by brine wash (200 mL). Organic layer was dried over Na₂SO₄, filtered and evaporated completely to give crude compound. This crude product obtained was purified by flash chromatography using 10% ethyl acetate in hexane as eluent to afford desired compound [4-(acetoxymethyl)-2-chloro-5-(4,4,5,5-tetramethyl-1,3,2-dioxaborolan-2-yl)phenyl]methyl acetate (14 g, 84.7% of theoretical yield).

¹H NMR (400 MHz, DMSO-d₆) δ ppm 1.30 (s, 12H) 2.06 (d, J=2.01 Hz, 6H) 5.15 (s, 2H) 5.24 (s, 2H) 7.53 (s, 1H) 7.79 (s, 1H)

### Example 10

### Synthesis of (5-chloro-1-hydroxy-3H-2,1-benzoxaborol-6-yl)methanol

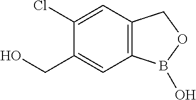 [SMILES: OCc1cc2c(cc1Cl)COB2O]

To a stirred solution of [4-(acetoxymethyl)-2-chloro-5-(4,4,5,5-tetramethyl-1,3,2-dioxaborolan-2-yl)phenyl]methyl acetate (14 g, 36.59 mmol) in methanol (100 mL) was added 6N HCl (100 mL) in drops at 0° C. over a period of 20 min. Reaction mixture was then allowed to stir at ambient temperature for 12 h. The reaction mixture was diluted with water (100 mL) and then extracted with dichloromethane (3×100 mL). Organic layer was dried over Na₂SO₄, filtered and evaporated completely to afford (5-chloro-1-hydroxy-3H-2,1-benzoxaborol-6-yl)methanol (5.4 g, 80% of theoretical yield) as a semi solid.

¹H NMR (400 MHz, DMSO-d₆) δ ppm 4.60 (d, J=4.4 Hz, 2H), 4.97 (s, 2H), 5.41 (t, J=5.6 Hz, 1H) 7.48 (s, 1H), 7.94 (s, 1H), 9.29 (s, 1H)

### Example 11

### Synthesis of 5-chloro-1-hydroxy-3H-2,1-benzoxaborole-6-carbaldehyde

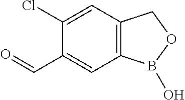 [SMILES: O=Cc1cc2c(cc1Cl)COB2O]

To a stirred solution of compound (5-chloro-1-hydroxy-3H-2,1-benzoxaborol-6-yl)methanol (1 g, 5.04 mmol) in DCM (150 mL) was added Pyridinium dichromate (4 g, 10.08 mmol) and celite (20 g) at 0° C. in portions. Reaction mixture was then stirred at ambient temperature for 6 h. starting was consumed completely and was confirmed by TLC. Reaction mixture was then filtered through celite bed and bed was washed with DCM (50 mL). Filtrate was evaporated and crude obtained was purified by flash chromatography using 60% ethyl acetate in hexane as eluent to afford pure 5-chloro-1-hydroxy-3H-2, 1-benzoxaborole-6-carbaldehyde (0.63 g, 63.64% of theoretical yield) as a white solid.

¹H NMR (400 MHz, DMSO-d₆) δ ppm 5.06 (s, 2H), 7.71 (s, 1H), 8.26 (s, 1H), 9.53 (s, 1H), 10.39 (s, 1H)

### Example 12

### Synthesis of 1-(5-chloro-1-hydroxy-3H-2,1-benzoxaborol-6-yl)-N-methoxy-methanimine

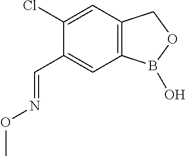

5-chloro-1-hydroxy-3H-2,1-benzoxaborole-6-carbaldehyde (250 mg, 1.3 mmol) was mixed with O-methylhydroxylamine hydrochloride (450 mg, 5.1 mmol) and sodium acetate (420 mg, 5.1 mmol) in ethanol (8 ml). The reaction mixture was refluxed for 3 h. The solvent was removed under reduced pressure and the residue was diluted with ethyl acetate (50 ml). The organic phase was washed with water (1×20 ml), dried over magnesium sulphate, filtered and evaporated under reduced pressure. The crude residue was purified by flash chromatography using 5% Methanol in dichloromenthane as eluent to give 1-(5-chloro-1-hydroxy-3H-2,1-benzoxaborol-6-yl)-N-methoxy-methanimine (270 mg, 94% of theoretical yield).

¹H NMR (400 MHz, DMSO-d₆) δ ppm 3.96 (d, J=2.51 Hz, 3H) 5.01 (s, 2H) 7.62 (s, 1H) 8.24 (s, 1H) 8.48 (s, 1H) 9.43 (s, 1H)

LC−MS− M+H− 226.1 (RT; 1.75-1.82)

### Example 13

### Synthesis of 1-[(5-chloro-1-hydroxy-3H-2,1-benzoxaborol-6-yl)methyleneamino]-3-methyl-thiourea

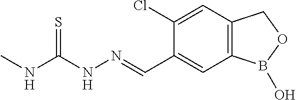 [SMILES: CNC(=S)N/N=C/c1cc2c(cc1Cl)COB2O]

5-chloro-1-hydroxy-3H-2,1-benzoxaborole-6-carbaldehyde (80 mg, 0.4 mmol) was mixed with 1-amino-3-methyl-thiourea (50 mg, 0.4 mmol) in methanol (4 ml). The reaction mixture was stirred at ambient temperature for 1 h. The solvent was removed under reduced pressure and the residue was diluted with ethyl acetate (50 ml). The organic phase was filtered to get 1-(5-chloro-1-hydroxy-3H-2,1-benzoxaborol-6-yl)-N-methoxy-methanimine as white solid (80 mg, 70% of theoretical yield).

¹H NMR (400 MHz, DMSO-d₆) δ ppm 3.03 (d, J=4.52 Hz, 3H) 5.01 (s, 2H) 7.58 (s, 1H) 8.49 (s, 1H) 8.53 (s, J=9.40, 9.40 Hz, 2H) 9.33 (s, 1H) 11.67 (s, 1H)

LC−MS− M+H− 284 (RT; 1.56-1.58)

### Example 14

### Synthesis of 1-(1-hydroxy-3H-2,1-benzoxaborol-7-yl)-N-methoxy-methanimine

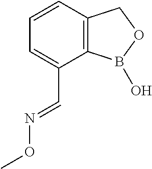

1-hydroxy-3H-2,1-benzoxaborole-7-carbaldehyde (100 mg, 0.6 mmol) was mixed with O-methylhydroxylamine hydrochloride (100 mg, 2 mmol) and sodium acetate (100 mg, 2 mmol) in methanol (10 ml). The reaction mixture was reflux overnight. The solvent was removed under reduced pressure and the residue was diluted with ethyl acetate (50 ml). The organic phase was washed with water (1×20 ml), dried over magnesium sulphate, filtered and evaporated under reduced pressure. The crude residue was purified by flash chromatography using 5% Methanol in dichloromenthane as eluent to give 1-(5-chloro-1-hydroxy-3H-2,1-benzoxaborol-6-yl)-N-methoxy-methanimine (100 mg, 80% of theoretical yield).

¹H NMR (400 MHz, DMSO-d₆) δ ppm 3.93 (s, 3H) 5.04 (s, 2H) 7.45-7.56 (m, 2H) 7.69 (d, J=6.77 Hz, 1H) 8.53 (s, 1H) 9.12 (s, 1H)

LC−MS− M+H− 191.9 (RT; 1.74-1.77)

### Example 15

### Synthesis of 1-[(1-hydroxy-3H-2,1-benzoxaborol-7-yl)methyleneamino]-3-methyl-thiourea

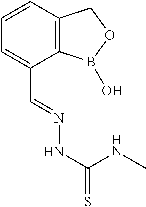 [SMILES: CNC(=S)N/N=C/c1cccc2c1B(O)OC2]

1-hydroxy-3H-2,1-benzoxaborole-7-carbaldehyde (70 mg, 0.4322 mmol) was mixed with 1-amino-3-methyl-thiourea (45.5 mg, 0.4322 mmol) in methanol (4 ml). The reaction mixture was stirred at ambient temperature for 1 h. The precipitate formed during reaction was collected by filtration and washed with cyclohexane to afford 1-[(1-hydroxy-3H-2,1-benzoxaborol-7-yl)methyleneamino]-3-methyl-thiourea (107 mg, 83% of theoretical yield).

obtain white solid The solvent was removed under reduced pressure and the residue was diluted with ethyl acetate (50 ml). The organic phase was washed with water (1×20 ml), dried over magnesium sulphate, filtered and evaporated under reduced pressure. The crude residue was purified by flash chromatography using 5% Methanol in dichloromenthane as eluent to give 1-(5-chloro-1-hydroxy-3H-2,1-benzoxaborol-6-yl)-N-methoxy-methanimine (100 mg, 80% of theoretical yield).

¹H NMR (400 MHz, DMSO-d₆) δ ppm 3.01 (d, J=4.52 Hz, 3H), 5.02 (s, 2H), 7.41 (d, J=7.53 Hz, 1H), 7.51 (t, J=7.65 Hz, 1H), 8.03 (d, J=7.53 Hz, 1H), 8.46 (s, 1H), 8.67 (m, 1H), 9.28 (s, 1H) 11.61 (s, 1H)

LC−MS− M+H− 250 (RT; 1.47-1.51)

### Example 16

### Synthesis of 1-(1-hydroxy-3H-2,1-benzoxaborol-5-yl)-N-methoxy-methanimine

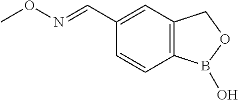

1-hydroxy-3H-2,1-benzoxaborole-5-carbaldehyde (100 mg, 0.62 mmol) was mixed with O-methylhydroxylamine hydrochloride (220 mg, 2.5 mmol) and sodium acetate (200 mg, 2.5 mmol) in ethanol (10 ml). The reaction mixture was reflux for 3 h. The solvent was removed under reduced pressure and the residue was diluted with ethyl acetate (50 ml). The organic phase was washed with water (1×20 ml), dried over sodium sulfate, filtered and evaporated under reduced pressure. The crude residue was purified by flash chromatography using 5% Methanol in dichloromenthane as eluent to afford 1-(1-hydroxy-3H-2,1-benzoxaborol-5-yl)-N-methoxy-methanimine (60 mg, 50% of theoretical yield).

¹H NMR (400 MHz, DMSO-d₆) δ ppm 3.91 (s, 3H) 5.01 (s, 2H) 7.59 (s, 1H) 7.54-7.54 (m, 1H) 7.61-7.67 (m, 1H) 7.75 (d, J=7.53 Hz, 1H) 8.29 (s, 1H) 9.27 (s, 1H)

LC−MS− M+H− 192 (RT; 1.52-1.59)

### Example 17

### Synthesis of 1-(1-hydroxy-3H-2,1-benzoxaborol-4-yl)-N-methoxy-methanimine

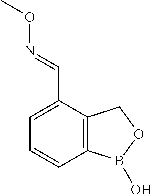

1-hydroxy-3H-2,1-benzoxaborole-4-carbaldehyde (80 mg, 0.5 mmol) was mixed with O-methylhydroxylamine hydrochloride (200 mg, 2 mmol) and sodium acetate (200 mg, 2 mmol) in ethanol (8 ml). The reaction mixture was reflux for 3 h. The solvent was removed under reduced pressure and the residue was diluted with ethyl acetate (50 ml). The organic phase was washed with water (1×20 ml), dried over sodium sulfate, filtered and evaporated under reduced pressure. The crude residue was purified by flash chromatography using 50% ethyl acetate in hexane as eluent to afford 1-(1-hydroxy-3H-2,1-benzoxaborol-4-yl)-N-methoxy-methanimine (70 mg, 70% of theoretical yield).

¹H NMR (400 MHz, DMSO-d₆) δ ppm 3.92 (s, 3H) 5.08 (s, 2H) 7.45 (t, J=7.42 Hz, 1H) 7.64 (d, J=7.35 Hz, 1H) 7.79 (dd, J=7.28, 1.00 Hz, 1H) 8.33 (s, 1H) 9.26 (s, 1H)

LC−MS− M+H− 192.1 (RT; 1.58-1.64)

The following tables illustrate the invention:

The A1 to A4 have the meaning as follows:

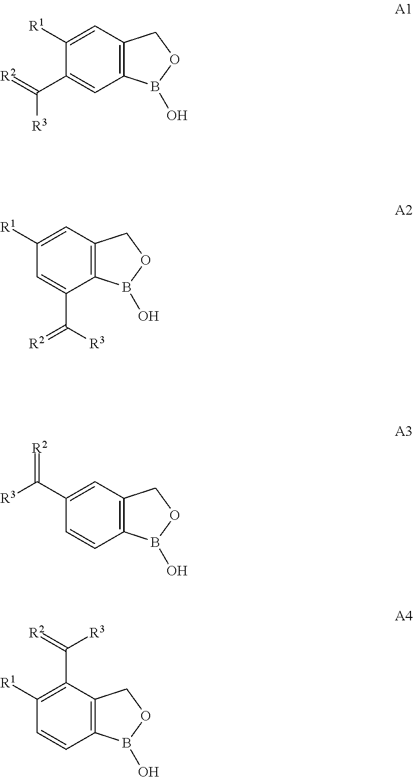

TABLE T2

| | |
|---|---|
| R2.001 | 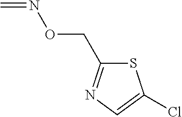 |
| R2.002 | 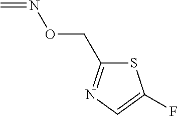 |
| R2.003 | ═N—NH—C(S)—NH—Ph |
| R2.004 | ═N—NH—C(S)—NH—CH₂—Ph |
| R2.005 | 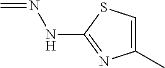 |
| R2.006 | ═N—NH—CH₂—C(O)OEt |
| R2.007 | ═N—NHC(O)-4-Cl—Ph |
| R2.008 | ═N—NHC(O)-4-NO₂—Ph |
| R2.009 | 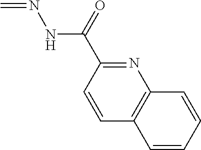 |
| R2.010 | ═N—NHC(O)—NH—Ph |
| R2.011 | ═N—NH—C(O)-3-pyridyl |
| R2.012 | ═N—NHC(O)-2,5-Cl—Ph |
| R2.013 | 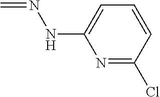 |
| R2.014 | ═N—NHC(O)-2-NO₂—Ph |
| R2.015 | ═N—NH-2,4-Cl—Ph |
| R2.016 | ═N—NH-4-Me—Ph |
| R2.017 | ═N—NH-2,4-F—Ph |
| R2.018 | 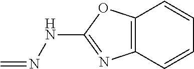 |
| R2.019 | ═N—NH—C(O)OEt |
| R2.020 | ═N—NHC(O)—NH-2,4-Ph |
| R2.021 | 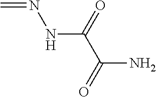 |
| R2.022 | ═N—NHC(O)—NH-4-OMe—Ph |
| R2.023 | ═N—NH-2,5-F—Ph |
| R2.024 | ═N—NH-2-NO₂—Ph |
| R2.025 | 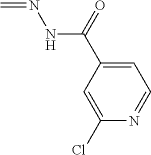 |
| R2.026 | ═N—NH-3,5-Cl—Ph |
| R2.027 | 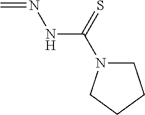 |
| R2.028 | 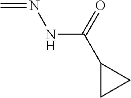 |
| R2.029 | 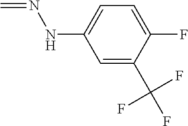 |
| R2.030 | 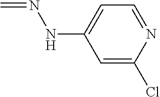 |
| R2.031 | ═N—NH—CH(CH₃)₂ |
| R2.032 | 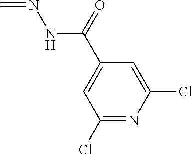 |
| R2.033 | ═N—NH-2,6-Cl-4-CF₃—Ph |
| R2.034 | 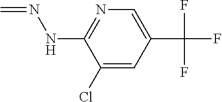 |
| R2.035 | 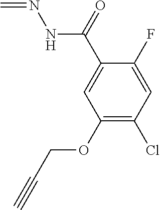 |
| R2.036 | ═N—NH-4-Cl—Ph |
| R2.037 | ═N—NH-3-NO₂—Ph |
| R2.038 | ═N—NH-4-CF₃—Ph |
| R2.039 | ═N—NH-2,6-Cl—Ph |
| R2.040 | 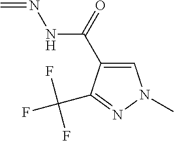 |
| R2.041 | ═N—NH—C(S)—NH—CH₂—Ph |
| R2.042 | 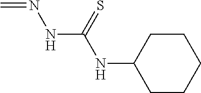 |
| R2.043 | 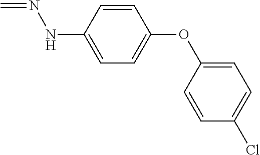 |
| R2.044 | 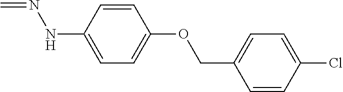 |
| R2.045 | ═N—NHCH₂—Ph |
| R2.046 | ═N—NH—CH₂—O—C(O)CH₂CH₃ |
| R2.047 | ═N—NH-4-OCH₃—Ph |
| R2.048 | 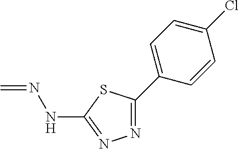 |
| R2.049 | ═N—NH—C(S)—NH—CH₂—CH₃ |
| R2.051 | 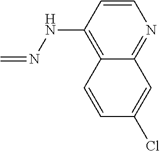 |
| R2.052 | ═N—NH—C(S)—NH₂ |
| R2.053 | ═N—NH—C(S)—NH—Me |
| R2.054 | ═N—O—CH₃—CH═CH—Cl |
| R2.055 | ═N—NH—C(S)—NH—CH₂—CH═CH₂ |
| R2.056 | —N—OC(CH₃)₃ |
| R2.057 | 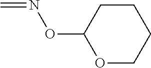 |
| R2.058 | ═N—OCH₂-4-Cl—Ph |
| R2.059 | ═N—OCH₂-2-F—Ph |
| R2.060 | ═N—OCH₂-4-NO₂—Ph |
| R2.061 | ═N—O(CH₂)₅CH₃ |
| R2.062 | ═N—O(CH₂)₃CH₃ |
| R2.063 | 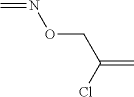 |
| R2.064 | 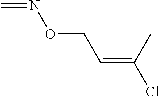 |
| R2.065 | 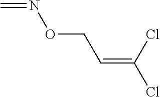 |
| R2.066 | ═N—OCH₂CH═C(CH₃)₂ |
| R2.067 | 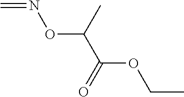 |
| R2.068 | ═N—OCH₂-2,6-Cl—Ph |
| R2.069 | 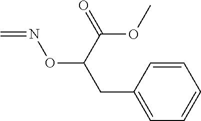 |
| R2.070 | ═N—OCH₂-2,3,4,5,6-F—Ph |
| R2.071 | ═N—OCH(CH₃)₂ |
| R2.072 | ═N—OCH₂CH₃ |
| R2.073 | ═N—OCH₂—CH═CH |
| R2.074 | 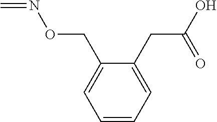 |
| R2.075 | 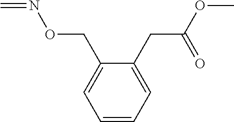 |
| R2.076 | —N—O(CH₂)₂CH₃ |
| R2.077 | ═N—O(CH₂)₂—CH₂—C(O)OH |
| R2.078 | ═N—O-4-CN—Ph |
| R2.079 | ═N—OCH₂-2,4-Cl—Ph |
| R2.080 | ═N—OCH₂-4-Me—Ph |
| R2.081 | ═N—OCH₂-2-Cl-4-F—Ph |
| R2.082 | 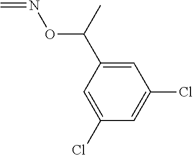 |
| R2.083 | 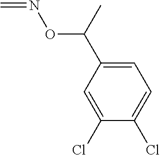 |
| R2.084 | 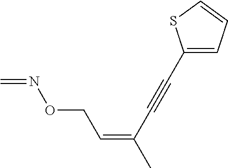 |
| R2.085 | 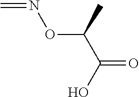 |
| R2.086 | ═N—O—CH₂—CH(CH₃)₂ |
| R2.087 | ═N—O-4-NO₂—Ph |
| R2.088 | 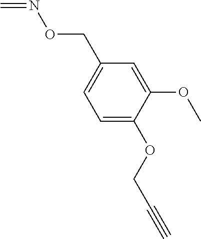 |
| R2.089 | ═N—O—(CH₂)₁₁—CH₃ |
| R2.090 | ═N—O—CH₂-2,4,5-Cl—Ph |
| R2.091 | —N—O—(CH₂)₃—C(O)—O—CH₂—CH₃ |
| R2.092 | 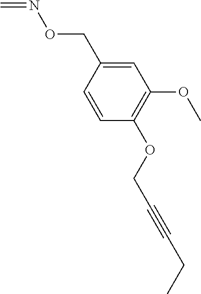 |
| R2.093 | ═N—OH |
| R2.094 | ═N—NH₂ |
| R2.095 | 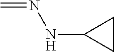 |
| R2.096 | 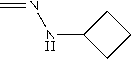 |
| R2.097 | 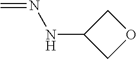 |
| R2.098 | 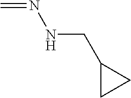 |
| R2.099 | 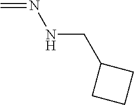 |
| R2.100 | 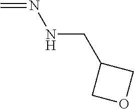 |
| R2.101 | 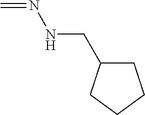 |
| R2.102 | 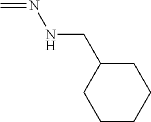 |
| R2.103 | 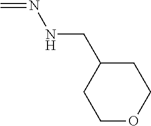 |
| R2.104 | 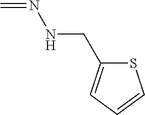 |
| R2.105 | 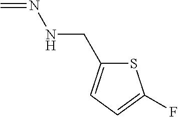 |
| R2.106 | 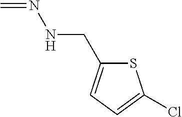 |
| R2.107 | 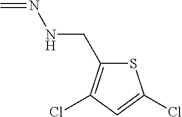 |
| R2.108 | 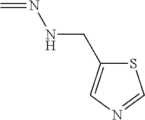 |
| R2.109 | 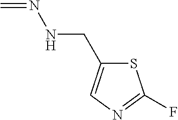 |
| R2.110 | 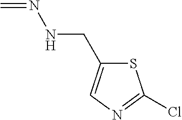 |
| R2.111 | 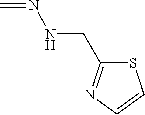 |
| R2.112 | 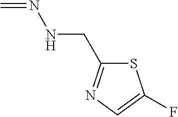 |
| R2.113 | 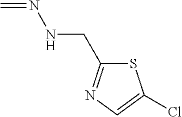 |
| R2.114 | ═N—N(CH₃)₂ |
| R2.115 | ═N—N(CH₃)CH₂CH₃ |
| R2.116 | ═N—N(CH₃)(CH₂)₂CH₃ |
| R2.117 | ═N—N(CH₃)(CH₂)₃CH₃ |
| R2.118 | ═N—N(CH₃)(CH₂)₄CH₃ |
| R2.119 | ═N—N(CH₃)(CH₂)₅CH₃ |
| R2.120 | ═N—N(CH₃)CH(CH₃)₂ |
| R2.121 | ═N—N(CH₃)C(CH₃)₃ |
| R2.122 | ═N—N(CH₃)CH₂CH(CH₃)₂ |
| R2.123 | ═N—N(CH₃)CH₂C(CH₃)₃ |
| R2.124 | ═N—N(CH₃)Ph |
| R2.125 | ═N—N(CH₃)-4-F—Ph |
| R2.126 | ═N—N(CH₃)-4-Cl—Ph |
| R2.127 | ═N—N(CH₃)-2,4-F—Ph |
| R2.128 | ═N—N(CH₃)-2,4-Cl—Ph |
| R2.129 | ═N—N(CH₃)CH₂—Ph |
| R2.130 | ═N—N(CH₃)CH₂-4-F—Ph |
| R2.131 | ═N—N(CH₃)CH₂-4-Cl—Ph |
| R2.132 | ═N—N(CH₃)CH₂-2,4-F—Ph |
| R2.133 | ═N—N(CH₃)CH₂-2,5-F—Ph |
| R2.134 | ═N—N(CH₃)CH₂-2,6-F—Ph |
| R2.135 | ═N—N(CH₃)CH₂-3,5-F—Ph |
| R2.136 | ═N—N(CH₃)CH₂-2,4,6-F—Ph |
| R2.137 | ═N—N(CH₃)CH₂-2,4-Cl—Ph |
| R2.138 | ═N—N(CH₃)CH₂-2,5-Cl—Ph |
| R2.139 | ═N—N(CH₃)CH₂-2,6-Cl—Ph |
| R2.140 | ═N—N(CH₃)CH₂-3,5-Cl—Ph |
| R2.141 | ═N—N(CH₃)CH₂-2,4,6-Cl—Ph |
| R2.142 | 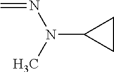 |
| R2.143 | 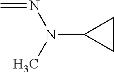 |
| R2.144 | 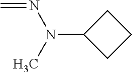 |
| R2.145 | 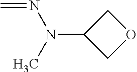 |
| R2.146 | 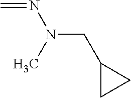 |
| R2.147 | 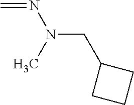 |
| R2.148 | 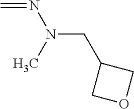 |
| R2.149 | 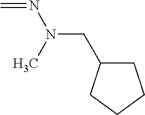 |
| R2.150 | 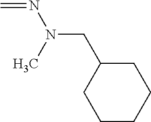 |
| R2.151 | 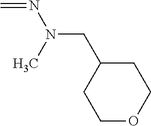 |
| R2.152 | 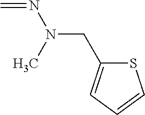 |
| R2.153 | 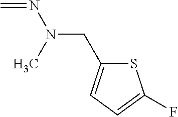 |
| R2.154 | 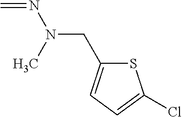 |
| R2.155 | 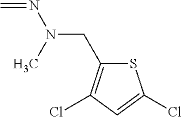 |
| R2.156 | 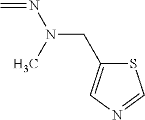 |
| R2.157 | 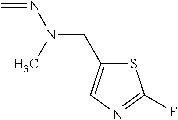 |
| R2.158 | 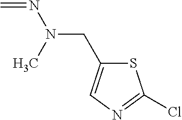 |
| R2.159 | 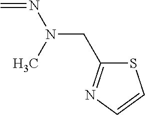 |
| R2.160 | 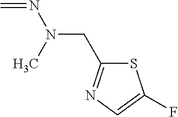 |
| R2.161 | 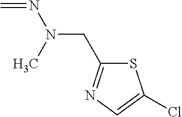 |
| R2.162 | 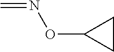 |
| R2.163 | 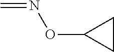 |
| R2.164 | 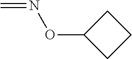 |
| R2.165 | 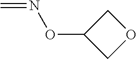 |
| R2.166 | 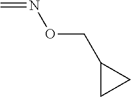 |
| R2.167 | 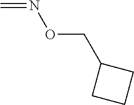 |
| R2.168 | 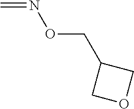 |
| R2.169 | 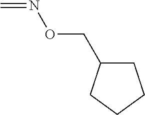 |
| R2.170 | 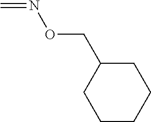 |
| R2.171 | 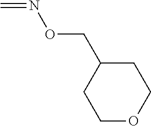 |
| R2.172 | 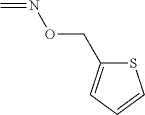 |
| R2.173 | 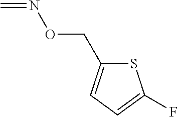 |
| R2.174 | 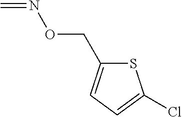 |
| R2.175 | 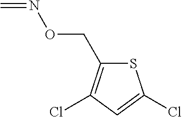 |
| R2.176 | 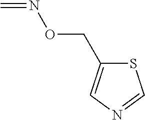 |
| R2.177 | 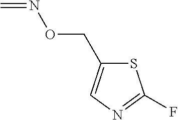 |
| R2.178 | 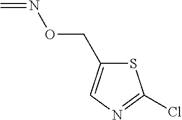 |
| R2.179 | 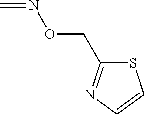 |
| R2.180 | ═N—OCH₂—Ph |
| R2.181 | ═N—O—CH₃ |
| R2.182 | ═O |
| R2.183 | ═N—NH—C(O)OMe |

TABLE T4

| No. | R³ |
|---|---|
| 1 | Me |
| 2 | 4-Cl—Ph |
| 3 | 4-F—Ph |
| 4 | 2,4-Cl—Ph |
| 5 | 4-OMe—Ph |
| 6 | 4-Me—Ph |
| 7 | acetylene |
| 8 | cyclopropyl |
| 9 | vinyl |
| 10 | Allyl |
| 11 | Ph |
| 12 | H |

Table 1: This table discloses the 183 specific compounds of the formula A1 wherein R¹ is Me, R³ is as defined in line 1 of Table T4 and R² has the specific meaning given in the corresponding line appropriately selected from the 183 lines R2.001 to R2.0183 of Table T2.

Table 2: This table discloses the 183 specific compounds of the formula A1 wherein R¹ is Me, R³ is as defined in line 2 of Table T4 and R² has the specific meaning given in the corresponding line appropriately selected from the 183 lines R2.001 and R2.0183 of Table T2.

Table 3: This table discloses the 183 specific compounds of the formula A1 wherein R¹ is Me, R³ is as defined in line 3 of Table T4 and R² has the specific meaning given in the corresponding line appropriately selected from the 183 lines R2.001 to R2.0183 of Table T2.

Table 4: This table discloses the 183 specific compounds of the formula A1 wherein R¹ is Me, R³ is as defined in line 4 of Table T4 and R² has the specific meaning given in the corresponding line appropriately selected from the 183 lines R2.001 to R2.0183 of Table T2.

Table 5: This table discloses the 183 specific compounds of the formula A1 wherein R¹ is Me, R³ is as defined in line 5 of Table T4 and R² has the specific meaning given in the corresponding line appropriately selected from the 183 lines R2.001 to R2.0183 of Table T2.

Table 6: This table discloses the 183 specific compounds of the formula A1 wherein R¹ is Me, R³ is as defined in line 6 of Table T4 and R² has the specific meaning given in the corresponding line appropriately selected from the 183 lines R2.001 to R2.0183 of Table T2.

Table 7: This table discloses the 183 specific compounds of the formula A1 wherein R¹ is Me, R³ is as defined in line 7 of Table T4 and R² has the specific meaning given in the corresponding line appropriately selected from the 183 lines R2.001 to R2.0183 of Table T2.

Table 8: This table discloses the 183 specific compounds of the formula A1 wherein R¹ is Me, R³ is as defined in line 8 of Table T4 and R² has the specific meaning given in the corresponding line appropriately selected from the 183 lines R2.001 to R2.0183 of Table T2.

Table 9: This table discloses the 183 specific compounds of the formula A1 wherein R¹ is Me, R³ is as defined in line 9 of Table T4 and R² has the specific meaning given in the corresponding line appropriately selected from the 183 lines R2.001 to R2.0183 of Table T2.

Table 10: This table discloses the 183 specific compounds of the formula A1 wherein R¹ is Me, R³ is as defined in line 10 of Table T4 and R² has the specific meaning given in the corresponding line appropriately selected from the 183 lines R2.001 to R2.0183 of Table T2.

Table 11: This table discloses the 183 specific compounds of the formula A1 wherein R¹ is Me, R³ is as defined in line 11 of Table T4 and R² has the specific meaning given in the corresponding line appropriately selected from the 183 lines R2.001 to R2.0183 of Table T2.

Table 12: This table discloses the 183 specific compounds of the formula A1 wherein R¹ is Me, R³ is as defined in line 12 of Table T4 and R² has the specific meaning given in the corresponding line appropriately selected from the 183 lines R2.001 to R2.0183 of Table T2.

Table 13: This table discloses the 183 specific compounds of the formula A1 wherein R¹ is CF3, R³ is as defined in line 1 of Table T4 and R² has the specific meaning given in the corresponding line appropriately selected from the 183 lines R2.001 to R2.0183 of Table T2.

Table 14: This table discloses the 183 specific compounds of the formula A1 wherein R¹ is CF3, R³ is as defined in line 2 of Table T4 and R² has the specific meaning given in the corresponding line appropriately selected from the 183 lines R2.001 to R2.0183 of Table T2.

Table 15: This table discloses the 183 specific compounds of the formula A1 wherein R¹ is CF3, R³ is as defined in line 3 of Table T4 and R² has the specific meaning given in the corresponding line appropriately selected from the 183 lines R2.001 to R2.0183 of Table T2.

Table 16: This table discloses the 183 specific compounds of the formula A1 wherein R¹ is CF3, R³ is as defined in line 4 of Table T4 and R² has the specific meaning given in the corresponding line appropriately selected from the 183 lines R2.001 to R2.0183 of Table T2.

Table 17: This table discloses the 183 specific compounds of the formula A1 wherein R¹ is CF3, R³ is as defined in line 5 of Table T4 and R² has the specific meaning given in the corresponding line appropriately selected from the 183 lines R2.001 to R2.0183 of Table T2.

Table 18: This table discloses the 183 specific compounds of the formula A1 wherein R¹ is CF3, R³ is as defined in line 6 of Table T4 and R² has the specific meaning given in the corresponding line appropriately selected from the 183 lines R2.001 to R2.0183 of Table T2.

Table 19: This table discloses the 183 specific compounds of the formula A1 wherein R¹ is CF3, R³ is as defined in line 7 of Table T4 and R² has the specific meaning given in the corresponding line appropriately selected from the 183 lines R2.001 to R2.0183 of Table T2.

Table 20: This table discloses the 183 specific compounds of the formula A1 wherein R¹ is CF3, R³ is as defined in line 8 of Table T4 and R² has the specific meaning given in the corresponding line appropriately selected from the 183 lines R2.001 to R2.0183 of Table T2.

Table 21: This table discloses the 183 specific compounds of the formula A1 wherein R¹ is CF3, R³ is as defined in line 9 of Table T4 and R² has the specific meaning given in the corresponding line appropriately selected from the 183 lines R2.001 to R2.0183 of Table T2.

Table 22: This table discloses the 183 specific compounds of the formula A1 wherein R¹ is CF3, R³ is as defined in line 10 of Table T4 and R² has the specific meaning given in the corresponding line appropriately selected from the 183 lines R2.001 to R2.0183 of Table T2.

Table 23: This table discloses the 183 specific compounds of the formula A1 wherein R¹ is CF3, R³ is as defined in line 11 of Table T4 and R² has the specific meaning given in the corresponding line appropriately selected from the 183 lines R2.001 to R2.0183 of Table T2.

Table 24: This table discloses the 183 specific compounds of the formula A1 wherein R¹ is CF3, R³ is as defined in line 12 of Table T4 and R² has the specific meaning given in the corresponding line appropriately selected from the 183 lines R2.001 to R2.0183 of Table T2.

Table 25: This table discloses the 183 specific compounds of the formula A1 wherein R¹ is F, R³ is as defined in line 1 of Table T4 and R² has the specific meaning given in the corresponding line appropriately selected from the 183 lines R2.001 to R2.0183 of Table T2.

Table 26: This table discloses the 183 specific compounds of the formula A1 wherein R¹ is F, R³ is as defined in line 2 of Table T4 and R² has the specific meaning given in the corresponding line appropriately selected from the 183 lines R2.001 to R2.0183 of Table T2.

Table 27: This table discloses the 183 specific compounds of the formula A1 wherein R¹ is F, R³ is as defined in line 3 of Table T4 and R² has the specific meaning given in the corresponding line appropriately selected from the 183 lines R2.001 to R2.0183 of Table T2.

Table 28: This table discloses the 183 specific compounds of the formula A1 wherein R¹ is F, R³ is as defined in line 4 of Table T4 and R² has the specific meaning given in the corresponding line appropriately selected from the 183 lines R2.001 to R2.0183 of Table T2.

Table 29: This table discloses the 183 specific compounds of the formula A1 wherein R¹ is F, R³ is as defined in line 5 of Table T4 and R² has the specific meaning given in the corresponding line appropriately selected from the 183 lines R2.001 to R2.0183 of Table T2.

Table 30: This table discloses the 183 specific compounds of the formula A1 wherein R¹ is F, R³ is as defined in line 6 of Table T4 and R² has the specific meaning given in the corresponding line appropriately selected from the 183 lines R2.001 to R2.0183 of Table T2.

Table 31: This table discloses the 183 specific compounds of the formula A1 wherein R¹ is F, R³ is as defined in line 7 of Table T4 and R² has the specific meaning given in the corresponding line appropriately selected from the 183 lines R2.001 to R2.0183 of Table T2.

Table 32: This table discloses the 183 specific compounds of the formula A1 wherein R¹ is F, R³ is as defined in line 8 of Table T4 and R² has the specific meaning given in the corresponding line appropriately selected from the 183 lines R2.001 to R2.0183 of Table T2.

Table 33: This table discloses the 183 specific compounds of the formula A1 wherein R¹ is F, R³ is as defined in line 9 of Table T4 and R² has the specific meaning given in the corresponding line appropriately selected from the 183 lines R2.001 to R2.0183 of Table T2.

Table 34: This table discloses the 183 specific compounds of the formula A1 wherein R¹ is F, R³ is as defined in line 10 of Table T4 and R² has the specific meaning given in the corresponding line appropriately selected from the 183 lines R2.001 to R2.0183 of Table T2.

Table 35: This table discloses the 183 specific compounds of the formula A1 wherein R¹ is F, R³ is as defined in line 11 of Table T4 and R² has the specific meaning given in the corresponding line appropriately selected from the 183 lines R2.001 to R2.0183 of Table T2.

Table 36: This table discloses the 183 specific compounds of the formula A1 wherein R¹ is F, R³ is as defined in line 12 of Table T4 and R² has the specific meaning given in the corresponding line appropriately selected from the 183 lines R2.001 to R2.0183 of Table T2.

Table 37: This table discloses the 183 specific compounds of the formula A1 wherein R¹ is Cl, R³ is as defined in line 1 of Table T4 and R² has the specific meaning given in the corresponding line appropriately selected from the 183 lines R2.001 to R2.0183 of Table T2.

Table 38: This table discloses the 183 specific compounds of the formula A1 wherein R¹ is Cl, R³ is as defined in line 2 of Table T4 and R² has the specific meaning given in the corresponding line appropriately selected from the 183 lines R2.001 to R2.0183 of Table T2.

Table 39: This table discloses the 183 specific compounds of the formula A1 wherein R¹ is Cl, R³ is as defined in line 3 of Table T4 and R² has the specific meaning given in the corresponding line appropriately selected from the 183 lines R2.001 to R2.0183 of Table T2.

Table 40: This table discloses the 183 specific compounds of the formula A1 wherein R¹ is Cl, R³ is as defined in line 4 of Table T4 and R² has the specific meaning given in the corresponding line appropriately selected from the 183 lines R2.001 to R2.0183 of Table T2.

Table 41: This table discloses the 183 specific compounds of the formula A1 wherein R¹ is Cl, R³ is as defined in line 5 of Table T4 and R² has the specific meaning given in the corresponding line appropriately selected from the 183 lines R2.001 to R2.0183 of Table T2.

Table 42: This table discloses the 183 specific compounds of the formula A1 wherein R¹ is Cl, R³ is as defined in line 6 of Table T4 and R² has the specific meaning given in the corresponding line appropriately selected from the 183 lines R2.001 to R2.0183 of Table T2.

Table 43: This table discloses the 183 specific compounds of the formula A1 wherein R¹ is Cl, R³ is as defined in line 7 of Table T4 and R² has the specific meaning given in the corresponding line appropriately selected from the 183 lines R2.001 to R2.0183 of Table T2.

Table 44: This table discloses the 183 specific compounds of the formula A1 wherein R¹ is Cl, R³ is as defined in line 8 of Table T4 and R² has the specific meaning given in the corresponding line appropriately selected from the 183 lines R2.001 to R2.0183 of Table T2.

Table 45: This table discloses the 183 specific compounds of the formula A1 wherein R¹ is Cl, R³ is as defined in line 9 of Table T4 and R² has the specific meaning given in the corresponding line appropriately selected from the 183 lines R2.001 to R2.0183 of Table T2.

Table 46: This table discloses the 183 specific compounds of the formula A1 wherein R¹ is Cl, R³ is as defined in line 10 of Table T4 and R² has the specific meaning given in the corresponding line appropriately selected from the 183 lines R2.001 to R2.0183 of Table T2.

Table 47: This table discloses the 183 specific compounds of the formula A1 wherein R¹ is Cl, R³ is as defined in line 11 of Table T4 and R² has the specific meaning given in the corresponding line appropriately selected from the 183 lines R2.001 to R2.0183 of Table T2.

Table 48: This table discloses the 183 specific compounds of the formula A1 wherein R¹ is Cl, R³ is as defined in line 12 of Table T4 and R² has the specific meaning given in the corresponding line appropriately selected from the 183 lines R2.001 to R2.0183 of Table T2.

Table 49: This table discloses the 183 specific compounds of the formula A1 wherein R¹ is Nitro, R³ is as defined in line 1 of Table T4 and R² has the specific meaning given in the corresponding line appropriately selected from the 183 lines R2.001 to R2.0183 of Table T2.

Table 50: This table discloses the 183 specific compounds of the formula A1 wherein R¹ is Nitro, R³ is as defined in line 2 of Table T4 and R² has the specific meaning given in the corresponding line appropriately selected from the 183 lines R2.001 to R2.0183 of Table T2.

Table 51: This table discloses the 183 specific compounds of the formula A1 wherein R¹ is Nitro, R³ is as defined in line 3 of Table T4 and R² has the specific meaning given in the corresponding line appropriately selected from the 183 lines R2.001 to R2.0183 of Table T2.

Table 52: This table discloses the 183 specific compounds of the formula A1 wherein R¹ is Nitro, R³ is as defined in line 4 of Table T4 and R² has the specific meaning given in the corresponding line appropriately selected from the 183 lines R2.001 to R2.0183 of Table T2.

Table 53: This table discloses the 183 specific compounds of the formula A1 wherein R¹ is Nitro, R³ is as defined in line 5 of Table T4 and R² has the specific meaning given in the corresponding line appropriately selected from the 183 lines R2.001 to R2.0183 of Table T2.

Table 54: This table discloses the 183 specific compounds of the formula A1 wherein R¹ is Nitro, R³ is as defined in line 6 of Table T4 and R² has the specific meaning given in the corresponding line appropriately selected from the 183 lines R2.001 to R2.0183 of Table T2.

Table 55: This table discloses the 183 specific compounds of the formula A1 wherein R¹ is Nitro, R³ is as defined in line 7 of Table T4 and R² has the specific meaning given in the corresponding line appropriately selected from the 183 lines R2.001 to R2.0183 of Table T2.

Table 56: This table discloses the 183 specific compounds of the formula A1 wherein R¹ is Nitro, R³ is as defined in line 8 of Table T4 and R² has the specific meaning given in the corresponding line appropriately selected from the 183 lines R2.001 to R2.0183 of Table T2.

Table 57: This table discloses the 183 specific compounds of the formula A1 wherein R¹ is Nitro, R³ is as defined in line 9 of Table T4 and R² has the specific meaning given in the corresponding line appropriately selected from the 183 lines R2.001 to R2.0183 of Table T2.

Table 58: This table discloses the 183 specific compounds of the formula A1 wherein R¹ is Nitro, R³ is as defined in line 10 of Table T4 and R² has the specific meaning given in the corresponding line appropriately selected from the 183 lines R2.001 to R2.0183 of Table T2.

Table 59: This table discloses the 183 specific compounds of the formula A1 wherein R¹ is Nitro, R³ is as defined in line 11 of Table T4 and R² has the specific meaning given in the corresponding line appropriately selected from the 183 lines R2.001 to R2.0183 of Table T2.

Table 60: This table discloses the 183 specific compounds of the formula A1 wherein R¹ is Nitro, R³ is as defined in line 12 of Table T4 and R² has the specific meaning given in the corresponding line appropriately selected from the 183 lines R2.001 to R2.0183 of Table T2.

Table 61: This table discloses the 183 specific compounds of the formula A1 wherein R¹ is CN, R³ is as defined in line 1 of Table T4 and R² has the specific meaning given in the corresponding line appropriately selected from the 183 lines R2.001 to R2.0183 of Table T2.

Table 62: This table discloses the 183 specific compounds of the formula A1 wherein R¹ is CN, R³ is as defined in line 2 of Table T4 and R² has the specific meaning given in the corresponding line appropriately selected from the 183 lines R2.001 to R2.0183 of Table T2.

Table 63: This table discloses the 183 specific compounds of the formula A1 wherein R¹ is CN, R³ is as defined in line 3 of Table T4 and R² has the specific meaning given in the corresponding line appropriately selected from the 183 lines R2.001 to R2.0183 of Table T2.

Table 64: This table discloses the 183 specific compounds of the formula A1 wherein R¹ is CN, R³ is as defined in line 4 of Table T4 and R² has the specific meaning given in the corresponding line appropriately selected from the 183 lines R2.001 to R2.0183 of Table T2.

Table 65: This table discloses the 183 specific compounds of the formula A1 wherein R¹ is CN, R³ is as defined in line 5 of Table T4 and R² has the specific meaning given in the corresponding line appropriately selected from the 183 lines R2.001 to R2.0183 of Table T2.

Table 66: This table discloses the 183 specific compounds of the formula A1 wherein R¹ is CN, R³ is as defined in line 6 of Table T4 and R² has the specific meaning given in the corresponding line appropriately selected from the 183 lines R2.001 to R2.0183 of Table T2.

Table 67: This table discloses the 183 specific compounds of the formula A1 wherein R¹ is CN, R³ is as defined in line 7 of Table T4 and R² has the specific meaning given in the corresponding line appropriately selected from the 183 lines R2.001 to R2.0183 of Table T2.

Table 68: This table discloses the 183 specific compounds of the formula A1 wherein R¹ is CN, R³ is as defined in line 8 of Table T4 and R² has the specific meaning given in the corresponding line appropriately selected from the 183 lines R2.001 to R2.0183 of Table T2.

Table 69: This table discloses the 183 specific compounds of the formula A1 wherein R¹ is CN, R³ is as defined in line 9 of Table T4 and R² has the specific meaning given in the corresponding line appropriately selected from the 183 lines R2.001 to R2.0183 of Table T2.

Table 70: This table discloses the 183 specific compounds of the formula A1 wherein R¹ is CN, R³ is as defined in line 10 of Table T4 and R² has the specific meaning given in the corresponding line appropriately selected from the 183 lines R2.001 to R2.0183 of Table T2.

Table 71: This table discloses the 183 specific compounds of the formula A1 wherein R¹ is CN, R³ is as defined in line 11 of Table T4 and R² has the specific meaning given in the corresponding line appropriately selected from the 183 lines R2.001 to R2.0183 of Table T2.

Table 72: This table discloses the 183 specific compounds of the formula A1 wherein R¹ is CN, R³ is as defined in line 12 of Table T4 and R² has the specific meaning given in the corresponding line appropriately selected from the 183 lines R2.001 to R2.0183 of Table T2.

Table 73: This table discloses the 183 specific compounds of the formula A1 wherein R¹ is OMe, R³ is as defined in line 1 of Table T4 and R² has the specific meaning given in the corresponding line appropriately selected from the 183 lines R2.001 to R2.0183 of Table T2.

Table 74: This table discloses the 183 specific compounds of the formula A1 wherein R¹ is OMe, R³ is as defined in line 2 of Table T4 and R² has the specific meaning given in the corresponding line appropriately selected from the 183 lines R2.001 to R2.0183 of Table T2.

Table 75: This table discloses the 183 specific compounds of the formula A1 wherein R¹ is OMe, R³ is as defined in line 3 of Table T4 and R² has the specific meaning given in the corresponding line appropriately selected from the 183 lines R2.001 to R2.0183 of Table T2.

Table 76: This table discloses the 183 specific compounds of the formula A1 wherein R¹ is OMe, R³ is as defined in line 4 of Table T4 and R² has the specific meaning given in the corresponding line appropriately selected from the 183 lines R2.001 to R2.0183 of Table T2.

Table 77: This table discloses the 183 specific compounds of the formula A1 wherein R¹ is OMe, R³ is as defined in line 5 of Table T4 and R² has the specific meaning given in the corresponding line appropriately selected from the 183 lines R2.001 to R2.0183 of Table T2.

Table 78: This table discloses the 183 specific compounds of the formula A1 wherein R¹ is OMe, R³ is as defined in line 6 of Table T4 and R² has the specific meaning given in the corresponding line appropriately selected from the 183 lines R2.001 to R2.0183 of Table T2.

Table 79: This table discloses the 183 specific compounds of the formula A1 wherein R¹ is OMe, R³ is as defined in line 7 of Table T4 and R² has the specific meaning given in the corresponding line appropriately selected from the 183 lines R2.001 to R2.0183 of Table T2.

Table 80: This table discloses the 183 specific compounds of the formula A1 wherein R¹ is OMe, R³ is as defined in line 8 of Table T4 and R² has the specific meaning given in the corresponding line appropriately selected from the 183 lines R2.001 to R2.0183 of Table T2.

Table 81: This table discloses the 183 specific compounds of the formula A1 wherein R¹ is OMe, R³ is as defined in line 9 of Table T4 and R² has the specific meaning given in the corresponding line appropriately selected from the 183 lines R2.001 to R2.0183 of Table T2.

Table 82: This table discloses the 183 specific compounds of the formula A1 wherein R¹ is OMe, R³ is as defined in line 10 of Table T4 and R² has the specific meaning given in the corresponding line appropriately selected from the 183 lines R2.001 to R2.0183 of Table T2.

Table 83: This table discloses the 183 specific compounds of the formula A1 wherein R¹ is OMe, R³ is as defined in line 11 of Table T4 and R² has the specific meaning given in the corresponding line appropriately selected from the 183 lines R2.001 to R2.0183 of Table T2.

Table 84: This table discloses the 183 specific compounds of the formula A1 wherein R¹ is OMe, R³ is as defined in line 12 of Table T4 and R² has the specific meaning given in the corresponding line appropriately selected from the 183 lines R2.001 to R2.0183 of Table T2.

Table 85: This table discloses the 183 specific compounds of the formula A1 wherein R¹ is H, R³ is as defined in line 1 of Table T4 and R² has the specific meaning given in the corresponding line appropriately selected from the 183 lines R2.001 to R2.0183 of Table T2.

Table 86: This table discloses the 183 specific compounds of the formula A1 wherein R¹ is H, R³ is as defined in line 2 of Table T4 and R² has the specific meaning given in the corresponding line appropriately selected from the 183 lines R2.001 to R2.0183 of Table T2.

Table 87: This table discloses the 183 specific compounds of the formula A1 wherein R¹ is H, R³ is as defined in line 3 of Table T4 and R² has the specific meaning given in the corresponding line appropriately selected from the 183 lines R2.001 to R2.0183 of Table T2.

Table 88: This table discloses the 183 specific compounds of the formula A1 wherein R¹ is H, R³ is as defined in line 4 of Table T4 and R² has the specific meaning given in the corresponding line appropriately selected from the 183 lines R2.001 to R2.0183 of Table T2.

Table 89: This table discloses the 183 specific compounds of the formula A1 wherein R¹ is H, R³ is as defined in line 5 of Table T4 and R² has the specific meaning given in the corresponding line appropriately selected from the 183 lines R2.001 to R2.0183 of Table T2.

Table 90: This table discloses the 183 specific compounds of the formula A1 wherein R¹ is H, R³ is as defined in line 6 of Table T4 and R² has the specific meaning given in the corresponding line appropriately selected from the 183 lines R2.001 to R2.0183 of Table T2.

Table 91: This table discloses the 183 specific compounds of the formula A1 wherein R¹ is H, R³ is as defined in line 7 of Table T4 and R² has the specific meaning given in the corresponding line appropriately selected from the 183 lines R2.001 to R2.0183 of Table T2.

Table 92: This table discloses the 183 specific compounds of the formula A1 wherein R¹ is H, R³ is as defined in line 8 of Table T4 and R² has the specific meaning given in the corresponding line appropriately selected from the 183 lines R2.001 to R2.0183 of Table T2.

Table 93: This table discloses the 183 specific compounds of the formula A1 wherein R¹ is H, R³ is as defined in line 9 of Table T4 and R² has the specific meaning given in the corresponding line appropriately selected from the 183 lines R2.001 to R2.0183 of Table T2.

Table 94: This table discloses the 183 specific compounds of the formula A1 wherein R¹ is H, R³ is as defined in line 10 of Table T4 and R² has the specific meaning given in the corresponding line appropriately selected from the 183 lines R2.001 to R2.0183 of Table T2.

Table 95: This table discloses the 183 specific compounds of the formula A1 wherein R¹ is H, R³ is as defined in line 11 of Table T4 and R² has the specific meaning given in the corresponding line appropriately selected from the 183 lines R2.001 to R2.0183 of Table T2.

Table 96: This table discloses the 183 specific compounds of the formula A1 wherein R¹ is H, R³ is as defined in line 12 of Table T4 and R² has the specific meaning given in the corresponding line appropriately selected from the 183 lines R2.001 to R2.0183 of Table T2.

Table 97: This table discloses the 183 specific compounds of the formula A2 wherein R¹ is Me, R³ is as defined in line 1 of Table T4 and R² has the specific meaning given in the corresponding line appropriately selected from the 183 lines R2.001 to R2.0183 of Table T2.

Table 98: This table discloses the 183 specific compounds of the formula A2 wherein R¹ is Me, R³ is as defined in line 2 of Table T4 and R² has the specific meaning given in the corresponding line appropriately selected from the 183 lines R2.001 to R2.0183 of Table T2.

Table 99: This table discloses the 183 specific compounds of the formula A2 wherein R¹ is Me, R³ is as defined in line 3 of Table T4 and R² has the specific meaning given in the corresponding line appropriately selected from the 183 lines R2.001 to R2.0183 of Table T2.

Table 100: This table discloses the 183 specific compounds of the formula A2 wherein R¹ is Me, R³ is as defined in line 4 of Table T4 and R² has the specific meaning given in the corresponding line appropriately selected from the 183 lines R2.001 to R2.0183 of Table T2.

Table 101: This table discloses the 183 specific compounds of the formula A2 wherein R¹ is Me, R³ is as defined in line 5 of Table T4 and R² has the specific meaning given in the corresponding line appropriately selected from the 183 lines R2.001 to R2.0183 of Table T2.

Table 102: This table discloses the 183 specific compounds of the formula A2 wherein R¹ is Me, R³ is as defined in line 6 of Table T4 and R² has the specific meaning given in the corresponding line appropriately selected from the 183 lines R2.001 to R2.0183 of Table T2.

Table 103: This table discloses the 183 specific compounds of the formula A2 wherein R¹ is Me, R³ is as defined in line 7 of Table T4 and R² has the specific meaning given in the corresponding line appropriately selected from the 183 lines R2.001 to R2.0183 of Table T2.

Table 104: This table discloses the 183 specific compounds of the formula A2 wherein R¹ is Me, R³ is as defined in line 8 of Table T4 and R² has the specific meaning given in the corresponding line appropriately selected from the 183 lines R2.001 to R2.0183 of Table T2.

Table 105: This table discloses the 183 specific compounds of the formula A2 wherein R¹ is Me, R³ is as defined in line 9 of Table T4 and R² has the specific meaning given in the corresponding line appropriately selected from the 183 lines R2.001 to R2.0183 of Table T2.

Table 106: This table discloses the 183 specific compounds of the formula A2 wherein R¹ is Me, R³ is as defined in line 10 of Table T4 and R² has the specific meaning given in the corresponding line appropriately selected from the 183 lines R2.001 to R2.0183 of Table T2.

Table 107: This table discloses the 183 specific compounds of the formula A2 wherein R¹ is Me, R³ is as defined in line 11 of Table T4 and R² has the specific meaning given in the corresponding line appropriately selected from the 183 lines R2.001 to R2.0183 of Table T2.

Table 108: This table discloses the 183 specific compounds of the formula A2 wherein R¹ is Me, R³ is as defined in line 12 of Table T4 and R² has the specific meaning given in the corresponding line appropriately selected from the 183 lines R2.001 to R2.0183 of Table T2.

Table 109: This table discloses the 183 specific compounds of the formula A2 wherein R¹ is CF3, R³ is as defined in line 1 of Table T4 and R² has the specific meaning given in the corresponding line appropriately selected from the 183 lines R2.001 to R2.0183 of Table T2.

Table 110: This table discloses the 183 specific compounds of the formula A2 wherein R¹ is CF3, R³ is as defined in line 2 of Table T4 and R² has the specific meaning given in the corresponding line appropriately selected from the 183 lines R2.001 to R2.0183 of Table T2.

Table 111: This table discloses the 183 specific compounds of the formula A2 wherein R¹ is CF3, R³ is as defined in line 3 of Table T4 and R² has the specific meaning given in the corresponding line appropriately selected from the 183 lines R2.001 to R2.0183 of Table T2.

Table 112: This table discloses the 183 specific compounds of the formula A2 wherein R¹ is CF3, R³ is as defined in line 4 of Table T4 and R² has the specific meaning given in the corresponding line appropriately selected from the 183 lines R2.001 to R2.0183 of Table T2.

Table 113: This table discloses the 183 specific compounds of the formula A2 wherein R¹ is CF3, R³ is as defined in line 5 of Table T4 and R² has the specific meaning given in the corresponding line appropriately selected from the 183 lines R2.001 to R2.0183 of Table T2.

Table 114: This table discloses the 183 specific compounds of the formula A2 wherein R¹ is CF3, R³ is as defined in line 6 of Table T4 and R² has the specific meaning given in the corresponding line appropriately selected from the 183 lines R2.001 to R2.0183 of Table T2.

Table 115: This table discloses the 183 specific compounds of the formula A2 wherein R¹ is CF3, R³ is as defined in line 7 of Table T4 and R² has the specific meaning given in the corresponding line appropriately selected from the 183 lines R2.001 to R2.0183 of Table T2.

Table 116: This table discloses the 183 specific compounds of the formula A2 wherein R¹ is CF3, R³ is as defined in line 8 of Table T4 and R² has the specific meaning given in the corresponding line appropriately selected from the 183 lines R2.001 to R2.0183 of Table T2.

Table 117: This table discloses the 183 specific compounds of the formula A2 wherein R¹ is CF3, R³ is as defined in line 9 of Table T4 and R² has the specific meaning given in the corresponding line appropriately selected from the 183 lines R2.001 to R2.0183 of Table T2.

Table 118: This table discloses the 183 specific compounds of the formula A2 wherein R¹ is CF3, R³ is as defined in line 10 of Table T4 and R² has the specific meaning given in the corresponding line appropriately selected from the 183 lines R2.001 to R2.0183 of Table T2.

Table 119: This table discloses the 183 specific compounds of the formula A2 wherein R¹ is CF3, R³ is as defined in line 11 of Table T4 and R² has the specific meaning given in the corresponding line appropriately selected from the 183 lines R2.001 to R2.0183 of Table T2.

Table 120: This table discloses the 183 specific compounds of the formula A2 wherein R¹ is CF3, R³ is as defined in line 12 of Table T4 and R² has the specific meaning given in the corresponding line appropriately selected from the 183 lines R2.001 to R2.0183 of Table T2.

Table 121: This table discloses the 183 specific compounds of the formula A2 wherein R¹ is F, R³ is as defined in line 1 of Table T4 and R² has the specific meaning given in the corresponding line appropriately selected from the 183 lines R2.001 to R2.0183 of Table T2.

Table 122: This table discloses the 183 specific compounds of the formula A2 wherein R¹ is F, R³ is as defined in line 2 of Table T4 and R² has the specific meaning given in the corresponding line appropriately selected from the 183 lines R2.001 to R2.0183 of Table T2.

Table 123: This table discloses the 183 specific compounds of the formula A2 wherein R¹ is F, R³ is as defined in line 3 of Table T4 and R² has the specific meaning given in the corresponding line appropriately selected from the 183 lines R2.001 to R2.0183 of Table T2.

Table 124: This table discloses the 183 specific compounds of the formula A2 wherein R¹ is F, R³ is as defined in line 4 of Table T4 and R² has the specific meaning given in the corresponding line appropriately selected from the 183 lines R2.001 to R2.0183 of Table T2.

Table 125: This table discloses the 183 specific compounds of the formula A2 wherein R¹ is F, R³ is as defined in line 5 of Table T4 and R² has the specific meaning given in the corresponding line appropriately selected from the 183 lines R2.001 to R2.0183 of Table T2.

Table 126: This table discloses the 183 specific compounds of the formula A2 wherein R¹ is F, R³ is as defined in line 6 of Table T4 and R² has the specific meaning given in the corresponding line appropriately selected from the 183 lines R2.001 to R2.0183 of Table T2.

Table 127: This table discloses the 183 specific compounds of the formula A2 wherein R¹ is F, R³ is as defined in line 7 of Table T4 and R² has the specific meaning given in the corresponding line appropriately selected from the 183 lines R2.001 to R2.0183 of Table T2.

Table 128: This table discloses the 183 specific compounds of the formula A2 wherein R¹ is F, R³ is as defined in line 8 of Table T4 and R² has the specific meaning given in the corresponding line appropriately selected from the 183 lines R2.001 to R2.0183 of Table T2.

Table 129: This table discloses the 183 specific compounds of the formula A2 wherein R¹ is F, R³ is as defined in line 9 of Table T4 and R² has the specific meaning given in the corresponding line appropriately selected from the 183 lines R2.001 to R2.0183 of Table T2.

Table 130: This table discloses the 183 specific compounds of the formula A2 wherein R¹ is F, R³ is as defined in line 10 of Table T4 and R² has the specific meaning given in the corresponding line appropriately selected from the 183 lines R2.001 to R2.0183 of Table T2.

Table 131: This table discloses the 183 specific compounds of the formula A2 wherein R¹ is F, R³ is as defined in line 11 of Table T4 and R² has the specific meaning given in the corresponding line appropriately selected from the 183 lines R2.001 to R2.0183 of Table T2.

Table 132: This table discloses the 183 specific compounds of the formula A2 wherein R¹ is F, R³ is as defined in line 12 of Table T4 and R² has the specific meaning given in the corresponding line appropriately selected from the 183 lines R2.001 to R2.0183 of Table T2.

Table 133: This table discloses the 183 specific compounds of the formula A2 wherein R¹ is Cl, R³ is as defined in line 1 of Table T4 and R² has the specific meaning given in the corresponding line appropriately selected from the 183 lines R2.001 to R2.0183 of Table T2.

Table 134: This table discloses the 183 specific compounds of the formula A2 wherein R¹ is Cl, R³ is as defined in line 2 of Table T4 and R² has the specific meaning given in the corresponding line appropriately selected from the 183 lines R2.001 to R2.0183 of Table T2.

Table 135: This table discloses the 183 specific compounds of the formula A2 wherein R¹ is Cl, R³ is as defined in line 3 of Table T4 and R² has the specific meaning given in the corresponding line appropriately selected from the 183 lines R2.001 to R2.0183 of Table T2.

Table 136: This table discloses the 183 specific compounds of the formula A2 wherein R¹ is Cl, R³ is as defined in line 4 of Table T4 and R² has the specific meaning given in the corresponding line appropriately selected from the 183 lines R2.001 to R2.0183 of Table T2.

Table 137: This table discloses the 183 specific compounds of the formula A2 wherein R¹ is Cl, R³ is as defined in line 5 of Table T4 and R² has the specific meaning given in the corresponding line appropriately selected from the 183 lines R2.001 to R2.0183 of Table T2.

Table 138: This table discloses the 183 specific compounds of the formula A2 wherein R¹ is Cl, R³ is as defined in line 6 of Table T4 and R² has the specific meaning given in the corresponding line appropriately selected from the 183 lines R2.001 to R2.0183 of Table T2.

Table 139: This table discloses the 183 specific compounds of the formula A2 wherein R¹ is Cl, R³ is as defined in line 7 of Table T4 and R² has the specific meaning given in the corresponding line appropriately selected from the 183 lines R2.001 to R2.0183 of Table T2.

Table 140: This table discloses the 183 specific compounds of the formula A2 wherein R¹ is Cl, R³ is as defined in line 8 of Table T4 and R² has the specific meaning given in the corresponding line appropriately selected from the 183 lines R2.001 to R2.0183 of Table T2.

Table 141: This table discloses the 183 specific compounds of the formula A2 wherein R¹ is Cl, R³ is as defined in line 9 of Table T4 and R² has the specific meaning given in the corresponding line appropriately selected from the 183 lines R2.001 to R2.0183 of Table T2.

Table 142: This table discloses the 183 specific compounds of the formula A2 wherein R¹ is Cl, R³ is as defined in line 10 of Table T4 and R² has the specific meaning given in the corresponding line appropriately selected from the 183 lines R2.001 to R2.0183 of Table T2.

Table 143: This table discloses the 183 specific compounds of the formula A2 wherein R¹ is Cl, R³ is as defined in line 11 of Table T4 and R² has the specific meaning given in the corresponding line appropriately selected from the 183 lines R2.001 to R2.0183 of Table T2.

Table 144: This table discloses the 183 specific compounds of the formula A2 wherein R¹ is Cl, R³ is as defined in line 12 of Table T4 and R² has the specific meaning given in the corresponding line appropriately selected from the 183 lines R2.001 to R2.0183 of Table T2.

Table 145: This table discloses the 183 specific compounds of the formula A2 wherein R¹ is Nitro, R³ is as defined in line 1 of Table T4 and R² has the specific meaning given in the corresponding line appropriately selected from the 183 lines R2.001 to R2.0183 of Table T2.

Table 146: This table discloses the 183 specific compounds of the formula A2 wherein R¹ is Nitro, R³ is as defined in line 2 of Table T4 and R² has the specific meaning given in the corresponding line appropriately selected from the 183 lines R2.001 to R2.0183 of Table T2.

Table 147: This table discloses the 183 specific compounds of the formula A2 wherein R¹ is Nitro, R³ is as defined in line 3 of Table T4 and R² has the specific meaning given in the corresponding line appropriately selected from the 183 lines R2.001 to R2.0183 of Table T2.

Table 148: This table discloses the 183 specific compounds of the formula A2 wherein R¹ is Nitro, R³ is as defined in line 4 of Table T4 and R² has the specific meaning given in the corresponding line appropriately selected from the 183 lines R2.001 to R2.0183 of Table T2.

Table 149: This table discloses the 183 specific compounds of the formula A2 wherein R¹ is Nitro, R³ is as defined in line 5 of Table T4 and R² has the specific meaning given in the corresponding line appropriately selected from the 183 lines R2.001 to R2.0183 of Table T2.

Table 150: This table discloses the 183 specific compounds of the formula A2 wherein R¹ is Nitro, R³ is as defined in line 6 of Table T4 and R² has the specific meaning given in the corresponding line appropriately selected from the 183 lines R2.001 to R2.0183 of Table T2.

Table 151: This table discloses the 183 specific compounds of the formula A2 wherein R¹ is Nitro, R³ is as defined in line 7 of Table T4 and R² has the specific meaning given in the corresponding line appropriately selected from the 183 lines R2.001 to R2.0183 of Table T2.

Table 152: This table discloses the 183 specific compounds of the formula A2 wherein R¹ is Nitro, R³ is as defined in line 8 of Table T4 and R² has the specific meaning given in the corresponding line appropriately selected from the 183 lines R2.001 to R2.0183 of Table T2.

Table 153: This table discloses the 183 specific compounds of the formula A2 wherein R¹ is Nitro, R³ is as defined in line 9 of Table T4 and R² has the specific meaning given in the corresponding line appropriately selected from the 183 lines R2.001 to R2.0183 of Table T2.

Table 154: This table discloses the 183 specific compounds of the formula A2 wherein R¹ is Nitro, R³ is as defined in line 10 of Table T4 and R² has the specific meaning given in the corresponding line appropriately selected from the 183 lines R2.001 to R2.0183 of Table T2.

Table 155: This table discloses the 183 specific compounds of the formula A2 wherein R¹ is Nitro, R³ is as defined in line 11 of Table T4 and R² has the specific meaning given in the corresponding line appropriately selected from the 183 lines R2.001 to R2.0183 of Table T2.

Table 156: This table discloses the 183 specific compounds of the formula A2 wherein R¹ is Nitro, R³ is as defined in line 12 of Table T4 and R² has the specific meaning given in the corresponding line appropriately selected from the 183 lines R2.001 to R2.0183 of Table T2.

Table 157: This table discloses the 183 specific compounds of the formula A2 wherein R¹ is CN, R³ is as defined in line 1 of Table T4 and R² has the specific meaning given in the corresponding line appropriately selected from the 183 lines R2.001 to R2.0183 of Table T2.

Table 158: This table discloses the 183 specific compounds of the formula A2 wherein R¹ is CN, R³ is as defined in line 2 of Table T4 and R² has the specific meaning given in the corresponding line appropriately selected from the 183 lines R2.001 to R2.0183 of Table T2.

Table 159: This table discloses the 183 specific compounds of the formula A2 wherein R¹ is CN, R³ is as defined in line 3 of Table T4 and R² has the specific meaning given in the corresponding line appropriately selected from the 183 lines R2.001 to R2.0183 of Table T2.

Table 160: This table discloses the 183 specific compounds of the formula A2 wherein R¹ is CN, R³ is as defined in line 4 of Table T4 and R² has the specific meaning given in the corresponding line appropriately selected from the 183 lines R2.001 to R2.0183 of Table T2.

Table 161: This table discloses the 183 specific compounds of the formula A2 wherein R¹ is CN, R³ is as defined in line 5 of Table T4 and R² has the specific meaning given in the corresponding line appropriately selected from the 183 lines R2.001 to R2.0183 of Table T2.

Table 162: This table discloses the 183 specific compounds of the formula A2 wherein R¹ is CN, R³ is as defined in line 6 of Table T4 and R² has the specific meaning given in the corresponding line appropriately selected from the 183 lines R2.001 to R2.0183 of Table T2.

Table 163: This table discloses the 183 specific compounds of the formula A2 wherein R¹ is CN, R³ is as defined in line 7 of Table T4 and R² has the specific meaning given in the corresponding line appropriately selected from the 183 lines R2.001 to R2.0183 of Table T2.

Table 164: This table discloses the 183 specific compounds of the formula A2 wherein R¹ is CN, R³ is as defined in line 8 of Table T4 and R² has the specific meaning given in the corresponding line appropriately selected from the 183 lines R2.001 to R2.0183 of Table T2.

Table 165: This table discloses the 183 specific compounds of the formula A2 wherein R¹ is CN, R³ is as defined in line 9 of Table T4 and R² has the specific meaning given in the corresponding line appropriately selected from the 183 lines R2.001 to R2.0183 of Table T2.

Table 166: This table discloses the 183 specific compounds of the formula A2 wherein R¹ is CN, R³ is as defined in line 10 of Table T4 and R² has the specific meaning given in the corresponding line appropriately selected from the 183 lines R2.001 to R2.0183 of Table T2.

Table 167: This table discloses the 183 specific compounds of the formula A2 wherein R¹ is CN, R³ is as defined in line 11 of Table T4 and R² has the specific meaning given in the corresponding line appropriately selected from the 183 lines R2.001 to R2.0183 of Table T2.

Table 168: This table discloses the 183 specific compounds of the formula A2 wherein R¹ is CN, R³ is as defined in line 12 of Table T4 and R² has the specific meaning given in the corresponding line appropriately selected from the 183 lines R2.001 to R2.0183 of Table T2.

Table 169: This table discloses the 183 specific compounds of the formula A2 wherein R¹ is OMe, R³ is as defined in line 1 of Table T4 and R² has the specific meaning given in the corresponding line appropriately selected from the 183 lines R2.001 to R2.0183 of Table T2.

Table 170: This table discloses the 183 specific compounds of the formula A2 wherein R¹ is OMe, R³ is as defined in line 2 of Table T4 and R² has the specific meaning given in the corresponding line appropriately selected from the 183 lines R2.001 to R2.0183 of Table T2.

Table 171: This table discloses the 183 specific compounds of the formula A2 wherein R¹ is OMe, R³ is as defined in line 3 of Table T4 and R² has the specific meaning given in the corresponding line appropriately selected from the 183 lines R2.001 to R2.0183 of Table T2.

Table 172: This table discloses the 183 specific compounds of the formula A2 wherein R¹ is OMe, R³ is as defined in line 4 of Table T4 and R² has the specific meaning given in the corresponding line appropriately selected from the 183 lines R2.001 to R2.0183 of Table T2.

Table 173: This table discloses the 183 specific compounds of the formula A2 wherein R¹ is OMe, R³ is as defined in line 5 of Table T4 and R² has the specific meaning given in the corresponding line appropriately selected from the 183 lines R2.001 to R2.0183 of Table T2.

Table 174: This table discloses the 183 specific compounds of the formula A2 wherein R¹ is OMe, R³ is as defined in line 6 of Table T4 and R² has the specific meaning given in the corresponding line appropriately selected from the 183 lines R2.001 to R2.0183 of Table T2.

Table 175: This table discloses the 183 specific compounds of the formula A2 wherein R¹ is OMe, R³ is as defined in line 7 of Table T4 and R² has the specific meaning given in the corresponding line appropriately selected from the 183 lines R2.001 to R2.0183 of Table T2.

Table 176: This table discloses the 183 specific compounds of the formula A2 wherein R¹ is OMe, R³ is as defined in line 8 of Table T4 and R² has the specific meaning given in the corresponding line appropriately selected from the 183 lines R2.001 to R2.0183 of Table T2.

Table 177: This table discloses the 183 specific compounds of the formula A2 wherein R¹ is OMe, R³ is as defined in line 9 of Table T4 and R² has the specific meaning given in the corresponding line appropriately selected from the 183 lines R2.001 to R2.0183 of Table T2.

Table 178: This table discloses the 183 specific compounds of the formula A2 wherein R¹ is OMe, R³ is as defined in line 10 of Table T4 and R² has the specific meaning given in the corresponding line appropriately selected from the 183 lines R2.001 to R2.0183 of Table T2.

Table 179: This table discloses the 183 specific compounds of the formula A2 wherein R¹ is OMe, R³ is as defined in line 11 of Table T4 and R² has the specific meaning given in the corresponding line appropriately selected from the 183 lines R2.001 to R2.0183 of Table T2.

Table 180: This table discloses the 183 specific compounds of the formula A2 wherein R¹ is OMe, R³ is as defined in line 12 of Table T4 and R² has the specific meaning given in the corresponding line appropriately selected from the 183 lines R2.001 to R2.0183 of Table T2.

Table 181: This table discloses the 183 specific compounds of the formula A2 wherein R¹ is H, R³ is as defined in line 1 of Table T4 and R² has the specific meaning given in the corresponding line appropriately selected from the 183 lines R2.001 to R2.0183 of Table T2.

Table 182: This table discloses the 183 specific compounds of the formula A2 wherein R¹ is H, R³ is as defined in line 2 of Table T4 and R² has the specific meaning given in the corresponding line appropriately selected from the 183 lines R2.001 to R2.0183 of Table T2.

Table 183: This table discloses the 183 specific compounds of the formula A2 wherein R¹ is H, R³ is as defined in line 3 of Table T4 and R² has the specific meaning given in the corresponding line appropriately selected from the 183 lines R2.001 to R2.0183 of Table T2.

Table 184: This table discloses the 183 specific compounds of the formula A2 wherein R¹ is H, R³ is as defined in line 4 of Table T4 and R² has the specific meaning given in the corresponding line appropriately selected from the 183 lines R2.001 to R2.0183 of Table T2.

Table 185: This table discloses the 183 specific compounds of the formula A2 wherein R¹ is H, R³ is as defined in line 5 of Table T4 and R² has the specific meaning given in the corresponding line appropriately selected from the 183 lines R2.001 to R2.0183 of Table T2.

Table 186: This table discloses the 183 specific compounds of the formula A2 wherein R¹ is H, R³ is as defined in line 6 of Table T4 and R² has the specific meaning given in the corresponding line appropriately selected from the 183 lines R2.001 to R2.0183 of Table T2.

Table 187: This table discloses the 183 specific compounds of the formula A2 wherein R¹ is H, R³ is as defined in line 7 of Table T4 and R² has the specific meaning given in the corresponding line appropriately selected from the 183 lines R2.001 to R2.0183 of Table T2.

Table 188: This table discloses the 183 specific compounds of the formula A2 wherein R¹ is H, R³ is as defined in line 8 of Table T4 and R² has the specific meaning given in the corresponding line appropriately selected from the 183 lines R2.001 to R2.0183 of Table T2.

Table 189: This table discloses the 183 specific compounds of the formula A2 wherein R¹ is H, R³ is as defined in line 9 of Table T4 and R² has the specific meaning given in the corresponding line appropriately selected from the 183 lines R2.001 to R2.0183 of Table T2.

Table 190: This table discloses the 183 specific compounds of the formula A2 wherein R¹ is H, R³ is as defined in line 10 of Table T4 and R² has the specific meaning given in the corresponding line appropriately selected from the 183 lines R2.001 to R2.0183 of Table T2.

Table 191: This table discloses the 183 specific compounds of the formula A2 wherein R¹ is H, R³ is as defined in line 11 of Table T4 and R² has the specific meaning given in the corresponding line appropriately selected from the 183 lines R2.001 to R2.0183 of Table T2.

Table 192: This table discloses the 179 specific compounds of the formula A2 wherein R¹ is H, R³ is as defined in line 12 of Table T4 and R² has the specific meaning given in the corresponding line appropriately selected from the 179 lines R2.001 to R2.0179 of Table T2.

Table 193: This table discloses the 183 specific compounds of the formula A3 wherein R³ is as defined in line 1 of Table T4 and R² has the specific meaning given in the corresponding line appropriately selected from the 183 lines R2.001 to R2.0183 of Table T2.

Table 194: This table discloses the 183 specific compounds of the formula A3 wherein R³ is as defined in line 2 of Table T4 and R² has the specific meaning given in the corresponding line appropriately selected from the 183 lines R2.001 to R2.0183 of Table T2.

Table 195: This table discloses the 183 specific compounds of the formula A3 wherein R³ is as defined in line 3 of Table T4 and R² has the specific meaning given in the corresponding line appropriately selected from the 183 lines R2.001 to R2.0183 of Table T2.

Table 196: This table discloses the 183 specific compounds of the formula A3 wherein R³ is as defined in line 4 of Table T4 and R² has the specific meaning given in the corresponding line appropriately selected from the 183 lines R2.001 to R2.0183 of Table T2.

Table 197: This table discloses the 183 specific compounds of the formula A3 wherein R³ is as defined in line 5 of Table T4 and R² has the specific meaning given in the corresponding line appropriately selected from the 183 lines R2.001 to R2.0183 of Table T2.

Table 198: This table discloses the 183 specific compounds of the formula A3 wherein R³ is as defined in line 6 of Table T4 and R² has the specific meaning given in the corresponding line appropriately selected from the 183 lines R2.001 to R2.0183 of Table T2.

Table 199: This table discloses the 183 specific compounds of the formula A3 wherein R³ is as defined in line 7 of Table T4 and R² has the specific meaning given in the corresponding line appropriately selected from the 183 lines R2.001 to R2.0183 of Table T2.

Table 200: This table discloses the 183 specific compounds of the formula A3 wherein R³ is as defined in line 8 of Table T4 and R² has the specific meaning given in the corresponding line appropriately selected from the 183 lines R2.001 to R2.0183 of Table T2.

Table 201: This table discloses the 183 specific compounds of the formula A3 wherein R³ is as defined in line 9 of Table T4 and R² has the specific meaning given in the corresponding line appropriately selected from the 183 lines R2.001 to R2.0183 of Table T2.

Table 202: This table discloses the 183 specific compounds of the formula A3 wherein R³ is as defined in line 10 of Table T4 and R² has the specific meaning given in the corresponding line appropriately selected from the 183 lines R2.001 to R2.0183 of Table T2.

Table 203: This table discloses the 183 specific compounds of the formula A3 wherein R³ is as defined in line 11 of Table T4 and R² has the specific meaning given in the corresponding line appropriately selected from the 183 lines R2.001 to R2.0183 of Table T2.

Table 204: This table discloses the 183 specific compounds of the formula A3 wherein R³ is as defined in line 12 of Table T4 and R² has the specific meaning given in the corresponding line appropriately selected from the 183 lines R2.001 to R2.0183 of Table T2.

Table 205: This table discloses the 183 specific compounds of the formula A4 wherein R¹ is Me, R³ is as defined in line 1 of Table T4 and R² has the specific meaning given in the corresponding line appropriately selected from the 183 lines R2.001 to R2.0183 of Table T2.

Table 206: This table discloses the 183 specific compounds of the formula A4 wherein R¹ is Me, R³ is as defined in line 2 of Table T4 and R² has the specific meaning given in the corresponding line appropriately selected from the 183 lines R2.001 to R2.0183 of Table T2.

Table 207: This table discloses the 183 specific compounds of the formula A4 wherein R¹ is Me, R³ is as defined in line 3 of Table T4 and R² has the specific meaning given in the corresponding line appropriately selected from the 183 lines R2.001 to R2.0183 of Table T2.

Table 208: This table discloses the 183 specific compounds of the formula A4 wherein R¹ is Me, R³ is as defined in line 4 of Table T4 and R² has the specific meaning given in the corresponding line appropriately selected from the 183 lines R2.001 to R2.0183 of Table T2.

Table 209: This table discloses the 183 specific compounds of the formula A4 wherein R¹ is Me, R³ is as defined in line 5 of Table T4 and R² has the specific meaning given in the corresponding line appropriately selected from the 183 lines R2.001 to R2.0183 of Table T2.

Table 210: This table discloses the 183 specific compounds of the formula A4 wherein R¹ is Me, R³ is as defined in line 6 of Table T4 and R² has the specific meaning given in the corresponding line appropriately selected from the 183 lines R2.001 to R2.0183 of Table T2.

Table 211: This table discloses the 183 specific compounds of the formula A4 wherein R¹ is Me, R³ is as defined in line 7 of Table T4 and R² has the specific meaning given in the corresponding line appropriately selected from the 183 lines R2.001 to R2.0183 of Table T2.

Table 212: This table discloses the 183 specific compounds of the formula A4 wherein R¹ is Me, R³ is as defined in line 8 of Table T4 and R² has the specific meaning given in the corresponding line appropriately selected from the 183 lines R2.001 to R2.0183 of Table T2.

Table 213: This table discloses the 183 specific compounds of the formula A4 wherein R¹ is Me, R³ is as defined in line 9 of Table T4 and R² has the specific meaning given in the corresponding line appropriately selected from the 183 lines R2.001 to R2.0183 of Table T2.

Table 214: This table discloses the 183 specific compounds of the formula A4 wherein R¹ is Me, R³ is as defined in line 10 of Table T4 and R² has the specific meaning given in the corresponding line appropriately selected from the 183 lines R2.001 to R2.0183 of Table T2.

Table 215: This table discloses the 183 specific compounds of the formula A4 wherein R¹ is Me, R³ is as defined in line 11 of Table T4 and R² has the specific meaning given in the corresponding line appropriately selected from the 183 lines R2.001 to R2.0183 of Table T2.

Table 216: This table discloses the 183 specific compounds of the formula A4 wherein R¹ is Me, R³ is as defined in line 12 of Table T4 and R² has the specific meaning given in the corresponding line appropriately selected from the 183 lines R2.001 to R2.0183 of Table T2.

Table 217: This table discloses the 183 specific compounds of the formula A4 wherein R¹ is CF3, R³ is as defined in line 1 of Table T4 and R² has the specific meaning given in the corresponding line appropriately selected from the 183 lines R2.001 to R2.0183 of Table T2.

Table 218: This table discloses the 183 specific compounds of the formula A4 wherein R¹ is CF3, R³ is as defined in line 2 of Table T4 and R² has the specific meaning given in the corresponding line appropriately selected from the 183 lines R2.001 to R2.0183 of Table T2.

Table 219: This table discloses the 183 specific compounds of the formula A4 wherein R¹ is CF3, R³ is as defined in line 3 of Table T4 and R² has the specific meaning given in the corresponding line appropriately selected from the 183 lines R2.001 to R2.0183 of Table T2.

Table 220: This table discloses the 183 specific compounds of the formula A4 wherein R¹ is CF3, R³ is as defined in line 4 of Table T4 and R² has the specific meaning given in the corresponding line appropriately selected from the 183 lines R2.001 to R2.0183 of Table T2.

Table 221: This table discloses the 183 specific compounds of the formula A4 wherein R¹ is CF3, R³ is as defined in line 5 of Table T4 and R² has the specific meaning given in the corresponding line appropriately selected from the 183 lines R2.001 to R2.0183 of Table T2.

Table 222: This table discloses the 183 specific compounds of the formula A4 wherein R¹ is CF3, R³ is as defined in line 6 of Table T4 and R² has the specific meaning given in the corresponding line appropriately selected from the 183 lines R2.001 to R2.0183 of Table T2.

Table 223: This table discloses the 183 specific compounds of the formula A4 wherein R¹ is CF3, R³ is as defined in line 7 of Table T4 and R² has the specific meaning given in the corresponding line appropriately selected from the 183 lines R2.001 to R2.0183 of Table T2.

Table 224: This table discloses the 183 specific compounds of the formula A4 wherein R¹ is CF3, R³ is as defined in line 8 of Table T4 and R² has the specific meaning given in the corresponding line appropriately selected from the 183 lines R2.001 to R2.0183 of Table T2.

Table 225: This table discloses the 183 specific compounds of the formula A4 wherein R¹ is CF3, R³ is as defined in line 9 of Table T4 and R² has the specific meaning given in the corresponding line appropriately selected from the 183 lines R2.001 to R2.0183 of Table T2.

Table 226: This table discloses the 183 specific compounds of the formula A4 wherein R¹ is CF3, R³ is as defined in line 10 of Table T4 and R² has the specific meaning given in the corresponding line appropriately selected from the 183 lines R2.001 to R2.0183 of Table T2.

Table 227: This table discloses the 183 specific compounds of the formula A4 wherein R¹ is CF3, R³ is as defined in line 11 of Table T4 and R² has the specific meaning given in the corresponding line appropriately selected from the 183 lines R2.001 to R2.0183 of Table T2.

Table 228: This table discloses the 183 specific compounds of the formula A4 wherein R¹ is CF3, R³ is as defined in line 12 of Table T4 and R² has the specific meaning given in the corresponding line appropriately selected from the 183 lines R2.001 to R2.0183 of Table T2.

Table 229: This table discloses the 183 specific compounds of the formula A4 wherein R¹ is F, R³ is as defined in line 1 of Table T4 and R² has the specific meaning given in the corresponding line appropriately selected from the 183 lines R2.001 to R2.0183 of Table T2.

Table 230: This table discloses the 183 specific compounds of the formula A4 wherein R¹ is F, R³ is as defined in line 2 of Table T4 and R² has the specific meaning given in the corresponding line appropriately selected from the 183 lines R2.001 to R2.0183 of Table T2.

Table 231: This table discloses the 183 specific compounds of the formula A4 wherein R¹ is F, R³ is as defined in line 3 of Table T4 and R² has the specific meaning given in the corresponding line appropriately selected from the 183 lines R2.001 to R2.0183 of Table T2.

Table 232: This table discloses the 183 specific compounds of the formula A4 wherein R¹ is F, R³ is as defined in line 4 of Table T4 and R² has the specific meaning given in the corresponding line appropriately selected from the 183 lines R2.001 to R2.0183 of Table T2.

Table 233: This table discloses the 183 specific compounds of the formula A4 wherein R¹ is F, R³ is as defined in line 5 of Table T4 and R² has the specific meaning given in the corresponding line appropriately selected from the 183 lines R2.001 to R2.0183 of Table T2.

Table 234: This table discloses the 183 specific compounds of the formula A4 wherein R¹ is F, R³ is as defined in line 6 of Table T4 and R² has the specific meaning given in the corresponding line appropriately selected from the 183 lines R2.001 to R2.0183 of Table T2.

Table 235: This table discloses the 183 specific compounds of the formula A4 wherein R¹ is F, R³ is as defined in line 7 of Table T4 and R² has the specific meaning given in the corresponding line appropriately selected from the 183 lines R2.001 to R2.0183 of Table T2.

Table 236: This table discloses the 183 specific compounds of the formula A4 wherein R¹ is F, R³ is as defined in line 8 of Table T4 and R² has the specific meaning given in the corresponding line appropriately selected from the 183 lines R2.001 to R2.0183 of Table T2.

Table 237: This table discloses the 183 specific compounds of the formula A4 wherein R¹ is F, R³ is as defined in line 9 of Table T4 and R² has the specific meaning given in the corresponding line appropriately selected from the 183 lines R2.001 to R2.0183 of Table T2.

Table 238: This table discloses the 183 specific compounds of the formula A4 wherein R¹ is F, R³ is as defined in line 10 of Table T4 and R² has the specific meaning given in the corresponding line appropriately selected from the 183 lines R2.001 to R2.0183 of Table T2.

Table 239: This table discloses the 183 specific compounds of the formula A4 wherein R¹ is F, R³ is as defined in line 11 of Table T4 and R² has the specific meaning given in the corresponding line appropriately selected from the 183 lines R2.001 to R2.0183 of Table T2.

Table 240: This table discloses the 183 specific compounds of the formula A4 wherein R¹ is F, R³ is as defined in line 12 of Table T4 and R² has the specific meaning given in the corresponding line appropriately selected from the 183 lines R2.001 to R2.0183 of Table T2.

Table 241: This table discloses the 183 specific compounds of the formula A4 wherein R¹ is Cl, R³ is as defined in line 1 of Table T4 and R² has the specific meaning given in the corresponding line appropriately selected from the 183 lines R2.001 to R2.0183 of Table T2.

Table 242: This table discloses the 183 specific compounds of the formula A4 wherein R¹ is Cl, R³ is as defined in line 2 of Table T4 and R² has the specific meaning given in the corresponding line appropriately selected from the 183 lines R2.001 to R2.0183 of Table T2.

Table 243: This table discloses the 183 specific compounds of the formula A4 wherein R¹ is Cl, R³ is as defined in line 3 of Table T4 and R² has the specific meaning given in the corresponding line appropriately selected from the 183 lines R2.001 to R2.0183 of Table T2.

Table 244: This table discloses the 183 specific compounds of the formula A4 wherein R¹ is Cl, R³ is as defined in line 4 of Table T4 and R² has the specific meaning given in the corresponding line appropriately selected from the 183 lines R2.001 to R2.0183 of Table T2.

Table 245: This table discloses the 183 specific compounds of the formula A4 wherein R¹ is Cl, R³ is as defined in line 5 of Table T4 and R² has the specific meaning given in the corresponding line appropriately selected from the 183 lines R2.001 to R2.0183 of Table T2.

Table 246: This table discloses the 183 specific compounds of the formula A4 wherein R¹ is Cl, R³ is as defined in line 6 of Table T4 and R² has the specific meaning given in the corresponding line appropriately selected from the 183 lines R2.001 to R2.0183 of Table T2.

Table 247: This table discloses the 183 specific compounds of the formula A4 wherein R¹ is Cl, R³ is as defined in line 7 of Table T4 and R² has the specific meaning given in the corresponding line appropriately selected from the 183 lines R2.001 to R2.0183 of Table T2.

Table 248: This table discloses the 183 specific compounds of the formula A4 wherein R¹ is Cl, R³ is as defined in line 8 of Table T4 and R² has the specific meaning given in the corresponding line appropriately selected from the 183 lines R2.001 to R2.0183 of Table T2.

Table 249: This table discloses the 183 specific compounds of the formula A4 wherein R¹ is Cl, R³ is as defined in line 9 of Table T4 and R² has the specific meaning given in the corresponding line appropriately selected from the 183 lines R2.001 to R2.0183 of Table T2.

Table 250: This table discloses the 183 specific compounds of the formula A4 wherein R¹ is Cl, R³ is as defined in line 10 of Table T4 and R² has the specific meaning given in the corresponding line appropriately selected from the 183 lines R2.001 to R2.0183 of Table T2.

Table 251: This table discloses the 183 specific compounds of the formula A4 wherein R¹ is Cl, R³ is as defined in line 11 of Table T4 and R² has the specific meaning given in the corresponding line appropriately selected from the 183 lines R2.001 to R2.0183 of Table T2.

Table 252: This table discloses the 183 specific compounds of the formula A4 wherein R¹ is Cl, R³ is as defined in line 12 of Table T4 and R² has the specific meaning given in the corresponding line appropriately selected from the 183 lines R2.001 to R2.0183 of Table T2.

Table 253: This table discloses the 183 specific compounds of the formula A4 wherein R¹ is Nitro, R³ is as defined in line 1 of Table T4 and R² has the specific meaning given in the corresponding line appropriately selected from the 183 lines R2.001 to R2.0183 of Table T2.

Table 254: This table discloses the 183 specific compounds of the formula A4 wherein R¹ is Nitro, R³ is as defined in line 2 of Table T4 and R² has the specific meaning given in the corresponding line appropriately selected from the 183 lines R2.001 to R2.0183 of Table T2.

Table 255: This table discloses the 183 specific compounds of the formula A4 wherein R¹ is Nitro, R³ is as defined in line 3 of Table T4 and R² has the specific meaning given in the corresponding line appropriately selected from the 183 lines R2.001 to R2.0183 of Table T2.

Table 256: This table discloses the 183 specific compounds of the formula A4 wherein R¹ is Nitro, R³ is as defined in line 4 of Table T4 and R² has the specific meaning given in the corresponding line appropriately selected from the 183 lines R2.001 to R2.0183 of Table T2.

Table 257: This table discloses the 183 specific compounds of the formula A4 wherein R¹ is Nitro, R³ is as defined in line 5 of Table T4 and R² has the specific meaning given in the corresponding line appropriately selected from the 183 lines R2.001 to R2.0183 of Table T2.

Table 258: This table discloses the 183 specific compounds of the formula A4 wherein R¹ is Nitro, R³ is as defined in line 6 of Table T4 and R² has the specific meaning given in the corresponding line appropriately selected from the 183 lines R2.001 to R2.0183 of Table T2.

Table 259: This table discloses the 183 specific compounds of the formula A4 wherein R¹ is Nitro, R³ is as defined in line 7 of Table T4 and R² has the specific meaning given in the corresponding line appropriately selected from the 183 lines R2.001 to R2.0183 of Table T2.

Table 260: This table discloses the 183 specific compounds of the formula A4 wherein R¹ is Nitro, R³ is as defined in line 8 of Table T4 and R² has the specific meaning given in the corresponding line appropriately selected from the 183 lines R2.001 to R2.0183 of Table T2.

Table 261: This table discloses the 183 specific compounds of the formula A4 wherein R¹ is Nitro, R³ is as defined in line 9 of Table T4 and R² has the specific meaning given in the corresponding line appropriately selected from the 183 lines R2.001 to R2.0183 of Table T2.

Table 262: This table discloses the 183 specific compounds of the formula A4 wherein R¹ is Nitro, R³ is as defined in line 10 of Table T4 and R² has the specific meaning given in the corresponding line appropriately selected from the 183 lines R2.001 to R2.0183 of Table T2.

Table 263: This table discloses the 183 specific compounds of the formula A4 wherein R¹ is Nitro, R³ is as defined in line 11 of Table T4 and R² has the specific meaning given in the corresponding line appropriately selected from the 183 lines R2.001 to R2.0183 of Table T2.

Table 264: This table discloses the 183 specific compounds of the formula A4 wherein R¹ is Nitro, R³ is as defined in line 12 of Table T4 and R² has the specific meaning given in the corresponding line appropriately selected from the 183 lines R2.001 to R2.0183 of Table T2.

Table 265: This table discloses the 183 specific compounds of the formula A4 wherein R¹ is CN, R³ is as defined in line 1 of Table T4 and R² has the specific meaning given in the corresponding line appropriately selected from the 183 lines R2.001 to R2.0183 of Table T2.

Table 266: This table discloses the 183 specific compounds of the formula A4 wherein R¹ is CN, R³ is as defined in line 2 of Table T4 and R² has the specific meaning given in the corresponding line appropriately selected from the 183 lines R2.001 to R2.0183 of Table T2.

Table 267: This table discloses the 183 specific compounds of the formula A4 wherein R¹ is CN, R³ is as defined in line 3 of Table T4 and R² has the specific meaning given in the corresponding line appropriately selected from the 183 lines R2.001 to R2.0183 of Table T2.

Table 268: This table discloses the 183 specific compounds of the formula A4 wherein R¹ is CN, R³ is as defined in line 4 of Table T4 and R² has the specific meaning given in the corresponding line appropriately selected from the 183 lines R2.001 to R2.0183 of Table T2.

Table 269: This table discloses the 183 specific compounds of the formula A4 wherein R¹ is CN, R³ is as defined in line 5 of Table T4 and R² has the specific meaning given in the corresponding line appropriately selected from the 183 lines R2.001 to R2.0183 of Table T2.

Table 270: This table discloses the 183 specific compounds of the formula A4 wherein R¹ is CN, R³ is as defined in line 6 of Table T4 and R² has the specific meaning given in the corresponding line appropriately selected from the 183 lines R2.001 to R2.0183 of Table T2.

Table 271: This table discloses the 183 specific compounds of the formula A4 wherein R¹ is CN, R³ is as defined in line 7 of Table T4 and R² has the specific meaning given in the corresponding line appropriately selected from the 183 lines R2.001 to R2.0183 of Table T2.

Table 272: This table discloses the 183 specific compounds of the formula A4 wherein R¹ is CN, R³ is as defined in line 8 of Table T4 and R² has the specific meaning given in the corresponding line appropriately selected from the 183 lines R2.001 to R2.0183 of Table T2.

Table 273: This table discloses the 183 specific compounds of the formula A4 wherein R¹ is CN, R³ is as defined in line 9 of Table T4 and R² has the specific meaning given in the corresponding line appropriately selected from the 183 lines R2.001 to R2.0183 of Table T2.

Table 274: This table discloses the 183 specific compounds of the formula A4 wherein R¹ is CN, R³ is as defined in line 10 of Table T4 and R² has the specific meaning given in the corresponding line appropriately selected from the 183 lines R2.001 to R2.0183 of Table T2.

Table 275: This table discloses the 183 specific compounds of the formula A4 wherein R¹ is CN, R³ is as defined in line 11 of Table T4 and R² has the specific meaning given in the corresponding line appropriately selected from the 183 lines R2.001 to R2.0183 of Table T2.

Table 276: This table discloses the 183 specific compounds of the formula A4 wherein R¹ is CN, R³ is as defined in line 12 of Table T4 and R² has the specific meaning given in the corresponding line appropriately selected from the 183 lines R2.001 to R2.0183 of Table T2.

Table 277: This table discloses the 183 specific compounds of the formula A4 wherein R¹ is OMe, R³ is as defined in line 1 of Table T4 and R² has the specific meaning given in the corresponding line appropriately selected from the 183 lines R2.001 to R2.0183 of Table T2.

Table 278: This table discloses the 183 specific compounds of the formula A4 wherein R¹ is OMe, R³ is as defined in line 2 of Table T4 and R² has the specific meaning given in the corresponding line appropriately selected from the 183 lines R2.001 to R2.0183 of Table T2.

Table 279: This table discloses the 183 specific compounds of the formula A4 wherein R¹ is OMe, R³ is as defined in line 3 of Table T4 and R² has the specific meaning given in the corresponding line appropriately selected from the 183 lines R2.001 to R2.0183 of Table T2.

Table 280: This table discloses the 183 specific compounds of the formula A4 wherein R¹ is OMe, R³ is as defined in line 4 of Table T4 and R² has the specific meaning given in the corresponding line appropriately selected from the 183 lines R2.001 to R2.0183 of Table T2.

Table 281: This table discloses the 183 specific compounds of the formula A4 wherein R¹ is OMe, R³ is as defined in line 5 of Table T4 and R² has the specific meaning given in the corresponding line appropriately selected from the 183 lines R2.001 to R2.0183 of Table T2.

Table 282: This table discloses the 183 specific compounds of the formula A4 wherein R¹ is OMe, R³ is as defined in line 6 of Table T4 and R² has the specific meaning given in the corresponding line appropriately selected from the 183 lines R2.001 to R2.0183 of Table T2.

Table 283: This table discloses the 183 specific compounds of the formula A4 wherein R¹ is OMe, R³ is as defined in line 7 of Table T4 and R² has the specific meaning given in the corresponding line appropriately selected from the 183 lines R2.001 to R2.0183 of Table T2.

Table 284: This table discloses the 183 specific compounds of the formula A4 wherein R¹ is OMe, R³ is as defined in line 8 of Table T4 and R² has the specific meaning given in the corresponding line appropriately selected from the 183 lines R2.001 to R2.0183 of Table T2.

Table 285: This table discloses the 183 specific compounds of the formula A4 wherein R¹ is OMe, R³ is as defined in line 9 of Table T4 and R² has the specific meaning given in the corresponding line appropriately selected from the 183 lines R2.001 to R2.0183 of Table T2.

Table 286: This table discloses the 183 specific compounds of the formula A4 wherein R¹ is OMe, R³ is as defined in line 10 of Table T4 and R² has the specific meaning given in the corresponding line appropriately selected from the 183 lines R2.001 to R2.0183 of Table T2.

Table 287: This table discloses the 183 specific compounds of the formula A4 wherein R¹ is OMe, R³ is as defined in line 11 of Table T4 and R² has the specific meaning given in the corresponding line appropriately selected from the 183 lines R2.001 to R2.0183 of Table T2.

Table 288: This table discloses the 183 specific compounds of the formula A4 wherein R¹ is OMe, R³ is as defined in line 12 of Table T4 and R² has the specific meaning given in the corresponding line appropriately selected from the 183 lines R2.001 to R2.0183 of Table T2.

Table 289: This table discloses the 183 specific compounds of the formula A4 wherein R¹ is H, R³ is as defined in line 1 of Table T4 and R² has the specific meaning given in the corresponding line appropriately selected from the 183 lines R2.001 to R2.0183 of Table T2.

Table 290: This table discloses the 183 specific compounds of the formula A4 wherein R¹ is H, R³ is as defined in line 2 of Table T4 and R² has the specific meaning given in the corresponding line appropriately selected from the 183 lines R2.001 to R2.0183 of Table T2.

Table 291: This table discloses the 183 specific compounds of the formula A4 wherein R¹ is H, R³ is as defined in line 3 of Table T4 and R² has the specific meaning given in the corresponding line appropriately selected from the 183 lines R2.001 to R2.0183 of Table T2.

Table 292: This table discloses the 183 specific compounds of the formula A4 wherein R¹ is H, R³ is as defined in line 4 of Table T4 and R² has the specific meaning given in the corresponding line appropriately selected from the 183 lines R2.001 to R2.0183 of Table T2.

Table 293: This table discloses the 183 specific compounds of the formula A4 wherein R¹ is H, R³ is as defined in line 5 of Table T4 and R² has the specific meaning given in the corresponding line appropriately selected from the 183 lines R2.001 to R2.0183 of Table T2.

Table 294: This table discloses the 183 specific compounds of the formula A4 wherein R¹ is H, R³ is as defined in line 6 of Table T4 and R² has the specific meaning given in the corresponding line appropriately selected from the 183 lines R2.001 to R2.0183 of Table T2.

Table 295: This table discloses the 183 specific compounds of the formula A4 wherein R¹ is H, R³ is as defined in line 7 of Table T4 and R² has the specific meaning given in the corresponding line appropriately selected from the 183 lines R2.001 to R2.0183 of Table T2.

Table 296: This table discloses the 183 specific compounds of the formula A4 wherein R¹ is H, R³ is as defined in line 8 of Table T4 and R² has the specific meaning given in the corresponding line appropriately selected from the 183 lines R2.001 to R2.0183 of Table T2.

Table 297: This table discloses the 183 specific compounds of the formula A4 wherein R¹ is H, R³ is as defined in line 9 of Table T4 and R² has the specific meaning given in the corresponding line appropriately selected from the 183 lines R2.001 to R2.0183 of Table T2.

Table 298: This table discloses the 183 specific compounds of the formula A4 wherein R¹ is H, R³ is as defined in line 10 of Table T4 and R² has the specific meaning given in the corresponding line appropriately selected from the 183 lines R2.001 to R2.0183 of Table T2.

Table 299: This table discloses the 183 specific compounds of the formula A4 wherein R¹ is H, R³ is as defined in line 11 of Table T4 and R² has the specific meaning given in the corresponding line appropriately selected from the 183 lines R2.001 to R2.0183 of Table T2.

Table 300: This table discloses the 183 specific compounds of the formula A4 wherein R¹ is H, R³ is as defined in line 12 of Table T4 and R² has the specific meaning given in the corresponding line

Table of selected examples: Table T1

| Cpd. | | | | | C═N | MS | Rt | | M.P | |
|---|---|---|---|---|---|---|---|---|---|---|
| No. | A | R¹ | R² | R³ | Geometry | [M + H]⁺ | (min) | LCMSmethod | (° C.) | 1H-NMR data: ppm (multiplicity/number of Hs) |
| 1 | A1 | Cl | R2.007 | H | E or Z | 348.94 | 1.34 | M1 | | |
| 2 | A1 | Cl | R2.008 | H | E or Z | 359.96 | 1.22 | M1 | | |
| 3 | A1 | Cl | R2.009 | H | E or Z | 365.98 | 1.48 | M1 | | |
| 4 | A1 | Cl | R2.010 | H | E or Z | 329.96 | 1.26 | M1 | | |
| 5 | A1 | Cl | R2.011 | H | E or Z | 315.93 | 0.89 | M1 | | |
| 6 | A1 | Cl | R2.012 | H | E or Z | 382.87 | 1.35 | M1 | | |
| 7 | A1 | Cl | R2.013 | H | E or Z | 321.93 | 1.48 | M1 | | |
| 8 | A1 | Cl | R2.014 | H | E or Z | 359.97 | 1.1 | M1 | | |
| 9 | A1 | Cl | R2.015 | H | E or Z | 354.9 | 1.87 | M1 | | |
| 10 | A1 | Cl | R2.016 | H | E or Z | 300.98 | 1.6 | M1 | | |
| 11 | A1 | Cl | R2.017 | H | E or Z | 322.98 | 1.61 | M1 | | |
| 12 | A1 | Cl | R2.018 | H | E or Z | 327.94 | 1.29 | M1 | | |
| 13 | A1 | Cl | R2.019 | H | E or Z | 282.96 | 1.07 | M1 | | |
| 14 | A1 | Cl | R2.020 | H | E or Z | 350.94 | 1.24 | M1 | | |
| 15 | A1 | Cl | R2.021 | H | E or Z | 281.95 | 0.79 | M1 | | |
| 16 | A1 | Cl | R2.022 | H | E or Z | 344.96 | 1.22 | M1 | | |
| 17 | A1 | Cl | R2.023 | H | E or Z | 322.94 | 1.61 | M1 | | |
| 18 | A1 | Cl | R2.024 | H | E or Z | 321.9 | 1.64 | M1 | | |
| 19 | A1 | Cl | R2.025 | H | E or Z | 349.93 | 1.14 | M1 | | |
| 20 | A1 | Cl | R2.026 | H | E or Z | 354.9 | 1.82 | M1 | | |
| 21 | A1 | Cl | R2.027 | H | E or Z | 323.92 | 1.13 | M1 | | |
| 22 | A1 | Cl | R2.028 | H | E or Z | 278.96 | 1 | M1 | | |
| 23 | A1 | Cl | R2.029 | H | E or Z | 372.96 | 1.72 | M1 | | |
| 24 | A1 | Cl | R2.030 | H | E or Z | 321.91 | 1.18 | M1 | | |
| 25 | A1 | Cl | R2.031 | H | E or Z | 252.99 | 1.24 | M1 | | |
| 26 | A1 | Cl | R2.032 | H | E or Z | 383.87 | 1.37 | M1 | | |
| 27 | A1 | Cl | R2.033 | H | E or Z | 422.87 | 1.93 | M1 | | |
| 28 | A1 | Cl | R2.034 | H | E or Z | 389.91 | 1.58 | M1 | | |
| 29 | A1 | Cl | R2.035 | H | E or Z | 421.9 | 1.46 | M1 | | |
| 30 | A1 | Cl | R2.036 | H | E or Z | 320.91 | 1.63 | M1 | | |
| 31 | A1 | Cl | R2.037 | H | E or Z | 332.1 | 1.53 | M1 | | |
| 32 | A1 | Cl | R2.038 | H | E or Z | 354.97 | 1.7 | M1 | | |
| 33 | A1 | Cl | R2.039 | H | E or Z | 354.9 | 1.67 | M1 | | |
| 34 | A1 | Cl | R2.040 | H | E or Z | 386.95 | 1.15 | M1 | | |
| 35 | A1 | Cl | R2.003 | H | E or Z | 345 | 1.83-1.89 | M2 | | 1H NMR (400 MHz, DMSO-d6) δ ppm 5.02 (s, 2 H) |
| | | | | | | | | | | 5.11 (s, 1 H) 7.19-7.26 (m, 1 H) 7.33-7.43 |
| | | | | | | | | | | (m, 2 H) 7.50-7.65 (m, 3 H) 8.60-8.70 |
| | | | | | | | | | | (m, 2 H) 9.32 (s, 1 H) 10.18 (s, 1 H) 10.32 (s, 1 H) |
| | | | | | | | | | | 11.94-12.07 (m, 1 H) |
| 36 | A1 | Cl | R2.055 | H | E or Z | 310 | 1.71-1.73 | M2 | | 1H NMR (400 MHz, DMSO-d6) δ ppm 4.10 |
| | | | | | | | | | | (d, J = 5.27 Hz, 1 H) 5.01 (s, 2 H) 5.05-5.22 |
| | | | | | | | | | | (m, 2 H) 5.83-6.00 (m, 1 H) 7.58 (s, 1 H) 8.49 |
| | | | | | | | | | | (s, 1 H) 8.54-8.57 (m, 1 H) 8.72 (t, J = 5.90 Hz, 1 H) |
| | | | | | | | | | | 9.35 (s, 1 H) 11.71 (s, 1 H) |
| 37 | A1 | Cl | R2.041 | H | E or Z | 373.99 | 1.51 | M1 | | |
| 38 | A1 | Cl | R2.042 | H | E or Z | 352 | 1.53 | M1 | | |
| 39 | A1 | Cl | R2.054 | H | E | 285.92 | 1.58 | M1 | | |
| 40 | A1 | Cl | R2.180 | H | E or Z | 302.02 | 1.67 | M1 | | |
| 41 | A1 | Cl | R2.056 | H | E or Z | 268.06 | 1.7 | M1 | | |
| 42 | A1 | Cl | R2.057 | H | E or Z | 295.97 | 1.49 | M1 | | |
| 43 | A1 | Cl | R2.058 | H | E or Z | 335.92 | 1.8 | M1 | | |
| 44 | A1 | Cl | R2.059 | H | E or Z | 319.98 | 1.68 | M1 | | |
| 45 | A1 | Cl | R2.060 | H | E or Z | 346.98 | 1.64 | M1 | | |
| 46 | A1 | Cl | R2.061 | H | E or Z | 296 | 1.97 | M1 | | |
| 47 | A1 | Cl | R2.062 | H | E or Z | 268.02 | 1.72 | M1 | | |
| 48 | A1 | Cl | R2.063 | H | E or Z | 286 | 1.57 | M1 | | |
| 49 | A1 | Cl | R2.064 | H | E | 299.94 | 1.7 | M1 | | |
| 50 | A1 | Cl | R2.065 | H | E or Z | 319.73 | 1.75 | M1 | | |
| 51 | A1 | Cl | R2.066 | H | E or Z | 280.07 | 1.7 | M1 | | |
| 52 | A1 | Cl | R2.067 | H | E or Z | 311.98 | 1.46 | M1 | | |
| 53 | A1 | Cl | R2.068 | H | E or Z | 369.89 | 1.86 | M1 | | |
| 54 | A1 | Cl | R2.069 | H | E or Z | 374.01 | 1.66 | M1 | | |
| 55 | A1 | Cl | R2.070 | H | E or Z | 391.79 | 1.83 | M1 | | |
| 56 | A1 | Cl | R2.071 | H | E or Z | 254.01 | 1.56 | M1 | | |
| 57 | A1 | Cl | R2.072 | H | E or Z | 240.01 | 1.41 | M1 | | |
| 58 | A1 | Cl | R2.073 | H | E or Z | 252.01 | 1.47 | M1 | | |
| 59 | A1 | Cl | R2.075 | H | E or Z | 373.98 | 1.38 | M1 | | |
| 60 | A1 | Cl | R2.074 | H | E or Z | 359.96 | 1.6 | M1 | | |
| 61 | A1 | Cl | R2.076 | H | E or Z | 254.03 | 1.58 | M1 | | |
| 62 | A1 | Cl | R2.077 | H | E or Z | 297.95 | 1.16 | M1 | | |
| 63 | A1 | Cl | R2.078 | H | E or Z | 312.99 | 1.62 | M1 | | |
| 64 | A1 | Cl | R2.079 | H | E or Z | 369.98 | 1.97 | M1 | | |
| 65 | A1 | Cl | R2.080 | H | E or Z | 316 | 1.78 | M1 | | |
| 66 | A1 | Cl | R2.081 | H | E or Z | 353.87 | 1.83 | M1 | | |
| 67 | A1 | Cl | R2.082 | H | E or Z | 383.85 | 2.06 | M1 | | |
| 68 | A1 | Cl | R2.083 | H | E or Z | 384.25 | 2.02 | M1 | | |
| 69 | A1 | Cl | R2.084 | H | Z | 372.18 | 1.97 | M1 | | |
| 70 | A1 | Cl | R2.006 | H | E or Z | 297 | 1.66-1.69 | M2 | | 1H NMR (400 MHz, DMSO-d6) δ ppm 1.20 |
| | | | | | | | | | | (t, J = 7.03 Hz, 4 H) 4.02 (d, J = 5.27 Hz, 2 H) |
| | | | | | | | | | | 4.96 (s, 2 H) 7.49 (s, 1 H) 7.99 (s, 1 H) 7.99-8.02 |
| | | | | | | | | | | (m, 1 H) 8.19 (s, 1 H) 9.33 (s, 1 H) |
| 71 | A1 | Cl | R2.181 | H | E or Z | 225.9 | 1.72-1.79 | M2 | | 1H NMR (400 MHz, DMSO-d6) δ ppm 3.95 |
| | | | | | | | | | | (s, 3 H) 5.01 (s, 2 H) 7.62 (s, 1 H) 8.24 (s, 1 H) |
| | | | | | | | | | | 8.48 (s, 1 H) 9.42 (s, 1 H) |
| 72 | A1 | Cl | R2.053 | H | E or Z | 284 | 1.56-1.58 | M2 | | 1H NMR (400 MHz, DMSO-d6) δ ppm 3.03 |
| | | | | | | | | | | (d, J = 4.52 Hz, 3 H) 5.01 (s, 2 H) 7.58 (s, 1 H) |
| | | | | | | | | | | 8.47-8.59 (m, 3 H) 9.33 (s, 1 H) 11.67 (s, 1 H) |
| 73 | A1 | Cl | R2.004 | H | E or Z | 360 | 1.88-1.91 | M2 | | 1H NMR (400 MHz, DMSO-d6) δ ppm 4.86 |
| | | | | | | | | | | (d, J = 6.02 Hz, 2 H) 5.01 (s, 2 H) 7.22-7.37 |
| | | | | | | | | | | (m, 5 H) 7.58 (s, 1 H) 8.49 (s, 1 H) 8.59 (s, 1 H) |
| | | | | | | | | | | 9.15 (t, J = 6.18 Hz, 1 H) 9.32 (s, 1 H) |
| | | | | | | | | | | 11.78 (s, 1 H) |
| 74 | A1 | Cl | R2.093 | H | E or Z | 211.9 | 1.44-1.49 | M2 | | 1H NMR (400 MHz, DMSO-d6) δ ppm 5.00 |
| | | | | | | | | | | (s, 2 H) 7.60 (s, 1 H) 8.22 (s, 1 H) 8.41 (s, 1 H) |
| | | | | | | | | | | 9.42 (s, 1 H) 11.63 (s, 1 H) |
| 75 | A1 | Cl | R2.005 | H | E or Z | 308 | 1.47-1.49 | M2 | | 1H NMR (400 MHz, DMSO-d6) δ ppm) 5.02 |
| | | | | | | | | | | (s, 3 H) 6.60 (s, 2 H) 7.61 (s, 1 H) 8.35 |
| | | | | | | | | | | (s, 1 H) 8.61 (s, 1 H) |
| 76 | A1 | Cl | R2.052 | H | E or Z | 270 | 1.41-1.43 | M2 | | 1H NMR (400 MHz, DMSO-d6) δ ppm 5.01 (s, |
| | | | | | | | | | | 2 H) 7.57 (s, 1 H) 7.95 (br. s., 1 H) 8.34 (br. s., 1 H) |
| | | | | | | | | | | 8.49 (s, 1 H) 8.53 (s, 1 H) 9.29 (s, 1 H) 11.64 (s, 1 H) |
| 77 | A1 | F | R2.007 | H | E or Z | 332.95 | 1.23 | M1 | | |
| 78 | A1 | F | R2.008 | H | E or Z | 343.96 | 1.12 | M1 | | |
| 79 | A1 | F | R2.009 | H | E or Z | 349.97 | 1.37 | M1 | | |
| 80 | A1 | F | R2.010 | H | E or Z | 314.02 | 1.17 | M1 | | |
| 81 | A1 | F | R2.011 | H | E or Z | 299.94 | 0.78 | M1 | | |
| 82 | A1 | F | R2.043 | H | E or Z | 397 | 1.83 | M1 | | |
| 83 | A1 | F | R2.012 | H | E or Z | 366.9 | 1.25 | M1 | | |
| 84 | A1 | F | R2.044 | H | E or Z | 411 | 1.81 | M1 | | |
| 85 | A1 | F | R2.013 | H | E or Z | 305.95 | 1.38 | M1 | | |
| 86 | A1 | F | R2.014 | H | E or Z | 343.97 | 1 | M1 | | |
| 87 | A1 | F | R2.015 | H | E or Z | 338.93 | 1.77 | M1 | | |
| 88 | A1 | F | R2.016 | H | E or Z | 285.02 | 1.5 | M1 | | |
| 89 | A1 | F | R2.017 | H | E or Z | 306.98 | 1.5 | M1 | | |
| 90 | A1 | F | R2.018 | H | E or Z | 311.96 | 1.19 | M1 | | |
| 91 | A1 | F | R2.019 | H | E or Z | 266.98 | 0.94 | M1 | | |
| 92 | A1 | F | R2.020 | H | E or Z | 334.94 | 1.13 | M1 | | |
| 93 | A1 | F | R2.021 | H | E or Z | 266 | 0.68 | M1 | | |
| 94 | A1 | F | R2.045 | H | E or Z | 284.98 | 1.35 | M1 | | |
| 95 | A1 | F | R2.022 | H | E or Z | 328.95 | 1.11 | M1 | | |
| 96 | A1 | F | R2.023 | H | E or Z | 306.97 | 1.51 | M1 | | |
| 97 | A1 | F | R2.024 | H | E or Z | 316.1 | 1.53 | M1 | | |
| 98 | A1 | F | R2.025 | H | E or Z | 333.94 | 1.03 | M1 | | |
| 99 | A1 | F | R2.026 | H | E or Z | 338.96 | 1.74 | M1 | | |
| 100 | A1 | F | R2.027 | H | E or Z | 307.95 | 1.03 | M1 | | |
| 101 | A1 | F | R2.028 | H | E or Z | 262.98 | 0.89 | M1 | | |
| 102 | A1 | F | R2.029 | H | E or Z | 356.97 | 1.63 | M1 | | |
| 103 | A1 | F | R2.030 | H | E or Z | 305.89 | 1.06 | M1 | | |
| 104 | A1 | F | R2.046 | H | E or Z | 280.98 | 1.03 | M1 | | |
| 105 | A1 | F | R2.031 | H | E or Z | 236.99 | 1.05 | M1 | | |
| 106 | A1 | F | R2.032 | H | E or Z | 367.9 | 1.26 | M1 | | |
| 107 | A1 | F | R2.047 | H | E or Z | 301.04 | 1.35 | M1 | | |
| 108 | A1 | F | R2.033 | H | E or Z | 406.89 | 1.83 | M1 | | |
| 109 | A1 | F | R2.048 | H | E or Z | 388.93 | 1.5 | M1 | | |
| 110 | A1 | F | R2.034 | H | E or Z | 373.9 | 1.48 | M1 | | |
| 111 | A1 | F | R2.035 | H | E or Z | 405.94 | 1.36 | M1 | | |
| 112 | A1 | F | R2.036 | H | E or Z | 304.98 | 1.54 | M1 | | |
| 113 | A1 | F | R2.037 | H | E or Z | 315.87 | 1.43 | M1 | | |
| 114 | A1 | F | R2.038 | H | E or Z | 338.98 | 1.61 | M1 | | |
| 115 | A1 | F | R2.039 | H | E or Z | 338.91 | 1.56 | M1 | | |
| 116 | A1 | F | R2.040 | H | E or Z | 370.95 | 1.05 | M1 | | |
| 117 | A1 | F | R2.003 | H | E or Z | 330 | 1.77-1.81 | M2 | | 1H NMR (400 MHz, DMSO-d6) δ ppm 5.02 |
| | | | | | | | | | | (s, 2 H) 7.17-7.27 (m, 1 H) 7.33-7.42 (m, 3 H) 7.57 |
| | | | | | | | | | | (d, J = 7.76 Hz, 2 H) 8.43 (s, 1 H) 8.58 (d, J = 7.53 |
| | | | | | | | | | | Hz, 1 H) 9.25 (s, 1 H) 10.16 (s, 1 H) 11.94 (s, 1 H) |
| 118 | A1 | F | R2.055 | H | E or Z | 293.98 | 1.12 | M1 | | |
| 119 | A1 | F | R2.041 | H | E or Z | 358 | 1.43 | M1 | | |
| 120 | A1 | F | R2.042 | H | E or Z | 336 | 1.44 | M1 | | |
| 121 | A1 | F | R2.056 | H | E or Z | 251.82 | 1.04 | M1 | | |
| 122 | A1 | F | R2.057 | H | E or Z | 280.09 | 1.34 | M1 | | |
| 123 | A1 | F | R2.058 | H | E or Z | 319.96 | 1.68 | M1 | | |
| 124 | A1 | F | R2.059 | H | E or Z | 304.02 | 1.55 | M1 | | |
| 125 | A1 | F | R2.060 | H | E or Z | 331.01 | 1.51 | M1 | | |
| 126 | A1 | F | R2.061 | H | E or Z | 280.09 | 1.84 | M1 | | |
| 127 | A1 | F | R2.062 | H | E or Z | 252.08 | 1.58 | M1 | | |
| 128 | A1 | F | R2.063 | H | E or Z | 269.99 | 1.44 | M1 | | |
| 129 | A1 | F | R2.085 | H | E or Z | 268.07 | 0.98 | M1 | | |
| 130 | A1 | F | R2.064 | H | E | 283.98 | 1.56 | M1 | | |
| 131 | A1 | F | R2.065 | H | E or Z | 303.79 | 1.61 | M1 | | |
| 132 | A1 | F | R2.054 | H | Z | 270.01 | 1.44 | M1 | | |
| 133 | A1 | F | R2.067 | H | E or Z | 296.08 | 1.33 | M1 | | |
| 134 | A1 | F | R2.068 | H | E or Z | 353.98 | 1.74 | M1 | | |
| 135 | A1 | F | R2.069 | H | E or Z | 358.06 | 1.55 | M1 | | |
| 136 | A1 | F | R2.086 | H | E or Z | 252.08 | 1.58 | M1 | | |
| 137 | A1 | F | R2.070 | H | E or Z | 376.02 | 1.72 | M1 | | |
| 138 | A1 | F | R2.071 | H | E or Z | 238.06 | 1.42 | M1 | | |
| 139 | A1 | F | R2.072 | H | E or Z | 224.04 | 1.26 | M1 | | |
| 140 | A1 | F | R2.181 | H | E or Z | 210.03 | 1.09 | M1 | | |
| 141 | A1 | F | R2.073 | H | E or Z | 236.05 | 1.32 | M1 | | |
| 142 | A1 | F | R2.180 | H | E or Z | 286.03 | 1.54 | M1 | | |
| 143 | A1 | F | R2.074 | H | E or Z | 358.06 | 1.49 | M1 | | |
| 144 | A1 | F | R2.076 | H | E or Z | 238.03 | 1.43 | M1 | | |
| 145 | A1 | F | R2.077 | H | E or Z | 282.04 | 1.03 | M1 | | |
| 146 | A1 | F | R2.087 | H | E or Z | 316.94 | 1.57 | M1 | | |
| 147 | A1 | F | R2.078 | H | E or Z | 297.04 | 1.48 | M1 | | |
| 148 | A1 | F | R2.079 | H | E or Z | 354.03 | 1.76 | M1 | | |
| 149 | A1 | F | R2.080 | H | E or Z | 300.05 | 1.66 | M1 | | |
| 150 | A1 | F | R2.081 | H | E or Z | 337.93 | 1.71 | M1 | | |
| 151 | A1 | F | R2.082 | H | E or Z | 367.88 | 1.94 | M1 | | |
| 152 | A1 | F | R2.083 | H | E or Z | 367.98 | 1.9 | M1 | | |
| 153 | A1 | F | R2.084 | H | Z | 355.99 | 1.85 | M1 | | |
| 154 | A1 | F | R2.088 | H | E or Z | 370.03 | 1.48 | M1 | | |
| 155 | A1 | F | R2.053 | H | E or Z | 268 | 1.45-1.48 | M2 | | 1H NMR (400 MHz, DMSO-d6) δ ppm 5.01 |
| | | | | | | | | | | (s, 1 H) 5.10 (s, 1 H) 7.31 (s, 1 H) 7.34 (s, J = 11.52 |
| | | | | | | | | | | Hz, 1 H) 8.30 (d, J = 6.65 Hz, 1 H) 8.31 (s, 1 H) |
| | | | | | | | | | | 8.45 (d, J = 7.53 Hz, 2 H) 9.25 (s, 1 H) 11.59 (d, |
| | | | | | | | | | | J = 4.03 Hz, 1 H) 11.59 (s, 1 H) |
| 156 | A1 | F | R2.052 | H | E or Z | 254 | 1.31-1.33 | M2 | | 1H NMR (400 MHz, DMSO-d6) δ ppm 5.01 |
| | | | | | | | | | | (s, 2 H) 5.09 (s, 1 H) 7.31 (s, 1 H) 7.34 (s, |
| | | | | | | | | | | J = 10.45 Hz, 1 H) 7.93 (br. s., 1 H) 8.22-8.35 |
| | | | | | | | | | | (m, 2 H) 8.45 (d, J = 7.53 Hz, 1 H) 9.21 |
| | | | | | | | | | | (s, 1 H) 11.57 (s, 1 H) |
| 157 | A2 | Cl | R2.007 | H | E or Z | 348.9 | 1.51 | M1 | | |
| 158 | A2 | Cl | R2.009 | H | E or Z | 366 | 1.65 | M1 | | |
| 159 | A2 | Cl | R2.051 | H | E or Z | 371.89 | 1.06 | M1 | | |
| 160 | A2 | Cl | R2.011 | H | E or Z | 315.92 | 1.08 | M1 | | |
| 161 | A2 | Cl | R2.012 | H | E or Z | 382.89 | 1.53 | M1 | | |
| 162 | A2 | Cl | R2.013 | H | E or Z | 321.92 | 1.57 | M1 | | |
| 163 | A2 | Cl | R2.014 | H | E or Z | 359.95 | 1.27 | M1 | | |
| 164 | A2 | Cl | R2.015 | H | E or Z | 354.89 | 2.02 | M1 | | |
| 165 | A2 | Cl | R2.017 | H | E or Z | 322.96 | 1.76 | M1 | | |
| 166 | A2 | Cl | R2.018 | H | E or Z | 328 | 1.48 | M1 | | |
| 167 | A2 | Cl | R2.019 | H | E or Z | 282.97 | 1.26 | M1 | | |
| 168 | A2 | Cl | R2.020 | H | E or Z | 350.95 | 1.42 | M1 | | |
| 169 | A2 | Cl | R2.045 | H | E or Z | 300.96 | 1.56 | M1 | | |
| 170 | A2 | Cl | R2.022 | H | E or Z | 344.97 | 1.39 | M1 | | |
| 171 | A2 | Cl | R2.023 | H | E or Z | 322.97 | 1.77 | M1 | | |
| 172 | A2 | Cl | R2.024 | H | E or Z | 332 | 1.81 | M1 | | |
| 173 | A2 | Cl | R2.026 | H | E or Z | 354.9 | 2.03 | M1 | | |
| 174 | A2 | Cl | R2.028 | H | E or Z | 278.99 | 1.15 | M1 | | |
| 175 | A2 | Cl | R2.029 | H | E or Z | 372.96 | 1.9 | M1 | | |
| 176 | A2 | Cl | R2.030 | H | E or Z | 321.88 | 1.42 | M1 | | |
| 177 | A2 | Cl | R2.046 | H | E or Z | 296.96 | 1.28 | M1 | | |
| 178 | A2 | Cl | R2.031 | H | E or Z | 252.97 | 1.47 | M1 | | |
| 179 | A2 | Cl | R2.047 | H | E or Z | 316.96 | 1.42 | M1 | | |
| 180 | A2 | Cl | R2.033 | H | E or Z | 422.87 | 1.84 | M1 | | |
| 181 | A2 | Cl | R2.034 | H | E or Z | 389.91 | 1.81 | M1 | | |
| 182 | A2 | Cl | R2.035 | H | E or Z | 421.89 | 1.63 | M1 | | |
| 183 | A2 | Cl | R2.036 | H | E or Z | 320.9 | 1.83 | M1 | | |
| 184 | A2 | Cl | R2.037 | H | E or Z | 332 | 1 | M1 | | |
| 185 | A2 | Cl | R2.038 | H | E or Z | 354.96 | 1.89 | M1 | | |
| 186 | A2 | Cl | R2.003 | H | E or Z | 345.9 | 1.97-2.01 | M2 | | 1H NMR (400 MHz, DMSO-d6) δ ppm 5.03 |
| | | | | | | | | | | (s, 2 H) 7.14-7.30 (m, 1 H) 7.32-7.44 (m, 2 H) |
| | | | | | | | | | | 7.47-7.61 (m, 3 H) 8.29 (s, 1 H) 8.54 (s, 1 H) |
| | | | | | | | | | | 9.42 (s, 1 H) 10.35 (s, 1 H) 12.03 (s, 1 H) |
| 187 | A2 | Cl | R2.055 | H | E or Z | 309.97 | 1.38 | M1 | | |
| 188 | A2 | Cl | R2.041 | H | E or Z | 373.99 | 1.66 | M1 | | |
| 189 | A2 | Cl | R2.054 | H | E | 285.95 | 1.71 | M1 | | |
| 190 | A2 | Cl | R2.180 | H | E or Z | 302.01 | 1.8 | M1 | | |
| 191 | A2 | Cl | R2.056 | H | E or Z | 268.04 | 1.85 | M1 | | |
| 192 | A2 | Cl | R2.058 | H | E or Z | 336 | 1.93 | M1 | | |
| 193 | A2 | Cl | R2.059 | H | E or Z | 319.97 | 1.81 | M1 | | |
| 194 | A2 | Cl | R2.060 | H | E or Z | 347.05 | 1.74 | M1 | | |
| 195 | A2 | Cl | R2.061 | H | E or Z | 296.03 | 2.13 | M1 | | |
| 196 | A2 | Cl | R2.062 | H | E or Z | 268.02 | 1.88 | M1 | | |
| 197 | A2 | Cl | R2.063 | H | E or Z | 285.96 | 1.69 | M1 | | |
| 198 | A2 | Cl | R2.064 | H | E | 299.97 | 1.84 | M1 | | |
| 199 | A2 | Cl | R2.065 | H | E or Z | 319.49 | 1.65 | M1 | | |
| 200 | A2 | Cl | R2.066 | H | E or Z | 280.01 | 1.87 | M1 | | |
| 201 | A2 | Cl | R2.067 | H | E or Z | 312 | 1.61 | M1 | | |
| 202 | A2 | Cl | R2.068 | H | E or Z | 369.88 | 2 | M1 | | |
| 203 | A2 | Cl | R2.069 | H | E or Z | 374.01 | 1.79 | M1 | | |
| 204 | A2 | Cl | R2.086 | H | E or Z | 268.04 | 1.88 | M1 | | |
| 205 | A2 | Cl | R2.070 | H | E or Z | 392.08 | 1.93 | M1 | | |
| 206 | A2 | Cl | R2.071 | H | E or Z | 254.04 | 1.73 | M1 | | |
| 207 | A2 | Cl | R2.072 | H | E or Z | 240.02 | 1.59 | M1 | | |
| 208 | A2 | Cl | R2.181 | H | E or Z | 225.99 | 1.43 | M1 | | |
| 209 | A2 | Cl | R2.073 | H | E or Z | 252.01 | 1.62 | M1 | | |
| 210 | A2 | Cl | R2.075 | H | E or Z | 374.02 | 1.73 | M1 | | |
| 211 | A2 | Cl | R2.076 | H | E or Z | 254.04 | 1.74 | M1 | | |
| 212 | A2 | Cl | R2.077 | H | E or Z | 298.05 | 1.28 | M1 | | |
| 213 | A2 | Cl | R2.078 | H | E or Z | 312.89 | 1.69 | M1 | | |
| 214 | A2 | Cl | R2.079 | H | E or Z | 369.96 | 2.08 | M1 | | |
| 215 | A2 | Cl | R2.080 | H | E or Z | 315.99 | 1.92 | M1 | | |
| 216 | A2 | Cl | R2.082 | H | E or Z | 383.86 | 2.15 | M1 | | |
| 217 | A2 | Cl | R2.083 | H | E or Z | 383.95 | 2.12 | M1 | | |
| 218 | A2 | Cl | R2.084 | H | Z | 372.02 | 2.08 | M1 | | |
| 219 | A2 | Cl | R2.088 | H | E or Z | 386.01 | 1.73 | M1 | | |
| 220 | A2 | Cl | R2.092 | H | E or Z | 414 | 1.93 | M1 | | |
| 221 | A2 | Cl | R2.050 | H | E or Z | 364.9 | 1.95-2.0 | M2 | | 1H NMR (400 MHz, DMSO-d6) δ ppm 2.36 (s, 3 H) |
| | | | | | | | | | | 5.01 (s, 2 H) 7.42 (d, J = 8.03 Hz, 2 H) 7.54 |
| | | | | | | | | | | (s, 1 H) 7.60 (d, J = 1.51 Hz, 1 H) 7.75 (d, J = 7.80 |
| | | | | | | | | | | Hz, 2 H) 8.20 (s, 1 H) 9.01 (s, 1 H) 11.90 (s, 1 H) |
| 222 | A2 | Cl | R2.093 | H | E or Z | 211.8 | 1.39-1.44 | M2 | | 1H NMR (400 MHz, DMSO-d6) δ ppm 4.92 |
| | | | | | | | | | | (s, 3 H) 5.02-5.06 (m, 2 H) 7.54-7.67 (m, 4 H) 7.75 |
| | | | | | | | | | | (d, J = 2.01 Hz, 1 H) 7.84 (s, 1 H) 8.41 (s, 1 H) |
| | | | | | | | | | | 8.56 (s, 1 H) 8.63 (s, 1 H) 9.21 (s, 1 H) 9.52 (br. s., |
| | | | | | | | | | | 1 H) 11.77 (s, 1 H) |
| 223 | A2 | Cl | R2.004 | H | E or Z | 359.9 | 2.01-2.05 | M2 | | 1H NMR (400 MHz, DMSO-d6) δ ppm 4.86 (d, |
| | | | | | | | | | | J = 6.27 Hz, 2 H) 5.01 (s, 2 H) 7.25 (d, J = 6.27 Hz, |
| | | | | | | | | | | 1 H) 7.31-7.37 (m, 4 H) 7.49 (s, 1 H) 8.19 (d, |
| | | | | | | | | | | J = 1.25 Hz, 1 H) 8.50 (s, 1 H) 9.33 (t, |
| | | | | | | | | | | J = 6.13 Hz, 1 H) 9.39 (s, 1 H) 11.81 |
| | | | | | | | | | | (s, 1 H) |
| 224 | A2 | Cl | R2.053 | H | E or Z | 283.9 | 1.71-1.74 | M2 | | 1H NMR (400 MHz, DMSO-d6) δ ppm 3.03 |
| | | | | | | | | | | (d, J = 4.52 Hz, 3 H) 5.01 (s, 2 H) 7.48 (s, 1 H) 8.19 |
| | | | | | | | | | | (d, J = 1.26 Hz, 1 H) 8.45 (s, 1 H) 8.74 (d, J = 4.52 |
| | | | | | | | | | | Hz, 1 H) 9.36 (s, 1 H) 11.69 (s, 1 H) |
| 225 | A2 | Cl | R2.052 | H | E or Z | 270 | 1.5-1.57 | M2 | | 1H NMR (400 MHz, DMSO-d6) δ ppm 5.00 |
| | | | | | | | | | | (s, 2 H) 7.48 (s, 1 H) 8.24 (br. s., 3 H) 8.45 (s, 1 H) |
| | | | | | | | | | | 9.33 (s, 1 H) 11.62 (s, 1 H) |
| 226 | A2 | Cl | R2.005 | H | E or Z | 307.9 | 1.80-1.82 | M2 | | 1H NMR (400 MHz, DMSO-d) δ ppm 3.17 |
| | | | | | | | | | | (s, 3 H) 5.02 (s, 2 H) 7.47 (d, J = 1.51 Hz, 1 H) 7.72 |
| | | | | | | | | | | (s, 1 H) 8.38 (s, 1 H) 9.34 (s, 1 H) 12.09 |
| | | | | | | | | | | (d, J = 15.81 Hz, 1 H) |
| 227 | A2 | Cl | R2.049 | H | E or Z | 297.9 | 1.80-1.85 | M2 | | 1H NMR (400 MHz, DMSO-d6) δ ppm 1.16 |
| | | | | | | | | | | (t, J = 7.03 Hz, 3H) 3.56-3.65 (m, 2 H) 5.01 (s, 2 H) |
| | | | | | | | | | | 7.49 (d, J = 1.76 Hz, 1 H) 8.15 (d, |
| | | | | | | | | | | J = 1.51 Hz, 1 H) 8.43 (s, 1 H) 8.81 (t, J = 6.08 |
| | | | | | | | | | | Hz, 1 H) 9.37 (s, 1 H) 11.62 (s, 1 H) |
| 228 | A2 | Cl | R2.006 | H | E or Z | 297 | 1.77-1.81 | M2 | | 1H NMR (400 MHz, DMSO-d6) δ ppm 1.21 |
| | | | | | | | | | | (t, J = 7.03 Hz, 1 H) 4.13 (q, J = 7.03 Hz, 1 H) |
| | | | | | | | | | | 4.60-4.67 (m, 1 H) 4.89 (d, J = 4.27 Hz, 1 H) |
| | | | | | | | | | | 6.43 (br. s., 1 H) 7.68 (d, J = 2.01 Hz, 1 H) |
| | | | | | | | | | | 7.80 (d, J = 2.01 Hz, 1 H) 8.01 (s, 1 H) |
| | | | | | | | | | | 8.90-9.00 (m, 1 H) |
| 229 | A2 | Cl | R2.094 | H | E or Z | 210 | 1.52-1.54 | M2 | | 1H NMR (400 MHz, DMSO-d6) δ ppm 4.94 |
| | | | | | | | | | | (s, 2 H) 5.50-6.22 (m, 1 H) 7.67 (s, 1 H) 7.73 |
| | | | | | | | | | | (d, J = 2.01 Hz, 1 H) 7.99 (s, 1 H) 8.26 (s, 1 |
| | | | | | | | | | | H) 9.76 (s, 1 H) |
| 230 | A2 | F | R2.007 | H | E or Z | 332.95 | 1.39 | M1 | | |
| 231 | A2 | F | R2.009 | H | E or Z | 350 | 1.53 | M1 | | |
| 232 | A2 | F | R2.010 | H | E or Z | 314.02 | 1.27 | M1 | | |
| 233 | A2 | F | R2.051 | H | E or Z | 355.94 | 1.02 | M1 | | |
| 234 | A2 | F | R2.011 | H | E or Z | 299.94 | 0.94 | M1 | | |
| 235 | A2 | F | R2.043 | H | E or Z | 397 | 1.98 | M1 | | |
| 236 | A2 | F | R2.012 | H | E or Z | 366.9 | 1.4 | M1 | | |
| 237 | A2 | F | R2.044 | H | E or Z | 411.01 | 1.95 | M1 | | |
| 238 | A2 | F | R2.013 | H | E or Z | 305.95 | 1.44 | M1 | | |
| 239 | A2 | F | R2.014 | H | E or Z | 343.97 | 1.14 | M1 | | |
| 240 | A2 | F | R2.015 | H | E or Z | 338.9 | 1.9 | M1 | | |
| 241 | A2 | F | R2.016 | H | E or Z | 285.05 | 1.65 | M1 | | |
| 242 | A2 | F | R2.018 | H | E or Z | 311.94 | 1.35 | M1 | | |
| 243 | A2 | F | R2.019 | H | E or Z | 267.02 | 1.12 | M1 | | |
| 244 | A2 | F | R2.017 | H | E or Z | 306.99 | 1.63 | M1 | | |
| 245 | A2 | F | R2.020 | H | E or Z | 334.97 | 1.29 | M1 | | |
| 246 | A2 | F | R2.045 | H | E or Z | 284.97 | 1.42 | M1 | | |
| 247 | A2 | F | R2.022 | H | E or Z | 329.03 | 1.26 | M1 | | |
| 248 | A2 | F | R2.023 | H | E or Z | 306.99 | 1.65 | M1 | | |
| 249 | A2 | F | R2.024 | H | E or Z | 315.98 | 1.68 | M1 | | |
| 250 | A2 | F | R2.025 | H | E or Z | 333.96 | 1.19 | M1 | | |
| 251 | A2 | F | R2.026 | H | E or Z | 338.9 | 1.92 | M1 | | |
| 252 | A2 | F | R2.027 | H | E or Z | 307.97 | 1.13 | M1 | | |
| 253 | A2 | F | R2.028 | H | E or Z | 263.01 | 1.01 | M1 | | |
| 254 | A2 | F | R2.029 | H | E or Z | 356.96 | 1.79 | M1 | | |
| 255 | A2 | F | R2.030 | H | E or Z | 305.93 | 1.28 | M1 | | |
| 256 | A2 | F | R2.006 | H | E or Z | 281 | 1.65-1.68 | M2 | | 1H NMR (400 MHz, DMSO-d6) δ ppm 1.21 |
| | | | | | | | | | | (t, J = 7.03 Hz, 3 H) 4.14 (q, J = 7.19 Hz, 2 H) 4.63 |
| | | | | | | | | | | (s, 2 H) 4.90 (s, 2 H) 7.49 (s, 1 H) 7.51-7.52 (m, 1 H) |
| | | | | | | | | | | 8.00 (s, 1 H) 8.88 (s, 1 H) |
| 257 | A2 | F | R2.031 | H | E or Z | 236.98 | 1.31 | M1 | | |
| 258 | A2 | F | R2.047 | H | E or Z | 301.04 | 1.51 | M1 | | |
| 259 | A2 | F | R2.033 | H | E or Z | 406.87 | 1.91 | M1 | | |
| 260 | A2 | F | R2.034 | H | E or Z | 373.91 | 1.69 | M1 | | |
| 261 | A2 | F | R2.035 | H | E or Z | 405.94 | 1.51 | M1 | | |
| 262 | A2 | F | R2.036 | H | E or Z | 304.96 | 1.7 | M1 | | |
| 263 | A2 | F | R2.037 | H | E or Z | 316.01 | 1.58 | M1 | | |
| 264 | A2 | F | R2.038 | H | E or Z | 338.99 | 1.77 | M1 | | |
| 265 | A2 | F | R2.039 | H | E or Z | 338.9 | 1.4 | M1 | | |
| 266 | A2 | F | R2.040 | H | E or Z | 370.98 | 1.2 | M1 | | |
| 267 | A2 | F | R2.003 | H | E and Z | 330 | 1.89-1.93 | M2 | | 1H NMR (400 MHz, DMSO-d6) δ ppm 5.03 (s, 2 H) |
| | | | | | | | | | | 5.11 (s, 1 H) 7.20-7.32 (m, 3 H) 7.35-7.42 (m, 3 H) |
| | | | | | | | | | | 7.52-7.58 (m, 3 H) 8.12 (d, J = 10.66 Hz, 1 H) |
| | | | | | | | | | | 8.53-8.57 (m, 1 H) 9.35 (s, 1 H) 10.25 (s, 1 H) |
| | | | | | | | | | | 10.32 (s, 1 H) 12.03 (s, 1 H) 12.09 (s, 1 H) |
| 268 | A2 | F | R2.055 | H | E and Z | 294 | 1.76-1.82 | M2 | | 1H NMR (400 MHz, DMSO-d6) δ ppm 4.09 |
| | | | | | | | | | | (q, J = 5.27 Hz, 2 H) 5.01 (s, 4 H) 5.08-5.15 (m, 6 H) |
| | | | | | | | | | | 5.18 (d, J = 1.76 Hz, 2 H) 5.87-5.97 (m, 3 H) 7.26 |
| | | | | | | | | | | (dd, J = 8.91, 2.13 Hz, 3 H) 7.99 (d, J = 2.01 |
| | | | | | | | | | | Hz, 1 H) |
| | | | | | | | | | | 8.02 (d, J = 4.76 Hz, 1 H) 8.43 (d, J = 1.76 Hz, 1 H) |
| | | | | | | | | | | 8.48 (d, J = 1.76 Hz, 2 H) 8.93 (s, 3 H) 9.29 (s, 2 H) |
| | | | | | | | | | | 11.74 (s, 2 H) 11.80 (s, 1 H) |
| 269 | A2 | F | R2.041 | H | E or Z | 358 | 1.56 | M1 | | |
| 270 | A2 | F | R2.042 | H | E or Z | 335.99 | 1.58 | M1 | | |
| 271 | A2 | F | R2.054 | H | E | 270.07 | 1.56 | M1 | | |
| 272 | A2 | F | R2.180 | H | E or Z | 286.02 | 1.66 | M1 | | |
| 273 | A2 | F | R2.058 | H | E or Z | 319.98 | 1.8 | M1 | | |
| 274 | A2 | F | R2.059 | H | E or Z | 304.01 | 1.67 | M1 | | |
| 275 | A2 | F | R2.060 | H | E or Z | 330.87 | 1.61 | M1 | | |
| 276 | A2 | F | R2.061 | H | E or Z | 280.04 | 1.99 | M1 | | |
| 277 | A2 | F | R2.063 | H | E or Z | 270 | 1.54 | M1 | | |
| 278 | A2 | F | R2.085 | H | E or Z | 268.03 | 1.09 | M1 | | |
| 279 | A2 | F | R2.064 | H | E | 284.01 | 1.7 | M1 | | |
| 280 | A2 | F | R2.065 | H | E or Z | 304.11 | 1.53 | M1 | | |
| 281 | A2 | F | R2.067 | H | E or Z | 296.02 | 1.47 | M1 | | |
| 282 | A2 | F | R2.068 | H | E or Z | 353.95 | 1.88 | M1 | | |
| 283 | A2 | F | R2.069 | H | E or Z | 358.05 | 1.67 | M1 | | |
| 284 | A2 | F | R2.089 | H | E or Z | 364.16 | 2.57 | M1 | | |
| 285 | A2 | F | R2.070 | H | E or Z | 375.98 | 1.81 | M1 | | |
| 286 | A2 | F | R2.090 | H | E or Z | 388.17 | 2.06 | M1 | | |
| 287 | A2 | F | R2.075 | H | E or Z | 358.05 | 1.6 | M1 | | |
| 288 | A2 | F | R2.091 | H | E or Z | 309.99 | 1.54 | M1 | | |
| 289 | A2 | F | R2.087 | H | E or Z | 317.13 | 1.67 | M1 | | |
| 290 | A2 | F | R2.079 | H | E or Z | 353.82 | 1.95 | M1 | | |
| 291 | A2 | F | R2.080 | H | E or Z | 300 | 1.79 | M1 | | |
| 292 | A2 | F | R2.081 | H | E or Z | 337.97 | 1.82 | M1 | | |
| 293 | A2 | F | R2.082 | H | E or Z | 367.97 | 2.03 | M1 | | |
| 294 | A2 | F | R2.083 | H | E or Z | 367.94 | 1.99 | M1 | | |
| 295 | A2 | F | R2.084 | H | Z | 355.95 | 1.96 | M1 | | |
| 296 | A2 | F | R2.088 | H | E or Z | 370.04 | 1.61 | M1 | | |
| 297 | A2 | F | R2.092 | H | E or Z | 398.07 | 1.82 | M1 | | |
| 298 | A2 | F | R2.053 | H | E and Z | 268 | 1.59-1.63 | M2 | | 1H NMR (400 MHz, DMSO-d6) δ ppm 3.01-3.04 |
| | | | | | | | | | | (m, 4 H) 5.01 (s, 2 H) 5.09 (s, 1 H) 7.25 (dd, J = 8.91, |
| | | | | | | | | | | 1.88 Hz, 1 H) 7.97 (d, J = 2.01 Hz, 1 H) 8.00 (s, 1 H) |
| | | | | | | | | | | 8.01 (d, J = 5.87 Hz, 1 H) 8.42 (d, J = 2.01 Hz, 1 H) |
| | | | | | | | | | | 8.46 (d, J = 1.51 Hz, 1 H) 8.72 (d, J = 4.52 Hz, 1 H) |
| | | | | | | | | | | 9.29 (s, 1 H) 11.70 (s, 1 H) 11.75 (s, 1 H) |
| 299 | A2 | F | R2.050 | H | E or Z | 349 | 1.84-1.91 | M2 | | 1H NMR (400 MHz, DMSO-d6) δ ppm 0.00 |
| | | | | | | | | | | (s, 1 H) 2.36 (s, 3 H) 5.01 (s, 2 H) 7.29-7.44 (m, 4 H) |
| | | | | | | | | | | 7.76 (d, J = 7.80 Hz, 2 H) 8.20 (s, 1 H) 8.97 |
| | | | | | | | | | | (s, 1 H) 11.86 (s, 1 H) |
| 300 | A2 | F | R2.094 | H | E or Z | 194.9 | 1.35-1.37 | M2 | | 1H NMR (400 MHz, DMSO-d6) δ ppm 4.95 |
| | | | | | | | | | | (s, 2 H) 5.16-6.04 (m, 1 H) 7.42 (d, J = 9.56 Hz, |
| | | | | | | | | | | 1 H) 7.48 (d, J = 10.60 Hz, 1 H) 7.98 (s, 1 |
| | | | | | | | | | | H) 8.18 (br. s., 1 H) 9.70 (s, 1 H) |
| 301 | A2 | F | R2.093 | H | E or Z | 195.8 | 1.20-1.25 | M2 | | 1H NMR (400 MHz, DMSO-d6) δ ppm 4.93 |
| | | | | | | | | | | (s, 2 H) 7.48 (dd, J = 8.91, 2.64 Hz, 2 H) 7.64 |
| | | | | | | | | | | (d, J = 10.71 Hz, 1 H) 8.63 (s, 1 H) 9.45 |
| | | | | | | | | | | (s, 1 H) 11.40-11.92 (m, 1 H) |
| 302 | A2 | H | R2.007 | H | E or Z | 314.96 | 1.32 | M1 | | |
| 303 | A2 | H | R2.009 | H | E or Z | 332.02 | 1.46 | M1 | | |
| 304 | A2 | H | R2.010 | H | E or Z | 296.03 | 1.19 | M1 | | |
| 305 | A2 | H | R2.011 | H | E or Z | 281.95 | 0.86 | M1 | | |
| 306 | A2 | H | R2.013 | H | E or Z | 287.97 | 1.36 | M1 | | |
| 307 | A2 | H | R2.014 | H | E or Z | 325.98 | 1.06 | M1 | | |
| 308 | A2 | H | R2.015 | H | E or Z | 320.95 | 1.84 | M1 | | |
| 309 | A2 | H | R2.016 | H | E or Z | 267.03 | 1.58 | M1 | | |
| 310 | A2 | H | R2.017 | H | E or Z | 289 | 1.56 | M1 | | |
| 311 | A2 | H | R2.019 | H | E or Z | 248.98 | 1.04 | M1 | | |
| 312 | A2 | H | R2.020 | H | E or Z | 316.92 | 1.22 | M1 | | |
| 313 | A2 | H | R2.045 | H | E or Z | 2 | 1.33 | M1 | | |
| 314 | A2 | H | R2.022 | H | E or Z | 310.98 | 1.19 | M1 | | |
| 315 | A2 | H | R2.033 | H | E or Z | 388.88 | 1.65 | M1 | | |
| 316 | A2 | H | R2.034 | H | E or Z | 355.92 | 1.63 | M1 | | |
| 317 | A2 | H | R2.035 | H | E or Z | 387.94 | 1.45 | M1 | | |
| 318 | A2 | H | R2.037 | H | E or Z | 297.99 | 1.51 | M1 | | |
| 319 | A2 | H | R2.038 | H | E or Z | 321.01 | 1.71 | M1 | | |
| 320 | A2 | H | R2.039 | H | E or Z | 320.89 | 1.31 | M1 | | |
| 321 | A2 | H | R2.003 | H | E or Z | 311.9 | 1.79-1.85 | M2 | | 1H NMR (400 MHz, DMSO-d6) δ ppm 5.04 (s, 2 H) |
| | | | | | | | | | | 7.20 (t, J = 7.24 Hz, 1 H) 7.33-7.46 (m, 3 H) 7.53 |
| | | | | | | | | | | (t, J = 7.56 Hz, 1 H) 7.62 (d, J = 8.03 Hz, 2 H) |
| | | | | | | | | | | 8.05 (d, J = 7.28 Hz, 1 H) 8.52 (s, 1 H) 9.36 (s, 1 H) |
| | | | | | | | | | | 10.33 (s, 1 H) 11.96 (s, 1 H) |
| 322 | A2 | H | R2.055 | H | E or Z | 275.97 | 1.16 | M1 | | |
| 323 | A2 | H | R2.041 | H | E or Z | 340.01 | 1.48 | M1 | | |
| 324 | A2 | H | R2.042 | H | E or Z | 318.01 | 1.5 | M1 | | |
| 325 | A2 | H | R2.054 | H | E | 251.97 | 1.5 | M1 | | |
| 326 | A2 | H | R2.056 | H | E or Z | 234.07 | 1.63 | M1 | | |
| 327 | A2 | H | R2.058 | H | E or Z | 301.97 | 1.75 | M1 | | |
| 328 | A2 | H | R2.059 | H | E or Z | 286 | 1.61 | M1 | | |
| 329 | A2 | H | R2.060 | H | E or Z | 313.01 | 1.56 | M1 | | |
| 330 | A2 | H | R2.061 | H | E or Z | 262.06 | 1.95 | M1 | | |
| 331 | A2 | H | R2.062 | H | E or Z | 234.03 | 1.68 | M1 | | |
| 332 | A2 | H | R2.063 | H | E or Z | 251.99 | 1.48 | M1 | | |
| 333 | A2 | H | R2.064 | H | E | 265.99 | 1.63 | M1 | | |
| 334 | A2 | H | R2.065 | H | E or Z | 285.91 | 1.66 | M1 | | |
| 335 | A2 | H | R2.066 | H | E or Z | 246.05 | 1.67 | M1 | | |
| 336 | A2 | H | R2.054 | H | Z | 251.96 | 1.49 | M1 | | |
| 337 | A2 | H | R2.067 | H | E or Z | 278.01 | 1.4 | M1 | | |
| 338 | A2 | H | R2.068 | H | E or Z | 335.95 | 1.82 | M1 | | |
| 339 | A2 | H | R2.069 | H | E or Z | 340.02 | 1.62 | M1 | | |
| 340 | A2 | H | R2.089 | H | E or Z | 346.14 | 2.56 | M1 | | |
| 341 | A2 | H | R2.070 | H | E or Z | 357.95 | 1.77 | M1 | | |
| 342 | A2 | H | R2.090 | H | E or Z | 369.91 | 2.02 | M1 | | |
| 343 | A2 | H | R2.075 | H | E or Z | 340.02 | 1.51 | M1 | | |
| 344 | A2 | H | R2.077 | H | E or Z | 264.06 | 1.08 | M1 | | |
| 345 | A2 | H | R2.087 | H | E or Z | 298.96 | 1.61 | M1 | | |
| 346 | A2 | H | R2.078 | H | E or Z | 279.06 | 1.51 | M1 | | |
| 347 | A2 | H | R2.079 | H | E or Z | 335.98 | 1.91 | M1 | | |
| 348 | A2 | H | R2.080 | H | E or Z | 282.04 | 1.73 | M1 | | |
| 349 | A2 | H | R2.081 | H | E or Z | 319.95 | 1.77 | M1 | | |
| 350 | A2 | H | R2.082 | H | E or Z | 349.97 | 1.99 | M1 | | |
| 351 | A2 | H | R2.083 | H | E or Z | 349.96 | 1.95 | M1 | | |
| 352 | A2 | H | R2.084 | H | Z | 338.01 | 1.62 | M1 | | |
| 353 | A2 | H | R2.088 | H | E or Z | 352.06 | 1.55 | M1 | | |
| 354 | A2 | H | R2.053 | H | E or Z | 250 | 1.47-1.51 | M2 | | 1H NMR (400 MHz, DMSO-d6) δ ppm 3.01 |
| | | | | | | | | | | (d, J = 4.52 Hz, 3 H) 5.02 (s, 2 H) 7.41 (d, J = 7.53 |
| | | | | | | | | | | Hz, 1 H) 7.51 (t, J = 7.65 Hz, 1 H) 8.03 (d, J = 7.53 |
| | | | | | | | | | | Hz, 1 H) 8.46 (s, 1 H) 8.67 (d, J = 6.15 Hz, 1 H) 9.28 |
| | | | | | | | | | | (s, 1 H) 11.61 (s, 1 H) |
| 355 | A2 | H | R2.050 | H | E or Z | 330.9 | 1.80-1.83 | M2 | | 1H NMR (400 MHz, DMSO-d6) δ ppm 2.35 |
| | | | | | | | | | | (s, 3 H) 5.03 (s, 2 H) 7.39-7.57 (m, 5 H) 7.75 (d, |
| | | | | | | | | | | J = 7.76 Hz, 2 H) 8.19 (s, 1 H) 8.90 (s, 1 H) |
| | | | | | | | | | | 11.74 (br. s., 1 H) |
| 356 | A2 | H | R2.049 | H | E or Z | 264 | 1.58-1.65 | M2 | | 1H NMR (400 MHz, DMSO-d6) δ ppm 1.16 |
| | | | | | | | | | | (t, J = 7.15 Hz, 3H) 3.59 (quin, J = 6.78 Hz, 2 H) |
| | | | | | | | | | | 5.02 (s, 2 H) 7.41 (d, J = 7.53 Hz, 1 H) 7.52 (t, |
| | | | | | | | | | | J = 7.65 Hz, 1 H) 7.98 (d, J = 7.78 Hz, 1 H) |
| | | | | | | | | | | 8.44 (s, 1 H) 8.71 (t, J = 5.65 Hz, 1 H) 9.26 (s, |
| | | | | | | | | | | 1 H) 11.53 (s, 1 H) |
| 357 | A2 | H | R2.052 | H | E or Z | 236 | 1.29-1.35 | M2 | | 1H NMR (400 MHz, DMSO-d6) δ ppm 5.02 (s, |
| | | | | | | | | | | 2 H) 7.41 (d, J = 6.78 Hz, 1 H) 7.49 (t, J = 7.53 Hz, |
| | | | | | | | | | | 1 H) 8.05 (d, J = 8.28 Hz, 3 H) 8.48 (s, 1 H) 9.22 |
| | | | | | | | | | | (s, 1 H) 11.56 (s, 1 H) |
| 358 | A2 | H | R2.004 | H | E or Z | 326 | 1.87-1.89 | M2 | | 1H NMR (400 MHz, DMSO-d6) δ ppm 2.09 |
| | | | | | | | | | | (s, 1 H) 4.84 (d, J = 6.27 Hz, 2 H) 5.02 (s, 2 H) |
| | | | | | | | | | | 7.21-7.42 (m, 6 H) 7.50 (t, J = 7.28 Hz, 1 H) 8.04 |
| | | | | | | | | | | (d, J = 7.53 Hz, 1 H) 8.50 (s, 1 H) 9.23 (t, J = 6.45 |
| | | | | | | | | | | Hz, 1 H) 9.28 (s, 1 H) 11.71 (s, 1 H) |
| 359 | A2 | H | R2.072 | H | E or Z | 206 | 1.89-1.92 | M2 | | 1H NMR (400 MHz, DMSO-d6) δ ppm 1.27 |
| | | | | | | | | | | (t, J = 7.15 Hz, 3 H) 4.19 (q, J = 7.03 Hz, 2 H) |
| | | | | | | | | | | 5.04 (s, 2 H) 7.44-7.55 (m, 2 H) 7.69 (d, J = 7.53 Hz, |
| | | | | | | | | | | 1 H) 8.52 (s, 1 H) 9.14 (s, 1 H) |
| 360 | A3 | — | R2.007 | H | E or Z | 314.96 | 1.1 | M1 | | |
| 361 | A3 | — | R2.008 | H | E or Z | 326 | 1.01 | M1 | | |
| 362 | A3 | — | R2.009 | H | E or Z | 331.97 | 1.24 | M1 | | |
| 363 | A3 | — | R2.051 | H | E or Z | 337.92 | 0.86 | M1 | | |
| 364 | A3 | — | R2.011 | H | E or Z | 281.96 | 0.67 | M1 | | |
| 365 | A3 | — | R2.012 | H | E or Z | 348.93 | 1.17 | M1 | | |
| 366 | A3 | — | R2.013 | H | E or Z | 287.94 | 1.33 | M1 | | |
| 367 | A3 | — | R2.014 | H | E or Z | 325.97 | 0.92 | M1 | | |
| 368 | A3 | — | R2.015 | H | E or Z | 320.9 | 1.73 | M1 | | |
| 369 | A3 | — | R2.017 | H | E or Z | 289 | 1.45 | M1 | | |
| 370 | A3 | — | R2.018 | H | E or Z | 293.94 | 1.11 | M1 | | |
| 371 | A3 | — | R2.019 | H | E or Z | 249 | 0.82 | M1 | | |
| 372 | A3 | — | R2.020 | H | E or Z | 316.94 | 1.02 | M1 | | |
| 373 | A3 | — | R2.021 | H | E or Z | 248.04 | 0.57 | M1 | | |
| 374 | A3 | — | R2.022 | H | E or Z | 311 | 0.98 | M1 | | |
| 375 | A3 | — | R2.023 | H | E or Z | 289 | 1.45 | M1 | | |
| 376 | A3 | — | R2.024 | H | E or Z | 297.7 | 1.48 | M1 | | |
| 377 | A3 | — | R2.025 | H | E or Z | 315.99 | 0.92 | M1 | | |
| 378 | A3 | — | R2.026 | H | E or Z | 320.9 | 1.71 | M1 | | |
| 379 | A3 | — | R2.028 | H | E or Z | 245.03 | 0.79 | M1 | | |
| 380 | A3 | — | R2.029 | H | E or Z | 339 | 1.59 | M1 | | |
| 381 | A3 | — | R2.030 | H | E or Z | 288 | 0.97 | M1 | | |
| 382 | A3 | — | R2.033 | H | E or Z | 388.86 | 1.8 | M1 | | |
| 383 | A3 | — | R2.034 | H | E or Z | 355.9 | 1.38 | M1 | | |
| 384 | A3 | — | R2.035 | H | E or Z | 387.94 | 1.26 | M1 | | |
| 385 | A3 | — | R2.036 | H | E or Z | 286.97 | 1.5 | M1 | | |
| 386 | A3 | — | R2.037 | H | E or Z | 298 | 1.37 | M1 | | |
| 387 | A3 | — | R2.038 | H | E or Z | 321 | 1.57 | M1 | | |
| 388 | A3 | — | R2.039 | H | E or Z | 320.93 | 1.51 | M1 | | |
| 389 | A3 | — | R2.003 | H | E or Z | 311.98 | 1.21 | M1 | | |
| 390 | A3 | — | R2.055 | H | E or Z | 275.99 | 1.05 | M1 | | |
| 391 | A3 | — | R2.041 | H | E or Z | 340.01 | 1.36 | M1 | | |
| 392 | A3 | — | R2.042 | H | E or Z | 318.03 | 1.39 | M1 | | |
| 393 | A3 | — | R2.054 | H | E | 251.84 | 1.04 | M1 | | |
| 394 | A3 | — | R2.180 | H | E or Z | 268 | 1.94-1.97 | M2 | | 1H NMR (400 MHz, DMSO-d6) δ ppm |
| | | | | | | | | | | 5.00 (s, 2 H) 5.09 (s, 1 H) 5.19 (s, 2 H) 7.30-7.47 |
| | | | | | | | | | | (m, 5 H) 7.54-7.67 (m, 2 H) 7.75 (d, J = 7.53 |
| | | | | | | | | | | Hz, 2 H) 8.37 (s, 1 H) 9.27 (s, 1 H) |
| 395 | A3 | — | R2.056 | H | E or Z | 234.02 | 1.91 | M1 | | |
| 396 | A3 | — | R2.057 | H | E or Z | 262.06 | 1.23 | M1 | | |
| 397 | A3 | — | R2.058 | H | E or Z | 301.96 | 1.62 | M1 | | |
| 398 | A3 | — | R2.059 | H | E or Z | 286.03 | 1.49 | M1 | | |
| 399 | A3 | — | R2.060 | H | E or Z | 312.88 | 1.43 | M1 | | |
| 400 | A3 | — | R2.061 | H | E or Z | 262.12 | 1.79 | M1 | | |
| 401 | A3 | — | R2.062 | H | E or Z | 234.06 | 1.51 | M1 | | |
| 402 | A3 | — | R2.063 | H | E or Z | 252.14 | 0.95 | M1 | | |
| 403 | A3 | — | R2.085 | H | E or Z | 250.04 | 0.87 | M1 | | |
| 404 | A3 | — | R2.064 | H | E | 266.02 | 1.5 | M1 | | |
| 405 | A3 | — | R2.065 | H | E or Z | 285.92 | 1.55 | M1 | | |
| 406 | A3 | — | R2.067 | H | E or Z | 278.05 | 1.2 | M1 | | |
| 407 | A3 | — | R2.068 | H | E or Z | 335.93 | 1.69 | M1 | | |
| 408 | A3 | — | R2.069 | H | E or Z | 340.06 | 1.48 | M1 | | |
| 409 | A3 | — | R2.086 | H | E or Z | 234.06 | 1.51 | M1 | | |
| 410 | A3 | — | R2.070 | H | E or Z | 357.97 | 1.65 | M1 | | |
| 411 | A3 | — | R2.090 | H | E or Z | 371.83 | 1.92 | M1 | | |
| 412 | A3 | — | R2.071 | H | E or Z | 220.08 | 1.34 | M1 | | |
| 413 | A3 | — | R2.072 | H | E or Z | 206.03 | 1.17 | M1 | | |
| 414 | A3 | — | R2.181 | H | E or Z | 192 | 1.55-1.59 | M2 | | 1H NMR (400 MHz, DMSO-d6) δ ppm |
| | | | | | | | | | | 3.91 (s, 3 H) 5.01 (s, 2 H) 7.58 (d, J = 7.45 Hz, 1 H) |
| | | | | | | | | | | 7.63 (s, 1 H) 7.75 (d, J = 7.53 Hz, 1 H) 8.29 |
| | | | | | | | | | | (s, 1 H) 9.27 (s, 1 H) |
| 415 | A3 | — | R2.073 | H | E or Z | 218.22 | 1.24 | M1 | | |
| 416 | A3 | — | R2.074 | H | E or Z | 326 | 1.18 | M1 | | |
| 417 | A3 | — | R2.075 | H | E or Z | 340.06 | 1.41 | M1 | | |
| 418 | A3 | — | R2.076 | H | E or Z | 220.08 | 1.35 | M1 | | |
| 419 | A3 | — | R2.077 | H | E or Z | 264.04 | 0.92 | M1 | | |
| 420 | A3 | — | R2.087 | H | E or Z | 298.95 | 1.48 | M1 | | |
| 421 | A3 | — | R2.078 | H | E or Z | 279.01 | 1.38 | M1 | | |
| 422 | A3 | — | R2.079 | H | E or Z | 335.91 | 1.79 | M1 | | |
| 423 | A3 | — | R2.080 | H | E or Z | 282.21 | 1.6 | M1 | | |
| 424 | A3 | — | R2.081 | H | E or Z | 319.89 | 1.65 | M1 | | |
| 425 | A3 | — | R2.082 | H | E or Z | 349.99 | 1.79 | M1 | | |
| 426 | A3 | — | R2.083 | H | E or Z | 349.94 | 1.88 | M1 | | |
| 427 | A3 | — | R2.084 | H | Z | 338.02 | 1.79 | M1 | | |
| 428 | A3 | — | R2.088 | H | E or Z | 352.07 | 1.41 | M1 | | |
| 429 | A3 | — | R2.092 | H | E or Z | 380.08 | 1.63 | M1 | | |
| 430 | A3 | — | R2.027 | H | E or Z | 289.98 | 0.94 | M1 | | |
| 431 | A3 | — | R2.032 | H | E or Z | 349.93 | 1.17 | M1 | | |
| 432 | A4 | H | R2.072 | H | E or Z | 206 | 1.74-1.77 | M2 | | 1H NMR (400 MHz, DMSO-d6) δ ppm 1.34 |
| | | | | | | | | | | (t, J = 7.03 Hz, 3 H) 2.56 (dt, J = 3.58, 1.85 Hz, |
| | | | | | | | | | | 7 H) 3.38 (s, 2 H) 4.24 (q, J = 7.03 Hz, 2 H) 5.13 |
| | | | | | | | | | | (s, 2 H) 7.51 (t, J = 7.42 Hz, 1 H) 7.70 (dd, |
| | | | | | | | | | | J = 7.65, 0.88 Hz, 1 H) 7.84 (dd, J = 7.28, |
| | | | | | | | | | | 0.75 Hz, 1 H) 8.39 (s, 1 H) 9.31 (s, 1 H) |
| 433 | A4 | H | R2.181 | H | E or Z | 192.1 | 1.58-1.64 | M2 | | 1H NMR (400 MHz, DMSO-d6) δ ppm |
| | | | | | | | | | | 3.92 (s, 3 H) 5.08 (s, 2 H) 7.45 (t, J = 7.42 Hz, 1 H) |
| | | | | | | | | | | 7.64 (d, J = 7.35 Hz, 1 H) 7.79 (dd, J = 7.28, |
| | | | | | | | | | | 1.00 Hz, 1 H) 8.33 (s, 1 H) 9.26 (s, 1 H) |
| 434 | A2 | H | R2.180 | H | E or Z | 268.1 | 2.097-2.162. | M2 | | 1H NMR (400 MHz, DMSO-d6) δ ppm 5.03 |
| | | | | | | | | | | (s, 2 H) 5.21 (s, 2 H) 7.33 (s, 1 H) 7.36-7.47 (m, 5 H) |
| | | | | | | | | | | 7.52 (t, J = 7.60 Hz, 1 H) 7.67 (d, J = 7.53 Hz, 1 H) |
| | | | | | | | | | | 8.59 (s, 1 H) 9.08 (s, 1 H) |
| 435 | A2 | H | R2.181 | H | E or Z | 191.9 | 1.74-1.77 | M2 | | 1H NMR (400 MHz, DMSO-d6) δ ppm 3.93 |
| | | | | | | | | | | (s, 3 H) 5.04 (s, 2 H) 7.48 (d, J = 7.69 Hz, 1 H) |
| | | | | | | | | | | 7.53 (t, J = 7.47 Hz, 1 H) 8.53 (s, 1 H) |
| | | | | | | | | | | 9.12 (s, 1 H) |
| 447 | A2 | Me | R2.062 | H | | 248 | 2.27 | M2 | | |
| 448 | A2 | Me | R2.181 | H | | | | | 75-80 | |
| 449 | A2 | Me | R2.059 | H | | | | | 112-117 | |
| 450 | A2 | Me | R2.072 | H | | | | | 75-78 | |
| 451 | A2 | Me | R2.180 | H | | | | | 102-107 | |
| 452 | A2 | Me | R2.023 | H | | | | | 211-215 | |
| 453 | A1 | Cl | R2.183 | H | | | | | 152-159 | |
| 454 | A1 | F | R2.183 | H | | | | | 185-190 | |

### Table T3: Characterising Data:

Table T1 shows all the prepared examples with selected melting point and selected NMR data for prepared compounds. CDCl₃/D₂₀ and DMSO are used as solvents for NMR 400 MHz measurements. No attempt is made to list all characterising data in all cases.

In Table T1 and throughout the description that follows, temperatures are given in degrees Celsius; “NMR” means nuclear magnetic resonance spectrum; MS stands for mass spectrum; “%” is percent by weight, unless corresponding concentrations are indicated in other units. The following abbreviations are used throughout this description:
m.p.=melting point b.p.=boiling point.
S=singlet br=broad
d=doublet dd=doublet of doublets
t=triplet q=quartet
m=multiplet ppm=parts per million

The following LC-MS methods were used to characterize the compounds:

Method—M 1

ACQUITY SQD Mass Spectrometer from Waters (Single quadrupole mass spectrometer)

Ionisation method: Electrospray

Polarity: positive ions

Capillary (kV) 3.00, Cone (V) 20.00, Extractor (V) 3.00, Source Temperature (° C.) 150, Desolvation Temperature (° C.) 400, Cone Gas Flow (L/Hr) 60, Desolvation Gas Flow (L/Hr) 700

Mass range: 100 to 800 Da

DAD Wavelength range (nm): 210 to 400

Method Waters ACQUITY UPLC with the following HPLC gradient conditions

(Solvent A: Water/Methanol 9:1, 0.1% formic acid and Solvent B: Acetonitrile, 0.1% formic acid)

| Time | | | |
|---|---|---|---|
| (minutes) | A (%) | B (%) | Flow rate (ml/min) |
| 0 | 100 | 0 | 0.75 |
| 2.5 | 0 | 100 | 0.75 |
| 2.8 | 0 | 100 | 0.75 |
| 3.0 | 100 | 0 | 0.75 |

Type of column: Waters ACQUITY UPLC HSS T3; Column length: 30 mm; Internal diameter of column: 2.1 mm; Particle Size: 1.8 micron; Temperature: 60° C.

The characteristic values obtained for each compound were the retention time (“Rₜ”, recorded in minutes) and the molecular ion as listed in Table 1.

Method—M2

Instrumentation:—

Mass Spectrometer: 6410 Triple quadrupole Mass Spectrometer from Agilent Technologies

HPLC: Agilent 1200 Series HPLC

Optimized Mass Parameter:—

Ionisation method: Electrospray (ESI)

Polarity: positive and Negative Polarity Switch

Scan Type: MS2 Scan

Capillary (kV): 4.00

Fragmentor (V): 100.00

Gas Temperature (° C.): 350

Gas Flow (L/min): 11

Nebulizer Gas (psi): 35

Mass range: 110 to 1000 Da

DAD Wavelength range (nm): 190 to 400

Optimized Chromatographic Parameter:—

Gradient Conditions

(Solvent A: Water, 0.1% formic acid and Solvent B: Acetonitrile, 0.1% formic acid)

| Time | | | |
|---|---|---|---|
| (minutes) | A (%) | B (%) | Flow rate (ml/min) |
| 0 | 90 | 10 | 1.8 |
| 2.0 | 0 | 100 | 1.8 |
| 3.0 | 0 | 100 | 1.8 |
| 3.2 | 90 | 10 | 1.8 |
| 4.0 | 90 | 10 | 1.8 |

Type of column: Waters Xterra MS C18; Column length: 30 mm; Internal diameter of column: 4.6 mm; Particle Size: 3.5μ; Temperature: 30° C.

Formulation examples for compounds of formula (I):

### Example F-1.1 to F-1.2

### Emulsifiable Concentrates

| Components | F-2.1 | F-2.2 |
|---|---|---|
| A compound selected from the Table T1 | 25% | 50% |
| calciumdodecylbenzenesulfonate | 5% | 6% |
| castoroilpolyethyleneglycolether | | |
| (36 mol ethylenoxy units) | 5% | — |
| tributylphenolpolyethyleneglycolether | | |
| (30 mol ethylenoxy units) | — | |
| cyclohexanone | — | 20% |
| xylenemixture | 65% | 20% |

Emulsions of any desired concentration can be prepared by diluting such concentrates with water.

### Example F-2

### Emulsifiable Concentrate

| Components | F-2 |
|---|---|
| A compound selected from the Table T1 and the tables 1 to 300 | 10% |
| octylphenolpolyethyleneglycolether | 3% |
| (4 to 5 mol ethylenoxy units) | |
| Calcium dodecylbenzenesulfonate | 3% |
| Castoroilpolyglycolether | 4% |
| (36 mol ethylenoxy units) | |
| cyclohexanone | 30% |
| xylenemixture | 50% |

Emulsions of any desired concentration can be prepared by diluting such concentrates with water.

### Examples F-3.1 to F-3.4

### Solutions

| Components | F-3.1 | F-3.2 | F-3.3 | F-3.4 |
|---|---|---|---|---|
| A compound selected from the Table T1 and | 80% | 10% | 5% | 95% |
| the tables 1 to 300 | | | | |
| propylene glycol monomethyl ether | 20% | — | — | — |
| polyethylene glycol (relative | — | 70% | — | — |
| molecular mass: 400 atomic mass units) | | | | |
| N-methylpyrrolid-2-one | — | 20% | — | — |
| epoxidised coconut oil | — | — | 1% | 5% |
| benzin (boiling range: 160-190°) | — | — | 94% | — |

The solutions are suitable for use in the form of microdrops.

### Examples F-4.1 to F-4.4

### Granulates

| Components | F-4.1 | F-4.2 | F-4.3 | F-4.4 |
|---|---|---|---|---|
| A compound selected from the Table T1 and | 5% | 10% | 8% | 21% |
| the tables 1 to 300 | | | | |
| Kaolin | 94% | — | 79% | 54% |
| highly dispersed silicic acid | 1% | — | 13% | 7% |
| Attapulgite | — | 90% | — | 18% |

The novel compound is dissolved in dichloromethane, the solution is sprayed onto the carrier and the solvent is then removed by distillation under vacuum.

### Examples F-5.1 and F-5.2

### Dusts

| Components | F-5.1 | F-5.2 |
|---|---|---|
| A compound selected from the Table T1 and | 2% | 5% |
| the tables 1 to 300 | | |
| highly dispersed silicic acid | 1% | 5% |
| Talcum | 97% | — |
| Kaolin | — | 90% |

Ready for use dusts are obtained by intimately mixing all components.

### Examples F-6.1 to F-6.3

### Wettable Powders

| Components | F-6.1 | F-6.2 | F-6.3 |
|---|---|---|---|
| A compound selected from the Table T1 and the | 25% | 50% | 75% |
| tables 1 to 300 | | | |
| sodium lignin sulfonate | 5% | 5% | — |
| sodium lauryl sulphate | 3% | — | 5% |
| sodium diisobutylnaphthalene sulfonate | 6% | 10% | — |
| octylphenolpolyethylene glycol ether | 2% | — | — |
| (7 to 8 mol ethylenoxy units) | | | |
| highly dispersed silicic acid | 5% | 10% | 10% |
| Kaolin | 62% | 27% | — |

All components are mixed and the mixture is thoroughly ground in a suitable mill to give wettable powders which can be diluted with water to suspensions of any desired concentration.

### Example F7

### Flowable Concentrate for Seed Treatment

| Components | F-7 |
|---|---|
| A compound selected from the Table T1 and | 40% |
| the tables 1 to 300 | |
| propylene glycol | 5% |
| copolymer butanol PO/EO | 2% |
| tristyrenephenole with 10-20 moles EO | 2% |
| 1,2-benzisothiazolin-3-one | 0.5% |
| (in the form of a 20% solution in water) | |
| monoazo-pigment calcium salt | 5% |
| Silicone oil | 0.2% |
| (in the form of a 75% emulsion in water) | |
| Water | 45.3% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### BIOLOGICAL EXAMPLES

### Fungicidal Action

The compounds which gave >80% disease control at 200 ppm in various tests when compared to untreated control under the same conditions, which show extensive disease development are specified below

These examples illustrate the fungicidal properties of the compounds described in table T1.

### Biological Example 1

### Fungicidal Activity Against Blumeria graminis f. sp. Tritici (Erysiphe graminis f. Sp. Tritici)/Wheat/Leaf Disc Preventative (Powdery Mildew on Wheat)

Wheat leaf segments cv. Kanzler were placed on agar in a 24-well plate and sprayed with the formulated test compound diluted in water at an application rate of 200 ppm. The leaf disks were inoculated by shaking powdery mildew infected plants above the test plates 1 day after application. The inoculated leaf disks were incubated at 20° C. and 60% relative humidity under a light regime of 24 h darkness followed by 12 h/12 h (dark/light) in a climate chamber and the activity of a compound was assessed as percent disease control compared to untreated when an appropriate level of disease damage appears on untreated check leaf segments (6-8 days after application). Compounds (from table T1) 76 and 240 at 200 ppm give at least 80% disease control in this test when compared to untreated control leaf disks under the same conditions, which show extensive disease development.

### Biological Example 2

### Fungicidal Activity Against Giberella zeae (Fusarium graminearum)/Wheat/Spikelet

Fusarium graminearum, syn. Gibberella zeae, (Head blight): Wheat spikelets are placed on agar in in a 24-well plate and sprayed with test solutions. After drying, the spikelets are inoculated with a spore suspension of the fungus. After appropriate incubation the activity of a compound is assessed 6 dpi (days after inoculation) as preventative fungicidal activity. Compound (from table T1) 59 at 200 ppm give at least 80% disease control in this test when compared to untreated control leaf disks under the same conditions, which show extensive disease development.

### Biological Example 3

### Fungicidal Activity Against Phaeosphaeria nodorum (Septoria nodorum)/Wheat/Leaf Disc Preventative (Glume Blotch)

Wheat leaf segments cv Kanzler were placed on agar in a 24-well plate and sprayed with formulated test compound diluted in water at an application rate of 200 ppm. The leaf disks were inoculated with a spore suspension of the fungus 2 days after application. The inoculated test leaf disks were incubated at 20° C. and 75% relative humidity under a light regime of 12/12 h (light/dark) in a climate cabinet and the activity of a compound was assessed as percent disease control compared to untreated when an appropriate level of disease damage appears in untreated check leaf disks (5-7 days after application). Compounds (from table T1) 40, 41, 42, 44, 47, 56, 123, 131, 132, 142, 149 and 189 at 200 ppm give at least 80% disease control in this test when compared to untreated control leaf disks under the same conditions, which show extensive disease development.

### Biological Example 4

### Fungicidal Activity Against Phytophthora infestans/Tomato/Leaf Disc Preventative (Late Blight)

Tomato leaf disks were placed on water agar in multiwell plates (24-well format) and sprayed with the formulated test compound diluted in water at an application rate of 200 ppm. The leaf disks were inoculated with a spore suspension of the fungus 1 day after application. The inoculated leaf disks were incubated at 16° C. and 75% relative humidity under a light regime of 24 h darkness followed by 12/12 h (light/dark) in a climate cabinet and the activity of a compound was assessed as percent disease control compared to untreated when an appropriate level of disease damage appears in untreated check leaf disks. Compound (from table T1) 224 at 200 ppm give at least 80% disease control in this test when compared to untreated control leaf disks under the same conditions, which show extensive disease development.

### Biological Example 5

### Fungicidal Activity Against Plasmopara viticola/Grape/Leaf Disc Preventative (Late Blight)

Grape vine leaf disks were placed on water agar in multiwell plates (24-well format) and sprayed with the formulated test compound diluted in water. The leaf disks were inoculated with a spore suspension of the fungus 1 day after application. The inoculated leaf disks were incubated at 19° C. and 80% relative humidity under a light regime of 12/12 h (light/dark) in a climate cabinet and the activity of a compound was assessed as percent disease control compared to untreated when an appropriate level of disease damage appears in untreated check leaf disks (6-8 days after application). Compounds (from table T1) 4, 13, 16, 35, 36, 47, 48, 50, 51, 71, 77, 79, 80, 83, 89, 90, 91, 92, 95, 96, 99, 105, 107, 111, 113, 115, 117, 119, 120, 124, 131, 132, 142, 171, 178, 222, 315, 378, 389, 395, 397, 398, 400, 405, 408 and 423 at 200 ppm give at least 80% disease control in this test when compared to untreated control leaf disks under the same conditions, which show extensive disease development.

### Biological Example 6

### Fungicidal Activity Against Puccinia recondita f. sp. Tritici/Wheat/Leaf Disc Curative (Brown Rust)

Wheat leaf segments are placed on agar in multiwell plates (24-well format). The leaf disks are then inoculated with a spore suspension of the fungus. One day after inoculation the test solution is applied. After appropriate incubation the activity of a compound is assessed 8 dpi (days after inoculation) as curative fungicidal activity. Dose range: 200-22 ppm. Compounds (from table T1) 76, 91 and 122 at 200 ppm give at least 80% disease control in this test when compared to untreated control leaf disks under the same conditions, which show extensive disease development.

### Biological Example 7

### Fungicidal Activity Against Puccinia recondita f. sp. Tritici/Wheat/Leaf Disc Preventative (Brown Rust)

Wheat leaf segments cv. Kanzler were placed on agar in multiwell plates (24-well format) and sprayed with the formulated test compound diluted in water. The leaf disks were inoculated with a spore suspension of the fungus 1 day after application. The inoculated leaf segments were incubated at 19° C. and 75% rh under a light regime of 12 h light/12 h darkness in a climate cabinet and the activity of a compound was assessed as percent disease control compared to untreated when an appropriate level of disease damage appears in untreated check leaf segments (7-9 days after application).

Compounds (from table T1) 42, 48, 57, 71, 76, 128, 130, 131, 132, 142, 222, 284, 449 and 453 at 200 ppm give at least 80% disease control in this test when compared to untreated control leaf disks under the same conditions, which show extensive disease development.

### Biological Example 8

### Fungicidal Activity Against Magnaporthe grisea (Pyricularia oryzae)/Rice/Leaf Disc Preventative (Rice Blast)

Rice leaf segments cv. Ballila were placed on agar in multiwell plate (24-well format) and sprayed with the formulated test compound diluted in water at an application rate of 200 ppm. The leaf segments were inoculated with a spore suspension of the fungus 2 days after application. The inoculated leaf segments were incubated at 22° C. and 80% rh under a light regime of 24 h darkness followed by 12/12 h (light/dark) in a climate cabinet and the activity of a compound was assessed as percent disease control compared to untreated when an appropriate level of disease damage appears in untreated check leaf segments (5-7 days after application). Compounds (from table T1) 131 and 149 at 200 ppm give at least 80% disease control in this test when compared to untreated control leaf disks under the same conditions, which show extensive disease development.

### Biological Example 9

### Fungicidal Activity Against Pyrenophora teres/Barley/Leaf Disc Preventative (Net Blotch)

Barley leaf segments cv. Hasso were placed on agar in a multiwell plate (24-well format) and sprayed with the formulated test compound diluted in water. The leaf segments were inoculated with a spore suspension of the fungus 2 days after application. The inoculated leaf segments were incubated at 20° C. and 65% rh under a light regime of 12 h light/12 h darkness in a climate cabinet and the activity of a compound was assessed as disease control compared to untreated when an appropriate level of disease damage appears in untreated check leaf segments (5-7 days after application). Compounds (from table T1) 44 and 149 at 200 ppm give at least 80% disease control in this test when compared to untreated control leaf disks under the same conditions, which show extensive disease development.

### Biological Example 10

### Fungicidal Activity Against Botrvotinia fuckeliana (Botrytis cinerea)/Liquid Culture (Gray Mould)

Conidia of the fungus from cryogenic storage were directly mixed into nutrient broth (Vogels broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 3-4 days after application.

Compounds (from table T1) 11, 30, 76, 82, 89, 114, 123, 124, 126, 128, 130, 131, 132, 135, 139, 140, 141, 142, 149, 248, 263, 299, 369, 375, 378, 385, 387, 388, 405, 416, 448 and 450 at 200 ppm give at least 80% disease control in this test when compared to untreated control leaf disks under the same conditions, which show extensive disease development.

### Biological Example 11

### Fungicidal Activity Against Glomerella lagenarium (Colletotrichum lagenarium)/Liquid Culture (Anthracnose)

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was measured photometrically 3-4 days after application. Compounds (from table T1) 2, 3, 4, 5, 7, 8, 9, 10, 11, 12, 13, 14, 15, 16, 17, 19, 20, 21, 22, 23, 24, 25, 26, 27, 28, 30, 31, 32, 33, 34, 35, 36, 37, 38, 40, 41, 42, 44, 46, 47, 48, 49, 50, 51, 52, 53, 54, 56, 57, 58, 59, 60, 61, 62, 68, 69, 71, 72, 73, 75, 76, 77, 78, 80, 81, 82, 83, 84, 85, 86, 87, 88, 89, 91, 92, 93, 94, 95, 96, 98, 99, 100, 101, 102, 104, 105, 108, 112, 113, 114, 115, 116, 121, 122, 123, 124, 126, 127, 128, 130, 131, 132, 133, 134, 135, 136, 137, 138, 139, 140, 141, 142, 143, 144, 146, 147, 149, 151, 152, 153, 154, 160, 163, 165, 167, 171, 174, 175, 176, 180, 183, 184, 189, 190, 191, 192, 193, 195, 196, 197, 198, 199, 200, 201, 204, 206, 207, 208, 209, 210, 211, 212, 215, 221, 224, 225, 226, 227, 228, 235, 244, 248, 254, 255, 256, 257, 262, 263, 268, 271, 272, 273, 276, 277, 278, 279, 280, 281, 285, 287, 288, 289, 290, 291, 292, 293, 294, 297, 298, 299, 301, 305, 309, 310, 318, 319, 322, 325, 327, 328, 332, 333, 334, 335, 336, 337, 338, 339, 341, 343, 344, 345, 347, 348, 349, 353, 354, 356, 357, 359, 366, 368, 369, 375, 378, 380, 382, 385, 387, 388, 393, 394, 395, 397, 398, 400, 401, 402, 404, 405, 409, 412, 413, 414, 415, 417, 418, 420, 422, 423, 424, 425, 426, 427, 428, 429, 434, 435, 447, 448, 452 and 453 at 200 ppm give at least 80% disease control in this test when compared to untreated control leaf disks under the same conditions, which show extensive disease development.

### Biological Example 12

### Fungicidal Activity Against Fusarium culmorum/Liquid Culture (Head Blight)

Conidia of the fungus from cryogenic storage were directly mixed into nutrient broth (PDB potato dextrose broth). After placing a (DMSO) solution of the test compounds into a microtiter plate (96-well format), the nutrient broth containing the fungal spores was added. The test plates were incubated at 24° C. and the inhibition of growth was determined visually 3-4 days after application. Compounds (from table T1) 48, 57, 58, 59, 61, 71, 124, 127, 128, 130, 131, 132, 135, 139, 140, 141, 142, 143, 144, 197, 206, 207, 208, 209, 271, 279, 280, 378, 387, 393, 394, 395, 398, 401, 402, 404, 405, 412, 413, 415 and 418 at 200 ppm give at least 80% disease control in this test when compared to untreated control leaf disks under the same conditions, which show extensive disease development.

### Biological Example 13

### Fungicidal Activity Against Gaeumannomyces graminis/Liquid Culture (Take-all of Cereals)

Mycelial fragments of the fungus from cryogenic storage were directly mixed into nutrient broth (PDB potato dextrose broth). After placing a DMSO solution of test compound into a 96-well microtiter plate at an application rate of 200 ppm, the nutrient broth Cp.33, containing the fungal spores is added. The test plates were incubated at 24° C. and the inhibition of growth was determined photometrically 4-5 days after application. Compounds (from table T1) 9, 11, 13, 21, 27, 30, 32, 33, 40, 41, 42, 44, 47, 48, 49, 50, 51, 52, 53, 54, 55, 56, 57, 58, 61, 67, 68, 70, 71, 74, 82, 83, 88, 89, 90, 92, 96, 99, 102, 112, 114, 119, 121, 122, 123, 124, 125, 126, 127, 128, 130, 131, 132, 133, 134, 135, 136, 137, 138, 139, 140, 141, 142, 144, 149, 150, 151, 152, 153, 154, 165,169, 171,176, 180, 184,185,189, 190, 191, 192, 193, 195, 196, 197, 198, 199, 200, 201, 204, 206, 207, 208, 209, 210, 211, 212, 215, 217, 218, 220, 222, 235, 248, 254, 259, 263, 271, 272, 273, 274, 276, 277, 279, 280, 281, 283, 285, 286, 287, 288, 289, 290, 291, 292, 293, 294, 295, 297, 308, 310, 315, 318, 325, 326, 327, 328, 330, 331, 332, 333, 334, 335, 336, 337, 341, 343, 344, 345, 347, 348, 349, 350, 351, 352, 353, 362, 368, 369, 375, 376, 378, 380, 382, 385, 386, 387, 393, 394, 395, 396, 397, 398, 401, 402, 404, 405, 409, 410, 412, 413, 415, 416, 418, 420, 421, 422, 423, 424, 425, 426, 427, 428, 429, 449 and 450 at 200 ppm give at least 80% disease control in this test when compared to untreated control leaf disks under the same conditions, which show extensive disease development.

### Biological Example 14

### Fungicidal Activity Monographella nivalis (Microdochium nivale)/Liquid Culture (Foot Rot Cereals)

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. Compounds (from table T1) 11, 13, 21, 27, 30, 32, 33, 40, 41, 42, 44, 46, 47, 48, 49, 50, 51, 52, 53, 54, 55, 56, 57, 58, 61, 67, 68, 69, 70, 71, 74, 76, 82, 84, 88, 89, 96, 99, 102, 112, 114, 115, 121, 122, 123, 124, 125, 126, 127, 128, 130, 131, 132, 133, 134, 135, 136, 138, 139, 140, 141, 142, 143, 144, 149, 151, 152, 153, 154, 171, 175, 176, 178, 180, 183, 185, 189, 190, 191, 193, 195, 196, 197, 198, 199, 200, 201, 204, 205, 206, 207, 208, 209, 210, 211, 212, 215, 216, 217, 221, 222, 224, 225, 226, 227, 228, 229, 248, 257, 259, 271, 272, 273, 276, 277, 279, 280, 281, 285, 287, 290, 291, 292, 293, 294, 295, 299, 315, 325, 327, 328, 331, 332, 333, 334, 335, 336, 337, 339, 341, 343, 345, 348, 349, 350, 352, 353, 354, 356, 357, 359, 362, 366, 369, 375, 378, 380, 382, 385, 387, 388, 392, 393, 394, 395, 396, 397, 398, 400, 401, 402, 404, 405, 408, 409, 410, 412, 413, 414, 415, 416, 417, 418, 420, 421, 422, 423, 424, 425, 426, 427, 428, 429, 432, 433, 434, 435, 447, 448, 449, 450, 451 and 453 at 200 ppm give at least 80% disease control in this test when compared to untreated control leaf disks under the same conditions, which show extensive disease development.

### Biological Example 15

### Fungicidal Activity Against Mycosphaerella arachidis (Cercospora arachidicola)/Liquid Culture (Early Leaf Spot)

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. Compounds (from table T1) 41, 46, 47, 48, 51, 52, 54, 56, 57, 58, 59, 61, 67, 68, 70, 71, 76, 89, 114, 115, 123, 124, 125, 126, 127, 128, 130, 131, 132, 133, 134, 135, 136, 139, 140, 141, 142, 143, 144, 147, 149, 151, 153, 154, 160, 167, 174, 176, 178, 190, 197, 201, 204, 206, 207, 208, 209, 211, 212, 221, 222, 224, 225, 227, 257, 299, 301, 359, 369, 378, 380, 387, 388, 393, 402, 405, 413, 415, 416, 425, 434 and 448 at 200 ppm give at least 80% disease control in this test when compared to untreated control leaf disks under the same conditions, which show extensive disease development.

### Biological Example 16

### Fungicidal Activity Against Pythium ultimum/Liquid Culture (Seedling Damping Off)

Mycelia fragments and oospores of a newly grown liquid culture of the fungus were directly mixed into nutrient broth (potato dextrose broth). After placing a DMSO solution of test compound into a 96-well format microtiter plate at an application rate of 200 ppm, the nutrient broth containing the fungal mycelia/spore mixture was added. The test plates were incubated at 24° C. and the inhibition of growth was determined photometrically 2-3 days after application. Compounds (from table T1) 2, 3, 4, 5, 7, 8, 9, 10, 11, 12, 13, 14, 15, 16, 17, 19, 20, 21, 22, 23, 24, 25, 26, 27, 28, 30, 31, 32, 33, 34, 35, 36, 38, 41, 42, 47, 48, 52, 56, 57, 58, 60, 61, 62, 70, 71, 72, 73, 74, 75, 76, 77, 78, 79, 80, 81, 82, 83, 84, 85, 86, 87, 88, 89, 90, 91, 92, 93, 94, 95, 96, 98, 99, 100, 101, 102, 103, 104, 105, 106, 107, 110, 111, 112, 114, 115, 116, 117, 118, 119, 120, 121, 122, 127, 128, 129, 130, 131, 132, 133, 135, 138, 139, 140, 141, 142, 143, 144, 145, 146, 151, 155, 156, 157, 158, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 193, 195, 196, 197, 198, 199, 200, 201, 204, 206, 207, 208, 209, 210, 211, 212, 215, 218, 219, 220, 221, 222, 223, 224, 225, 226, 227, 228, 229, 230, 231, 232, 233, 234, 235, 236, 237, 239, 240, 241, 242, 243, 244, 245, 246, 247, 248, 250, 252, 253, 254, 255, 256, 257, 258, 259, 261, 262, 263, 264, 265, 266, 267, 268, 269, 270, 271, 272, 273, 274, 276, 277, 278, 279, 280, 281, 283, 285, 287, 288, 291, 295, 296, 297, 298, 299, 300, 301, 302, 303, 304, 305, 306, 307, 309, 310, 311, 312, 313, 314, 315, 317, 318, 320, 321, 322, 325, 326, 327, 328, 330, 331, 332, 333, 334, 335, 336, 337, 339, 341, 343, 344, 345, 348, 349, 352, 353, 354, 355, 356, 357, 358, 359, 360, 362, 370, 371, 372, 374, 383, 384, 387, 388, 389, 390, 393, 394, 395, 396, 402, 409, 412, 413, 414, 415, 416, 418, 419, 420, 421, 430, 432, 433, 434, 435, 447, 448, 449, 450, 453 and 454 at 200 ppm give at least 80% disease control in this test when compared to untreated control leaf disks under the same conditions, which show extensive disease development.

### Biological Example 17

### Fungicidal Activity Against Thanatephorus cucumeris (Rhizoctonia solani)/Liquid Culture (Foot Rot, Damping-Off)

Mycelia fragments of a newly grown liquid culture of the fungus were directly mixed into nutrient broth (PDB potato dextrose broth). After placing a (DMSO) solution of the test compounds into a microtiter plate (96-well format), the nutrient broth containing the fungal material was added. The test plates were incubated at 24° C. and the inhibition of growth was determined photometrically 3-4 days after application. Compounds (from table T1) 11, 30, 33, 41, 47, 48, 56, 57, 58, 61, 71, 75, 76, 85, 89, 96, 114, 131, 165, 171, 190, 197, 248, 255, 263, 280, 310, 334, 369, 378, 380, 387, 393, 405 and 425 at 200 ppm give at least 80% disease control in this test when compared to untreated control leaf disks under the same conditions, which show extensive disease development.

### Biological Example 18

### Fungicidal Activity Against Sclerotinia sclerotiorum/Liquid Culture (White Mold, Etc.)

Mycelial fragments of the fungus from cryogenic storage were directly mixed into nutrient broth (PDB potato dextrose broth). After placing a (DMSO) solution of the test compounds into a microtiter plate (96-well format) the nutrient broth containing the fungal spores was added. The test plates were incubated at 24 C and the inhibition of growth was determined photometrically after 72 hrs at 620 nm.

Compounds (from table T1) 76, 101, 102, 114, 139, 140, 141, 142, 149, 176, 387, 388, 413 and 454 at 200 ppm give at least 80% disease control in this test when compared to untreated control leaf disks under the same conditions, which show extensive disease development.

### Biological Example 19

### Fungicidal Activity Against Mycosphaerella graminicola (Septoria tritici)/Liquid Culture (Septoria Blotch)

Conidia of the fungus from cryogenic storage were directly mixed into nutrient broth (PDB potato dextrose broth). After placing a DMSO solution of test compound into a 96-well microtiter plate at an application rate of 200 ppm, the nutrient broth containing the fungal spores was added. The test plates were incubated at 24° C. and the inhibition of growth was determined photometrically 4-5 days after application. Compounds (from table T1) 30, 40, 41, 46, 47, 48, 49, 50, 51, 54, 56, 57, 58, 61, 67, 68, 71, 76, 82, 84, 88, 89, 114, 121, 123, 124, 126, 127, 128, 130, 131, 132, 135, 136, 138, 139, 140, 141, 142, 144, 149, 151, 152, 154, 189, 190, 193, 196, 197, 198, 199, 200, 201, 204, 206, 207, 208, 209, 210, 211, 212, 222, 271, 272, 276, 277, 279, 280, 281, 287, 325, 327, 332, 334, 336, 343, 348, 352, 369, 378, 380, 385, 387, 388, 393, 394, 395, 397, 398, 400, 401, 402, 404, 405, 408, 409, 412, 413, 414, 415, 416, 418, 420, 425, 426, 427, 428, 429, 432, 433, 448 and 450 at 200 ppm give at least 80% disease control in this test when compared to untreated control leaf disks under the same conditions, which show extensive disease development.

### Biological Example 20

### Fungicidal Activity Against Gaumannomyces graminis/Wheat

A defined amount of mycelium of G. graminis is mixed with water. The formulated test compounds are added to the mycelium suspension. The mixture is applied into a pouch which was previously equipped with a filter paper. After the application wheat seeds cv. Arina are sown into the upper fault of the filter paper. The prepared pouches are then incubated for 14 days at 18° C./16° C. (day/night) and a rel. humidity of 80% with a photo period of 14 h. The evaluation is made by assessing the degree of root browning.

Compounds (from table T1) 224 and 405 at 20 ppm give at least 80% disease control in this test compared to an untreated control, which shows extensive disease development.

### Biological Example 21

### Fungicidal Activity Against Monographella nivale (Microdochium nivale)/Wheat

Formulated test compound is applied into a pouch which was previously equipped with a filter paper. After the application wheat seeds cv. Arina infected with M. nivale are sown into the upper fault of the filter paper. The pouches are then incubated for 7 days in the dark at 7° C./5° C. (day/night) and 80% r. h. After 1 week light is supplied at the same temperature cycle. Another two weeks later plants were transferred to 17° C./16° C. (day/night) and 80% r. H. The disease incidence is assessed 4 weeks after sowing. Compound (from table T1) 70 at 60 ppm give at least 80% disease control in this test compared to an untreated control, which shows extensive disease development.

### Biological Example 22

### Fungicidal Activity Against Pythium ultimum/Cotton

A defined amount of mycelium of P. ultimum is mixed with water. The formulated test compound is added to the mycelium suspension. The mixture is applied into a pouch which was previously equipped with a filter paper. After the application cotton seeds cv. Sure Grow 747 are sown into the upper fault of the filter paper. The prepared pouches are then incubated for 7 days at 18° C. followed by 3 days at 24° C. and a rel. humidity of 100% with a photo period of 14 h. The evaluation is made by assessing the emergence and the degree of disease on the roots. Compound (from table T1) 224 and 225 at 20 ppm give at least 80% disease control in this test compared to an untreated control, which shows extensive disease development.

### Biological Example 23

### Fungicidal Activity Against Puccinia recondita/Wheat

1 week old wheat plants cv. Arina were treated with the formulated test compound in a spray chamber. Two days after application wheat plants were inoculated by spraying a spore suspension (1×105 uredospores/ml) on the test plants. After an incubation period of 1 day at 200 C and 95% r. h. plants were kept for 9 days at 200 C and 60% r.h. in a greenhouse. The disease incidence was assessed 10 days after inoculation.

Compound (from table T1) 50 at 20 ppm give at least 80% disease control in this test compared to an untreated control, which shows extensive disease development.

1. A method for controlling or preventing infestation of plants or plant propagation material and/or harvested food crops susceptible to microbial attack by treating plants or plant propagation material and/or harvested food crops with an effective amount of an oxaborole of general formula (I) 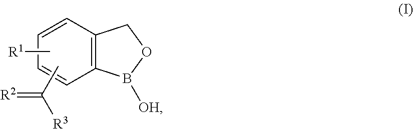
wherein
R¹ is H, fluorine, chlorine, bromine, cyano, nitro, unsubstituted or substituted C₁-C₄alkyl, unsubstituted or substituted C₁-C₄alkoxy, unsubstituted or substituted or C₁-C₄haloalkyl;
R³ is selected from H, unsubstituted or substituted C₁-C₄alkyl, unsubstituted or substituted C₁-C₄haloalkyl, unsubstituted or substituted six- to ten-membered aryl, unsubstituted or substituted five- to six-membered heteroary, unsubstituted or substituted C₃-C₇ cycloalkyl, or unsubstituted or substituted C₃-C₇ heterocycloalkyl;
R² is ═O, ═N—O—R⁵, ═N—NR⁶R⁷, ═N—N(CO)R⁶, ═N—NH(CO)NR⁸R⁹ or ═N—NH(CS)NR⁸R⁹
R⁵, R⁶, R⁷, R⁸ and R⁹ are independently of each other hydrogen, unsubstituted or substituted C₁-C₁₀alkyl, unsubstituted or substituted C₁-C₁₀ haloalkyl, unsubstituted or substituted C₁-C₁₀alkoxy(C₁-C₁₀)alkyl, unsubstituted or substituted C₂-C₁₀alkenyl, unsubstituted or substituted C₂-C₁₀haloalkenyl, unsubstituted or substituted C₂-C₁₀alkynyl, unsubstituted or substituted C₃-C₇cycloalkyl(alkylene)₍₀₋₂₎, unsubstituted or substituted six- to ten-membered-aryl(alkylene)₍₀₋₂₎, or unsubstituted or substituted five- to ten-membered heteroaryl(alkylene)₍₀₋₂₎;
wherein the substituents for the substituted aryl, heteroaryl, cycloalkyl and heterocycloalkyl moieties can be independently mono- or polysubstituted by substituents selected from the group consisting of halogen, hydroxy, nitro, cyano, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, unsubstituted or substituted six- to ten-membered-aryl(alkylene)₍₀₋₁₎ and unsubstituted or substituted six- to ten-membered-aryl(alkylene)₍₀₋₁₎oxy;
and wherein the substituents for the substituted cycloalkyl, heterocycloalkyl and alkyl can be independently mono- or polysubstituted by substituents selected from oxo, —OH, CN, NO₂, F, Cl, C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroary, unsubstituted or substituted C₃-C₇ cycloalkyl, and unsubstituted or substituted C₃-C₇ heterocycloalkyl;
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
or an agronomically acceptable salt, stereoisomer,
diastereoisomer, enantiomer, tautomer, atriopisomer or N-oxide thereof.

2. A compound of formula (I) 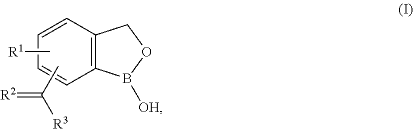
wherein
R¹ is H, fluorine, chlorine, bromine, cyano, nitro, unsubstituted or substituted C₁-C₄alkyl, unsubstituted or substituted C₁-C₄alkoxy, unsubstituted or substituted or C₁-C₄haloalkyl;
R³ is selected from H, unsubstituted or substituted C₁-C₄alkyl, unsubstituted or substituted C₁-C₄haloalkyl, unsubstituted or substituted six- to ten-membered aryl, unsubstituted or substituted five- to six-membered heteroary, unsubstituted or substituted C₃-C₇ cycloalkyl, or unsubstituted or substituted C₃-C₇ heterocycloalkyl;
R² is ═O, ═N—O—R⁵, ═N—NR⁶R⁷, ═N—N(CO)R⁶, ═N—NH(CO)NR⁸R⁹ or ═N—NH(CS)NR⁸R⁹
R⁵, R⁶, R⁷, R⁸ and R⁹ are independently of each other hydrogen, unsubstituted or substituted C₁-C₁₀alkyl, unsubstituted or substituted C₁-C₁₀ haloalkyl, unsubstituted or substituted C₁-C₁₀alkoxy(C₁-C₁₀)alkyl, unsubstituted or substituted C₂-C₁₀alkenyl, unsubstituted or substituted C₂-C₁₀haloalkenyl, unsubstituted or substituted C₂-C₁₀alkynyl, unsubstituted or substituted C₃-C₇cycloalkyl(alkylene)₍₀₋₂₎, unsubstituted or substituted six- to ten-membered-aryl(alkylene)₍₀₋₂₎, or unsubstituted or substituted five- to ten-membered heteroaryl(alkylene)₍₀₋₂₎;
wherein the substituents for the substituted aryl, heteroaryl, cycloalkyl and heterocycloalkyl moieties can be independently mono- or polysubstituted by substituents selected from the group consisting of halogen, hydroxy, nitro, cyano, C₁-C₆alkyl, C₁-C₆haloalkyl, C₁-C₆alkenyl, C₁-C₆haloalkenyl, C₁-C₆alkinyl, C₁-C₆haloalkinyl, C₁-C₆alkoxy, C₁-C₆haloalkoxy, C₁-C₆alkenyloxy, C₁-C₆haloalkenyloxy, C₁-C₆alkinyloxy, C₁-C₆haloalkinyl, C₁-C₆alkoxy-C₁-C₆alkyl, C₁-C₆haloalkoxy, C₁-C₆alkoximino, C₁-C₆alkylendioxy, —C(O)(C₁₋₄ alkyl), —(C₁₋₄ alkyl)-C(O)(C₁₋₄ alkyl), —C(O)OH, —(C₁₋₄ alkyl)-C(O)OH, unsubstituted or substituted six- to ten-membered-aryl(alkylene)₍₀₋₁₎ and unsubstituted or substituted six- to ten-membered-aryl(alkylene)₍₀₋₁₎oxy;
and wherein the substituents for the substituted cycloalkyl, heterocycloalkyl and alkyl can be independently mono- or polysubstituted by substituents selected from oxo, —OH, CN, NO₂, F, Cl, C₁₋₄alkoxy, —C(O)(C₁₋₄ alkoxy), —C(O)(C₁₋₄ alkyl), —C(O)—NH—(C₁₋₄ alkyl), —C(O)—N(C₁₋₄ alkyl)₂, C₁₋₄alkylamino, unsubstituted or substituted five- to ten-membered aryl, unsubstituted or substituted five- to six-membered heteroary, unsubstituted or substituted C₃-C₇ cycloalkyl, and unsubstituted or substituted C₃-C₇ heterocycloalkyl;
and wherein the heterocycloalkyl and the heteroaryl contain 1 to 3 hetero atoms selected from the group consisting of nitrogen, oxygen and sulfur, it not being possible for the ring system to contain more than 2 oxygen atoms and more than 2 sulfur atoms;
or an agronomically acceptable salt, stereoisomer,
diastereoisomer, enantiomer, tautomer, atriopisomer or N-oxide thereof
provided that
if R¹ is H then R⁵ is not methyl
if R¹ is H then R⁵ is not benzyl
R¹ and R³ are defined under formula I, provided that
If R¹ is H then —C(O)—R³ is not 6-CHO
If R¹ is H then —C(O)—R³ is not 4-CHO
If R¹ is 4-F then —C(O)—R³ is not 7-CHO
If R¹ is 4-OCH₃ then —C(O)—R³ is not 7-CHO
If R¹ is H then —C(O)—R³ is not 5-CHO
If R¹ is H then —C(O)—R³ is not 7-CHO
and if R¹ is H then R³ is not butyl or phenyl.

3. A compound of formula (I) according to claim 1 wherein
R² is ═O, ═N—OH, ═N—O—CH3-CH═CH—Cl, ═N—O—CH₃, ═N—OCH₂-Ph, ═N—OCH₂CH₃, ═N—OCH₂—CH═CH, ═N—OCH₂CH═C(CH₃)₂, ═N—O—CH₂—CH(CH₃)₂, ═N—OCH₂-4-NO₂-Ph, ═N—OCH₂-4-Me-Ph, ═N—OCH₂-4-Cl-Ph, ═N—OCH₂-2-F-Ph, ═N—OCH₂-2-Cl-4-F-Ph, ═N—OCH₂-2,6-Cl-Ph, ═N—OCH₂-2,4-Cl-Ph, ═N—O—CH₂-2,4,5-Cl-Ph, ═N—OCH₂-2,3,4,5,6-F-Ph, ═N—OCH(CH₃)₂, ═N—OC(CH₃)₃, ═N—O-4-NO₂-Ph, ═N—O-4-CN-Ph, ═N—O(CH₂)₅CH₃, ═N—O(CH₂)₃CH₃, ═N—O—(CH₂)₃—C(O)—O—CH₂—CH₃, ═N—O(CH₂)₂CH₃, ═N—O(CH₂)₂—CH₂—C(O)OH, ═N—O—(CH₂)₁₁—CH₃, ═N—NHCH₂-Ph, ═N—NH—CH₂—O—C(O)CH₂CH₃, ═N—NH—CH₂—C(O)OEt, ═N—NH—CH(CH₃)₂, ═N—NH—C(S)—NH-Ph, ═N—NH—C(S)—NH-Me, ═N—NH—C(S)—NH—CH₂-Ph, ═N—NH—C(S)—NH—CH₂-Ph, ═N—NH—C(S)—NH—CH₂—CH₃, ═N—NH—C(S)—NH—CH₂—CH═CH₂, ═N—NH—C(S)—NH₂, ═N—NH—C(O)OMe, ═N—NH—C(O)OEt, ═N—NHC(O)—NH-Ph, ═N—NHC(O)—NH-4-OMe-Ph, ═N—NHC(O)—NH-2,4-Ph, ═N—NHC(O)-4-NO₂-Ph, ═N—NHC(O)-4-Cl-Ph, ═N—NH—C(O)-3-pyridyl, ═N—NHC(O)-2-NO₂-Ph, ═N—NHC(O)-2,5-Cl-Ph, ═N—NH-4-OCH₃-Ph, ═N—NH-4-Me-Ph, ═N—NH-4-Cl-Ph, ═N—NH-4-CF₃-Ph, ═N—NH-3-NO₂-Ph, ═N—NH-3,5-Cl-Ph, ═N—NH-2-NO₂-Ph, ═N—NH-2,6-Cl-Ph, ═N—NH-2,6-Cl-4-CF₃-Ph, ═N—NH-2,5-F-Ph, ═N—NH-2,4-F-Ph, ═N—NH-2,4-Cl-Ph, ═N—NH₂, ═N—N(CH₃)Ph, ═N—N(CH₃)CH₂-Ph, ═N—N(CH₃)CH₂CH₃, ═N—N(CH₃)CH₂CH(CH₃)₂, ═N—N(CH₃)CH₂C(CH₃)₃, ═N—N(CH₃)CH₂-4-F-Ph, ═N—N(CH₃)CH₂-4-Cl-Ph, ═N—N(CH₃)CH₂-3,5-F-Ph, ═N—N(CH₃)CH₂-3,5-Cl-Ph, ═N—N(CH₃)CH₂-2,6-F-Ph, ═N—N(CH₃)CH₂-2,6-Cl-Ph, ═N—N(CH₃)CH₂-2,5-F-Ph, ═N—N(CH₃)CH₂-2,5-Cl-Ph, ═N—N(CH₃)CH₂-2,4-F-Ph, ═N—N(CH₃)CH₂-2,4-Cl-Ph, ═N—N(CH₃)CH₂-2,4, 6-F-Ph, ═N—N(CH₃)CH₂-2,4, 6-Cl-Ph, ═N—N(CH₃)CH(CH₃)₂, ═N—N(CH₃)C(CH₃)₃, ═N—N(CH₃)-4-F-Ph, ═N—N(CH₃)-4-Cl-Ph, ═N—N(CH₃)-2,4-F-Ph, ═N—N(CH₃)-2,4-Cl-Ph, ═N—N(CH₃)₂, ═N—N(CH₃)(CH₂)₅CH₃, ═N—N(CH₃)(CH₂)₄CH₃, ═N—N(CH₃)(CH₂)₃CH₃, ═N—N(CH₃)(CH₂)₂CH₃,

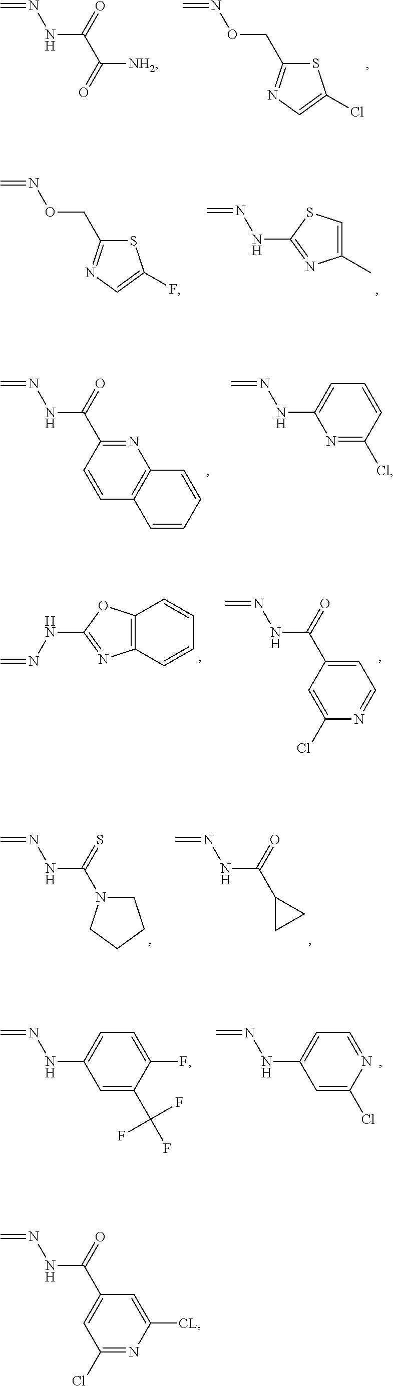

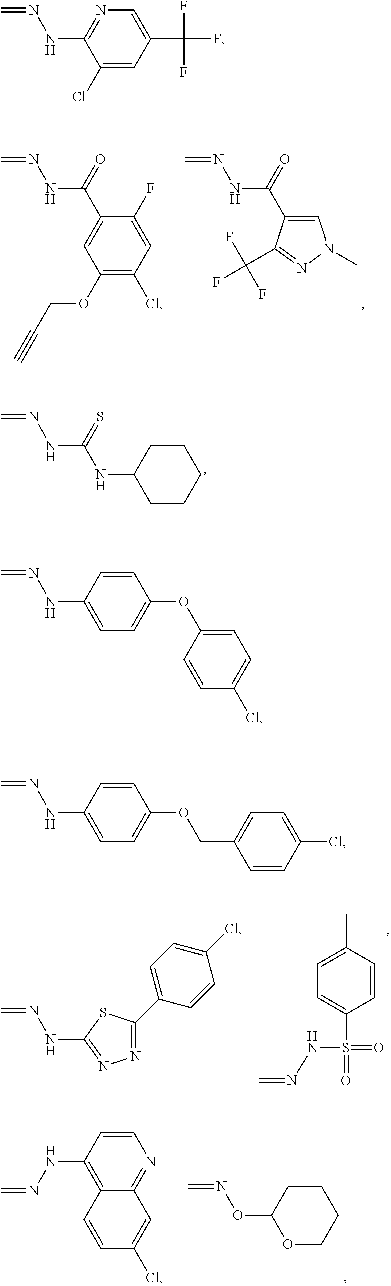

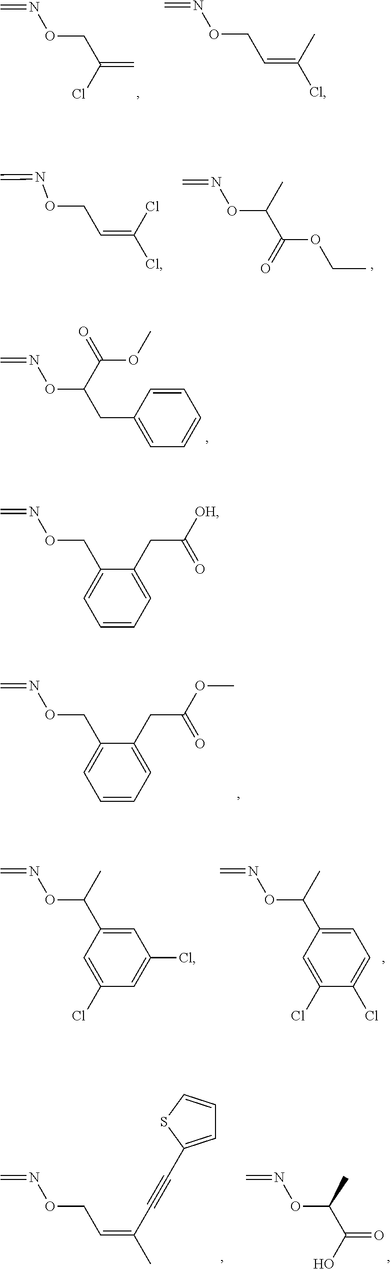

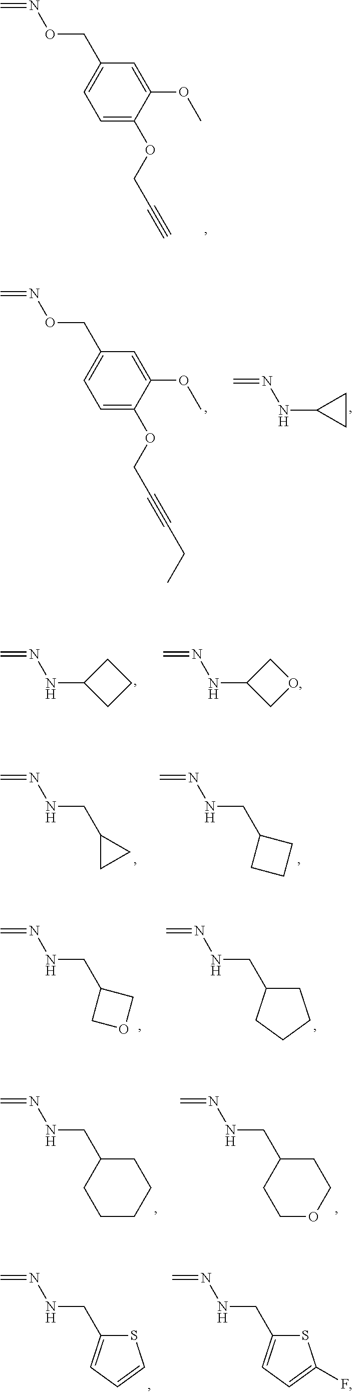

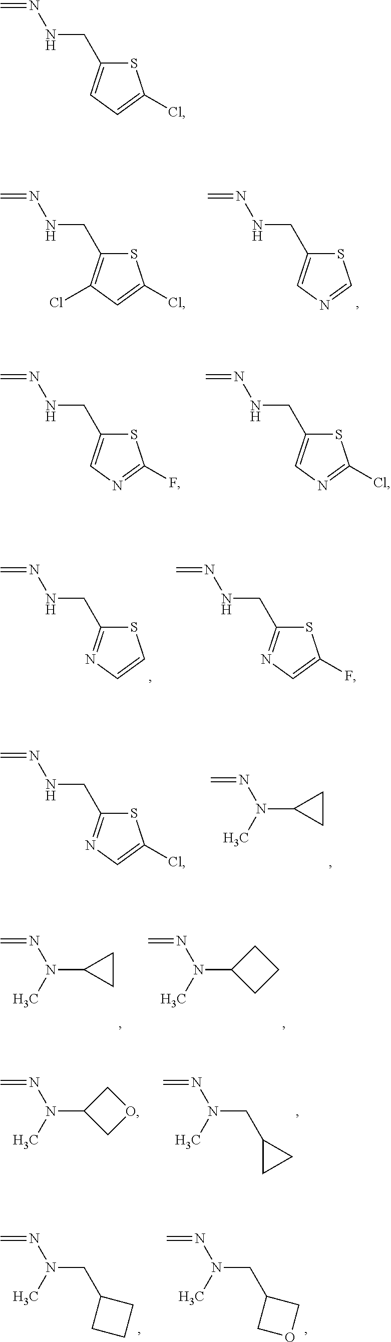

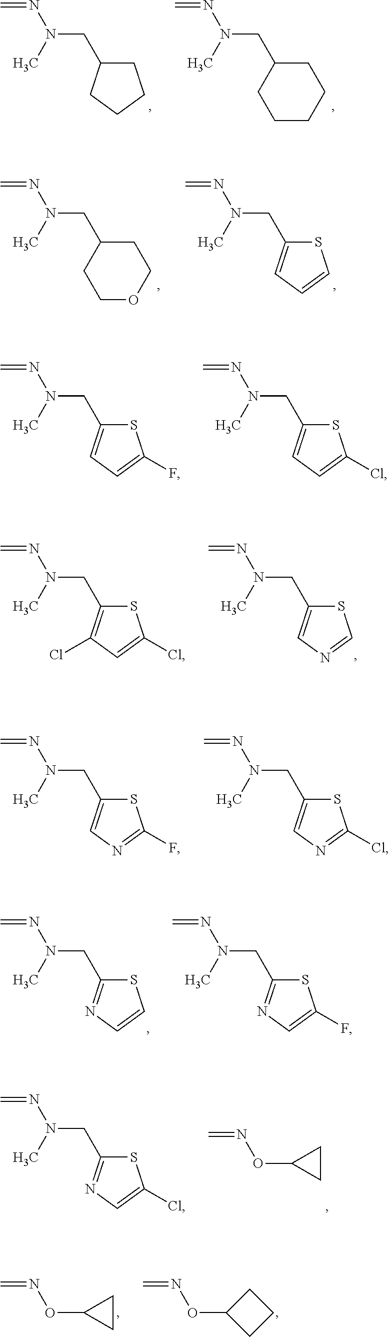

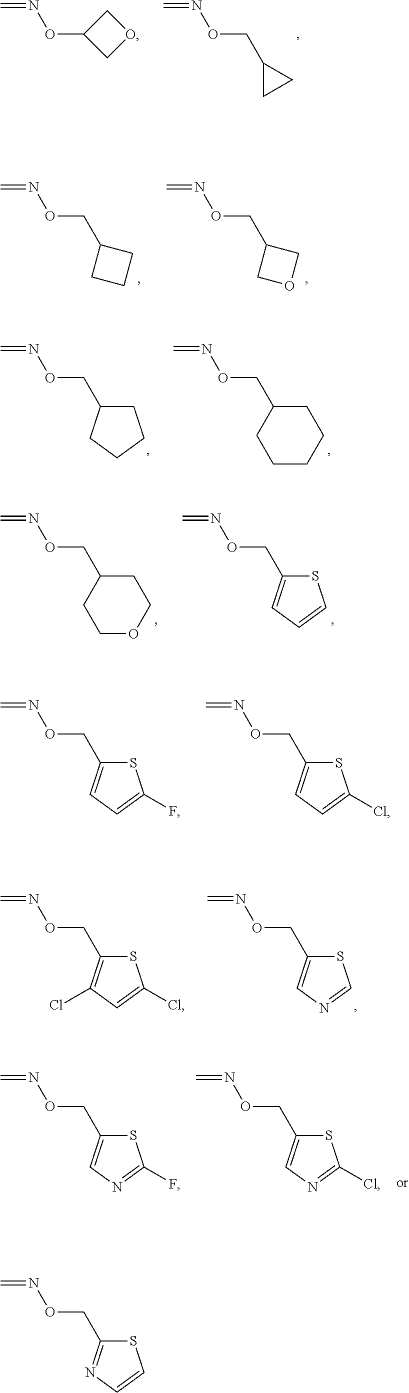

4. A compound of formula (I) according to claim 1 wherein R² is selected from
═O, ═N—OH, ═N—OCH₃, ═N—OCH₂CH₃, ═N—O(CH₂)₂CH₃, ═N—O(CH₂)₃CH₃, ═N—O(CH₂)₄CH₃, ═N—O(CH₂)₅CH₃, ═N—OCH(CH₃)₂, ═N—OC(CH₃)₃, ═N—OCH₂CH(CH₃)₂, ═N—OCH₂C(CH₃)₃, ═N—OPh, ═N—O-4-F-Ph, ═N—O-4-Cl-Ph, ═N—O-2,4-F-Ph, ═N—O-2,4-Cl-Ph, ═N—OCH₂-Ph, ═N—OCH₂-4-F-Ph, ═N—OCH₂-4-Cl-Ph, ═N—OCH₂-2,4-F-Ph, ═N—OCH₂-2,5-F-Ph, ═N—OCH₂-2,6-F-Ph, ═N—OCH₂-3,5-F-Ph, ═N—OCH₂-2,4, 6-F-Ph, ═N—OCH₂-2,4-Cl-Ph, ═N—OCH₂-2,5-Cl-Ph, ═N—OCH₂-2,6-Cl-Ph, ═N—OCH₂-3,5-Cl-Ph, ═N—OCH₂-2,4, 6-Cl-Ph, ═N—OCH₂-2-OMePh, ═N—OCH₂-3-OMePh, ═N—OCH₂-4-OMePh, ═N—O-2-OMe-Ph, ═N—O-3-OMePh, ═N—O-4-OMePh,

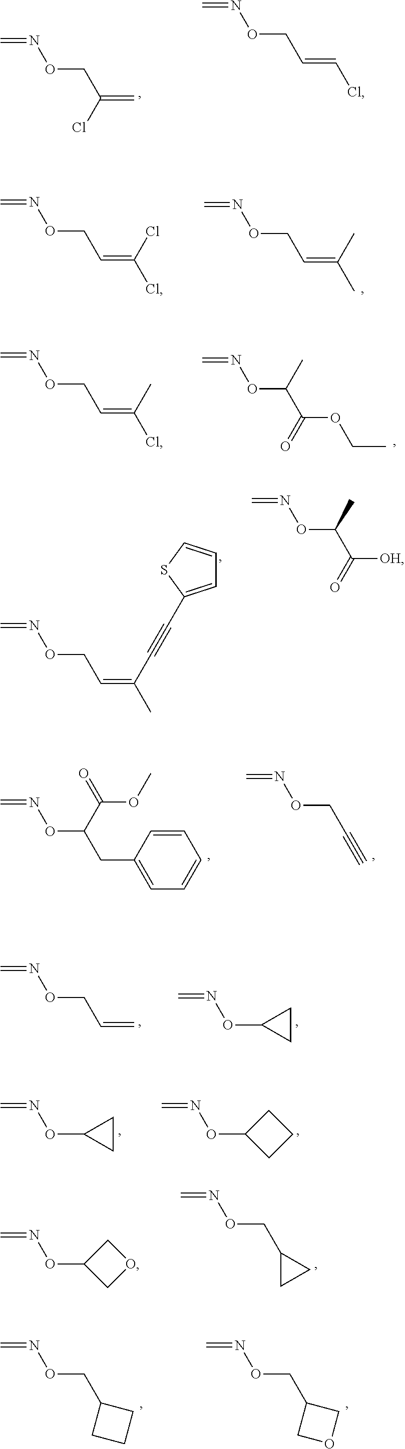

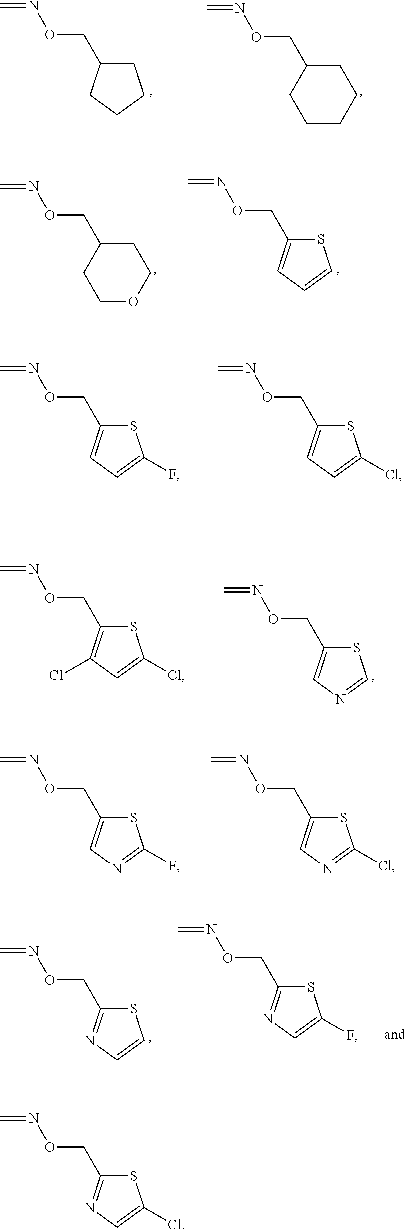

5. A compound of formula (I) according to claim 1 wherein R² is selected from

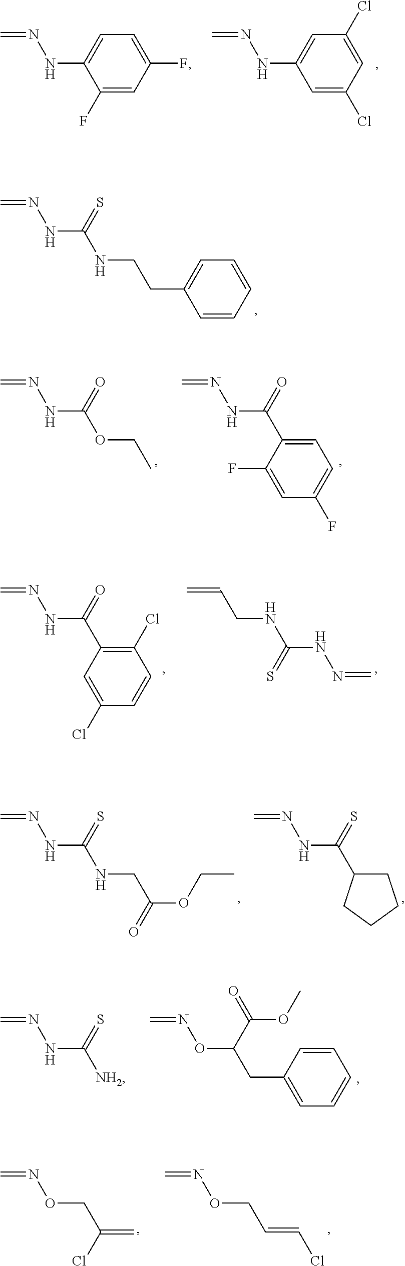

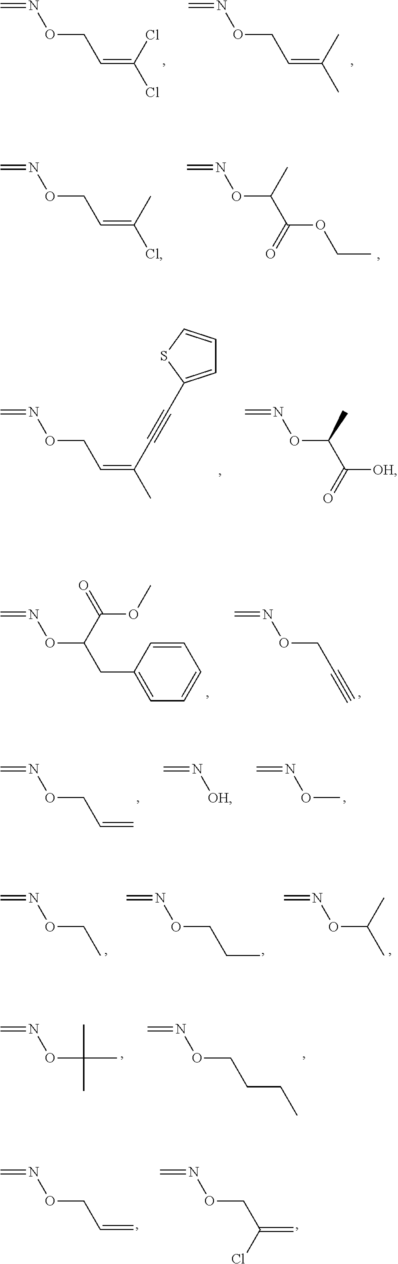

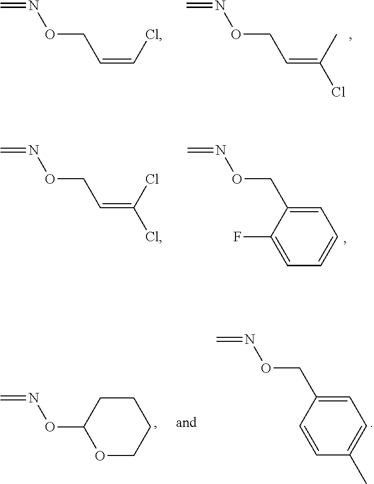

6. A compound of formula (I) according to claim 1 wherein
R² is ═N—O—R⁵, ═N—NR⁶R⁷, ═N—NH(CO)NR⁸R⁹, ═N—NH(CS)NR⁸R⁹.

7. A compound of formula (I) according to claim 1 wherein
R¹ is selected from F and Cl, and
R³ is selected from H, C₁-C₄alkyl, aryl, heteroaryl or C₁-C₄haloalkyl, and C₃-C₇ cycloalkyl.

8. A compound of formula (II) 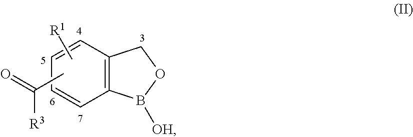
wherein R¹ and R³ are defined under formula (I), provided that
if R¹ is H then —C(O)—R³ is not 6-CHO,
if R¹ is H then —C(O)—R³ is not 4-CHO,
if R¹ is 4-F then —C(O)—R³ is not 7-CHO,
if R¹ is 4-OCH₃ then —C(O)—R³ is not 7-CHO
if R¹ is H then —C(O)—R³ is not 5-CHO,
if R¹ is H then —C(O)—R³ is not 7-CHO,
and if R¹ is H then R³ is not butyl or phenyl.

9. A method of controlling or preventing infestation of useful plants by phytopathogenic microorganisms, wherein a compound of formula (I) as defined in claim 1 is applied to the plants, to parts thereof or the locus thereof.

10. A composition for controlling and protecting against phytopathogenic microorganisms, comprising a compound of formula (I) as defined in claim 1 and at least one auxiliary.

11. A method of controlling phytopathogenic diseases on useful plants or plant propagation material thereof, which comprises applying to said plant propagation material a fungicidally effective amount of a plant propagation material protecting composition comprising a compound of formula (I) as defined in claim 1, together with a suitable carrier therefor.

12. The composition of claim 10 further comprising at least one additional active ingredient.
